(19) United States
(12) Patent Application Publication
(10) Pub. No.: US 2026/0016429 A1
(43) Pub. Date: Jan. 15, 2026

(54) ADVANCED LYOPHILIZATION CONTROL INTERFACES AND TECHNIQUES

(71) Applicants: Michael FREI, Dixon, CA (US); Jonathan FREI, Dixon, CA (US); Elizabeth FREI, Dixon, CA (US); Bruce FREI, Dixon, CA (US); Shane FREI, Dixon, CA (US); Cynthia FREI, DIxon, CA (US); James FREI, Dixon, CA (US); Michael HATCH, Dixon, CA (US); Kenneth HATCH, Sunol, CA (US)

(72) Inventors: Michael FREI, Dixon, CA (US); Jonathan FREI, Dixon, CA (US); Elizabeth FREI, Dixon, CA (US); Bruce FREI, Dixon, CA (US); Shane FREI, Dixon, CA (US); Cynthia FREI, Dixon, CA (US); James FREI, Dixon, CA (US); Michael HATCH, Dixon, CA (US); Kenneth HATCH, Sunol, CA (US)

(21) Appl. No.: 19/269,029

(22) Filed: Jul. 14, 2025

Related U.S. Application Data
(60) Provisional application No. 63/671,256, filed on Jul. 14, 2024.

(51) Int. Cl. G01N 25/14; G06F 3/0483

(52) U.S. Cl. CPC G01N 25/14; G06F 3/0483

(57) ABSTRACT

Advanced methods, apparatuses, and systems are presented for the real-time monitoring and precise control of substances undergoing phase transitions within a vacuum system, in particular, for lyophilization processes. Utilizing sophisticated interfaces, these techniques enable the visualization of phase diagrams depicting the equilibrium conditions of temperature and pressure for distinct substances. Real-time temperature and pressure data are seamlessly integrated and graphically represented on these phase diagrams. Furthermore, the methodology incorporates advanced regression models to accurately estimate mass quantities and employs dynamic environmental control curves for system parameter adjustments. These techniques encompass real-time data analysis, responsive adjustment inputs, intuitive graphical representations that ensure meticulous control and monitoring of phase transitions, thereby optimizing process monitoring and outcomes. The applications span diverse fields including chemical processing, materials science, food science, and pharmaceutical manufacturing, where precise control over phase transitions is paramount.

### FIELD

The present disclosure generally relates to lyophilization processes and freeze-dryers, more specifically to lyophilization controllers, devices, graphical user interfaces, and techniques for interacting and controlling the lyophilization process.

### BACKGROUND

Lyophilization, or freeze-drying, is a process employed to preserve and stabilize a diverse range of substances, including pharmaceuticals, biologics, enzymes, bacteria, foods, and other heat-sensitive substances. In this process, a solvent is extracted from a substance through sublimation, where the solvent within the material directly transitions from a solid state to a vapor state under conditions of reduced pressure and low temperature. The resultant desiccated product offers a range of advantages, such as an extended shelf life, reduced weight and volume, and improved properties upon reconstitution. The process involves meticulous control of process parameters, often accomplished through controllers that prioritize a high degree of automation without providing any insight into the parameters of the machine or process state, potentially hindering any ability to diagnose issues or optimize the lyophilization process. More advanced controllers that provide these parameters offer greater control over the various aspects of the lyophilization process is desirable.

### SUMMARY

The following presents a simplified summary of one or more embodiments in order to provide a basic understanding. This summary is not an extensive overview of all contemplated examples and is intended to neither identify key or important elements of all embodiments nor delineate the scope of any or all embodiments. Its purpose is to present some concepts of one or more embodiments in a simplified form as a prelude to the more detailed description that is presented below.

In accordance with some embodiments, a method is described. The method is performed at a system that is in communication with a display generation component. The method includes displaying, via the display generation component, a phase diagram that illustrates the equilibrium conditions of temperature and pressure corresponding to distinct phases of matter of a first substance; receiving real-time temperature data of a second substance and real-time pressure data of the second substance; and in response to receiving real-time temperature data of a second substance and real-time pressure data of the second substance, displaying, via the display generation component, one or more indicators overlaid on the phase diagram of the first substance, wherein at least one indicator of the one or more indicators represents the real-time temperature data of a second substance and real-time pressure data of the second substance as a coordinate point on the phase diagram.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: displaying, via the display generation component, a phase diagram that illustrates the equilibrium conditions of temperature and pressure corresponding to distinct phases of matter of a first substance; receiving real-time temperature data of a second substance and real-time pressure data of the second substance; and in response to receiving real-time temperature data of a second substance and real-time pressure data of the second substance, displaying, via the display generation component, one or more indicators overlaid on the phase diagram of the first substance, wherein at least one indicator of the one or more indicators represents the real-time temperature data of a second substance and real-time pressure data of the second substance as a coordinate point on the phase diagram.

In accordance with some embodiments, a system that is configured to communicate with a display generation component. The system includes one or more processors; and memory storing one or more programs configured to be executed by the one or more processors, the one or more programs including instructions for: displaying, via the display generation component, a phase diagram that illustrates the equilibrium conditions of temperature and pressure corresponding to distinct phases of matter of a first substance; receiving real-time temperature data of a second substance and real-time pressure data of the second substance; and in response to receiving real-time temperature data of a second substance and real-time pressure data of the second substance, displaying, via the display generation component, one or more indicators overlaid on the phase diagram of the first substance, wherein at least one indicator of the one or more indicators represents the real-time temperature data of a second substance and real-time pressure data of the second substance as a coordinate point on the phase diagram.

In accordance with some embodiments, a system that is configured to communicate with a display generation component. The computer system includes one or more processors; and memory storing one or more programs configured to be executed by the one or more processors, means for displaying, via the display generation component, a phase diagram that illustrates the equilibrium conditions of temperature and pressure corresponding to distinct phases of matter of a first substance; means for receiving real-time temperature data of a second substance and real-time pressure data of the second substance; and means, in response to receiving real-time temperature data of a second substance and real-time pressure data of the second substance, for displaying, via the display generation component, one or more indicators overlaid on the phase diagram of the first substance, wherein at least one indicator of the one or more indicators represents the real-time temperature data of a second substance and real-time pressure data of the second substance as a coordinate point on the phase diagram.

In accordance with some embodiments, a computer program product is described. The computer program product comprises one or more programs configured to be executed by one or more processors of a computer system that is in communication with a display generation component. The one or more programs include instructions for: displaying, via the display generation component, a phase diagram that illustrates the equilibrium conditions of temperature and pressure corresponding to distinct phases of matter of a first substance; receiving real-time temperature data of a second substance and real-time pressure data of the second substance; and in response to receiving real-time temperature data of the second substance and real-time pressure data of the second substance, displaying, via the display generation component, one or more indicators overlaid on the phase diagram of the first substance, wherein at least one indicator of the one or more indicators represents the real-time temperature data of a second substance and real-time pressure data of the second substance as a coordinate point on the phase diagram.

In accordance with some embodiments, a method is described. The method is performed at a system that is in communication with a display generation component. The method includes displaying, via the display generation component, a phase curve of a first substance that delineates a boundary between a first equilibrium phase of matter of the first substance and a second equilibrium phase of matter of the first substance different from the first equilibrium phase of matter of the first substance; in accordance with a determination that a predetermined time period has elapsed: receiving real-time data of a second substance, wherein the real-time data includes real-time temperature and pressure data of the second substance; in response to receiving real-time data of a second substance, displaying, via the display generation component, one or more indicators representing the real-time temperature and pressure data of the second substance relative to the phase curve of the first substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: displaying, via the display generation component, a phase curve of a first substance that delineates a boundary between a first equilibrium phase of matter of the first substance and a second equilibrium phase of matter of the first substance different from the first equilibrium phase of matter of the first substance; in accordance with a determination that a predetermined time period has elapsed: receiving real-time data of a second substance, wherein the real-time data includes real-time temperature and pressure data of the second substance; in response to receiving real-time data of a second substance, displaying, via the display generation component, one or more indicators representing the real-time temperature and pressure data of the second substance relative to the phase curve of the first substance.

In accordance with some embodiments, a system that is configured to communicate with a display generation component. The system includes one or more processors; and memory storing one or more programs configured to be executed by the one or more processors, the one or more programs including instructions for: displaying, via the display generation component, a phase curve of a first substance that delineates a boundary between a first equilibrium phase of matter of the first substance and a second equilibrium phase of matter of the first substance different from the first equilibrium phase of matter of the first substance; in accordance with a determination that a predetermined time period has elapsed: receiving real-time data of a second substance, wherein the real-time data includes real-time temperature and pressure data of the second substance; in response to receiving real-time data of a second substance, displaying, via the display generation component, one or more indicators representing the real-time temperature and pressure data of the second substance relative to the phase curve of the first substance.

In accordance with some embodiments, a system that is configured to communicate with a display generation component. The computer system includes one or more processors; and memory storing one or more programs configured to be executed by the one or more processors, means for displaying, via the display generation component, a phase curve of a first substance that delineates a boundary between a first equilibrium phase of matter of the first substance and a second equilibrium phase of matter of the first substance different from the first equilibrium phase of matter of the first substance; in accordance with a determination that a predetermined time period has elapsed: means for receiving real-time data of a second substance, wherein the real-time data includes real-time temperature and pressure data of the second substance; means, in response to receiving real-time data of a second substance, for displaying, via the display generation component, one or more indicators representing the real-time temperature and pressure data of the second substance relative to the phase curve of the first substance.

In accordance with some embodiments, a computer program product is described. The computer program product comprises one or more programs configured to be executed by one or more processors of a computer system that is in communication with a display generation component. The one or more programs include instructions for: displaying, via the display generation component, a phase curve of a first substance that delineates a boundary between a first equilibrium phase of matter of the first substance and a second equilibrium phase of matter of the first substance different from the first equilibrium phase of matter of the first substance; in accordance with a determination that a predetermined time period has elapsed: receiving real-time data of a second substance, wherein the real-time data includes real-time temperature and pressure data of the second substance; in response to receiving real-time data of a second substance, via the display generation component, one or more indicators representing the real-time temperature and pressure data of the second substance relative to the phase curve of the first substance.

In accordance with some embodiments, a method is described. The method is performed at a system that is in communication with a display generation component. The method includes receiving real-time temperature data and real-time pressure data of a second substance; determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and displaying, via the display generation component, a phase indicator corresponding to the determined phase state of the first substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: receiving real-time temperature data and real-time pressure data of a second substance; determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and displaying, via the display generation component, a phase indicator corresponding to the determined phase state of the first substance.

In accordance with some embodiments, a system that is configured to communicate with a display generation component. The system includes one or more processors; and memory storing one or more programs configured to be executed by the one or more processors, the one or more programs including instructions for: receiving real-time temperature data and real-time pressure data of a second substance; determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and displaying, via the display generation component, a phase indicator corresponding to the determined phase state of the first substance.

In accordance with some embodiments, a system that is configured to communicate with a display generation component. The computer system includes one or more processors; and memory storing one or more programs configured to be executed by the one or more processors, means for receiving real-time temperature data and real-time pressure data of a second substance; means for determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and means for displaying, via the display generation component, a phase indicator corresponding to the determined phase state of the first substance.

In accordance with some embodiments, a computer program product is described. The computer program product comprises one or more programs configured to be executed by one or more processors of a computer system that is in communication with a display generation component. The one or more programs include instructions for: receiving real-time temperature data and real-time pressure data of a second substance; determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and displaying, via the display generation component, a phase indicator corresponding to the determined phase state of the first substance.

In accordance with some embodiments, a method is described. The method is performed at a system that is in communication with a display generation component. The method includes receiving real-time temperature and pressure data of a second substance; in response to receiving the real-time data: displaying, via the display generation component, one or more series of indicators, each indicator representing a point in one or more sequences of data of the second substance, wherein the one or more sequences includes both the real-time data and previously recorded data; and in accordance with a determination that the real-time temperature data and real-time pressure data of the second substance correspond to a first equilibrium phase of matter of a first substance, displaying, via the display generation component, a first equilibrium phase of matter indicator corresponding to the first equilibrium phase of matter of the first substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: receiving real-time temperature and pressure data of a second substance; in response to receiving the real-time data: displaying, via the display generation component, one or more series of indicators, each indicator representing a point in one or more sequences of data of the second substance, wherein the one or more sequences includes both the real-time data and previously recorded data; and in accordance with a determination that the real-time temperature data and real-time pressure data of the second substance correspond to a first equilibrium phase of matter of a first substance, displaying, via the display generation component, a first equilibrium phase of matter indicator corresponding to the first equilibrium phase of matter of the first substance.

In accordance with some embodiments, a system that is configured to communicate with a display generation component. The system includes one or more processors; and memory storing one or more programs configured to be executed by the one or more processors, the one or more programs including instructions for: receiving real-time temperature and pressure data of a second substance; in response to receiving the real-time data: displaying, via the display generation component, one or more series of indicators, each indicator representing a point in one or more sequences of data of the second substance, wherein the one or more sequences includes both the real-time data and previously recorded data; and in accordance with a determination that the real-time temperature data and real-time pressure data of the second substance correspond to a first equilibrium phase of matter of a first substance, displaying, via the display generation component, a first equilibrium phase of matter indicator corresponding to the first equilibrium phase of matter of the first substance.

In accordance with some embodiments, a system that is configured to communicate with a display generation component. The computer system includes one or more processors; and memory storing one or more programs configured to be executed by the one or more processors, means for receiving real-time temperature and pressure data of a second substance; means, in response to receiving the real-time data, for: displaying, via the display generation component, one or more series of indicators, each indicator representing a point in one or more sequences of data of the second substance, wherein the one or more sequences includes both the real-time data and previously recorded data; and in accordance with a determination that the real-time temperature data and real-time pressure data of the second substance correspond to a first equilibrium phase of matter of a first substance, displaying, via the display generation component, a first equilibrium phase of matter indicator corresponding to the first equilibrium phase of matter of the first substance.

In accordance with some embodiments, a computer program product is described. The computer program product comprises one or more programs configured to be executed by one or more processors of a computer system that is in communication with a display generation component. The one or more programs include instructions for: receiving real-time temperature and pressure data of a second substance; in response to receiving the real-time data: displaying, via the display generation component, one or more series of indicators, each indicator representing a point in one or more sequences of data of the second substance, wherein the one or more sequences includes both the real-time data and previously recorded data; and in accordance with a determination that the real-time temperature data and real-time pressure data of the second substance correspond to a first equilibrium phase of matter of a first substance, displaying, via the display generation component, a first equilibrium phase of matter indicator corresponding to the first equilibrium phase of matter of the first substance.

In accordance with some embodiments, a method is described. The method is performed at a system that is in communication with a display generation component. The method includes receiving real-time temperature data and real-time pressure data of a second substance; determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and displaying, via the display generation component, a phase indicator corresponding to the determined phase state of the first substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: receiving real-time temperature data and real-time pressure data of a second substance; determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and displaying, via the display generation component, a phase indicator corresponding to the determined phase state of the first substance.

In accordance with some embodiments, a system that is configured to communicate with a display generation component. The system includes one or more processors; and memory storing one or more programs configured to be executed by the one or more processors, the one or more programs including instructions for: receiving real-time temperature data and real-time pressure data of a second substance; determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and displaying, via the display generation component, a phase indicator corresponding to the determined phase state of the first substance.

In accordance with some embodiments, a system that is configured to communicate with a display generation component. The computer system includes one or more processors; and memory storing one or more programs configured to be executed by the one or more processors, means for receiving real-time temperature data and real-time pressure data of a second substance; means for determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and means for displaying, via the display generation component, a phase indicator corresponding to the determined phase state of the first substance.

In accordance with some embodiments, a computer program product is described. The computer program product comprises one or more programs configured to be executed by one or more processors of a computer system that is in communication with a display generation component. The one or more programs include instructions for: receiving real-time temperature data and real-time pressure data of a second substance; determining, based on the real-time temperature data and real-time pressure data of the second substance, a phase state of a first substance contained within the second substance, wherein the phase state corresponds to either: an equilibrium phase of matter of the first substance, or a transition between equilibrium phases of matter of the first substance; and displaying, via the display generation component, a phase indicator corresponding to the determined phase state of the first substance.

In accordance with some embodiments, a method is described. The method is performed at a system that is in communication with a display generation component. The method includes displaying, via the display generation component, a first phase matter indicator corresponding to a first equilibrium phase of matter of a first substance; receiving, real-time temperature and pressure data of a second substance; and in response to receiving the real-time data, displaying, via the display generation component: a series of temperature indicators, each representing a point in a sequence of temperature data of the second substance, wherein the sequence includes both the real-time temperature data and previously recorded temperature data; and a series of pressure indicators, each representing a point in a sequence of pressure data of the second substance, wherein the sequence includes both the real-time pressure data and previously recorded pressure data; wherein the series of temperature and pressure indicators provide a chronological visualization of the temperature and pressure changes of the second substance over time in relation to equilibrium phase of matter of the first substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: displaying, via the display generation component, a first phase matter indicator corresponding to a first equilibrium phase of matter of a first substance; receiving, real-time temperature and pressure data of a second substance; and in response to receiving the real-time data, displaying, via the display generation component: a series of temperature indicators, each representing a point in a sequence of temperature data of the second substance, wherein the sequence includes both the real-time temperature data and previously recorded temperature data; and a series of pressure indicators, each representing a point in a sequence of pressure data of the second substance, wherein the sequence includes both the real-time pressure data and previously recorded pressure data; wherein the series of temperature and pressure indicators provide a chronological visualization of the temperature and pressure changes of the second substance over time in relation to equilibrium phase of matter of the first substance.

In accordance with some embodiments, a system that is configured to communicate with a display generation component. The system includes one or more processors; and memory storing one or more programs configured to be executed by the one or more processors, the one or more programs including instructions for: displaying, via the display generation component, a first phase matter indicator corresponding to a first equilibrium phase of matter of a first substance; receiving, real-time temperature and pressure data of a second substance; and in response to receiving the real-time data, displaying, via the display generation component: a series of temperature indicators, each representing a point in a sequence of temperature data of the second substance, wherein the sequence includes both the real-time temperature data and previously recorded temperature data; and a series of pressure indicators, each representing a point in a sequence of pressure data of the second substance, wherein the sequence includes both the real-time pressure data and previously recorded pressure data; wherein the series of temperature and pressure indicators provide a chronological visualization of the temperature and pressure changes of the second substance over time in relation to equilibrium phase of matter of the first substance.

In accordance with some embodiments, a system that is configured to communicate with a display generation component. The computer system includes one or more processors; and memory storing one or more programs configured to be executed by the one or more processors, means for displaying, via the display generation component, a first phase matter indicator corresponding to a first equilibrium phase of matter of a first substance; means for receiving, real-time temperature and pressure data of a second substance; and means, in response to receiving the real-time data, for, displaying, via the display generation component: a series of temperature indicators, each representing a point in a sequence of temperature data of the second substance, wherein the sequence includes both the real-time temperature data and previously recorded temperature data; and a series of pressure indicators, each representing a point in a sequence of pressure data of the second substance, wherein the sequence includes both the real-time pressure data and previously recorded pressure data; wherein the series of temperature and pressure indicators provide a chronological visualization of the temperature and pressure changes of the second substance over time in relation to equilibrium phase of matter of the first substance.

In accordance with some embodiments, a computer program product is described. The computer program product comprises one or more programs configured to be executed by one or more processors of a computer system that is in communication with a display generation component. The one or more programs include instructions for: displaying, via the display generation component, a first phase matter indicator corresponding to a first equilibrium phase of matter of a first substance; receiving, real-time temperature and pressure data of a second substance; and in response to receiving the real-time data, displaying, via the display generation component: a series of temperature indicators, each representing a point in a sequence of temperature data of the second substance, wherein the sequence includes both the real-time temperature data and previously recorded temperature data; and a series of pressure indicators, each representing a point in a sequence of pressure data of the second substance, wherein the sequence includes both the real-time pressure data and previously recorded pressure data; wherein the series of temperature and pressure indicators provide a chronological visualization of the temperature and pressure changes of the second substance over time in relation to equilibrium phase of matter of the first substance.

In accordance with some embodiments, a method is described. The method is performed at a system that is in communication with a display generation component. The method includes displaying, via the display generation component, a first equilibrium phase of matter indicator corresponding to a first equilibrium phase of matter of a first substance; and in accordance with a determination that a first predetermined time period has elapsed: receiving real-time temperature and pressure data of the second substance; and in response to receiving real-time temperature and pressure data of the second substance: adding the real-time temperature data of the second substance to a sequence of temperature data of the second substance and adding the real-time pressure data of the second substance to a sequence of pressure data of the second substance; and displaying, via the display generation component: a plurality of indicators representing the sequence of temperature data of the second substance with respect to time; and a plurality of indicators representing the sequence of pressure data of the second substance with respect to time.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: displaying, via the display generation component, a first equilibrium phase of matter indicator corresponding to a first equilibrium phase of matter of a first substance; and in accordance with a determination that a first predetermined time period has elapsed: receiving real-time temperature and pressure data of the second substance; and in response to receiving real-time temperature and pressure data of the second substance: adding the real-time temperature data of the second substance to a sequence of temperature data of the second substance and adding the real-time pressure data of the second substance to a sequence of pressure data of the second substance; and displaying, via the display generation component: a plurality of indicators representing the sequence of temperature data of the second substance with respect to time; and a plurality of indicators representing the sequence of pressure data of the second substance with respect to time.

In accordance with some embodiments, a system that is configured to communicate with a display generation component. The system includes one or more processors; and memory storing one or more programs configured to be executed by the one or more processors, the one or more programs including instructions for: displaying, via the display generation component, a first equilibrium phase of matter indicator corresponding to a first equilibrium phase of matter of a first substance; and in accordance with a determination that a first predetermined time period has elapsed: receiving real-time temperature and pressure data of the second substance; and in response to receiving real-time temperature and pressure data of the second substance: adding the real-time temperature data of the second substance to a sequence of temperature data of the second substance and adding the real-time pressure data of the second substance to a sequence of pressure data of the second substance; and displaying, via the display generation component: a plurality of indicators representing the sequence of temperature data of the second substance with respect to time; and a plurality of indicators representing the sequence of pressure data of the second substance with respect to time.

In accordance with some embodiments, a system that is configured to communicate with a display generation component. The computer system includes one or more processors; and memory storing one or more programs configured to be executed by the one or more processors, means for displaying, via the display generation component, a first equilibrium phase of matter indicator corresponding to a first equilibrium phase of matter of a first substance; and in accordance with a determination that a first predetermined time period has elapsed: means for receiving real-time temperature and pressure data of the second substance; and means, in response to receiving real-time temperature and pressure data of the second substance, for: adding the real-time temperature data of the second substance to a sequence of temperature data of the second substance and adding the real-time pressure data of the second substance to a sequence of pressure data of the second substance; and displaying, via the display generation component: a plurality of indicators representing the sequence of temperature data of the second substance with respect to time; and a plurality of indicators representing the sequence of pressure data of the second substance with respect to time.

In accordance with some embodiments, a computer program product is described. The computer program product comprises one or more programs configured to be executed by one or more processors of a computer system that is in communication with a display generation component. The one or more programs include instructions for: displaying, via the display generation component, a first equilibrium phase of matter indicator corresponding to a first equilibrium phase of matter of a first substance; and in accordance with a determination that a first predetermined time period has elapsed: receiving real-time temperature and pressure data of the second substance; and in response to receiving real-time temperature and pressure data of the second substance: adding the real-time temperature data of the second substance to a sequence of temperature data of the second substance and adding the real-time pressure data of the second substance to a sequence of pressure data of the second substance; and displaying, via the display generation component: a plurality of indicators representing the sequence of temperature data of the second substance with respect to time; and a plurality of indicators representing the sequence of pressure data of the second substance with respect to time.

In accordance with some embodiments, a method is described. The method is performed at a system that is in communication with a display generation component. The method includes receiving a sequence of temperature data of a second substance; in accordance with a determination that the sequence of temperature data includes temperature data corresponding to a sequence of liquid temperature data of a first substance, a sequence of liquid-solid equilibrium temperature data of the first substance, and a sequence of solid temperature data of the first substance: fitting a first regression model to the sequence of liquid temperature data, a second regression model to the sequence of liquid-solid equilibrium temperature data, and a third regression model to the sequence of solid temperature data; calculating a liquidus point corresponding to an intersection of the first regression model and the second regression model, and a solidus point corresponding to an intersection of the second regression model and the third regression model; estimating mass of the first substance based on a time difference between the liquidus point and the solidus point; and displaying, via the display generation component, a representation corresponding to the mass estimate of the first substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: receiving real-time temperature and pressure data of a second substance; receiving a sequence of temperature data of a second substance; in accordance with a determination that the sequence of temperature data includes temperature data corresponding to a sequence of liquid temperature data of a first substance, a sequence of liquid-solid equilibrium temperature data of the first substance, and a sequence of solid temperature data of the first substance: fitting a first regression model to the sequence of liquid temperature data, a second regression model to the sequence of liquid-solid equilibrium temperature data, and a third regression model to the sequence of solid temperature data; calculating a liquidus point corresponding to an intersection of the first regression model and the second regression model, and a solidus point corresponding to an intersection of the second regression model and the third regression model; estimating mass of the first substance based on a time difference between the liquidus point and the solidus point; and displaying, via the display generation component, a representation corresponding to the mass estimate of the first substance.

In accordance with some embodiments, a system that is configured to communicate with a display generation component. The system includes one or more processors; and memory storing one or more programs configured to be executed by the one or more processors, the one or more programs including instructions for: receiving real-time temperature and pressure data of a second substance; receiving a sequence of temperature data of a second substance; in accordance with a determination that the sequence of temperature data includes temperature data corresponding to a sequence of liquid temperature data of a first substance, a sequence of liquid-solid equilibrium temperature data of the first substance, and a sequence of solid temperature data of the first substance: fitting a first regression model to the sequence of liquid temperature data, a second regression model to the sequence of liquid-solid equilibrium temperature data, and a third regression model to the sequence of solid temperature data; calculating a liquidus point corresponding to an intersection of the first regression model and the second regression model, and a solidus point corresponding to an intersection of the second regression model and the third regression model; estimating mass of the first substance based on a time difference between the liquidus point and the solidus point; and displaying, via the display generation component, a representation corresponding to the mass estimate of the first substance.

In accordance with some embodiments, a system that is configured to communicate with a display generation component. The computer system includes one or more processors; and memory storing one or more programs configured to be executed by the one or more processors, means for receiving a sequence of temperature data of a second substance; in accordance with a determination that the sequence of temperature data includes temperature data corresponding to a sequence of liquid temperature data of a first substance, a sequence of liquid-solid equilibrium temperature data of the first substance, and a sequence of solid temperature data of the first substance: means for fitting a first regression model to the sequence of liquid temperature data, a second regression model to the sequence of liquid-solid equilibrium temperature data, and a third regression model to the sequence of solid temperature data; means for calculating a liquidus point corresponding to an intersection of the first regression model and the second regression model, and a solidus point corresponding to an intersection of the second regression model and the third regression model; means for estimating mass of the first substance based on a time difference between the liquidus point and the solidus point; and means for displaying, via the display generation component, a representation corresponding to the mass estimate of the first substance.

In accordance with some embodiments, a computer program product is described. The computer program product comprises one or more programs configured to be executed by one or more processors of a computer system that is in communication with a display generation component. The one or more programs include instructions for: receiving real-time temperature and pressure data of a second substance; receiving a sequence of temperature data of a second substance; in accordance with a determination that the sequence of temperature data includes temperature data corresponding to a sequence of liquid temperature data of a first substance, a sequence of liquid-solid equilibrium temperature data of the first substance, and a sequence of solid temperature data of the first substance: fitting a first regression model to the sequence of liquid temperature data, a second regression model to the sequence of liquid-solid equilibrium temperature data, and a third regression model to the sequence of solid temperature data; calculating a liquidus point corresponding to an intersection of the first regression model and the second regression model, and a solidus point corresponding to an intersection of the second regression model and the third regression model; estimating mass of the first substance based on a time difference between the liquidus point and the solidus point; and displaying, via the display generation component, a representation corresponding to the mass estimate of the first substance.

In accordance with some embodiments, a method is described. The method is performed at a system that is in communication with a display generation component. The method includes receiving real-time temperature data of a second substance; adding the real-time temperature data to a sequence of temperature data of the second substance; in accordance with a determination that the real-time temperature data exceeds a temperature threshold: fitting a first linear regression model to a first portion of the sequence of temperature data of the second substance, a second linear regression model to a second portion of the sequence of temperature data of the second substance, and a third linear regression model to a third portion of the sequence of temperature data of the second substance; calculating a first intersection of the first linear regression model with the third linear regression model and a second intersection of the second linear regression model with the third linear regression model; estimating mass of a first substance based on a time difference between the first intersection and the second intersection; and displaying, via the display generation component, a representation corresponding to the mass estimate of the first substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: receiving real-time temperature data of a second substance; adding the real-time temperature data to a sequence of temperature data of the second substance; in accordance with a determination that the real-time temperature data exceeds a temperature threshold: fitting a first linear regression model to a first portion of the sequence of temperature data of the second substance, a second linear regression model to a second portion of the sequence of temperature data of the second substance, and a third linear regression model to a third portion of the sequence of temperature data of the second substance; calculating a first intersection of the first linear regression model with the third linear regression model and a second intersection of the second linear regression model with the third linear regression model; estimating mass of a first substance based on a time difference between the first intersection and the second intersection; and displaying, via the display generation component, a representation corresponding to the mass estimate of the first substance.

In accordance with some embodiments, a system that is configured to communicate with a display generation component. The system includes one or more processors; and memory storing one or more programs configured to be executed by the one or more processors, the one or more programs including instructions for: receiving real-time temperature data of a second substance; adding the real-time temperature data to a sequence of temperature data of the second substance; in accordance with a determination that the real-time temperature data exceeds a temperature threshold: fitting a first linear regression model to a first portion of the sequence of temperature data of the second substance, a second linear regression model to a second portion of the sequence of temperature data of the second substance, and a third linear regression model to a third portion of the sequence of temperature data of the second substance; calculating a first intersection of the first linear regression model with the third linear regression model and a second intersection of the second linear regression model with the third linear regression model; estimating mass of a first substance based on a time difference between the first intersection and the second intersection; and displaying, via the display generation component, a representation corresponding to the mass estimate of the first substance.

In accordance with some embodiments, a system that is configured to communicate with a display generation component. The computer system includes one or more processors; and memory storing one or more programs configured to be executed by the one or more processors, means for receiving real-time temperature data of a second substance; means for adding the real-time temperature data to a sequence of temperature data of the second substance; in accordance with a determination that the real-time temperature data exceeds a temperature threshold: means for fitting a first linear regression model to a first portion of the sequence of temperature data of the second substance, a second linear regression model to a second portion of the sequence of temperature data of the second substance, and a third linear regression model to a third portion of the sequence of temperature data of the second substance; means for calculating a first intersection of the first linear regression model with the third linear regression model and a second intersection of the second linear regression model with the third linear regression model; means for estimating mass of a first substance based on a time difference between the first intersection and the second intersection; and means for displaying, via the display generation component, a representation corresponding to the mass estimate of the first substance.

In accordance with some embodiments, a computer program product is described. The computer program product comprises one or more programs configured to be executed by one or more processors of a computer system that is in communication with a display generation component. The one or more programs include instructions for: receiving real-time temperature data of a second substance; adding the real-time temperature data to a sequence of temperature data of the second substance; in accordance with a determination that the real-time temperature data exceeds a temperature threshold: fitting a first linear regression model to a first portion of the sequence of temperature data of the second substance, a second linear regression model to a second portion of the sequence of temperature data of the second substance, and a third linear regression model to a third portion of the sequence of temperature data of the second substance; calculating a first intersection of the first linear regression model with the third linear regression model and a second intersection of the second linear regression model with the third linear regression model; estimating mass of a first substance based on a time difference between the first intersection and the second intersection; and displaying, via the display generation component, a representation corresponding to the mass estimate of the first substance.

In accordance with some embodiments, a method is described. The method is performed at a system that is in communication with a display generation component. The method includes displaying, via the display generation component: a phase diagram that illustrates the equilibrium conditions of temperature and pressure corresponding to distinct phases of matter of a first substance; and an environmental control curve of a second substance in relation to the phase diagram, wherein the environmental control curve corresponds to connections of one or more set point responses to an environmental control variable; detecting an adjustment input to the environmental control curve; and in response to detecting the adjustment input to the environmental control curve: adjusting at least one set point of the environmental control variable; and updating displaying, via the display generation component, the environmental control curve in relation to the phase diagram reflecting a response to the at least one set point.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: displaying, via the display generation component: a phase diagram that illustrates the equilibrium conditions of temperature and pressure corresponding to distinct phases of matter of a first substance; and an environmental control curve of a second substance in relation to the phase diagram, wherein the environmental control curve corresponds to connections of one or more set point responses to an environmental control variable; detecting an adjustment input to the environmental control curve; and in response to detecting the adjustment input to the environmental control curve: adjusting at least one set point of the environmental control variable; and updating displaying, via the display generation component, the environmental control curve in relation to the phase diagram reflecting a response to the at least one set point.

In accordance with some embodiments, a system that is configured to communicate with a display generation component. The system includes one or more processors; and memory storing one or more programs configured to be executed by the one or more processors, the one or more programs including instructions for: displaying, via the display generation component: a phase diagram that illustrates the equilibrium conditions of temperature and pressure corresponding to distinct phases of matter of a first substance; and an environmental control curve of a second substance in relation to the phase diagram, wherein the environmental control curve corresponds to connections of one or more set point responses to an environmental control variable; detecting an adjustment input to the environmental control curve; and in response to detecting the adjustment input to the environmental control curve: adjusting at least one set point of the environmental control variable; and updating displaying, via the display generation component, the environmental control curve in relation to the phase diagram reflecting a response to the at least one set point.

In accordance with some embodiments, a system that is configured to communicate with a display generation component. The computer system includes one or more processors; and memory storing one or more programs configured to be executed by the one or more processors, means for displaying, via the display generation component: a phase diagram that illustrates the equilibrium conditions of temperature and pressure corresponding to distinct phases of matter of a first substance; and an environmental control curve of a second substance in relation to the phase diagram, wherein the environmental control curve corresponds to connections of one or more set point responses to an environmental control variable; means for detecting an adjustment input to the environmental control curve; and means, in response to detecting the adjustment input to the environmental control curve, for: adjusting at least one set point of the environmental control variable; and updating displaying, via the display generation component, the environmental control curve in relation to the phase diagram reflecting a response to the at least one set point.

In accordance with some embodiments, a computer program product is described. The computer program product comprises one or more programs configured to be executed by one or more processors of a computer system that is in communication with a display generation component. The one or more programs include instructions for: displaying, via the display generation component: a phase diagram that illustrates the equilibrium conditions of temperature and pressure corresponding to distinct phases of matter of a first substance; and an environmental control curve of a second substance in relation to the phase diagram, wherein the environmental control curve corresponds to connections of one or more set point responses to an environmental control variable; detecting an adjustment input to the environmental control curve; and in response to detecting the adjustment input to the environmental control curve: adjusting at least one set point of the environmental control variable; and updating displaying, via the display generation component, the environmental control curve in relation to the phase diagram reflecting a response to the at least one set point.

In accordance with some embodiments, a method is described. The method is performed at a system that is in communication with a display generation component. The method includes displaying, via the display generation component: a phase curve of a first substance, wherein the phase curve delineates a boundary between a first phase and a second phase of the first substance, the second phase being distinct from the first phase; and an environmental control curve of a second substance in relation to the phase curve of the first substance, wherein the environmental control curve of the second substance represents a series of set point responses to an environmental control variable; detecting an adjustment input to the environmental control curve; in response to detecting the adjustment input to the environmental control curve: adjusting at least one set point of the environmental control variable; and displaying, via the display generation component, an updated environmental control curve of the second substance reflecting the adjusted set point.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: displaying, via the display generation component: a phase curve of a first substance, wherein the phase curve delineates a boundary between a first phase and a second phase of the first substance, the second phase being distinct from the first phase; and an environmental control curve of a second substance in relation to the phase curve of the first substance, wherein the environmental control curve of the second substance represents a series of set point responses to an environmental control variable; detecting an adjustment input to the environmental control curve; in response to detecting the adjustment input to the environmental control curve: adjusting at least one set point of the environmental control variable; and displaying, via the display generation component, an updated environmental control curve of the second substance reflecting the adjusted set point.

In accordance with some embodiments, a system that is configured to communicate with a display generation component. The system includes one or more processors; and memory storing one or more programs configured to be executed by the one or more processors, the one or more programs including instructions for: displaying, via the display generation component: a phase curve of a first substance, wherein the phase curve delineates a boundary between a first phase and a second phase of the first substance, the second phase being distinct from the first phase; and an environmental control curve of a second substance in relation to the phase curve of the first substance, wherein the environmental control curve of the second substance represents a series of set point responses to an environmental control variable; detecting an adjustment input to the environmental control curve; in response to detecting the adjustment input to the environmental control curve: adjusting at least one set point of the environmental control variable; and displaying, via the display generation component, an updated environmental control curve of the second substance reflecting the adjusted set point.

In accordance with some embodiments, a system that is configured to communicate with a display generation component. The computer system includes one or more processors; and memory storing one or more programs configured to be executed by the one or more processors, means for displaying, via the display generation component: a phase curve of a first substance, wherein the phase curve delineates a boundary between a first phase and a second phase of the first substance, the second phase being distinct from the first phase; and an environmental control curve of a second substance in relation to the phase curve of the first substance, wherein the environmental control curve of the second substance represents a series of set point responses to an environmental control variable; means for detecting an adjustment input to the environmental control curve; means, in response to detecting the adjustment input to the environmental control curve for: adjusting at least one set point of the environmental control variable; and displaying, via the display generation component, an updated environmental control curve of the second substance reflecting the adjusted set point.

In accordance with some embodiments, a computer program product is described. The computer program product comprises one or more programs configured to be executed by one or more processors of a computer system that is in communication with a display generation component. The one or more programs include instructions for: displaying, via the display generation component: a phase curve of a first substance, wherein the phase curve delineates a boundary between a first phase and a second phase of the first substance, the second phase being distinct from the first phase; and an environmental control curve of a second substance in relation to the phase curve of the first substance, wherein the environmental control curve of the second substance represents a series of set point responses to an environmental control variable; detecting an adjustment input to the environmental control curve; in response to detecting the adjustment input to the environmental control curve: adjusting at least one set point of the environmental control variable; and displaying, via the display generation component, an updated environmental control curve of the second substance reflecting the adjusted set point.

In accordance with some embodiments, a method is described. The method is performed at a system that is in communication with a display generation component. The method includes displaying, via the display generation component: a pressure control curve of a second substance, representing one or more pressure responses to one or more environmental control variables, wherein the second substance includes a first substance; and a temperature control curve of the second substance, representing one or more temperature responses to the one or more environmental control variables, and wherein interrelationship between the one or more pressure responses and the one or more temperature responses is based on a pressure and temperature relationship of the first substance; detecting an adjustment input; and in response to detecting the adjustment input: in accordance with a determination that the adjustment input corresponds to adjusting the pressure control curve, adjusting position of at least a portion of the pressure control curve and adjusting position of at least a portion of a corresponding portion of the temperature control curve based on the pressure and temperature relationship of the first substance; in accordance with a determination that the adjustment input corresponds to adjusting the temperature control curve, adjusting position of at least a portion of the temperature control curve and adjusting position of at least a portion of a corresponding portion of the pressure control curve based on the pressure and temperature relationship of the first substance; and updating display of, via the display generation component, the adjusted pressure control curve or the adjusted temperature control curve of the second substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: displaying, via the display generation component: a pressure control curve of a second substance, representing one or more pressure responses to one or more environmental control variables, wherein the second substance includes a first substance; and a temperature control curve of the second substance, representing one or more temperature responses to the one or more environmental control variables, and wherein interrelationship between the one or more pressure responses and the one or more temperature responses is based on a pressure and temperature relationship of the first substance; detecting an adjustment input; and in response to detecting the adjustment input: in accordance with a determination that the adjustment input corresponds to adjusting the pressure control curve, adjusting position of at least a portion of the pressure control curve and adjusting position of at least a portion of a corresponding portion of the temperature control curve based on the pressure and temperature relationship of the first substance; in accordance with a determination that the adjustment input corresponds to adjusting the temperature control curve, adjusting position of at least a portion of the temperature control curve and adjusting position of at least a portion of a corresponding portion of the pressure control curve based on the pressure and temperature relationship of the first substance; and updating display of, via the display generation component, the adjusted pressure control curve or the adjusted temperature control curve of the second substance.

In accordance with some embodiments, a system that is configured to communicate with a display generation component. The system includes one or more processors; and memory storing one or more programs configured to be executed by the one or more processors, the one or more programs including instructions for: displaying, via the display generation component: a pressure control curve of a second substance, representing one or more pressure responses to one or more environmental control variables, wherein the second substance includes a first substance; and a temperature control curve of the second substance, representing one or more temperature responses to the one or more environmental control variables, and wherein interrelationship between the one or more pressure responses and the one or more temperature responses is based on a pressure and temperature relationship of the first substance; detecting an adjustment input; and in response to detecting the adjustment input: in accordance with a determination that the adjustment input corresponds to adjusting the pressure control curve, adjusting position of at least a portion of the pressure control curve and adjusting position of at least a portion of a corresponding portion of the temperature control curve based on the pressure and temperature relationship of the first substance; in accordance with a determination that the adjustment input corresponds to adjusting the temperature control curve, adjusting position of at least a portion of the temperature control curve and adjusting position of at least a portion of a corresponding portion of the pressure control curve based on the pressure and temperature relationship of the first substance; and updating display of, via the display generation component, the adjusted pressure control curve or the adjusted temperature control curve of the second substance.

In accordance with some embodiments, a system that is configured to communicate with a display generation component. The computer system includes one or more processors; and memory storing one or more programs configured to be executed by the one or more processors, means for displaying, via the display generation component: a pressure control curve of a second substance, representing one or more pressure responses to one or more environmental control variables, wherein the second substance includes a first substance; and a temperature control curve of the second substance, representing one or more temperature responses to the one or more environmental control variables, and wherein interrelationship between the one or more pressure responses and the one or more temperature responses is based on a pressure and temperature relationship of the first substance; means for detecting an adjustment input; and means, in response to detecting the adjustment input, for: in accordance with a determination that the adjustment input corresponds to adjusting the pressure control curve, adjusting position of at least a portion of the pressure control curve and adjusting position of at least a portion of a corresponding portion of the temperature control curve based on the pressure and temperature relationship of the first substance; in accordance with a determination that the adjustment input corresponds to adjusting the temperature control curve, adjusting position of at least a portion of the temperature control curve and adjusting position of at least a portion of a corresponding portion of the pressure control curve based on the pressure and temperature relationship of the first substance; and updating display of, via the display generation component, the adjusted pressure control curve or the adjusted temperature control curve of the second substance.

In accordance with some embodiments, a computer program product is described. The computer program product comprises one or more programs configured to be executed by one or more processors of a computer system that is in communication with a display generation component. The one or more programs include instructions for: displaying, via the display generation component: a pressure control curve of a second substance, representing one or more pressure responses to one or more environmental control variables, wherein the second substance includes a first substance; and a temperature control curve of the second substance, representing one or more temperature responses to the one or more environmental control variables, and wherein interrelationship between the one or more pressure responses and the one or more temperature responses is based on a pressure and temperature relationship of the first substance; detecting an adjustment input; and in response to detecting the adjustment input: in accordance with a determination that the adjustment input corresponds to adjusting the pressure control curve, adjusting position of at least a portion of the pressure control curve and adjusting position of at least a portion of a corresponding portion of the temperature control curve based on the pressure and temperature relationship of the first substance; in accordance with a determination that the adjustment input corresponds to adjusting the temperature control curve, adjusting position of at least a portion of the temperature control curve and adjusting position of at least a portion of a corresponding portion of the pressure control curve based on the pressure and temperature relationship of the first substance; and updating display of, via the display generation component, the adjusted pressure control curve or the adjusted temperature control curve of the second substance.

In accordance with some embodiments, a method is described. The method is performed at a system that is in communication with a display generation component. The method includes in response to an elapse of a predetermined time period: receiving real-time data, including a real-time temperature measurement of a second substance and a real-time pressure measurement of the second substance; deriving an equilibrium phase of matter of a first substance from the real-time temperature and pressure measurements of the second substance; and persistently displaying, via the display generation component, the temperature measurement of the second substance, the pressure measurement of the second substance, and the equilibrium phase of matter of the first substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: in response to an elapse of a predetermined time period: receiving real-time data, including a real-time temperature measurement of a second substance and a real-time pressure measurement of the second substance; deriving an equilibrium phase of matter of a first substance from the real-time temperature and pressure measurements of the second substance; and persistently displaying, via the display generation component, the temperature measurement of the second substance, the pressure measurement of the second substance, and the equilibrium phase of matter of the first substance.

In accordance with some embodiments, a system that is configured to communicate with a display generation component. The system includes one or more processors; and memory storing one or more programs configured to be executed by the one or more processors, the one or more programs including instructions for: in response to an elapse of a predetermined time period: receiving real-time data, including a real-time temperature measurement of a second substance and a real-time pressure measurement of the second substance; deriving an equilibrium phase of matter of a first substance from the real-time temperature and pressure measurements of the second substance; and persistently displaying, via the display generation component, the temperature measurement of the second substance, the pressure measurement of the second substance, and the equilibrium phase of matter of the first substance.

In accordance with some embodiments, a system that is configured to communicate with a display generation component. The computer system includes one or more processors; and memory storing one or more programs configured to be executed by the one or more processors, means, in response to an elapse of a predetermined time period, for: receiving real-time data, including a real-time temperature measurement of a second substance and a real-time pressure measurement of the second substance; deriving an equilibrium phase of matter of a first substance from the real-time temperature and pressure measurements of the second substance; and persistently displaying, via the display generation component, the temperature measurement of the second substance, the pressure measurement of the second substance, and the equilibrium phase of matter of the first substance.

In accordance with some embodiments, a computer program product is described. The computer program product comprises one or more programs configured to be executed by one or more processors of a computer system that is in communication with a display generation component. The one or more programs include instructions for: in response to an elapse of a predetermined time period: receiving real-time data, including a real-time temperature measurement of a second substance and a real-time pressure measurement of the second substance; deriving an equilibrium phase of matter of a first substance from the real-time temperature and pressure measurements of the second substance; and persistently displaying, via the display generation component, the temperature measurement of the second substance, the pressure measurement of the second substance, and the equilibrium phase of matter of the first substance.

In accordance with some embodiments, a method is described. The method is performed at a system that is in communication with a display generation component and a pressure sensor. The method includes setting a first predetermined condition; and in accordance with meeting the first predetermined condition: enabling the pressure sensor; detecting real-time pressure using the enabled pressure sensor; and displaying, via the display generation component, a pressure indicator to reflect the real-time pressure.

In accordance with some embodiments, a non-transitory computer-readable storage medium is described. The non-transitory computer-readable storage medium storing one or more programs configured to be executed by one or more processors of a computer system, wherein the system is in communication with a display generation component and a pressure sensor, the one or more programs including instructions for: setting a first predetermined condition; and in accordance with meeting the first predetermined condition: enabling the pressure sensor; detecting real-time pressure using the enabled pressure sensor; and displaying, via the display generation component, a pressure indicator to reflect the real-time pressure.

In accordance with some embodiments, a system that is configured to communicate with a display generation component and a pressure sensor. The system includes one or more processors; and memory storing one or more programs configured to be executed by the one or more processors, the one or more programs including instructions for: setting a first predetermined condition; and in accordance with meeting the first predetermined condition: enabling the pressure sensor; detecting real-time pressure using the enabled pressure sensor; and displaying, via the display generation component, a pressure indicator to reflect the real-time pressure.

In accordance with some embodiments, a system that is configured to communicate with a display generation component and a pressure sensor. The computer system includes one or more processors; and memory storing one or more programs configured to be executed by the one or more processors, means for setting a first predetermined condition; and in accordance with meeting the first predetermined condition: means for enabling the pressure sensor; means for detecting real-time pressure using the enabled pressure sensor; and means for displaying, via the display generation component, a pressure indicator to reflect the real-time pressure.

In accordance with some embodiments, a computer program product is described. The computer program product comprises one or more programs configured to be executed by one or more processors of a computer system that is in communication with a display generation component and a pressure sensor. The one or more programs include instructions for: setting a first predetermined condition; and in accordance with meeting the first predetermined condition: enabling the pressure sensor; detecting real-time pressure using the enabled pressure sensor; and displaying, via the display generation component, a pressure indicator to reflect the real-time pressure.

In accordance with some embodiments, a method is described. The method is performed at a system that is in communication with a display generation component and a pressure sensor. The method includes in response to initiating the process: in accordance with a determination that the pressure sensor is disabled, enabling the pressure sensor; in accordance with a determination that the pressure sensor is enabled, forgoing to enable the pressure sensor; detecting real-time pressure using the enabled pressure sensor; and displaying, via the display generation component, a pressure indicator to reflect the real-time pressure.

In accordance with some embodiments, a non-transitory computer-readable storage medium is described. The non-transitory computer-readable storage medium storing one or more programs configured to be executed by one or more processors of a computer system, wherein the system is in communication with a display generation component and a pressure sensor, the one or more programs including instructions for: in response to initiating the process: in accordance with a determination that the pressure sensor is disabled, enabling the pressure sensor; in accordance with a determination that the pressure sensor is enabled, forgoing to enable the pressure sensor; detecting real-time pressure using the enabled pressure sensor; and displaying, via the display generation component, a pressure indicator to reflect the real-time pressure.

In accordance with some embodiments, a system that is configured to communicate with a display generation component and a pressure sensor. The system includes one or more processors; and memory storing one or more programs configured to be executed by the one or more processors, the one or more programs including instructions for: in response to initiating the process: in accordance with a determination that the pressure sensor is disabled, enabling the pressure sensor; in accordance with a determination that the pressure sensor is enabled, forgoing to enable the pressure sensor; detecting real-time pressure using the enabled pressure sensor; and displaying, via the display generation component, a pressure indicator to reflect the real-time pressure.

In accordance with some embodiments, a system that is configured to communicate with a display generation component and a pressure sensor. The computer system includes one or more processors; and memory storing one or more programs configured to be executed by the one or more processors, in response to initiating the process: in accordance with a determination that the pressure sensor is disabled, means for enabling the pressure sensor; in accordance with a determination that the pressure sensor is enabled, means for forgoing to enable the pressure sensor; detecting real-time pressure using the enabled pressure sensor; and displaying, via the display generation component, a pressure indicator to reflect the real-time pressure.

In accordance with some embodiments, a computer program product is described. The computer program product comprises one or more programs configured to be executed by one or more processors of a computer system that is in communication with a display generation component and a pressure sensor. The one or more programs include instructions for: in response to initiating the process: in accordance with a determination that the pressure sensor is disabled, enabling the pressure sensor; in accordance with a determination that the pressure sensor is enabled, forgoing to enable the pressure sensor; detecting real-time pressure using the enabled pressure sensor; and displaying, via the display generation component, a pressure indicator to reflect the real-time pressure.

In accordance with some embodiments, a method is described. The method is performed at a system that is in communication with a display generation component. The method includes receiving a profile of a second substance; and in response to receiving the profile of the second substance: extracting one or more parameters of the second substance from the profile; generating one or more curves for a process of the second substance based on the one or more parameters; and displaying, via the display generation component, the one or more curves for the process including one or more series of indicators, each indicator representing a point on the one or more curves.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: receiving a profile of a second substance; and in response to receiving the profile of the second substance: extracting one or more parameters of the second substance from the profile; generating one or more curves for a process of the second substance based on the one or more parameters; and displaying, via the display generation component, the one or more curves for the process including one or more series of indicators, each indicator representing a point on the one or more curves.

In accordance with some embodiments, a system that is configured to communicate with a display generation component. The system includes one or more processors; and memory storing one or more programs configured to be executed by the one or more processors, the one or more programs including instructions for: receiving a profile of a second substance; and in response to receiving the profile of the second substance: extracting one or more parameters of the second substance from the profile; generating one or more curves for a process of the second substance based on the one or more parameters; and displaying, via the display generation component, the one or more curves for the process including one or more series of indicators, each indicator representing a point on the one or more curves.

In accordance with some embodiments, a system that is configured to communicate with a display generation component. The computer system includes one or more processors; and memory storing one or more programs configured to be executed by the one or more processors, means for receiving a profile of a second substance; and means, in response to receiving the profile of the second substance, for: extracting one or more parameters of the second substance from the profile; generating one or more curves for a process of the second substance based on the one or more parameters; and displaying, via the display generation component, the one or more curves for the process including one or more series of indicators, each indicator representing a point on the one or more curves.

In accordance with some embodiments, a computer program product is described. The computer program product comprises one or more programs configured to be executed by one or more processors of a computer system that is in communication with a display generation component. The one or more programs include instructions for: receiving a profile of a second substance; and in response to receiving the profile of the second substance: extracting one or more parameters of the second substance from the profile; generating one or more curves for a process of the second substance based on the one or more parameters; and displaying, via the display generation component, the one or more curves for the process including one or more series of indicators, each indicator representing a point on the one or more curves.

In accordance with some embodiments, a method is described. The method is performed at a system that is in communication with a power generator operatively coupled to one or more power diffusers. The method includes receiving real-time pressure data; and in response to receiving the real-time pressure data: in accordance with a determination that a pressure dependent state of a process is active: calculating a deviation parameter based on a difference between a desired pressure set point and the real-time pressure data; in response to the calculated deviation parameter exceeding a first threshold and not exceeding a second threshold, adjusting, via the power generator, a power level applied to the one or more power diffusers proportional to the deviation parameter; and delivering power from the power generator at the adjusted power level to the one or more power diffusers.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: receiving real-time pressure data; and in response to receiving the real-time pressure data: in accordance with a determination that a pressure dependent state of a process is active: calculating a deviation parameter based on a difference between a desired pressure set point and the real-time pressure data; in response to the calculated deviation parameter exceeding a first threshold and not exceeding a second threshold, adjusting, via the power generator, a power level applied to the one or more power diffusers proportional to the deviation parameter; and delivering power from the power generator at the adjusted power level to the one or more power diffusers.

The method is performed at a system that is in communication with a power generator operatively coupled to one or more power diffusers. The method includes receiving real-time pressure data; and in response to receiving the real-time pressure data: in accordance with a determination that a pressure dependent state of a process is active: calculating a deviation parameter based on a difference between a desired pressure set point and the real-time pressure data; in response to the calculated deviation parameter exceeding a first threshold and not exceeding a second threshold, adjusting, via the power generator, a power level applied to the one or more power diffusers proportional to the deviation parameter; and delivering power from the power generator at the adjusted power level to the one or more power diffusers.

In accordance with some embodiments, a system that is configured to communicate with a power generator operatively coupled to one or more power diffusers. The system includes one or more processors; and memory storing one or more programs configured to be executed by the one or more processors, the one or more programs including instructions for: receiving real-time pressure data; and in response to receiving the real-time pressure data: in accordance with a determination that a pressure dependent state of a process is active: calculating a deviation parameter based on a difference between a desired pressure set point and the real-time pressure data; in response to the calculated deviation parameter exceeding a first threshold and not exceeding a second threshold, adjusting, via the power generator, a power level applied to the one or more power diffusers proportional to the deviation parameter; and delivering power from the power generator at the adjusted power level to the one or more power diffusers.

In accordance with some embodiments, a system that is configured to communicate with a power generator operatively coupled to one or more power diffusers. The computer system includes one or more processors; and memory storing one or more programs configured to be executed by the one or more processors, means for receiving real-time pressure data; and means, in response to receiving the real-time pressure data, for: in accordance with a determination that a pressure dependent state of a process is active: calculating a deviation parameter based on a difference between a desired pressure set point and the real-time pressure data; in response to the calculated deviation parameter exceeding a first threshold and not exceeding a second threshold, adjusting, via the power generator, a power level applied to the one or more power diffusers proportional to the deviation parameter; and delivering power from the power generator at the adjusted power level to the one or more power diffusers.

In accordance with some embodiments, a computer program product is described. The computer program product comprises one or more programs configured to be executed by one or more processors of a computer system that is in communication with a power generator operatively coupled to one or more power diffusers. The one or more programs include instructions for: receiving real-time pressure data; and in response to receiving the real-time pressure data: in accordance with a determination that a pressure dependent state of a process is active: calculating a deviation parameter based on a difference between a desired pressure set point and the real-time pressure data; in response to the calculated deviation parameter exceeding a first threshold and not exceeding a second threshold, adjusting, via the power generator, a power level applied to the one or more power diffusers proportional to the deviation parameter; and delivering power from the power generator at the adjusted power level to the one or more power diffusers.

In accordance with some embodiments, a method is described. The method is performed at a system that is in communication with a display generation component and a mass monitoring component. The method includes initiating a lyophilization process of the second substance comprising adjusting one or both of pressure and temperature at a surface of the second substance favorable to sublimation equilibrium of a first substance within the second substance; during the lyophilization process: displaying, via the display generation component, a first mass indicator corresponding to an estimated quantity of mass of the first substance removed from the second substance over the lyophilization process; receiving, via the mass monitoring component, a first mass associated with the first substance; in response to a determination that a predetermined time period has elapsed since receiving the first mass: receiving, via the mass monitoring component, a second mass associated with the first substance; estimating a quantity of mass of the first substance removed from the second substance based on one or both of the first mass and the second mass; and updating displaying, via the display generation component, the first mass indicator.

In accordance with some embodiments, a non-transitory computer-readable storage medium is described. The non-transitory computer-readable storage medium storing one or more programs configured to be executed by one or more processors of a computer system, wherein the system is in communication with a display generation component and a mass monitoring component, the one or more programs including instructions for: initiating a lyophilization process of the second substance comprising adjusting one or both of pressure and temperature at a surface of the second substance favorable to sublimation equilibrium of a first substance within the second substance; during the lyophilization process: displaying, via the display generation component, a first mass indicator corresponding to an estimated quantity of mass of the first substance removed from the second substance over the lyophilization process; receiving, via the mass monitoring component, a first mass associated with the first substance; in response to a determination that a predetermined time period has elapsed since receiving the first mass: receiving, via the mass monitoring component, a second mass associated with the first substance; estimating a quantity of mass of the first substance removed from the second substance based on one or both of the first mass and the second mass; and updating displaying, via the display generation component, the first mass indicator.

In accordance with some embodiments, a system that is configured to communicate with a display generation component and a mass monitoring component. The system includes one or more processors; and memory storing one or more programs configured to be executed by the one or more processors, the one or more programs including instructions for: initiating a lyophilization process of the second substance comprising adjusting one or both of pressure and temperature at a surface of the second substance favorable to sublimation equilibrium of a first substance within the second substance; during the lyophilization process: displaying, via the display generation component, a first mass indicator corresponding to an estimated quantity of mass of the first substance removed from the second substance over the lyophilization process; receiving, via the mass monitoring component, a first mass associated with the first substance; in response to a determination that a predetermined time period has elapsed since receiving the first mass: receiving, via the mass monitoring component, a second mass associated with the first substance; estimating a quantity of mass of the first substance removed from the second substance based on one or both of the first mass and the second mass; and updating displaying, via the display generation component, the first mass indicator.

In accordance with some embodiments, a system that is configured to communicate with a display generation component and a mass monitoring component. The computer system includes one or more processors; and memory storing one or more programs configured to be executed by the one or more processors, means for initiating a lyophilization process of the second substance comprising adjusting one or both of pressure and temperature at a surface of the second substance favorable to sublimation equilibrium of a first substance within the second substance; during the lyophilization process: means for displaying, via the display generation component, a first mass indicator corresponding to an estimated quantity of mass of the first substance removed from the second substance over the lyophilization process; means for receiving, via the mass monitoring component, a first mass associated with the first substance; means, in response to a determination that a predetermined time period has elapsed since receiving the first mass, for: receiving, via the mass monitoring component, a second mass associated with the first substance; estimating a quantity of mass of the first substance removed from the second substance based on one or both of the first mass and the second mass; and updating displaying, via the display generation component, the first mass indicator.

In accordance with some embodiments, a computer program product is described. The computer program product comprises one or more programs configured to be executed by one or more processors of a computer system that is in communication with a display generation component and a mass monitoring component. The one or more programs include instructions for: initiating a lyophilization process of the second substance comprising adjusting one or both of pressure and temperature at a surface of the second substance favorable to sublimation equilibrium of a first substance within the second substance; during the lyophilization process: displaying, via the display generation component, a first mass indicator corresponding to an estimated quantity of mass of the first substance removed from the second substance over the lyophilization process; receiving, via the mass monitoring component, a first mass associated with the first substance; in response to a determination that a predetermined time period has elapsed since receiving the first mass: receiving, via the mass monitoring component, a second mass associated with the first substance; estimating a quantity of mass of the first substance removed from the second substance based on one or both of the first mass and the second mass; and updating displaying, via the display generation component, the first mass indicator.

In accordance with some embodiments, a method is described. The method is performed at a system that is in communication with a display generation component. The method includes receiving a predefined reference spectra of a first substance; during a lyophilization process: displaying, via the display generation component, a mass indicator corresponding to an estimated quantity of mass of the first substance removed from a second substance over the lyophilization process; irradiating the second substance with light from the one or more light generation components; after a predetermined time period: capturing, via the one or more image-capturing components, light reflected from a first portion of the second substance; generating a first targeted absorption spectrum of the second substance from the captured reflected light from the first portion of the second substance at specific wavelengths; comparing the first targeted absorption spectrum of the second substance with the predefined reference spectra for a first qualitative identification of one or more absorption characteristics of the first substance at the specific wavelengths; estimating a first quantitative mass of the first substance within the second substance from the first qualitative identification the one or more absorption characteristics; revising the estimated quantity of mass based on the first quantitative mass; and updating displaying, via the display generation component, the mass indicator corresponding to the estimated quantity of mass.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: receiving a predefined reference spectra of a first substance; during a lyophilization process: displaying, via the display generation component, a mass indicator corresponding to an estimated quantity of mass of the first substance removed from a second substance over the lyophilization process; irradiating the second substance with light from the one or more light generation components; after a predetermined time period: capturing, via the one or more image-capturing components, light reflected from a first portion of the second substance; generating a first targeted absorption spectrum of the second substance from the captured reflected light from the first portion of the second substance at specific wavelengths; comparing the first targeted absorption spectrum of the second substance with the predefined reference spectra for a first qualitative identification of one or more absorption characteristics of the first substance at the specific wavelengths; estimating a first quantitative mass of the first substance within the second substance from the first qualitative identification the one or more absorption characteristics; revising the estimated quantity of mass based on the first quantitative mass; and updating displaying, via the display generation component, the mass indicator corresponding to the estimated quantity of mass.

In accordance with some embodiments, a system that is configured to communicate with a display generation component. The system includes one or more processors; and memory storing one or more programs configured to be executed by the one or more processors, the one or more programs including instructions for: receiving a predefined reference spectra of a first substance; during a lyophilization process: displaying, via the display generation component, a mass indicator corresponding to an estimated quantity of mass of the first substance removed from a second substance over the lyophilization process; irradiating the second substance with light from the one or more light generation components; after a predetermined time period: capturing, via the one or more image-capturing components, light reflected from a first portion of the second substance; generating a first targeted absorption spectrum of the second substance from the captured reflected light from the first portion of the second substance at specific wavelengths; comparing the first targeted absorption spectrum of the second substance with the predefined reference spectra for a first qualitative identification of one or more absorption characteristics of the first substance at the specific wavelengths; estimating a first quantitative mass of the first substance within the second substance from the first qualitative identification the one or more absorption characteristics; revising the estimated quantity of mass based on the first quantitative mass; and updating displaying, via the display generation component, the mass indicator corresponding to the estimated quantity of mass.

In accordance with some embodiments, a system that is configured to communicate with a display generation component. The computer system includes one or more processors; and memory storing one or more programs configured to be executed by the one or more processors, means for receiving a predefined reference spectra of a first substance; during a lyophilization process: means for displaying, via the display generation component, a mass indicator corresponding to an estimated quantity of mass of the first substance removed from a second substance over the lyophilization process; means for irradiating the second substance with light from the one or more light generation components; after a predetermined time period: means for capturing, via the one or more image-capturing components, light reflected from a first portion of the second substance; means for generating a first targeted absorption spectrum of the second substance from the captured reflected light from the first portion of the second substance at specific wavelengths; means for comparing the first targeted absorption spectrum of the second substance with the predefined reference spectra for a first qualitative identification of one or more absorption characteristics of the first substance at the specific wavelengths; means for estimating a first quantitative mass of the first substance within the second substance from the first qualitative identification the one or more absorption characteristics; means for revising the estimated quantity of mass based on the first quantitative mass; and means for updating displaying, via the display generation component, the mass indicator corresponding to the estimated quantity of mass.

In accordance with some embodiments, a computer program product is described. The computer program product comprises one or more programs configured to be executed by one or more processors of a computer system that is in communication with a display generation component. The one or more programs include instructions for: receiving a predefined reference spectra of a first substance; during a lyophilization process: displaying, via the display generation component, a mass indicator corresponding to an estimated quantity of mass of the first substance removed from a second substance over the lyophilization process; irradiating the second substance with light from the one or more light generation components; after a predetermined time period: capturing, via the one or more image-capturing components, light reflected from a first portion of the second substance; generating a first targeted absorption spectrum of the second substance from the captured reflected light from the first portion of the second substance at specific wavelengths; comparing the first targeted absorption spectrum of the second substance with the predefined reference spectra for a first qualitative identification of one or more absorption characteristics of the first substance at the specific wavelengths; estimating a first quantitative mass of the first substance within the second substance from the first qualitative identification the one or more absorption characteristics; revising the estimated quantity of mass based on the first quantitative mass; and updating displaying, via the display generation component, the mass indicator corresponding to the estimated quantity of mass.

In accordance with some embodiments, a method is described. The method is performed at a system that is in communication with a display generation component, a first device, and a second device distinct from the first device. The method includes displaying, via the display generation component, a first graphical object representing the first device, a second graphical object representing the second device, and a first device identifier currently depicting an association between a first process variable and the first device; detecting a first association input corresponding to a request to associate the first process variable with the second device; and in response to detecting the first association input: disassociating the first process variable with the first device; ceasing to display, via the display generation component, the first device identifier depicting an association between the first process variable and the first device; associating the first process variable with the second device; and displaying, via the display generation component, a second device identifier depicting an association between the first process variable and the second device.

In accordance with some embodiments, a non-transitory computer-readable storage medium is described. The non-transitory computer-readable storage medium storing one or more programs configured to be executed by one or more processors of a computer system, wherein the system is in communication with a display generation component, a first device, and a second device distinct from the first device, the one or more programs including instructions for: displaying, via the display generation component, a first graphical object representing the first device, a second graphical object representing the second device, and a first device identifier currently depicting an association between a first process variable and the first device; detecting a first association input corresponding to a request to associate the first process variable with the second device; and in response to detecting the first association input: disassociating the first process variable with the first device; ceasing to display, via the display generation component, the first device identifier depicting an association between the first process variable and the first device; associating the first process variable with the second device; and displaying, via the display generation component, a second device identifier depicting an association between the first process variable and the second device.

In accordance with some embodiments, a system that is configured to communicate with a display generation component, a first device, and a second device distinct from the first device. The system includes one or more processors; and memory storing one or more programs configured to be executed by the one or more processors, the one or more programs including instructions for: displaying, via the display generation component, a first graphical object representing the first device, a second graphical object representing the second device, and a first device identifier currently depicting an association between a first process variable and the first device; detecting a first association input corresponding to a request to associate the first process variable with the second device; and in response to detecting the first association input: disassociating the first process variable with the first device; ceasing to display, via the display generation component, the first device identifier depicting an association between the first process variable and the first device; associating the first process variable with the second device; and displaying, via the display generation component, a second device identifier depicting an association between the first process variable and the second device.

In accordance with some embodiments, a system that is configured to communicate with a display generation component, a first device, and a second device distinct from the first device. The computer system includes one or more processors; and memory storing one or more programs configured to be executed by the one or more processors, means for displaying, via the display generation component, a first graphical object representing the first device, a second graphical object representing the second device, and a first device identifier currently depicting an association between a first process variable and the first device; detecting a first association input corresponding to a request to associate the first process variable with the second device; and in response to detecting the first association input: disassociating the first process variable with the first device; ceasing to display, via the display generation component, the first device identifier depicting an association between the first process variable and the first device; associating the first process variable with the second device; and displaying, via the display generation component, a second device identifier depicting an association between the first process variable and the second device.

In accordance with some embodiments, a computer program product is described. The computer program product comprises one or more programs configured to be executed by one or more processors of a computer system that is in communication with a display generation component, a first device, and a second device distinct from the first device. The one or more programs include instructions for: displaying, via the display generation component, a first graphical object representing the first device, a second graphical object representing the second device, and a first device identifier currently depicting an association between a first process variable and the first device; detecting a first association input corresponding to a request to associate the first process variable with the second device; and in response to detecting the first association input: disassociating the first process variable with the first device; ceasing to display, via the display generation component, the first device identifier depicting an association between the first process variable and the first device; associating the first process variable with the second device; and displaying, via the display generation component, a second device identifier depicting an association between the first process variable and the second device.

In accordance with some embodiments, a method is described. The method is performed at a system that is in communication with at least one input device equipped with a display generation component and during a lyophilization process involving a first substance within a second substance. The method includes after a predetermined time period: receiving real-time data, including real-time temperature data of a second substance, real-time pressure data of the second substance; and deriving a phase of matter of the first substance from the real-time temperature and pressure data of the second substance; detecting a request from the at least one input device to view a current status of the lyophilization process; in response to detecting the request to view the current status of the lyophilization process, triggering the display generation component of the at least one input device to display graphical indicators representing the real-time temperature data of the second substance, the real-time pressure data of the second substance, and the real-time phase of matter of the first substance.

In accordance with some embodiments, a non-transitory computer-readable storage medium is described. The non-transitory computer-readable storage medium storing one or more programs configured to be executed by one or more processors of a computer system, wherein the system is in communication with at least one input device equipped with a display generation component and during a lyophilization process involving a first substance within a second substance, the one or more programs including instructions for: after a predetermined time period: receiving real-time data, including real-time temperature data of a second substance, real-time pressure data of the second substance; and deriving a phase of matter of the first substance from the real-time temperature and pressure data of the second substance; detecting a request from the at least one input device to view a current status of the lyophilization process; in response to detecting the request to view the current status of the lyophilization process, triggering the display generation component of the at least one input device to display graphical indicators representing the real-time temperature data of the second substance, the real-time pressure data of the second substance, and the real-time phase of matter of the first substance.

In accordance with some embodiments, a system that is configured to communicate with at least one input device equipped with a display generation component and during a lyophilization process involving a first substance within a second substance. The system includes one or more processors; and memory storing one or more programs configured to be executed by the one or more processors, the one or more programs including instructions for: after a predetermined time period: receiving real-time data, including real-time temperature data of a second substance, real-time pressure data of the second substance; and deriving a phase of matter of the first substance from the real-time temperature and pressure data of the second substance; detecting a request from the at least one input device to view a current status of the lyophilization process; in response to detecting the request to view the current status of the lyophilization process, triggering the display generation component of the at least one input device to display graphical indicators representing the real-time temperature data of the second substance, the real-time pressure data of the second substance, and the real-time phase of matter of the first substance.

In accordance with some embodiments, a system that is configured to communicate with at least one input device equipped with a display generation component and during a lyophilization process involving a first substance within a second substance. The computer system includes one or more processors; and memory storing one or more programs configured to be executed by the one or more processors, after a predetermined time period: means for receiving real-time data, including real-time temperature data of a second substance, real-time pressure data of the second substance; and means for deriving a phase of matter of the first substance from the real-time temperature and pressure data of the second substance; means for detecting a request from the at least one input device to view a current status of the lyophilization process; in response to detecting the request to view the current status of the lyophilization process, means for triggering the display generation component of the at least one input device to display graphical indicators representing the real-time temperature data of the second substance, the real-time pressure data of the second substance, and the real-time phase of matter of the first substance.

In accordance with some embodiments, a computer program product is described. The computer program product comprises one or more programs configured to be executed by one or more processors of a computer system that is in communication with at least one input device equipped with a display generation component and during a lyophilization process involving a first substance within a second substance. The one or more programs include instructions for: after a predetermined time period: receiving real-time data, including real-time temperature data of a second substance, real-time pressure data of the second substance; and deriving a phase of matter of the first substance from the real-time temperature and pressure data of the second substance; detecting a request from the at least one input device to view a current status of the lyophilization process; in response to detecting the request to view the current status of the lyophilization process, triggering the display generation component of the at least one input device to display graphical indicators representing the real-time temperature data of the second substance, the real-time pressure data of the second substance, and the real-time phase of matter of the first substance.

In accordance with some embodiments, a method is described. The method is performed at a cold trap equipped with a first or second set of one or more removable condensing surfaces. The method includes attaching the first set of one or more removable condensing surfaces to the cold trap; pulling a first vacuum within the cold trap; while under the first vacuum: exposing the first set of one or more removable condensing surfaces to vapors; and collecting condensate on the first set of one or more removable condensing surfaces; while condensate remains on the first set of one or more removable condensing surfaces: detaching the first set of one or more removable condensing surfaces with the condensates from the cold trap; and attaching the second set of one or more removable condensing surfaces to the cold trap.

In accordance with some embodiments, a cold trap system, includes a cold trap equipped with a first or second set of one or more removable condensing surfaces; means for attaching the first set of one or more removable condensing surfaces to the cold trap; means for pulling a first vacuum within the cold trap; means for exposing the first set of one or more removable condensing surfaces to vapors while under the first vacuum, and for collecting condensate on the first set of one or more removable condensing surfaces; means for detaching the first set of one or more removable condensing surfaces with the condensates from the cold trap while condensate remains on the first set of one or more removable condensing surfaces; and means for attaching the second set of one or more removable condensing surfaces to the cold trap.

In accordance with some embodiments, a cold trap apparatus includes: an enclosure configured to hermetically seal to a vacuum system; a set of one or more removable condensing surfaces contained within the enclosure, whereon condensate is configured to form, distinct from the enclosure; and a latching mechanism configured to releasably attach the set of one or more condensing surfaces to the enclosure.

In accordance with some embodiments, a method is described. The method is performed at a cold trap equipped with a first or second removable container with one or more condensing surfaces and a latching mechanism. The method includes attaching the first removable container to the cold trap; pulling a first vacuum within the cold trap; while under the first vacuum: exposing the one or more condensing surfaces of the first removable container to vapors; and collecting condensate on the one or more condensing surfaces of the first removable container; while condensate remains on the one or more condensing surfaces: detaching the first removable container with the condensates from the cold trap; and attaching the second removable container to the cold trap.

In accordance with some embodiments, a cold trap system, includes a cold trap equipped with a first or second removable container with one or more condensing surfaces and a latching mechanism; means for attaching the first removable container to the cold trap; means for pulling a first vacuum within the cold trap; while under the first vacuum: means for exposing the one or more condensing surfaces of the first removable container to vapors; and means for collecting condensate on the one or more condensing surfaces of the first removable container; while condensate remains on the one or more condensing surfaces: means for detaching the first removable container with the condensates from the cold trap; and means for attaching the second removable container to the cold trap.

In accordance with some embodiments, a cold trap apparatus, comprising an enclosure hermetically sealed to a vacuum system; and a removable container within the enclosure, comprising: one or more condensing surfaces, wherein condensate is configured to form on the one or more condensing surfaces; and a latching mechanism configured to releasably attach the removable container to the enclosure.

In accordance with some embodiments, a method is described. The method is performed at a vacuum system equipped with a first or second condenser, each with one or more condensing surfaces. The method includes hermetically sealing the first condenser to the vacuum system; running the first condenser; pulling a first vacuum within the vacuum system; while under the first vacuum: exposing the one or more condensing surfaces of the first condenser to vapors; and collecting condensate on the one or more condensing surfaces of the first condenser; stopping the first condenser; while condensate remains on the one or more condensing surfaces of the first condenser: hermetically unsealing the first condenser with the condensate from the vacuum system; and hermetically sealing the second condenser to the vacuum system.

In accordance with some embodiments, a cold trap system, includes a cold trap equipped with a first or second condenser, each with one or more condensing surfaces; means for hermetically sealing the first condenser to the vacuum system; means for running the first condenser; means for pulling a first vacuum within the vacuum system; while under the first vacuum: means for exposing the one or more condensing surfaces of the first condenser to vapors; and means for collecting condensate on the one or more condensing surfaces of the first condenser; means for stopping the first condenser; while condensate remains on the one or more condensing surfaces of the first condenser: means for hermetically unsealing the first condenser with the condensate from the vacuum system; and means for hermetically sealing the second condenser to the vacuum system.

In accordance with some embodiments, a cold trap apparatus, comprising a removable enclosure; one or more couplers hermetically sealing the removable enclosure to a vacuum system; and a set of one or more condensing surfaces within the removable enclosure, wherein condensate is configured to form on the one or more condensing surfaces, distinct from the removable enclosure.

In accordance with some embodiments, a method is described. The method is performed at a system that is in communication with a display generation component. The method includes applying a vacuum to reduce pressure on a substance; collecting temperature-pressure data; fitting the collected temperature-pressure data to a phase transition model; and displaying, via the display generation component, a representation of the fit to the phase transition model that illustrates the equilibrium conditions of temperature and pressure corresponding to distinct phases of matter of the substance.

In accordance with some embodiments, a non-transitory computer-readable storage medium is described. The non-transitory computer-readable storage medium storing one or more programs configured to be executed by one or more processors of a computer system, wherein the system is in communication with a display generation component, the one or more programs including instructions for: applying a vacuum to reduce pressure on a substance; collecting temperature-pressure data; fitting the collected temperature-pressure data to a phase transition model; and displaying, via the display generation component, a representation of the fit to the phase transition model that illustrates the equilibrium conditions of temperature and pressure corresponding to distinct phases of matter of the substance.

In accordance with some embodiments, a system that is configured to communicate with a display generation component. The system includes one or more processors; and memory storing one or more programs configured to be executed by the one or more processors, the one or more programs including instructions for: applying a vacuum to reduce pressure on a substance; collecting temperature-pressure data; fitting the collected temperature-pressure data to a phase transition model; and displaying, via the display generation component, a representation of the fit to the phase transition model that illustrates the equilibrium conditions of temperature and pressure corresponding to distinct phases of matter of the substance.

In accordance with some embodiments, a system that is configured to communicate with a display generation component. The computer system includes one or more processors; and memory storing one or more programs configured to be executed by the one or more processors, means for applying a vacuum to reduce pressure on a substance; means for collecting temperature-pressure data; means for fitting the collected temperature-pressure data to a phase transition model; and means for displaying, via the display generation component, a representation of the fit to the phase transition model that illustrates the equilibrium conditions of temperature and pressure corresponding to distinct phases of matter of the substance.

In accordance with some embodiments, a computer program product is described. The computer program product comprises one or more programs configured to be executed by one or more processors of a computer system that is in communication with a display generation component. The one or more programs include instructions for: applying a vacuum to reduce pressure on a substance; collecting temperature-pressure data; fitting the collected temperature-pressure data to a phase transition model; and displaying, via the display generation component, a representation of the fit to the phase transition model that illustrates the equilibrium conditions of temperature and pressure corresponding to distinct phases of matter of the substance.

In accordance with some embodiments, a method is described. The method is performed at a system that is in communication with a display generation component and a mass sensor. The method includes while freeze-drying a substance with a sublimatable constituent: measuring, via the mass sensor, a first mass associated with the substance at a first time; measuring a second mass associated with the substance at a second time; estimating a sublimation rate of the sublimatable constituent based on a difference between the first mass and second mass and a difference between the first and second time; and displaying, via the display generation component, a sublimation rate indicator representing the estimated sublimation rate.

In accordance with some embodiments, a non-transitory computer-readable storage medium is described. The non-transitory computer-readable storage medium storing one or more programs configured to be executed by one or more processors of a computer system, wherein the system is in communication with a display generation component and a mass sensor, the one or more programs including instructions for: while freeze-drying a substance with a sublimatable constituent: measuring, via the mass sensor, a first mass associated with the substance at a first time; measuring a second mass associated with the substance at a second time; estimating a sublimation rate of the sublimatable constituent based on a difference between the first mass and second mass and a difference between the first and second time; and displaying, via the display generation component, a sublimation rate indicator representing the estimated sublimation rate.

In accordance with some embodiments, a system that is configured to communicate with a display generation component and a mass sensor. The system includes one or more processors; and memory storing one or more programs configured to be executed by the one or more processors, the one or more programs including instructions for: while freeze-drying a substance with a sublimatable constituent: measuring, via the mass sensor, a first mass associated with the substance at a first time; measuring a second mass associated with the substance at a second time; estimating a sublimation rate of the sublimatable constituent based on a difference between the first mass and second mass and a difference between the first and second time; and displaying, via the display generation component, a sublimation rate indicator representing the estimated sublimation rate.

In accordance with some embodiments, a system that is configured to communicate with a display generation component and a mass sensor. The computer system includes one or more processors; and memory storing one or more programs configured to be executed by the one or more processors, while freeze-drying a substance with a sublimatable constituent: means for measuring a first mass associated with the substance at a first time; means for measuring a second mass associated with the substance at a second time; means for estimating a sublimation rate of the sublimatable constituent based on a difference between the first mass and second mass and a difference between the first and second time; and means for displaying a sublimation rate indicator representing the estimated sublimation rate.

In accordance with some embodiments, a computer program product is described. The computer program product comprises one or more programs configured to be executed by one or more processors of a computer system that is in communication with a display generation component and a mass sensor. The one or more programs include instructions for: while freeze-drying a substance with a sublimatable constituent: measuring, via the mass sensor, a first mass associated with the substance at a first time; measuring a second mass associated with the substance at a second time; estimating a sublimation rate of the sublimatable constituent based on a difference between the first mass and second mass and a difference between the first and second time; and displaying, via the display generation component, a sublimation rate indicator representing the estimated sublimation rate.

In accordance with some embodiments, a method is described. The method is performed at a system that is in communication with a display generation component and one or more energy emitters. The method includes while freeze-drying a substance with a sublimatable constituent: adjusting a quantity of energy, via the one or more energy emitters, delivered to the substance over a predetermined time period; estimating a sublimation rate of the sublimatable constituent based on the quantity of energy delivered to the substance over the predetermined time period and a heat of sublimation; and displaying, via the display generation component, a sublimation rate indicator representing the estimated sublimation rate.

In accordance with some embodiments, a non-transitory computer-readable storage medium is described. The non-transitory computer-readable storage medium storing one or more programs configured to be executed by one or more processors of a computer system, wherein the system is in communication with a display generation component and one or more energy emitters, the one or more programs including instructions for: while freeze-drying a substance with a sublimatable constituent: adjusting a quantity of energy, via the one or more energy emitters, delivered to the substance over a predetermined time period; estimating a sublimation rate of the sublimatable constituent based on the quantity of energy delivered to the substance over the predetermined time period and a heat of sublimation; and displaying, via the display generation component, a sublimation rate indicator representing the estimated sublimation rate.

In accordance with some embodiments, a system that is configured to communicate with a display generation component and one or more energy emitters. The system includes one or more processors; and memory storing one or more programs configured to be executed by the one or more processors, the one or more programs including instructions for: while freeze-drying a substance with a sublimatable constituent: adjusting a quantity of energy, via the one or more energy emitters, delivered to the substance over a predetermined time period; estimating a sublimation rate of the sublimatable constituent based on the quantity of energy delivered to the substance over the predetermined time period and a heat of sublimation; and displaying, via the display generation component, a sublimation rate indicator representing the estimated sublimation rate.

In accordance with some embodiments, a system that is configured to communicate with a display generation component and one or more energy emitters. The computer system includes one or more processors; and memory storing one or more programs configured to be executed by the one or more processors, while freeze-drying a substance with a sublimatable constituent: means for adjusting a quantity of energy, via the one or more energy emitters, delivered to the substance over a predetermined time period; means for estimating a sublimation rate of the sublimatable constituent based on the quantity of energy delivered to the substance over the predetermined time period and a heat of sublimation; and means for displaying, via the display generation component, a sublimation rate indicator representing the estimated sublimation rate.

In accordance with some embodiments, a computer program product is described. The computer program product comprises one or more programs configured to be executed by one or more processors of a computer system that is in communication with a display generation component and one or more energy emitters. The one or more programs include instructions for: while freeze-drying a substance with a sublimatable constituent: adjusting a quantity of energy, via the one or more energy emitters, delivered to the substance over a predetermined time period; estimating a sublimation rate of the sublimatable constituent based on the quantity of energy delivered to the substance over the predetermined time period and a heat of sublimation; and displaying, via the display generation component, a sublimation rate indicator representing the estimated sublimation rate.

In accordance with some embodiments, a method is described. The method is performed at a system that is in communication with a display generation component, a touch-sensitive surface, and at least one sensor. The method includes while freeze-drying a substance: receiving, from the at least one sensor, time-sequenced data indicative of a condition of freeze-drying the substance; displaying, via the display generation component, a graphical control object configured apply one or more filter parameters; receiving, via the touch-sensitive surface, input at a location corresponding to the graphical control object; and in response to receiving the input, applying the one or more filter parameters to the time-sequenced data.

In accordance with some embodiments, a non-transitory computer-readable storage medium is described. The non-transitory computer-readable storage medium storing one or more programs configured to be executed by one or more processors of a computer system, wherein the system is in communication with a display generation component, a touch-sensitive surface, and at least one sensor, the one or more programs including instructions for: while freeze-drying a substance: receiving, from the at least one sensor, time-sequenced data indicative of a condition of freeze-drying the substance; displaying, via the display generation component, a graphical control object configured apply one or more filter parameters; receiving, via the touch-sensitive surface, input at a location corresponding to the graphical control object; and in response to receiving the input, applying the one or more filter parameters to the time-sequenced data.

In accordance with some embodiments, a system that is configured to communicate with a display generation component, a touch-sensitive surface, and at least one sensor. The system includes one or more processors; and memory storing one or more programs configured to be executed by the one or more processors, the one or more programs including instructions for: while freeze-drying a substance: receiving, from the at least one sensor, time-sequenced data indicative of a condition of freeze-drying the substance; displaying, via the display generation component, a graphical control object configured apply one or more filter parameters; receiving, via the touch-sensitive surface, input at a location corresponding to the graphical control object; and in response to receiving the input, applying the one or more filter parameters to the time-sequenced data.

In accordance with some embodiments, a system that is configured to communicate with a display generation component, a touch-sensitive surface, and at least one sensor. The computer system includes one or more processors; and memory storing one or more programs configured to be executed by the one or more processors, while freeze-drying a substance: means for receiving, from the at least one sensor, time-sequenced data indicative of a condition of freeze-drying the substance; means for displaying, via the display generation component, a graphical control object configured apply one or more filter parameters; means for receiving, via the touch-sensitive surface, input at a location corresponding to the graphical control object; and in response to receiving the input, means for applying the one or more filter parameters to the time-sequenced data.

In accordance with some embodiments, a computer program product is described. The computer program product comprises one or more programs configured to be executed by one or more processors of a computer system that is in communication with a display generation component, a touch-sensitive surface, and at least one sensor. The one or more programs include instructions for: while freeze-drying a substance: receiving, from the at least one sensor, time-sequenced data indicative of a condition of freeze-drying the substance; displaying, via the display generation component, a graphical control object configured apply one or more filter parameters; receiving, via the touch-sensitive surface, input at a location corresponding to the graphical control object; and in response to receiving the input, applying the one or more filter parameters to the time-sequenced data.

In accordance with some embodiments, a method is described. The method is performed at a system that is in communication with a display generation component and a plurality of sensors. The method includes while freeze-drying a substance comprising a sublimatable constituent: receiving, via the plurality of sensors, time-sequenced data associated with freeze-drying the substance; estimating, based on the time-sequenced data, one or both of: a sublimation rate of the sublimatable constituent, and a cumulative extracted mass of the sublimatable constituent; concurrently displaying, via the display generation component: one or more graphical representations of at least a portion of the time-sequenced data, and one or more graphical representations of one or both of the estimated sublimation rate and the estimated cumulative extracted mass.

In accordance with some embodiments, a non-transitory computer-readable storage medium is described. The non-transitory computer-readable storage medium storing one or more programs configured to be executed by one or more processors of a computer system, wherein the system is in communication with a display generation component and a plurality of sensors, the one or more programs including instructions for: while freeze-drying a substance comprising a sublimatable constituent: receiving, via the plurality of sensors, time-sequenced data associated with freeze-drying the substance; estimating, based on the time-sequenced data, one or both of: a sublimation rate of the sublimatable constituent, and a cumulative extracted mass of the sublimatable constituent; concurrently displaying, via the display generation component: one or more graphical representations of at least a portion of the time-sequenced data, and one or more graphical representations of one or both of the estimated sublimation rate and the estimated cumulative extracted mass.

In accordance with some embodiments, a system that is configured to communicate with a display generation component and a plurality of sensors. The system includes one or more processors; and memory storing one or more programs configured to be executed by the one or more processors, the one or more programs including instructions for: while freeze-drying a substance comprising a sublimatable constituent: receiving, via the plurality of sensors, time-sequenced data associated with freeze-drying the substance; estimating, based on the time-sequenced data, one or both of: a sublimation rate of the sublimatable constituent, and a cumulative extracted mass of the sublimatable constituent; concurrently displaying, via the display generation component: one or more graphical representations of at least a portion of the time-sequenced data, and one or more graphical representations of one or both of the estimated sublimation rate and the estimated cumulative extracted mass.

In accordance with some embodiments, a system that is configured to communicate with a display generation component and a plurality of sensors. The computer system includes one or more processors; and memory storing one or more programs configured to be executed by the one or more processors, while freeze-drying a substance comprising a sublimatable constituent: means for receiving, via the plurality of sensors, time-sequenced data associated with freeze-drying the substance; means for estimating, based on the time-sequenced data, one or both of: a sublimation rate of the sublimatable constituent, and a cumulative extracted mass of the sublimatable constituent; means for concurrently displaying, via the display generation component: one or more graphical representations of at least a portion of the time-sequenced data, and one or more graphical representations of one or both of the estimated sublimation rate and the estimated cumulative extracted mass.

In accordance with some embodiments, a computer program product is described. The computer program product comprises one or more programs configured to be executed by one or more processors of a computer system that is in communication with a display generation component and a plurality of sensors. The one or more programs include instructions for: while freeze-drying a substance comprising a sublimatable constituent: receiving, via the plurality of sensors, time-sequenced data associated with freeze-drying the substance; estimating, based on the time-sequenced data, one or both of: a sublimation rate of the sublimatable constituent, and a cumulative extracted mass of the sublimatable constituent; concurrently displaying, via the display generation component: one or more graphical representations of at least a portion of the time-sequenced data, and one or more graphical representations of one or both of the estimated sublimation rate and the estimated cumulative extracted mass.

In accordance with some embodiments, a method is described. The method is performed at a system that is in communication with a display generation component and a vacuum chamber coupled to a vacuum pump and a pressure sensor. The method includes activating the vacuum pump; receiving, from the pressure sensor, time-sequenced pressure data indicative of pressure within the vacuum chamber; identifying a linear region of a logarithmic transformation of the pressure data subsequent activation of the vacuum pump; determining one or more performance metrics of the vacuum pump based on a slope of the linear region; and concurrently displaying, via the display generation component, a graphical representation of the time-sequenced pressure data and representations of the one or more performance metrics.

In accordance with some embodiments, a non-transitory computer-readable storage medium is described. The non-transitory computer-readable storage medium storing one or more programs configured to be executed by one or more processors of a computer system, wherein the system is in communication with a display generation component and a vacuum chamber coupled to a vacuum pump and a pressure sensor, the one or more programs including instructions for: activating the vacuum pump; receiving, from the pressure sensor, time-sequenced pressure data indicative of pressure within the vacuum chamber; identifying a linear region of a logarithmic transformation of the pressure data subsequent activation of the vacuum pump; determining one or more performance metrics of the vacuum pump based on a slope of the linear region; and concurrently displaying, via the display generation component, a graphical representation of the time-sequenced pressure data and representations of the one or more performance metrics.

In accordance with some embodiments, a system that is configured to communicate with a display generation component and a vacuum chamber coupled to a vacuum pump and a pressure sensor. The system includes one or more processors; and memory storing one or more programs configured to be executed by the one or more processors, the one or more programs including instructions for: activating the vacuum pump; receiving, from the pressure sensor, time-sequenced pressure data indicative of pressure within the vacuum chamber; identifying a linear region of a logarithmic transformation of the pressure data subsequent activation of the vacuum pump; determining one or more performance metrics of the vacuum pump based on a slope of the linear region; and concurrently displaying, via the display generation component, a graphical representation of the time-sequenced pressure data and representations of the one or more performance metrics.

In accordance with some embodiments, a system that is configured to communicate with a display generation component and a vacuum chamber coupled to a vacuum pump and a pressure sensor. The computer system includes one or more processors; and memory storing one or more programs configured to be executed by the one or more processors, means for activating the vacuum pump; means for receiving, from the pressure sensor, time-sequenced pressure data indicative of pressure within the vacuum chamber; means for identifying a linear region of a logarithmic transformation of the pressure data subsequent activation of the vacuum pump; means for determining one or more performance metrics of the vacuum pump based on a slope of the linear region; and means for concurrently displaying, via the display generation component, a graphical representation of the time-sequenced pressure data and representations of the one or more performance metrics.

In accordance with some embodiments, a computer program product is described. The computer program product comprises one or more programs configured to be executed by one or more processors of a computer system that is in communication with a display generation component and a vacuum chamber coupled to a vacuum pump and a pressure sensor. The one or more programs include instructions for: activating the vacuum pump; receiving, from the pressure sensor, time-sequenced pressure data indicative of pressure within the vacuum chamber; identifying a linear region of a logarithmic transformation of the pressure data subsequent activation of the vacuum pump; determining one or more performance metrics of the vacuum pump based on a slope of the linear region; and concurrently displaying, via the display generation component, a graphical representation of the time-sequenced pressure data and representations of the one or more performance metrics.

In accordance with some embodiments, an apparatus for a freeze-dryer includes: a coupler configured to press-fit around an outer rim of a shelf enclosure; a flange joined to the coupler adjacent the rim, the flange extending outward from an interior of the shelf enclosure and forming a planar sealing surface oriented to face a door of the freeze-dryer, wherein the flange does not extend into the interior of the shelf enclosure; and a gasket mounted along the planar sealing surface, the gasket positioned to be compressed between the planar sealing surface and the door when the door is closed.

In accordance with some embodiments, a freeze-dryer system, includes: a shelf enclosure having an opening defined by a rim; a coupler press-fit around an outer portion of the rim; a flange joined to the coupler and extending outward from an interior of the shelf enclosure, the flange forming a planar sealing surface oriented to face a door of the freeze-dryer, wherein the flange does not extend into the interior of the shelf enclosure; a gasket mounted along the planar sealing surface; and a door configured to compress the gasket against the planar sealing surface when in a closed position to form a vacuum-tight seal between the door and the shelf enclosure.

In accordance with some embodiments, an apparatus for forming a vacuum seal in a freeze-dryer, includes: means for coupling to an outer rim of a shelf enclosure; means for supporting a gasket in a position extending outward from the rim and away from an interior of the shelf enclosure, the means forming a planar sealing surface configured to face a door of the freeze-dryer; and means for sealing, including a gasket positioned to be compressed between the planar sealing surface and the door when the door is closed.

In accordance with some embodiments, an apparatus for a freeze-dryer, includes: means for attaching to an outer rim of a shelf enclosure without penetrating into an interior thereof; means for forming a sealing surface that extends laterally from the shelf enclosure and remains external to the enclosure interior; and means for forming a vacuum seal between the sealing surface and a door of the freeze-dryer.

### BRIEF DESCRIPTION OF THE FIGURES

For a better understanding of the various described aspects, reference should be made to the description below, in conjunction with the following figures in which like-referenced numerals refer to corresponding parts throughout the figures.

FIGS. 1A-1D illustrate conventional freeze-dryer interfaces utilized in the lyophilization processes.

FIGS. 2A-2B illustrate an advanced freeze-dryer interface utilized in the lyophilization processes, featuring the exemplary presentation of the status tab.

FIGS. 3A-3G illustrate an advanced freeze-dryer interface utilized in the lyophilization processes, featuring a projected path for the equilibrium phase of matter within the run/setup tab.

FIGS. 4A-4F illustrate an advanced freeze-dryer interface utilized in the lyophilization processes, featuring a projected path for the transient pressure and transient temperature within the run/setup tab.

FIGS. 5A-5C illustrate an advanced freeze-dryer interface utilized in the lyophilization processes, featuring cooling curves within the run/setup tab.

FIGS. 6A-6R illustrate an advanced freeze-dryer interface utilized in the lyophilization processes, featuring instances of a process under PID control within the run/setup tab.

FIGS. 7A-7K illustrate an advanced freeze-dryer interface utilized in the lyophilization processes, featuring operation control within the functions tab.

FIGS. 8A-8E illustrate an advanced freeze-dryer interface utilized in the lyophilization processes, featuring modeling parameters within the models tab.

FIGS. 9A-9F illustrate an advanced freeze-dryer interface utilized in the lyophilization processes, featuring camera configurations within the camera tab.

FIGS. 10A-10D illustrate an advanced freeze-dryer interface utilized in the lyophilization processes, featuring shelf and cold trap configurations within the settings tab.

FIGS. 11A-11L illustrate an advanced freeze-dryer interface utilized in the lyophilization processes, featuring a relay map and sensors/calibration configurations within the settings tab.

FIGS. 12A-12D illustrate the remote access configuration of the advanced freeze-dryer along with a preview providing a visual representation of the interface on a remote device such as a smartphone.

FIG. 13 illustrates a conceptual data flow diagram illustrating the connections between different means/components of a freeze-drying system.

FIG. 14 illustrates a flow diagram outlining a method for displaying the dynamic visualization of real-time temperature and pressure readings for a second substance juxtaposed against a phase diagram representing a first substance.

FIG. 15 illustrates a flow diagram outlining a method, which dynamically visualizes real-time temperature and pressure readings for a second substance, along with one or more previous temperature and pressure readings for the second substance, and a current equilibrium phase of matter indicator of a first substance.

FIG. 16 illustrates a flow diagram outlining a method for displaying the dynamic visualization of real-time temperature and pressure readings for a second substance juxtaposed against a phase diagram representing a first substance.

FIG. 17 illustrates a flow diagram outlining a method for displaying a phase diagram representing temperature and pressure equilibrium conditions, accompanied by an environmental control curve illustrating connections between set points and an environmental variable.

FIG. 18 illustrates a flow diagram outlining a method for displaying pressure and temperature control curves of a second substance and dynamically adjusting the curves while maintaining a pressure-temperature relationship.

FIG. 19 illustrates a flow diagram outlining a method for persistently displaying real-time temperature and pressure of a second substance, and equilibrium phase of matter of a first substance after periodically determining the equilibrium phase of matter of the first substance based on real-time temperature and pressure measurements of the second substance.

FIG. 20 illustrates a flow diagram outlining a method for enabling a pressure sensor upon meeting conditions and displaying real-time pressure using the sensor.

FIG. 21 illustrates a flow diagram outlining a method for extracting parameters from a substance profile, generating process curves based on the extract parameters, and displaying the generated process curves.

FIG. 22 illustrates a flow diagram outlining a method for adjusting the power level applied to the power diffusers proportionally to a deviation parameter within specified thresholds.

FIG. 23 illustrates a flow diagram outlining a method for displaying an estimate of a quantity of mass of first substance removed from the second substance during a lyophilization process.

FIG. 24 illustrates a flow diagram outlining a method for comparing reflected light with reference spectra to estimate and display a quantity of mass of first substance removed from the second substance during a lyophilization process.

FIG. 25 illustrates a flow diagram outlining a method for dynamically assigning process variables between different devices represented graphically, allowing for flexible management and control of device associations within a system.

FIG. 26 illustrates a flow diagram outlining a method for displaying real-time temperature, pressure, and equilibrium phase of matter data of the first substance within a second substance upon a current process status request.

FIG. 27 illustrates a flow diagram outlining a method for replacing a first set of condensing surfaces of a cold trap containing condensate with a second set of condensing surfaces and before condensate has been removed from the first set of condensing surfaces initiating a vacuum process using the second set of condensing surfaces.

FIG. 28 illustrates a flow diagram outlining a method for replacing a first container of a cold trap containing condensate with a second container and before condensate has been removed from the first container initiating a vacuum process using the second container.

FIG. 29 illustrates a flow diagram outlining a method for running the first condenser to collect condensate while under vacuum, then switching to the second condenser once the first condenser is at condensate capacity, before condensate has been removed from the first condenser.

FIG. 30 illustrates a flow diagram outlining a method for determining a phase transition curve of a substance and displaying a representation that delineates distinct phases of matter of the substance at equilibrium conditions.

FIG. 31 illustrates a flow diagram for monitoring sublimation dynamics and controlling a freeze-drying (e.g., lyophilization) process based on measured mass loss over time.

FIG. 32 illustrates flow diagram for monitoring and controlling a freeze-drying process.

FIG. 33 illustrates a flow diagram for adjusting sensor data during a freeze-drying process using configurable filtering techniques.

FIG. 34 illustrates a flow diagram for displaying estimated sublimation behavior concurrently with time-sequenced process data.

FIG. 35 illustrates a flow diagram for evaluating vacuum system performance and vacuum chamber integrity in a freeze-drying apparatus.

FIG. 36 illustrates a flow diagram for signal routing and override control in a man-in-the-middle configuration within a freeze-drying system.

FIG. 37 illustrates a flow diagram for determining and displaying a phase state or phase transition state of a first substance during a freeze-drying process.

FIGS. 38A and 38B illustrate a conventional door seal configuration for freeze-dryers.

FIGS. 39A-D illustrate an improved door seal configuration, incorporating a removable pressed flange.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

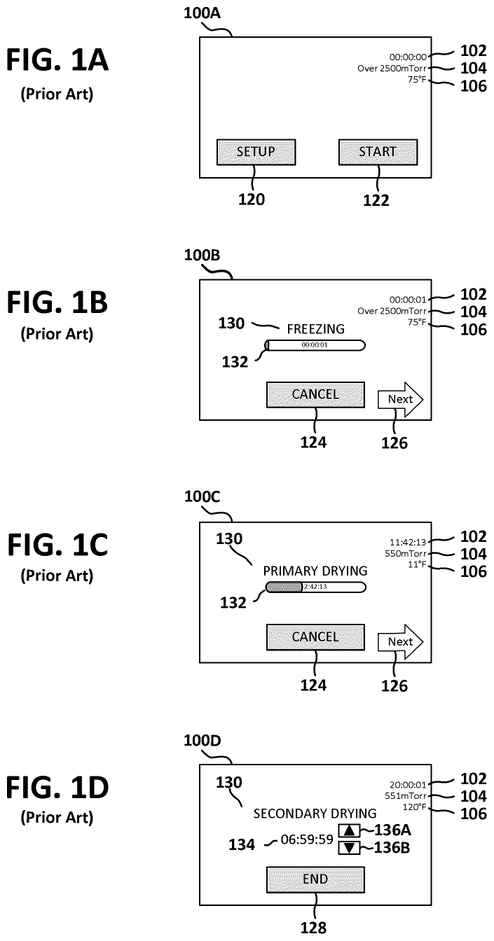

FIGS. 1A-1D illustrate conventional freeze-dryer interfaces utilized in the lyophilization processes. These interfaces prioritize automation over manual control, resulting in a process categorized into distinct stages: idle stage interface 100A, freezing stage interface 100B, primary drying stage interface 100C, secondary drying stage interface 100D, and process completed stage interface (not shown). Notably, these stages refer to generalized periods of lyophilization processes and lack specific detail of the state of the substance. As such, these conventional interfaces lack the capability to display the current state of the substance or its defining parameters. For instance, in FIG. 1B, the stage indicator 130 of the freezing stage interface 100B displays “freezing” just one second into the process as indicated by the timer 110, even though the temperature indicator 106 displaying 75° F. and the pressure indicator 104 exceeding 2500 mTorr remain unaltered from the idle stage interface 100A depicted in FIG. 1A.

Moreover, the conventional freeze-dryer interfaces further underscore the categorized stages by featuring a stage chronometer 134, which indicates the duration the freeze-dryer 110 has spent within a particular stage. This stage chronometer 134, as depicted in FIGS. 1B-1D, serves as a visual representation of the time elapsed for each stage of the lyophilization process. While the stage chronometer 134 provides the time elapsed for each stage of the lyophilization process, it remains disconnected from the dynamic display of real-time changes in the state of the substance or the intricate operational parameters of the freeze-dryer 110. Further, this visualization of stage progression is reinforced in FIGS. 1B and 1C through the presence of a stage progress bar 132, which provides a graphic representation of a comparison of the elapsed time of the stage compared to the predetermined time duration allotted for each stage of the lyophilization process of conventional freeze-dryers 110. This portrayal emphasizes that each stage is constrained by a fixed time interval rather than being responsive to the current state of the substance or its defining parameters. The stage progress bar 132 serves to reinforce the conventional reliance on predetermined timeframes of the freeze-dryer interface, potentially limiting the adaptability required for accommodating variations in the behavior of the substance during the process.

In addition, the control capabilities of conventional freeze-dryer interfaces are confined during the process cycle. For instance, in the initial idle stage interface 100A, the control options are: a start button 122 and a setup button 120. These options provide minimal parameter adjustments before commencing the process cycle. Similarly, the freezing stage interface 100B, as depicted in FIG. 1B, and the subsequent primary drying stage interface 100C, as depicted in FIG. 1C, offer a cancel button 124 to halt the process and an advance button 126 to move to the next stage. Likewise, the second drying stage interface 100D, as depicted in FIG. 1D, displays an end button 128 to conclude the process cycle and time duration buttons 136, affording the ability to extend or reduce the duration of the secondary drying stage. Despite the presence of these control elements, it is important to note that the control buttons are predominantly stage-oriented, rather than being intricately tied to the current state of the substance or its defining parameters. As a result, many dynamic nuances that could hold substantial influence over the lyophilization process within the conventional interfaces remain hidden, and certain controls are omitted. This can potentially hinder the ability to diagnose issues or optimize the lyophilization process.

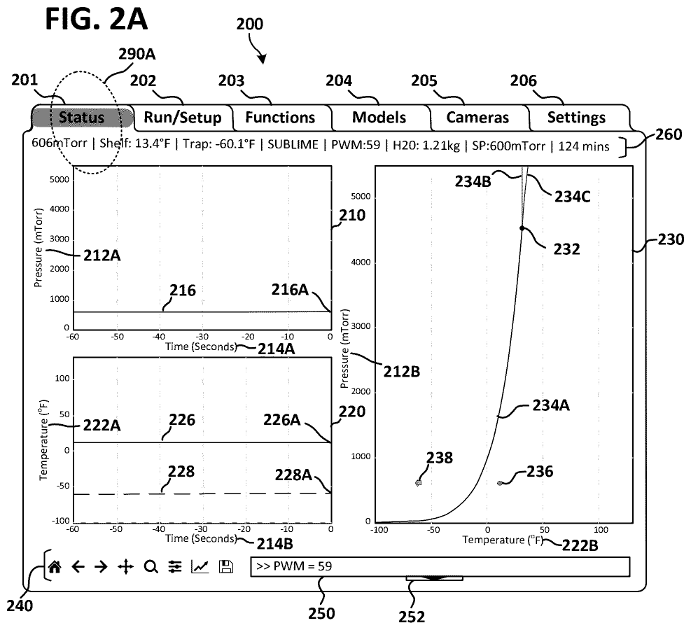

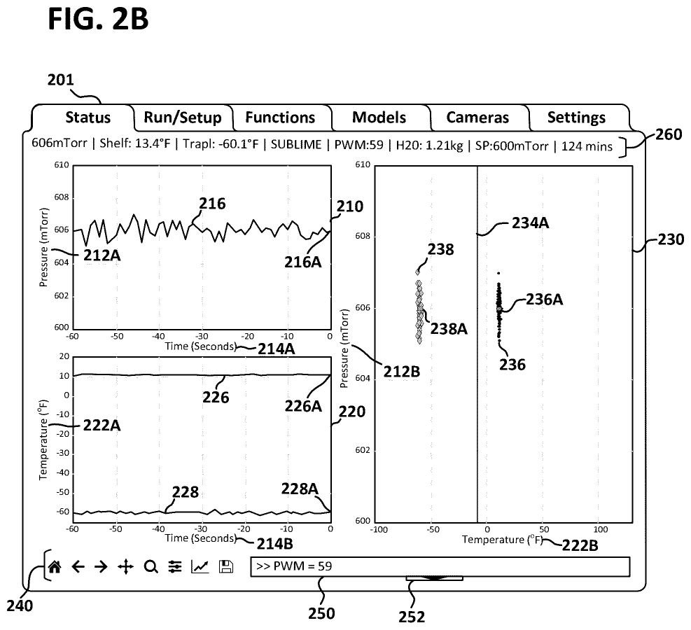

FIGS. 2A-2B illustrate an advanced freeze-dryer interface 200 utilized in the lyophilization processes, featuring the exemplary presentation of the status tab. The freeze-dryer interface 200 corresponds to an interactive user interface displayed on the screen (e.g., display 694) of one or more devices, such as smartphones 692 or computers 720. The interface 200 presents graphics in a manner that is more intuitive for the user. As used herein, the term “graphics” includes any object that can be displayed to a user, including, without limitation, text, web pages, icons (such as user-interface objects like soft keys), digital images, videos, animations, and similar visual elements.

The freeze-dryer interface 200 is structured with various tabs (e.g., navigational directories and the like) each serving as a navigational point to access different operational sections. These tabs include status tab 201, run/setup tab 202, functions tab 203, models tab 204, cameras tab 205, and settings tab 206. It should be noted that status tab 201, run/setup tab 202, functions tab 203, models tab 204, cameras tab 205, and settings tab 206 can be represented as navigable windows, menus, and the like.

The flexibility of the interface is demonstrated by its potential to include additional tabs for various operational controls and data from the freeze-dryer 110. For example, a viewer tab (not shown) could be included to allow the loading of data files from previously completed process cycles. These loaded data files could then be displayed using a transient pressure plot 210, a transient temperature plot 220, and a phase plot 230 similar to the layout of the status tab 201 in FIG. 2A. This capability of a viewer tab (not shown) offers valuable support for post-processing analysis, troubleshooting, and the optimization of the process cycle.

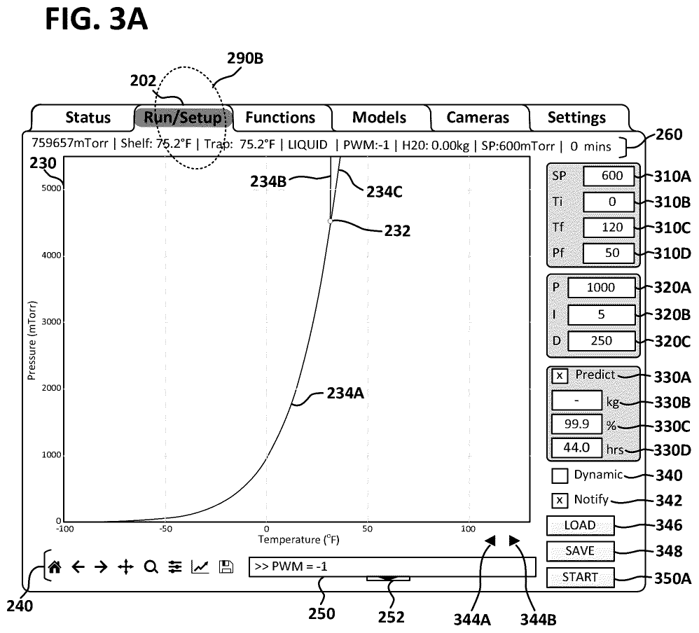

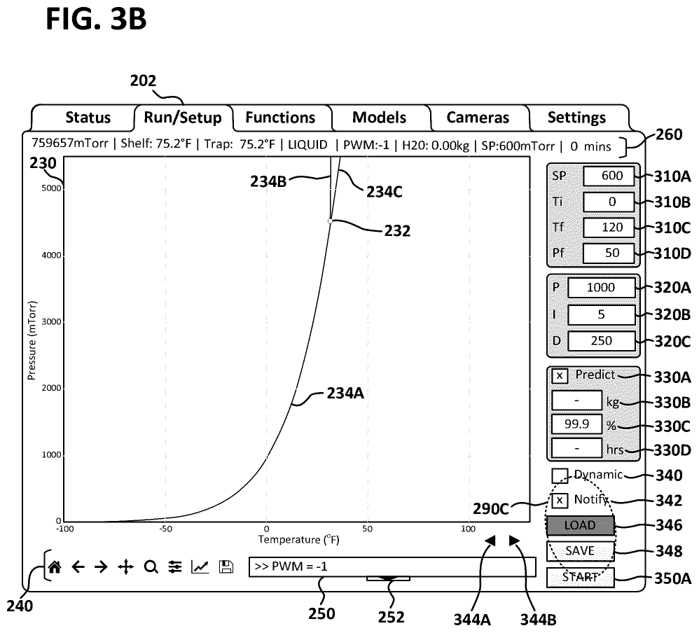

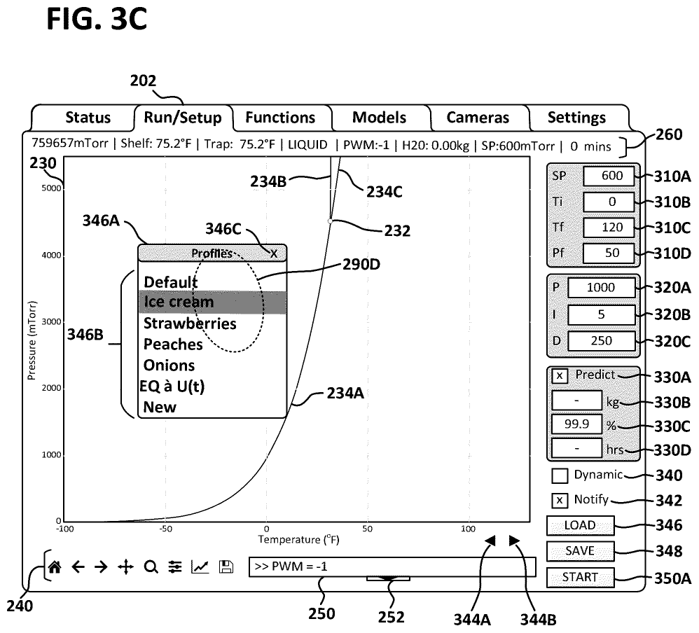

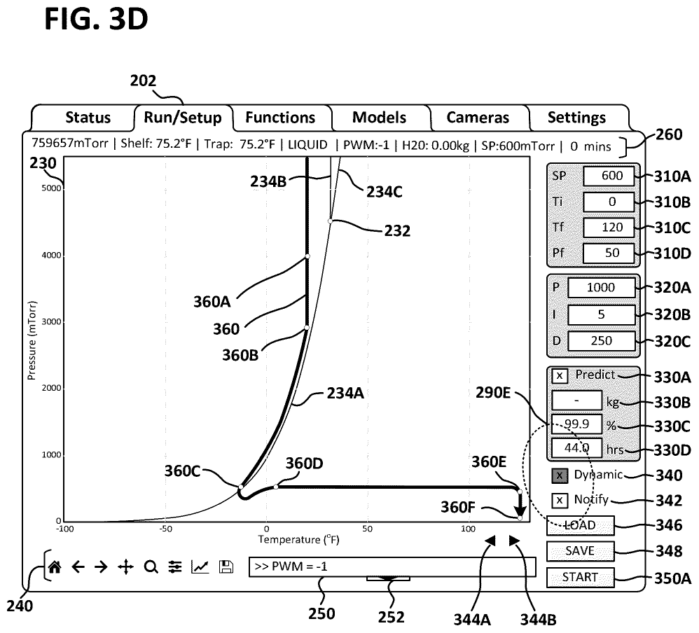

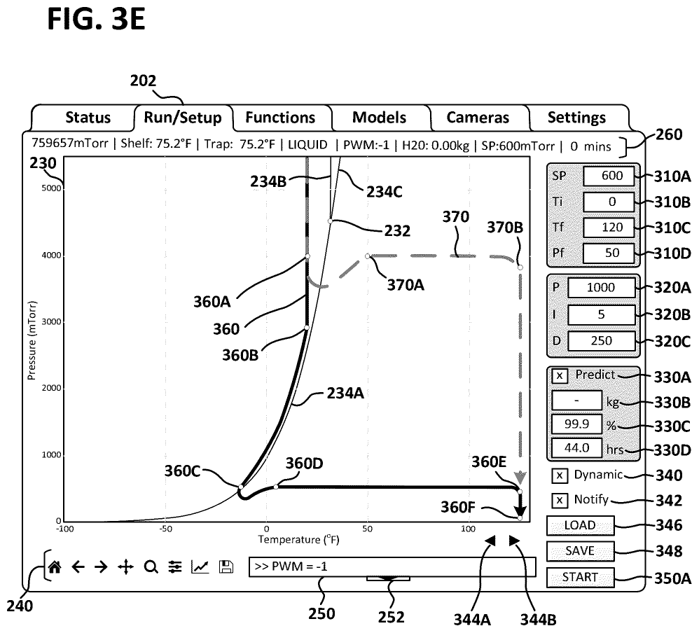

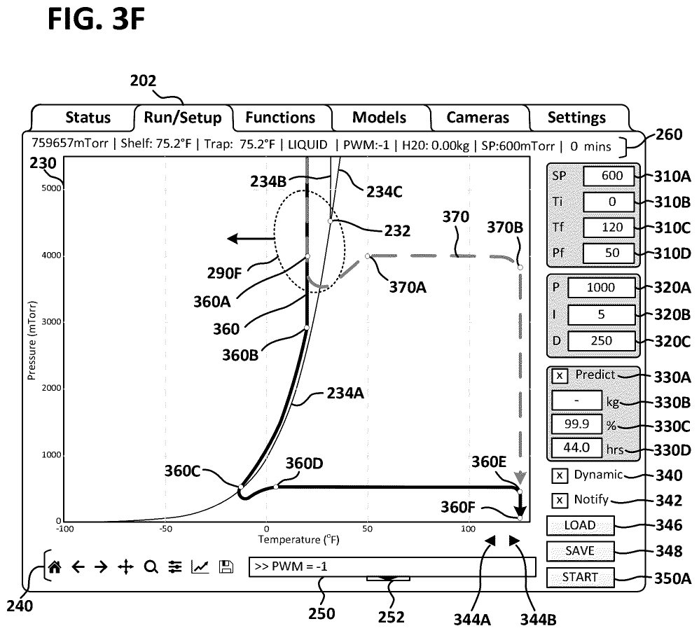

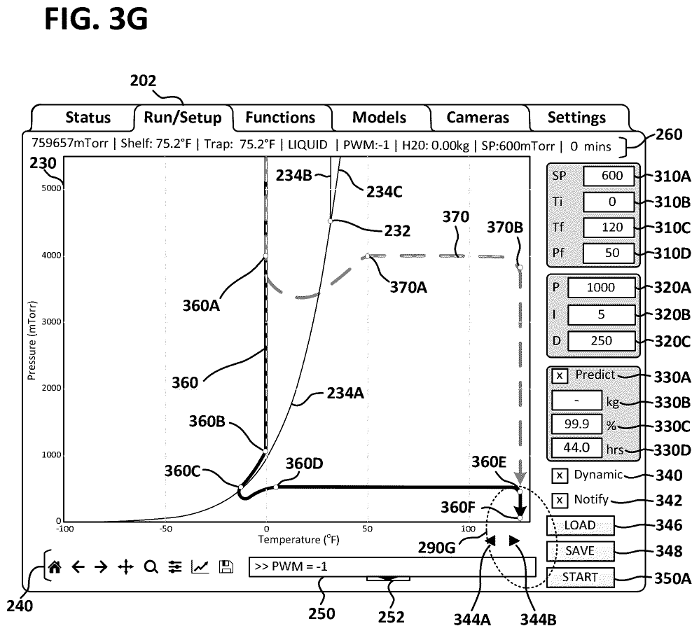

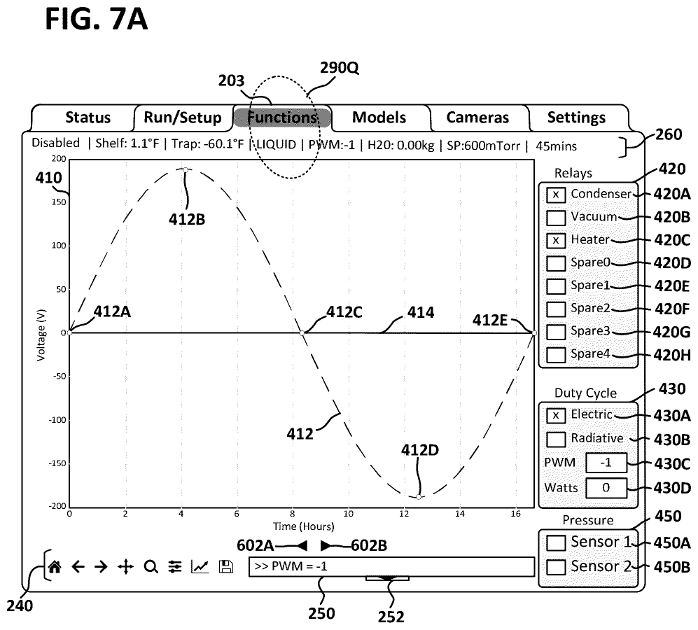

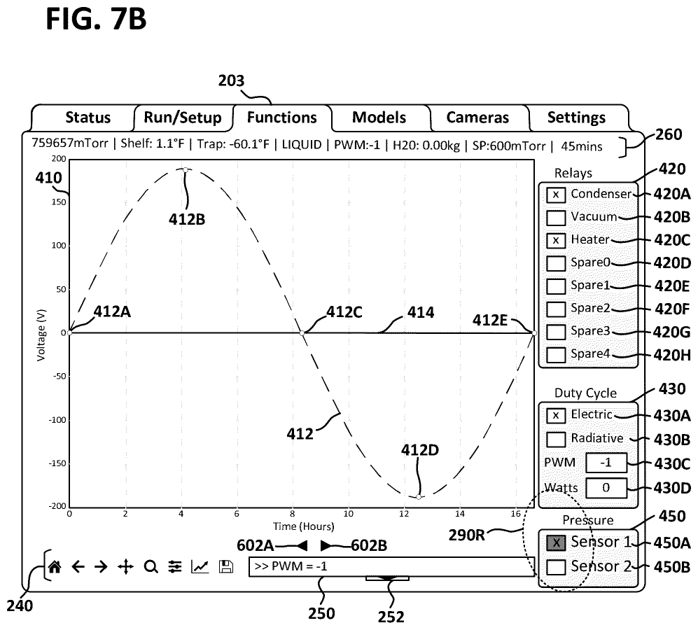

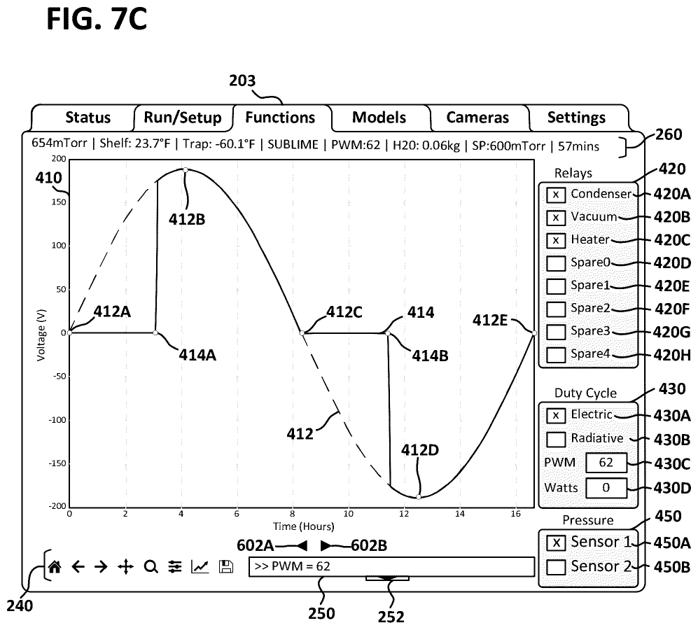

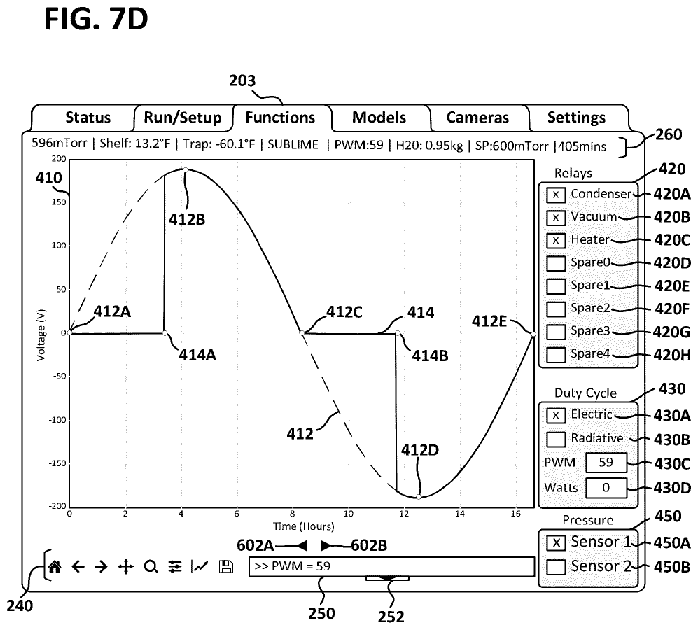

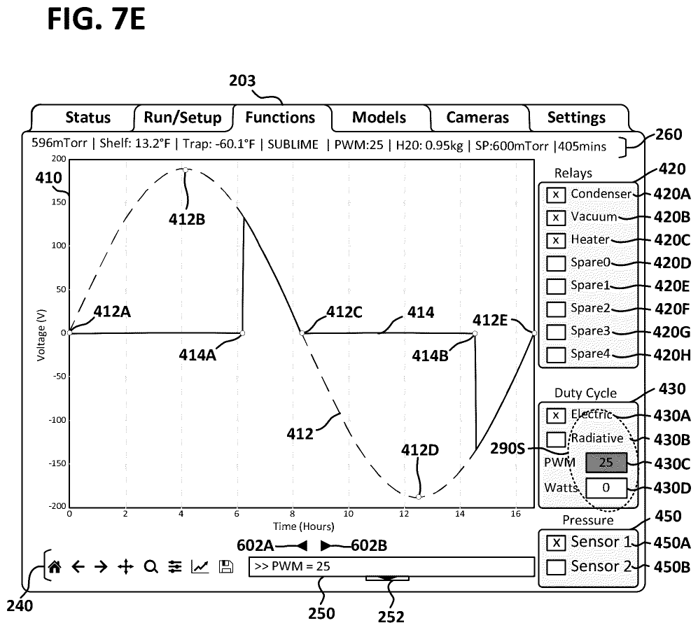

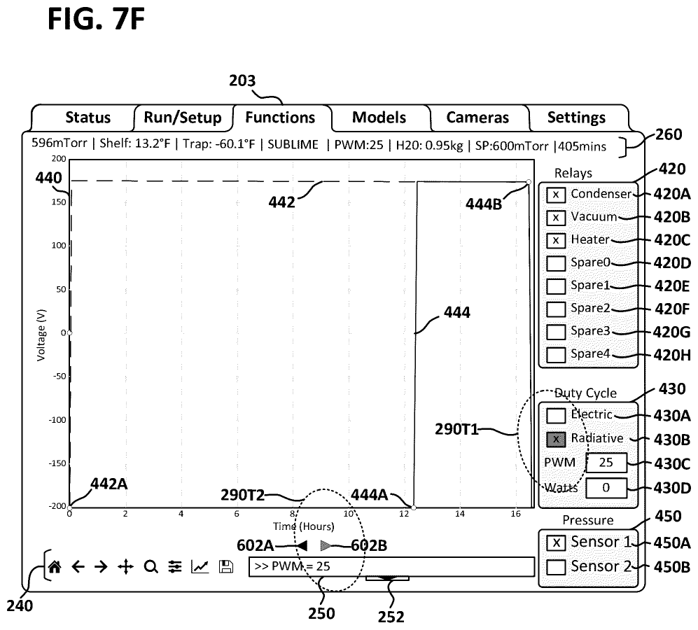

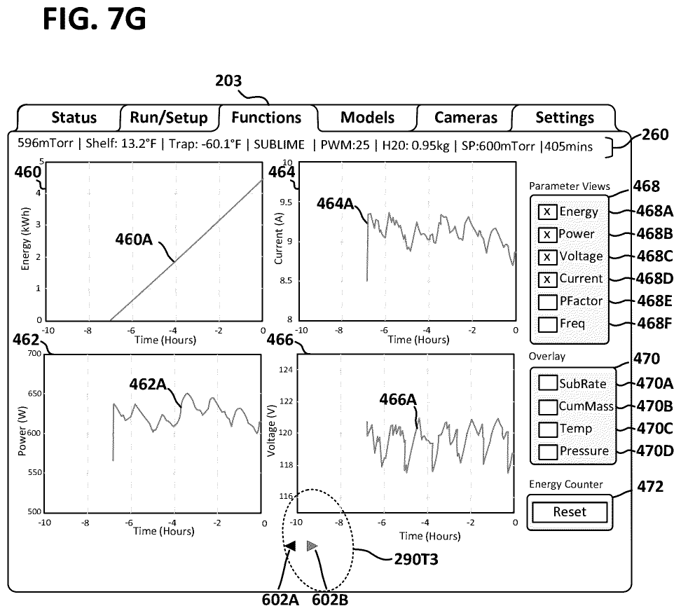

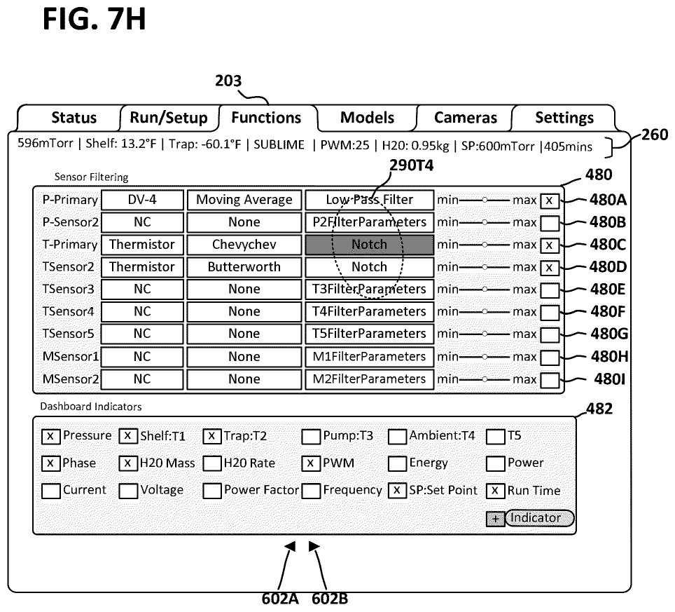

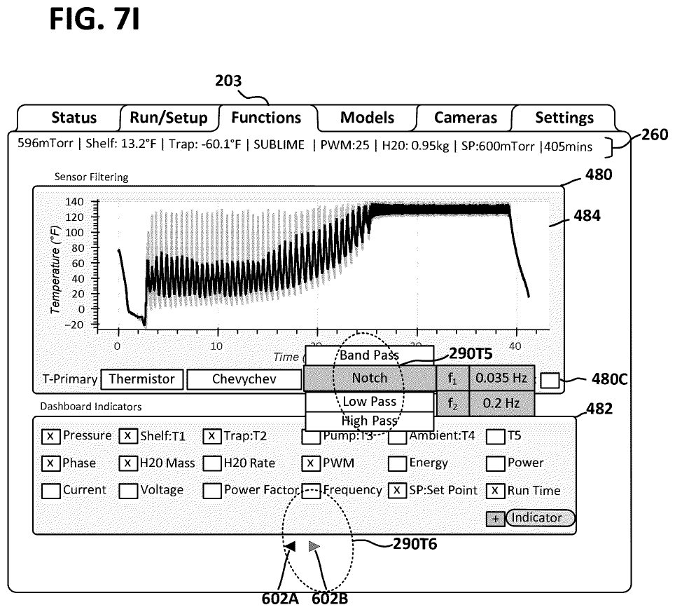

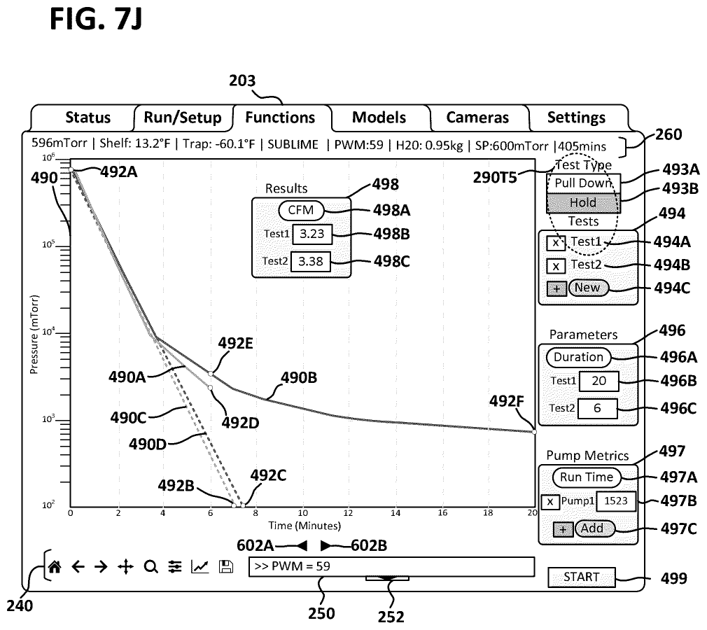

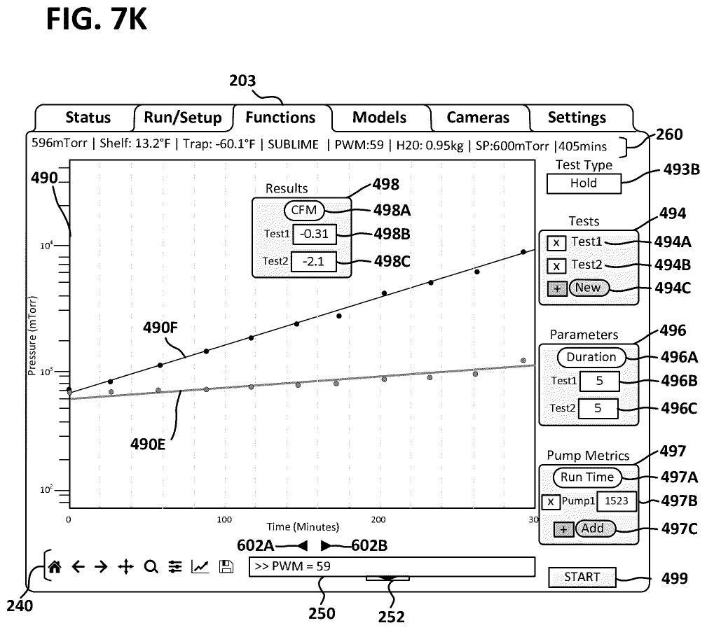

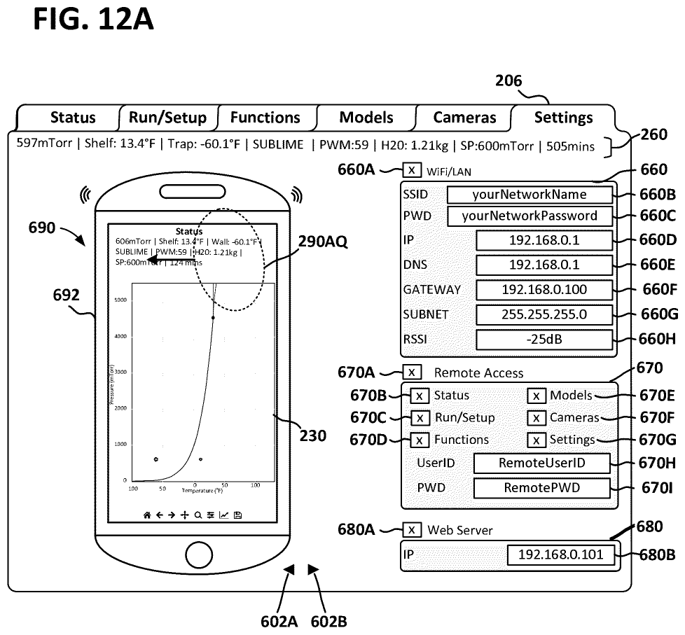

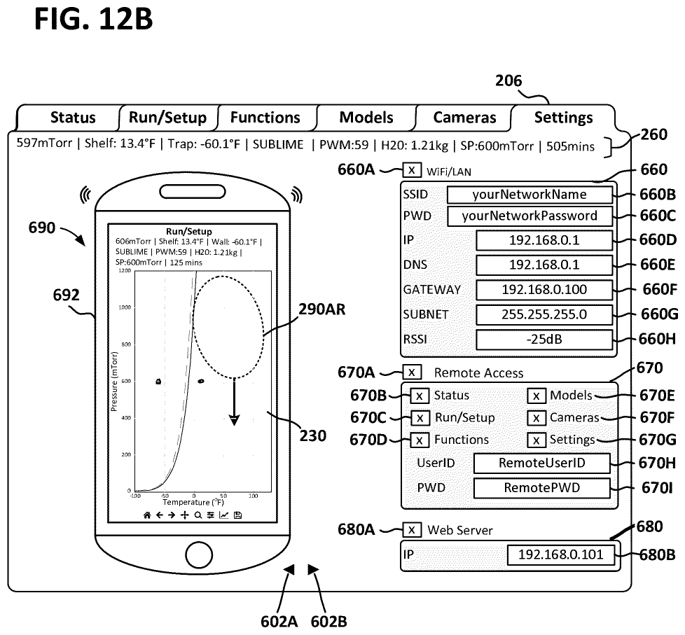

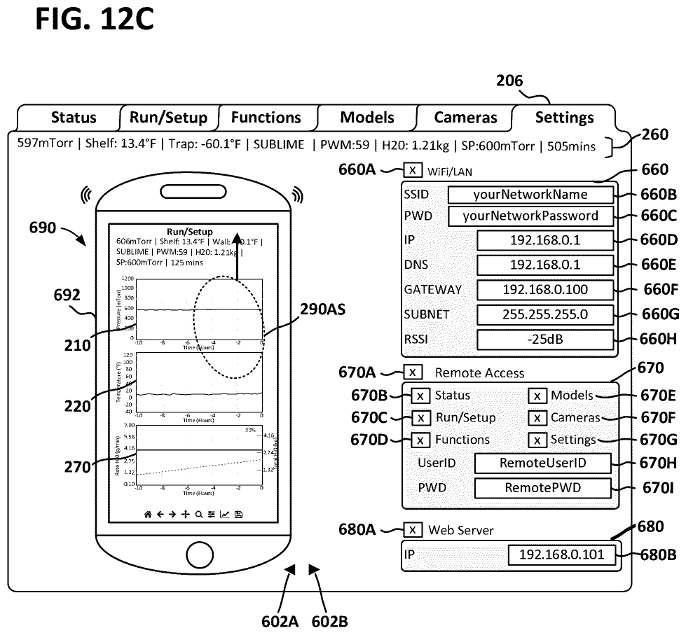

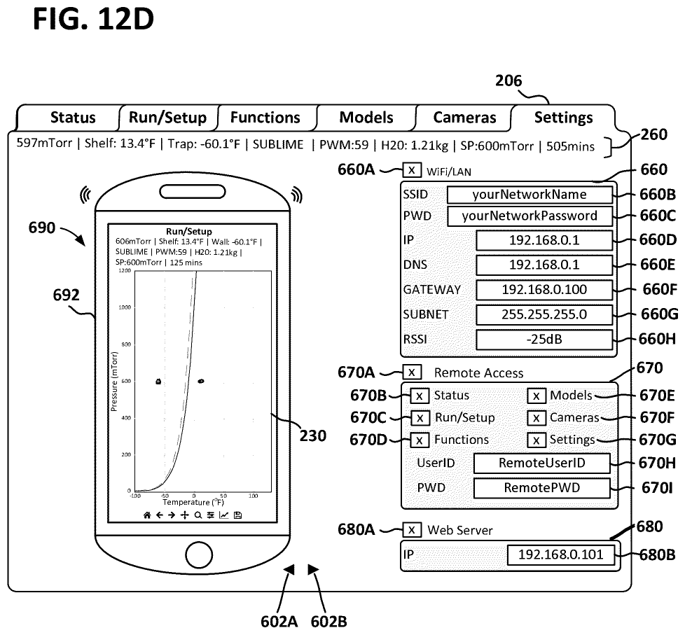

Selection of any of the tabs, such as the status tab 201, run/setup tab 202, functions tab 203, models tab 204, cameras tab 205, and settings tab 206, denoted by contacts 290A-290AK, provides users access to the corresponding contents of the tab. Notably, intuitive swipe and scroll gestures, including swiping left/right and up/down, or scrolling left/right and up/down, offer alternative navigation through menu tabs and items, akin to the depictions in FIGS. 12A and 12B. For instance, a left swipe gesture across the status tab 201 in FIG. 2A triggers a sequential menu tab switch to the run/setup tab 202 depicted in FIG. 3A. Similarly, a subsequent left swipe gesture across the run/setup tab 202 in FIG. 3A initiates the sequence menu tab switch to the functions tab 203 shown in FIG. 7A, and so forth. Conversely, a right swipe gesture across the functions tab 203 in FIG. 7A prompts the sequence menu tab switch to the run/setup tab 202 as illustrated in FIG. 3A.

Each tab of the freeze-dryer interface 200 also includes a dashboard 260 that serves as an information hub, presenting indicators that offer real-time insights into the current state of both the freeze-dryer 110 and the ongoing process cycle. Providing instant access to parameters such as pressure, temperature, phase state, and operational settings, the dashboard 260 enhances the ability to monitor, control, and fine-tune the lyophilization process. As depicted in FIG. 2A, the dashboard 260 concurrently displays indicators of the ongoing equilibrium phase state of a solvent including the defining parameters of the ongoing temperature measurement of a substance (e.g., displayed as Shelf: 13.4° F.), and ongoing pressure measurement of the substance (e.g., displayed as mTorr). In some embodiments, the substance includes the solvent, such as frozen food containing a certain amount of ice. As time advances, typically triggered by the lapse of a predetermined time period, this displayed information undergoes dynamic updates. These updates encompass the reception of real-time temperature and pressure measurements of the substance, followed by the determination of the real-time equilibrium phase state of the solvent based on these measurements. Consequently, the display is updated to reflect the latest real-time temperature measurement of the substance, the latest real-time pressure measurement of the substance, and the latest determined real-time equilibrium phase state of the solvent (e.g., water).

The equilibrium phase state of the solvent refers to the particular physical state or equilibrium phase of matter that the solvent naturally assumes when it is in a stable and balanced condition within a given environment. This can include states such as solid, liquid, or gas, as well as phase transitions like melting, freezing, sublimating, condensing, and depositing. The equilibrium phase state is reached when the rates of phase transitions in both directions (e.g., freezing and sublimating) are equal, resulting in a stable state of matter. In some embodiments, the equilibrium phase state of the solvent corresponds to an equilibrium phase state of matter such as liquid, solid, gas or a phase transition state of matter such as melting, freezing, sublimating, condensing, depositing, etc.

The arrangement of indicators within dashboard 260 is structured for clarity and to avoid confusion. These indicators are positioned in fixed locations, establishing a consistent visual layout that enhances familiarity and mitigates the risk of errors due to shifting indicators. Moreover, maintaining the persistent visibility of these indicators across tabs is desirable due to the significance of these indicators. Their consistent positions enable rapid location and interpretation of the information, fostering a streamlined experience and reducing the risk of misunderstanding. This approach recognizes the importance of these indicators and aims to optimize interaction by providing a reliable and intuitive reference point across various contexts within the application. In some embodiments, the dashboard 260 persistently remains visible across different tabs, ensuring continuous access to the indicators. This provides real-time updates on the status of the freeze-dryer and ongoing process cycle regardless of the active tab. In some embodiments, dashboard 260 includes a persistent portion that remains visible across different tabs and a non-persistent portion that changes with the specifics of the tab. The persistent portion of the dashboard 260 features indicators of the current state of the substance such as the current pressure in the shelf enclosure 511 (e.g., shown as 606 mTorr in FIG. 2A), the substance temperature (e.g., shown as Shelf: 13.4° F. in FIG. 2A), and the phase state (e.g., shown as SUBLIME in FIG. 2A) of the substance.

In some embodiments, the dashboard 260 assumes a continuous presence on the display, overlaying content in a consistent and unchanging manner, irrespective of the interface being used. This steadfast visibility is designed to ensure that the dashboard remains constantly accessible without impeding interactions with various elements within the freeze-dryer interface 200. In some embodiments, the dashboard 260 provides an unobtrusive persistence that extends across every tab of the freeze-dryer interface 200, where the dashboard 260 becomes an integral and continuous fixture, superimposing content.

Within its framework, the dashboard 260 encapsulates an array of parameters and functional indicators. These may include the real-time pressure within the vacuum chamber, the temperature of the substance, the equilibrium phase state of the substance, the environmental control variable setting, the set point of the environmental control variable, the estimate of the amount of mass of the solvent removed from substance, the cold trap temperature, the total runtime of the cycle, among others.

In some embodiments, the dashboard 260 includes an indicator for an environmental control variable setting (e.g., shown as PWM: 59 in FIG. 2A). The environmental control variable setting corresponds to the amount of pulse width modulation (PWM) applied to the electrical power. The PWM modulation facilitates the adjustment of effective power delivery by regulating the duty cycle of the PWM signal using a duty cycle regulator 432. This control governs the duration of time the power signal resides in its high and low phases, resulting in an adaptable power waveform. In some embodiments, the dashboard 260 includes an indicator for a duty cycle measurement (not shown). In certain embodiments, the PWM is applied to a direct current (DC) electrical power signal producing a series of square or rectangular pulses. In certain embodiments, the PWM is applied to an alternating current (AC) electrical power signal producing a “PWM-modulated AC waveform” or a “PWM-modulated sinusoidal waveform”.

In some embodiments, the dashboard 260 includes an indicator for a set point of the environmental control variable (e.g., shown as SP: 600 mTorr in FIG. 2A). The set point of the environmental control variable corresponds to a user-defined input that establishes a target for either a pressure measurement of the substance or a temperature of the substance. This set point acts as a reference point, guiding the lyophilization process. That is, the operational dynamics are orchestrated by an algorithm that continuously monitors and regulates the environmental control variable setting to converge with these set points. As the process unfolds, the algorithm actively manipulates the environmental control variable setting to align the predefined set points with either the pressure measurement of the substance or the temperature measurement of the substance, thereby ensuring that the conditions of the substance correspond to the desired equilibrium phase state of the solvent (e.g., water). In certain embodiments, the algorithm is a PID.

In some embodiments, the dashboard 260 includes an indicator for a cold trap temperature (e.g., shown as Trap: −60.1° F. in FIG. 2A). The cold trap provides the environment conducive to the condensation of the sublimated solvent, which include a lower cold trap temperature than the temperature of the substrate. Providing a location conducive to the condensation of the sublimated solvent prevents the solvents from negatively impacting the quality or characteristics of the substrate and simultaneously contributes to the reduction of pressure within the chamber, thereby facilitating the lyophilization process.

In some embodiments, the dashboard 260 includes an indicator for an estimate of the amount of mass of the solvent removed from the substance (e.g., shown as H2O: 1.21 kg in FIG. 2A). After a predetermined duration, a measurement is taken to gauge the change in mass, enabling the determination of the estimated mass of the removed solvent. In certain embodiments, this estimation involves weighing the substance, where the reduction in weight directly corresponds to the removed mass. In certain embodiments, this estimation involves weighing the trap, where the accumulation of ice on the trap leads to increased weight. In certain embodiments, this estimation involves thermodynamic models that assess energy input and output. In certain embodiments, this estimation involves image-based models that correlate the volume of accumulated ice on the trap to estimate the mass.

In some embodiments, the dashboard 260 includes an indicator for elapsed time. The elapsed time can describe the duration since commencing the process cycle (e.g., shown as 124 mins in FIG. 2A) or since milestones have been reached (e.g., reaching the target for either a pressure measurement of the substance or a temperature of the substance). The elapsed time indicator gauges the progress of the process and whether any adjustments or interventions are merited.

After a predetermined duration of time the dashboard 260 indicators are dynamically updated. These updates include the reception of real-time temperature and pressure measurements of the substance, reception of the real-time environmental control variable setting, followed by the determination of the real-time equilibrium phase state of the solvent based on these measurements, reception of the real-time duty cycle data, followed by the determination of the real-time duty cycle measurement from the real-time duty cycle data, reception of the real-time set point of the environmental control variable, reception of the real-time cold trap temperature measurement, and reception of the real-time estimate of the amount of mass of the solvent removed from the substance. Consequently, the display is updated to reflect the latest real-time temperature measurement of the substance, the latest real-time pressure measurement of the substance, the latest real-time environmental control variable setting, and the determined real-time equilibrium phase state of the solvent, the latest real-time duty cycle measurement, the latest real-time set point of the environmental control variable, the latest real-time cold trap temperature measurement, and the latest real-time estimate of the amount of mass of the solvent removed from the substance.

The indicators in FIG. 2A portray measurements that reveal the operational state of the freeze-dryer and substance characteristics. When a conversion request is initiated, freeze-dryer interface 200 determines whether the conversion involves temperature, pressure, or mass estimates, etc. If the conversion request corresponds to a request to alter the temperature measurement of “Shelf: 13.4° F.” for the substance to Celsius, the freeze-dryer interface 200 converts the temperature measurement from 13.4° F. to −10.3° C., and the substance measurement in the dashboard 260 is replaced with “Shelf: −10.3° C.” equivalent. This mechanism enables individuals to interpret the temperature data in units that align with their preferences or specific requirements. Likewise, if a conversion request related to altering the pressure measurement of “606 mTorr” for the substance to Pascals, the freeze-dryer interface 200 transforms the pressure measurement from 606 mTorr to 80.8 Pascal, and the corresponding indicator in the dashboard 260 is updated to “80.8 Pa”. Similar conversion requests can extend to modifying other units (e.g., kg-to-pounds hours-to-minutes, etc.).

In some embodiments, the request for unit conversion is directly related to a touch registered on a touch-sensitive surface incorporated with the freeze-dryer 110. That is, if a touch is detected within a corresponding area of the displayed indicators of dashboard 260, a conversion request is triggered. For example, contact on the touch-sensitive surface at a location corresponding to the estimated mass measurement of “1.21 kg” displayed in the dashboard 260, triggers a conversion request to alter the estimated mass measurement of “1.21 kg” for the substance to pounds, the freeze-dryer interface 200 transforms the estimated mass measurement from 1.21 kg to 2.67 pounds, and the corresponding indicator in the dashboard 260 is updated to “1.21 kg” to “2.67 lbs”.

Each individual indicator within the freeze-dryer dashboard 260 is meticulously color-coordinated to seamlessly align with the data points mapped on the plots of functional parameters within each tab. This color-coding facilitates effortless association of specific indicators with their corresponding data trends. For instance, the indicator for the pressure measurement of the substance is color-coded in red, synchronizing with the color scheme of the ordinate (e.g., y-axis) on the transient pressure plot 210. This visual consistency enhances comprehension and establishes a cohesive visual language that facilitates a quick and intuitive grasp of the freeze-drying process and its intricate dynamics.

The tabs of the interface are designed to present data relevant to the operations and controls of the freeze-dryer applicable to each specific operational section. For instance, the status tab 201 depicted in FIG. 2A is designed to convey the status of the freeze-dryer 110 over time (e.g., the past minute in FIG. 2) using a transient pressure plot 210, a transient temperature plot 220, and a phase plot 230. The transient pressure plot 210 displays visual representations of the transient vacuum chamber pressure data 216 over time (e.g., the past minute in FIG. 2), as well as the real-time transient vacuum chamber pressure data 216A. The transient pressure plot 210 further incorporates a pressure label 212A (in mTorr) on the y-axis and a pressure time label 214A (in seconds) on the x-axis.

The transient pressure plot 210 is updated to incorporate the current real-time pressure after a predefined duration has passed. During the update the real-time pressure measurement of the solvent is added to a sequence of pressure data of the solvent. In some instances, the real-time pressure measurement of the solvent is added to the end of the sequence, which orders the sequence in reverse chronological order to accommodate negative time values depicted in the transient pressure plot 210 of FIG. 2A, denoting instances proceeding the current time. In some embodiments, during the update, the items in the sequence of pressure data are shifted and/or the first item in the sequence of pressure data is removed.

Similarly, the transient temperature plot 220 displays visual representations of the transient temperature data 226 and the transient trap temperature data 228 over time (e.g., the past minute in FIG. 2), as well as, the real-time transient temperature data 226A, and the real-time transient trap temperature data 228A. The transient temperature plot 220 further incorporates a temperature label 222A (in ° F.) on the y-axis and a temperature time label 214B (in seconds) on the x-axis. Notably, both the transient pressure plot 210 and the transient temperature plot 220 accommodate negative time values, denoting instances preceding the current time.

The transient temperature plot 220 is updated to incorporate the current real-time temperature after a predefined duration has passed. During the update the real-time temperature measurement of the solvent is added to a sequence of temperature data of the solvent, and the real-time temperature measurement of the cold trap is added to a sequence of temperature data of the cold trap. In some instances, the real-time temperature measurement of the solvent and/or the real-time temperature measurement of the cold trap are added to the end of the sequence, which orders the sequence in reverse chronological order to accommodate negative time values of the transient temperature plot 220 of FIG. 2A, denoting instances preceding the current time. In some embodiments, during the update, the items in the sequence of temperature data are shifted and/or the first item in the sequence of temperature data is removed.

In some embodiments, when the transient temperature plot 220 is updated one or more of the dashboard 260 indicators (e.g., the temperature measurement of the solvent, the temperature measurement of the cold trap, the pressure measurement, the equilibrium phase of matter state of the solvent, etc.) are concurrently displayed with the data from the transient temperature plot 220 including at least one element of the sequence of temperature data corresponding to a historical temperature measurement. As an illustrative example, when the transient temperature plot 220 is refreshed, a visual representation of the temperature history of the solvent can accompany the indicators, displaying a historical temperature measurement that corresponds to a significant phase transition of the solvent.

In some embodiments, when the transient temperature plot 220 is updated a temperature target of the solvent for a future time period is estimated and one or more of the dashboard 260 indicators (e.g., the temperature measurement of the solvent, the temperature measurement of the cold trap, the pressure measurement, the equilibrium phase of matter state of the solvent, etc.) are concurrently displayed with the temperature target.

In some embodiments, when the transient pressure plot 210 is updated a pressure target of the solvent for a future time period is estimated and one or more of the dashboard 260 indicators (e.g., the temperature measurement of the solvent, the temperature measurement of the cold trap, the pressure measurement, the equilibrium phase of matter state of the solvent, etc.) are concurrently displayed with the pressure target.

The phase plot 230 offers a comprehensive depiction of freeze-dryer dynamics, capturing the interplay between transient vacuum chamber pressure data 216, transient temperature data 226, and transient trap temperature data 228 over time (e.g., the past minute in FIG. 2). The plotted points for the vacuum chamber pressure data 216 and temperature data 226 are visually depicted as substance temperature-pressure data 236, while the vacuum chamber pressure data 216 and trap temperature data 228 are represented as substance temperature-pressure data 236 and 238, respectively in FIG. 2A. The phase plot 230 incorporates the pressure label 212B (in mTorr) on the y-axis, the temperature label 212B (in ° F.) on the x-axis, and a phase curve that illustrates thermodynamic phase equilibrium of water (H2O). This phase curve traces the boundary between various phases of water matter, providing a graphical representation of the coexistence of solid, liquid, and gaseous states. The boundary between various phases of water matter includes: the sublimation line (ice-to-water vapor line) 234A, the fusion line (ice-to-liquid water line) 234B, and the vaporization line (liquid water-to-water vapor line) 234C. These lines graphically highlight the equilibrium thresholds at which phase transitions occur. As depicted in FIG. 2A, the sublimation line 234A, the fusion line 234B, and the vaporization line 234A converge at the triple point of water 232, which denotes the unique thermodynamic equilibrium of ice, liquid water, and water vapor.

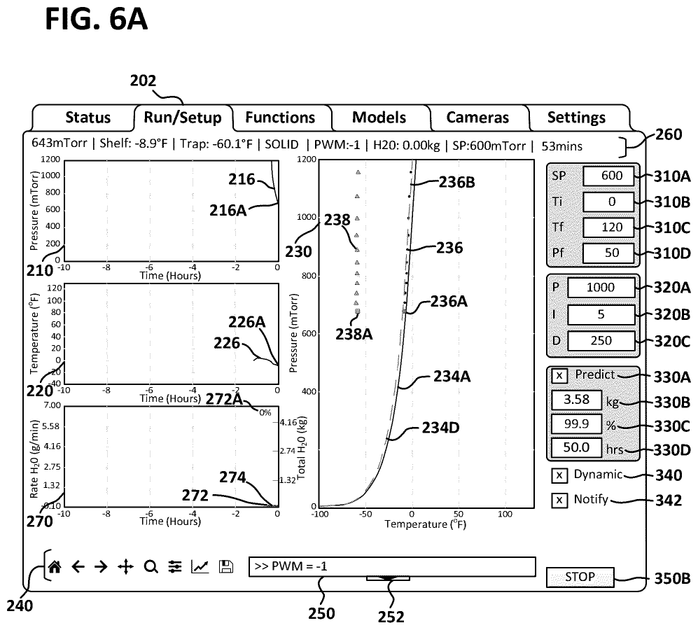

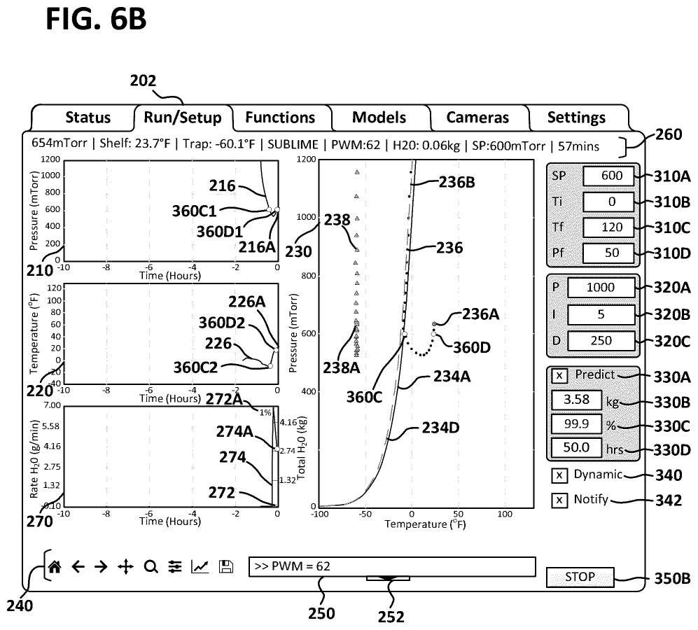

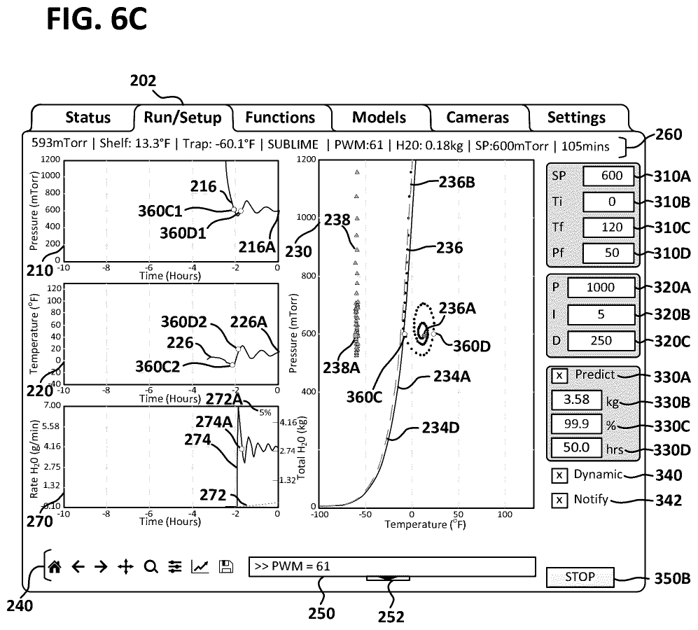

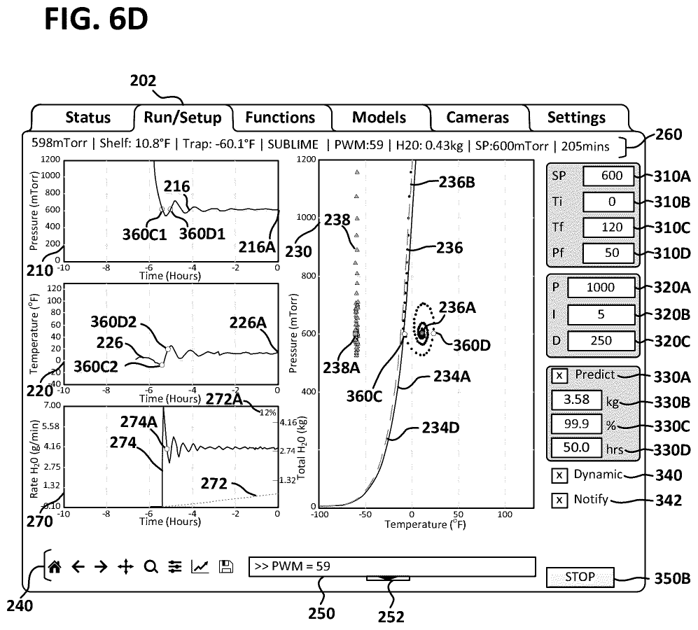

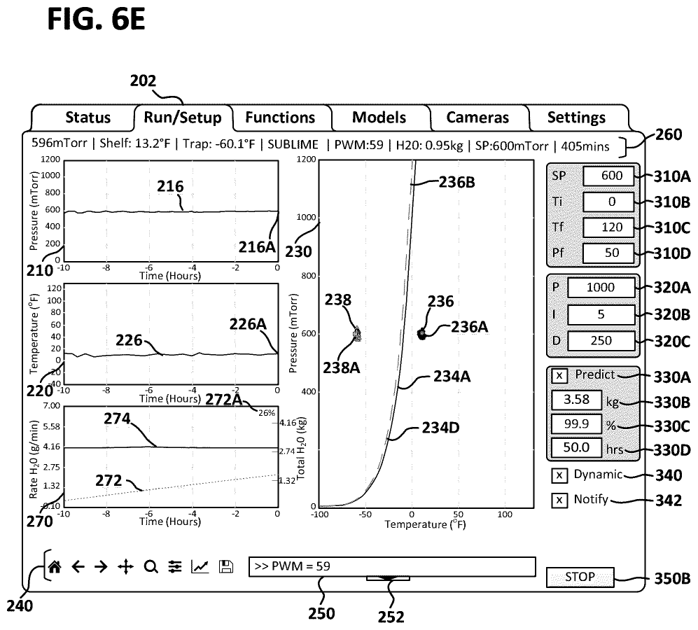

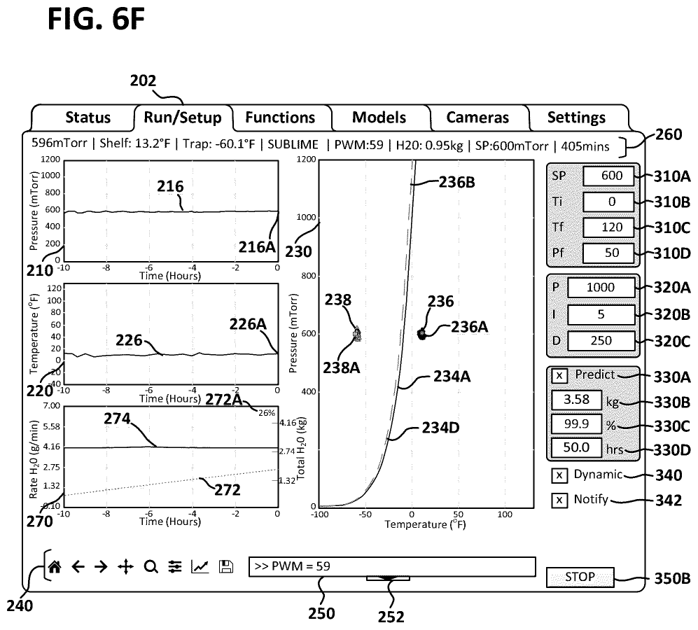

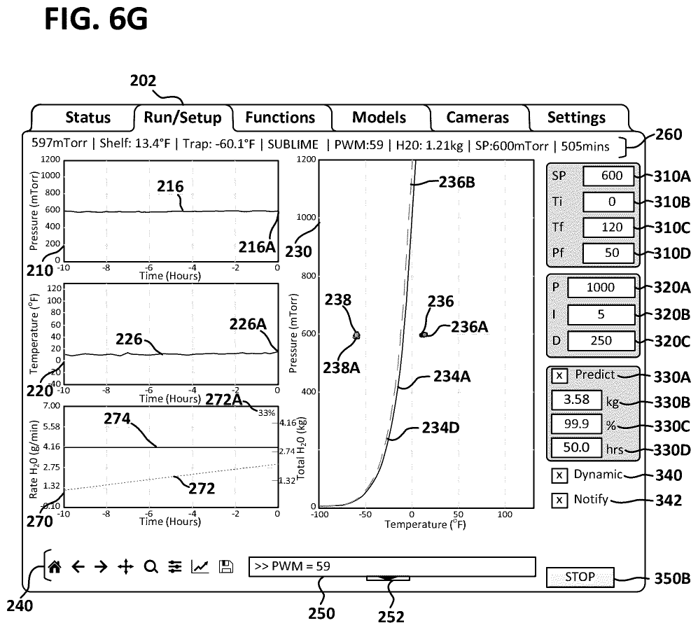

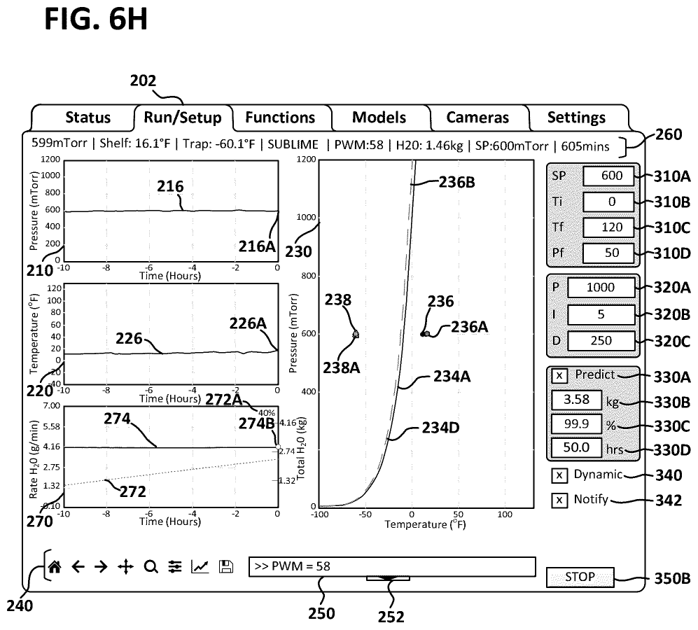

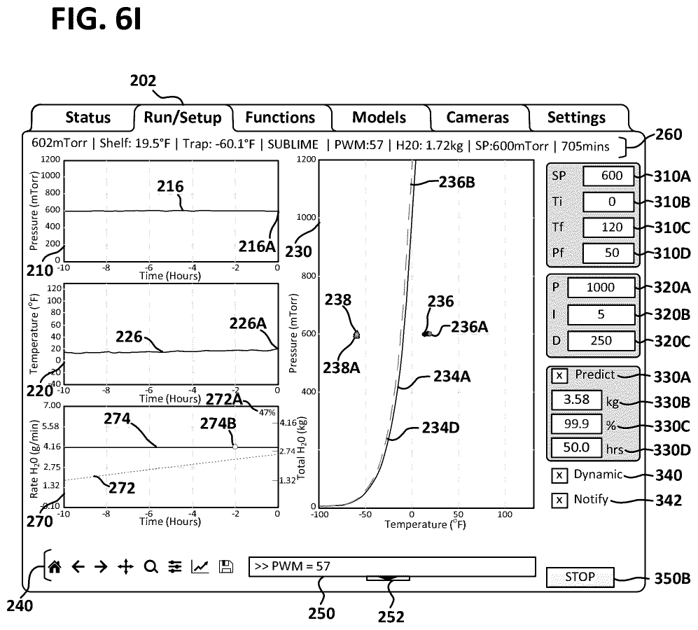

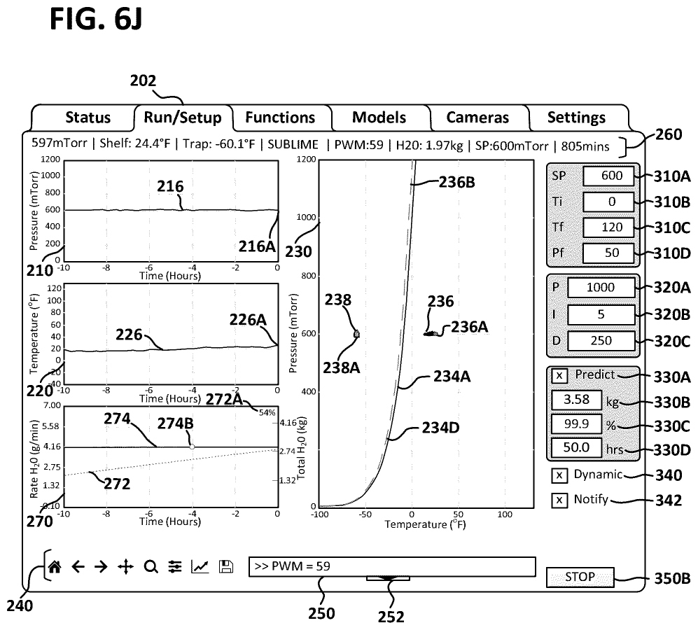

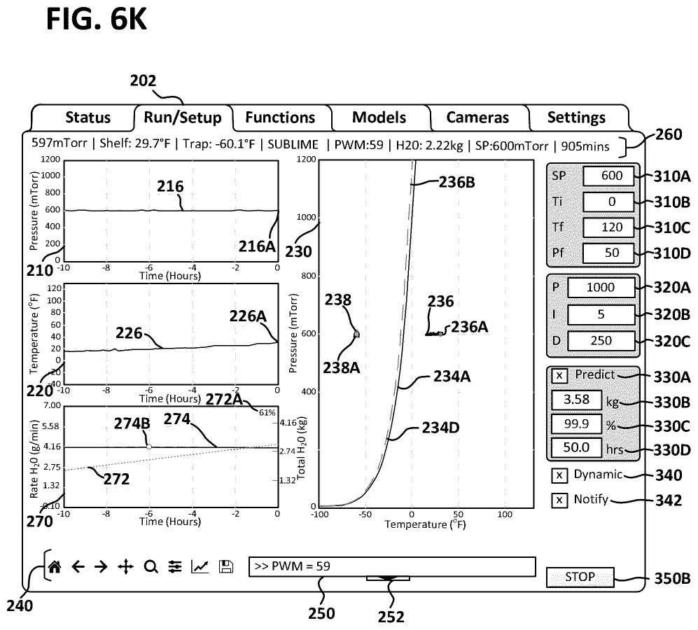

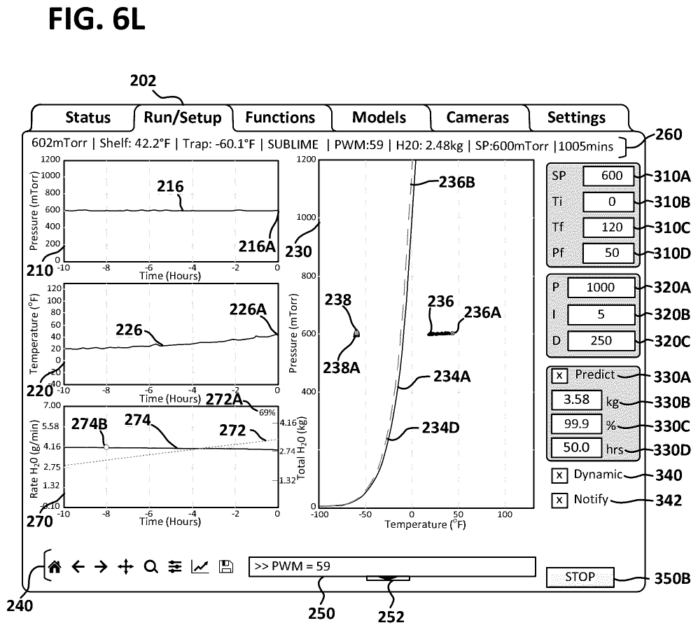

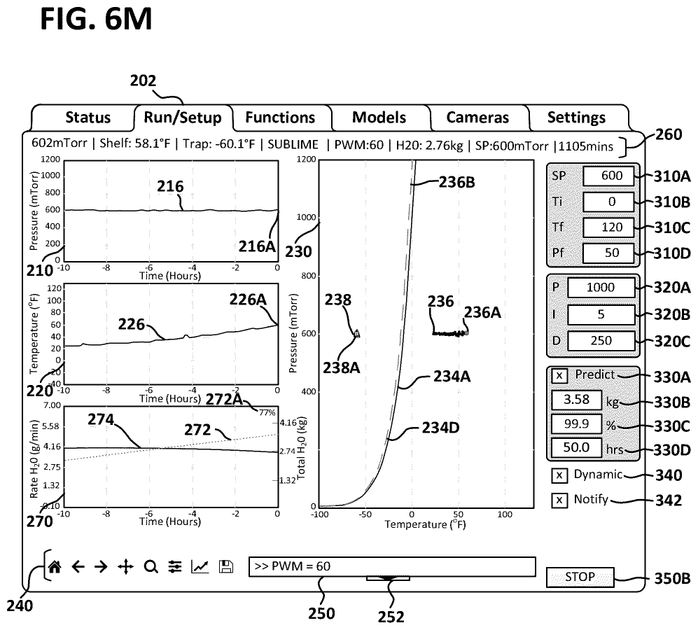

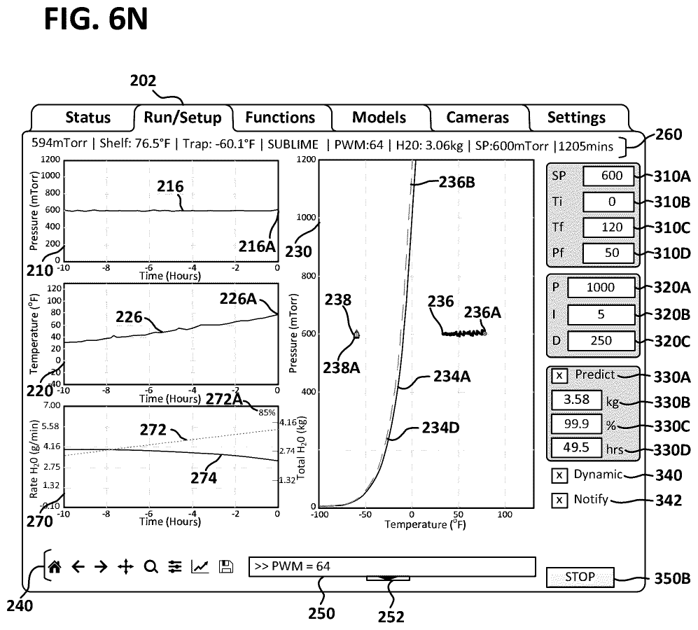

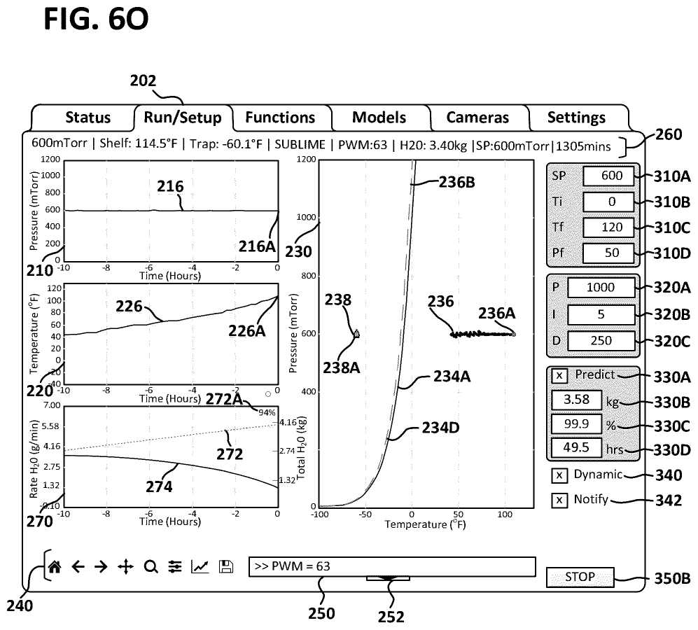

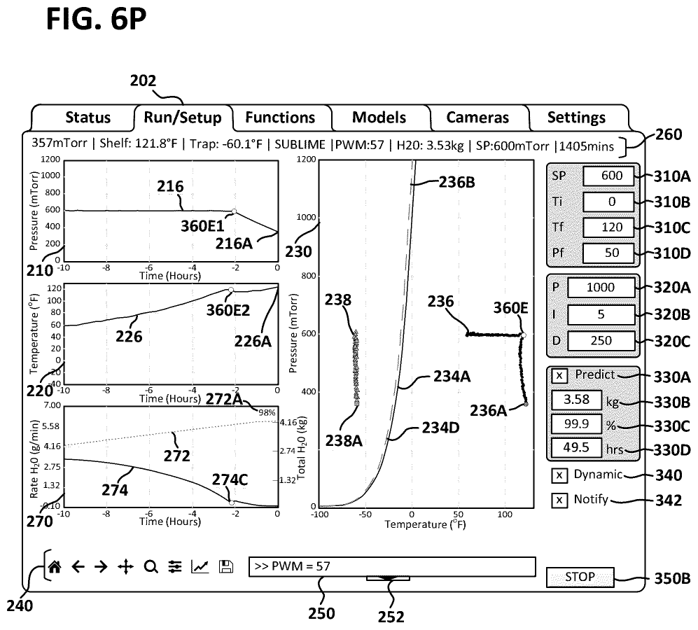

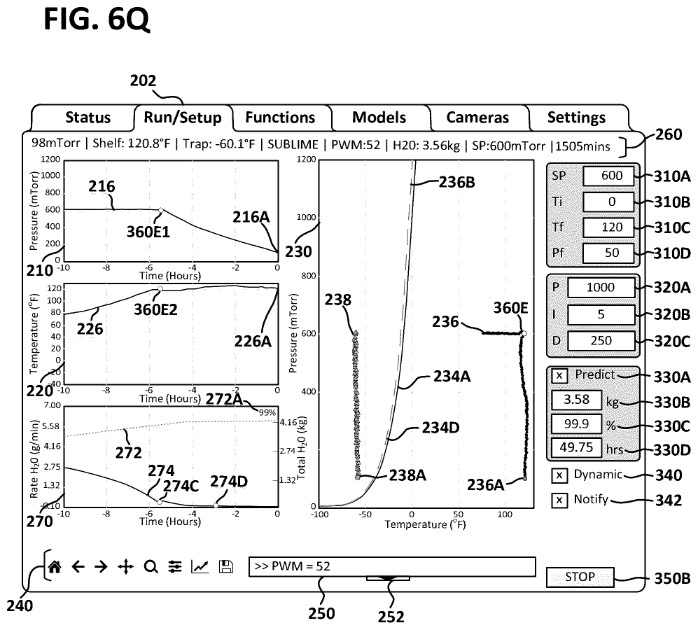

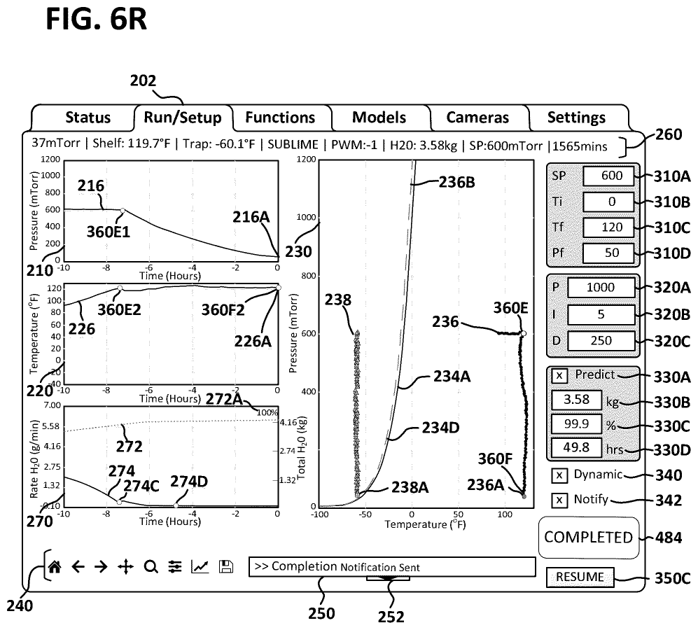

In some embodiments, the phase plot 230 includes a sublimation fit line 236B derived from the substance temperature-pressure data 236, as depicted in FIGS. 6A-6R. This line is generated based on transient data points collected during the lyophilization process, particularly when the substance is in its solid phase and the pressure is initially decreased below the triple point of water (e.g., 4588 mTorr). The sublimation fit line 236B accurately delineates the transition phase line of the substance, thereby enhancing precision in monitoring and controlling phase transitions. Notably, in some embodiments, the sublimation fit line 236B is derived using the Clausius-Clapeyron relation of the substance, further refining its capability to identify phase transitions. In some embodiments, sublimation fit line 236B is derived using the Arrhenius equation.

The technique of determining sublimation curves or phase diagrams, especially accounting for real-world compositions and conditions, holds significant importance across various industries and scientific disciplines. In pharmaceuticals, for instance, precise control over phase transitions ensures the stability and efficacy of drugs during manufacturing and storage. Understanding how impurities in substances such as water or complex compositions in frozen foods influence sublimation behavior is crucial for optimizing processes such as freeze-drying, where maintaining product quality and integrity is paramount. Moreover, in materials science and environmental studies, accurately predicting phase transitions helps in designing materials with specific properties or in modeling natural phenomena like sublimation in the atmosphere.

In reference to FIG. 2A, the substance temperature-pressure data 236 depicted in the phase plot illustrates a significant interplay between water (acting as the solvent) and the prevailing conditions. Specifically, this data highlights how the substance temperature-pressure relationship favors the formation of water vapor. Conversely, the trap temperature-pressure data 238 favors deposition of the water vapor to form ice. This dynamic interaction results in the sublimation of ice from the substance, leading to its deposition onto the trap.

In some embodiments, the phase plot 230 is further enhanced by employing visual cues to delineate the areas representing the solid, liquid, and gaseous states of water. This augmentation involves coloration or marking of the respective regions on the phase plot 230. Such visual aids provide a more intuitive understanding of the transitions between these states. The distinct coloring or marking in the solid, liquid, and gaseous regions adds an extra layer of clarity to the representation, aiding in the interpretation of the freeze-dryer dynamics and thermodynamic phase equilibrium of water (H2O).

It should be understood that the substances subjected to the lyophilization process within the freeze-dryer 110 correspond to a solvent and a solute. The solvent is typically water, while the solute can encompass a diverse range of materials such as food products, pharmaceutical compounds, biological substances, and more. In the context of freeze-drying, “solvent” refers to the liquid component that dissolves or disperses the “solute,” which is the substance to be preserved. During freeze-drying, a substance is frozen and then subjected to a process where the frozen solvent is removed by sublimation, leaving behind the preserved solute. For example, when freeze-drying strawberries, the strawberries themselves (the solute) are the main substance of interest to be preserved and the liquid present in the strawberries (e.g., water) acts as the solvent. During freeze-drying, the strawberries are frozen and then placed in a vacuum chamber, where the frozen water within the strawberries sublimates directly from ice to vapor, leaving behind freeze-dried strawberries that retain their original shape and many of their properties.

In pharmaceutical a similar concept applies, where an active pharmaceutical ingredient (API) of a medication in a liquid acts as the solute and the liquid itself (e.g., water-based solution) serves as the solvent. During freeze-drying, the medication is frozen and then placed in a vacuum chamber, where the solvent (liquid) is removed by sublimation, leaving behind a stable, dry, and preserved form of the medication that can be reconstituted with a suitable solvent before use.

Within this context, the phase plot 230 pertains to the solvent of water (H2O), illustrating its thermodynamic phase equilibrium. It is important to acknowledge that the use of a phase curve for the solvent of water is exemplary, and variations in solvents can be accommodated. In general, the phase plot 230 encompasses a phase curve tailored to the specific thermodynamic behaviors of the solvent, whether it is water, organic solvents (e.g., ethanol, methanol), or others. In some embodiments, phase plot 230 incorporates a phase curve that illustrates thermodynamic phase equilibrium of water. In some embodiments, phase plot 230 incorporates a phase curve that illustrates thermodynamic phase equilibrium of organic solvents (e.g., ethanol, methanol, etc.).

In some embodiments, cryoprotectants are added to the substance. Cryoprotectants, substances introduced to biological materials or solutions, serve the purpose of safeguarding biological materials or solutions from the detrimental effects of freezing. Cryoprotectants effectively mitigate the formation of ice crystals, which possess the potential to inflict harm upon cellular structures during the freezing and subsequent thawing processes. These beneficial compounds are dissolved within a solvent, typically water or another suitable medium, thereby giving rise to a cryoprotectant solution where the cryoprotectant operates as the solute within the solvent. The resultant blend of solvent and solute constitutes the substance, setting the stage for subsequent freeze-drying or alternative preservation procedures, as elucidated in the illustrated FIG. 2A.

The advanced freeze-dryer interface 200 further includes an interactive data navigation toolbar 240 that enhances interaction. This toolbar offers a home button, forward and back buttons for smooth state transitions, a pan/zoom button for flexible data exploration, a zoom-to-rectangle button for focused analysis, a subplot-configuration button for appearance customization, a data selector to pinpoint specific data sets, and a save button for plot storage.

The advanced freeze-dryer interface 200 further includes an input/output terminal 250, integrated to provide manual input and output display for the operation of the freeze-dryer. Serving as a direct interface, this terminal facilitates manual instructions to the operations and functions of the freeze-dryer while also displaying output generated during operation. This two-way communication channel simplifies control and provides a transparent and real-time glimpse into the performance of the freeze-dryer. In certain embodiments, the input/output terminal 250 is equipped with an expansion button 252 that can be activated through a mouse click or contact with a touch-sensitive surface at a location corresponding to the expansion button 252. When activated, the expansion button 252 triggers the enlargement of the input/output terminal 250, to provide a larger view of features and information from the input/output terminal 250. Additionally, it should be noted that the interface includes a retraction button (not shown) that when activated reverts the expanded input/output terminal 250 back to its original display state as depicted in FIG. 2A.

The status tab 201 within the advanced freeze-dryer interface provides a snapshot of the current and past conditions of the freeze-dryer. This snapshot is highlighted through the juxtaposition of the transient pressure plot 210, transient temperature plot 220, and phase plot 230. The transient pressure plot 210 illustrates the vacuum chamber pressure data 216 over time, while the transient temperature plot 220 portrays the transient temperature data 226 and transient trap temperature data 228 over time. The phase plot 230 incorporates the pressure and temperature dynamics to graphically depict the interplay between different phases of the solvent.

The transient pressure plot 210 visually portrays the vacuum chamber pressure data 216 in a chronological sequence, with data points taken at one-second intervals. In some embodiments, the freeze-dryer 110 detects the vacuum chamber pressure each second, leading to the continual update of the transient pressure plot 210. During each update, the oldest data point in the sequenced vacuum chamber pressure data 216 is removed from display and the remaining displayed data shift to the left to accommodate the new data. Simultaneously, the real-time transient vacuum chamber pressure data 216A is appended to the end of the sequence, and displayed on the right. This dynamic process ensures that the transient pressure plot 210 remains current, reflecting the evolving vacuum chamber pressure conditions over time. In some embodiments, the real-time transient vacuum chamber pressure data 216A is appended to the end of the sequence in response to receiving or detecting the real-time transient vacuum chamber pressure data 216A of the solvent.

The transient temperature plot 220 presents a similar dynamic representation as the transient pressure plot 210. The transient temperature plot 220 visually displays the transient temperature data 226 and the transient trap temperature data 228 in a chronological sequence, capturing data at one-second intervals. The freeze-dryer 110 records the temperature measurements every second, resulting in an ongoing update of the transient temperature plot 220. In some embodiments, the system receives real-time temperature data (e.g., the real-time transient temperature data 226A and real-time transient trap temperature data 228A) of the solvent. In some embodiments, the freeze-dryer 110 detects the vacuum chamber pressure each second, leading to the continual update of the transient pressure plot 210. During each update, the oldest data in the sequenced temperature data (both substance and trap) is removed from display, causing the remaining data displayed to shift to the left. This removes older (stale) data and frees space for new data to be added, which is displayed on the right side, where the real-time transient temperature data 226A and real-time transient trap temperature data 228A are displayed and appended. As a result, the transient temperature plot 220 provides a real-time representation of the evolving temperature conditions of the substance and the trap, ensuring accurate monitoring and assessment of the temperature dynamics over time. In some embodiments, the real-time transient temperature data 226A is appended to the end of the sequence in response to receiving or detecting the real-time transient temperature data 226A of the solvent. In some embodiments, the real-time transient trap temperature data 228A is appended to the end of the sequence in response to receiving or detecting the real-time transient trap temperature data 228A of the solvent.

The phase plot 230, as depicted in FIG. 2A, offers a comprehensive visualization of freeze-dryer 110 dynamics, capturing the dynamic interplay between transient vacuum chamber pressure data 216, transient temperature data 226, and transient trap temperature data 228 over time (e.g., the past minute). The arrangement of sequenced vacuum chamber pressure data 216 is linked to temperature data 226 and transient trap temperature data 228, depicted respectively as substance temperature-pressure data 236 and trap temperature-pressure data 238 on the phase plot 230. The phase plot 230 updates every second, following the updates to the sequenced data in the transient pressure plot 210 and the sequenced data in the transient temperature plot 220.

In some embodiments, the indicators representing the substance temperature-pressure data 236 and trap temperature-pressure data 238 on the phase plot 230 are displayed on the phase plot 230 relative to the phase curve of the first substance (e.g., water, solvent, etc.) in response to receiving the real-time temperature data and pressure data of the solvent. In some embodiments, the indicators representing the substance temperature-pressure data 236 and trap temperature-pressure data 238 on the phase plot 230 are displayed on the phase plot 230 relative to the phase curve of the first substance (e.g., water, solvent, etc.) in response to a determination that a predetermined time period has elapsed. One or more of the indicators representing the substance temperature-pressure data 236 and the trap temperature-pressure data 238 include previous (historical) pressure data and temperature data of the solvent. Notably, the indicators representing substance temperature-pressure data 236 and trap temperature-pressure data 238 on the phase plot 230 do not follow a strict left-to-right order; instead, they correspond to the condition of the freeze-dryer at specific instances in time.

The phase plot 230 further includes a phase curve (e.g., one or more of the sublimation line 234A, fusion line 234B, vaporization line 234C) illustrating thermodynamic phase equilibrium of water (H2O). This phase curve delineates the boundary between the various phases of water matter, providing a visual representation of the coexistence of solid, liquid, and gaseous states. Notably, the phase curve includes one or more of the sublimation line (ice-to-water vapor line) 234A, the fusion line (ice-to-liquid water line) 234B, and the vaporization line (liquid water-to-water vapor line) 234C, graphically emphasizing the equilibrium thresholds at which phase transitions occur. Importantly, in FIG. 2A, the sublimation line 234A, fusion line 234B, and vaporization line 234A converge at the triple point of water 232, which signifies the distinct thermodynamic equilibrium of ice, liquid water, and water vapor.

In some embodiments, the location of the real-time temperature-pressure data 236A on the phase plot 230 relative to the phase curve (e.g., one or more of the sublimation line 234A, fusion line 234B, vaporization line 234C) is detected. In response to detecting the location of the real-time temperature-pressure data 236A on the phase plot 230 relative to the phase curve, a matter state indicator corresponding to the equilibrium phase of matter of the solvent is displayed. For example, the system determines that real-time temperature data 226A and real-time pressure data 216A of the solvent correspond to the vapor equilibrium phase of matter of the solvent as depicted by the location of 236A in FIG. 2B and displays “SUBLIME” in the dashboard 260.

In some embodiments, the matter state indicator corresponds to displaying text labels such as SOLID, LIQUID, or SUBLIME, offering a clear textual indication of the phase of the substance. In some embodiments, the matter state indicator corresponds to displaying a color code or symbol situated at the point 236A on the phase plot, distinctly marking the phase of the substance. In some embodiments, the matter state indicator include color gradients, shading, or patterns to illustrate the phase transition dynamically, catering to diverse preferences and enhancing the clarity of phase depiction.

In some embodiments, the matter state indicator corresponds to a real-time equilibrium phase of matter of the solvent. For example, in response to a determination that the real-time temperature data of the substance and real-time pressure data of the substance traversed the boundary between a first equilibrium phase of matter of the solvent and a second equilibrium phase of matter of the solvent the matter state indicator ceases to display the matter state indicator corresponding to the first equilibrium phase of matter of the solvent and displays the matter state indicator corresponding to the second equilibrium phase of matter of the solvent. In some embodiments, the equilibrium phase of matter of the solvent corresponds to a solid and the second equilibrium phase of matter of the solvent corresponds to a gas. In some embodiments, the solvent corresponds to a pure substance such as water. The second substance (e.g., food, pharmaceutical, etc.) includes the first substance (e.g., water, solvent, etc.).

To ensure the presentation of up-to-date information the system can cease to display one or more indicators (e.g., markers, graphical elements) representing a portion of previous temperature data of the substance and a portion of previous pressure data. For example, in response to a determination that a portion of previous temperature data of the substance and a portion of previous pressure data of the substance exceed a predetermined time threshold, the freeze-dryer 110 ceases to display the one or more indicators representing the portion of the previous temperature data of the substance and the portion of the previous pressure data of the substance. This often results in more efficient and responsive performance of computational resources enabling a focus on the most pertinent and recent information. Moreover, this streamlined presentation enhances the experience by reducing clutter and facilitating rapid, accurate interpretation of ongoing process dynamics. In some embodiments, the one or more indicators representing the previous temperature data of the substance (e.g., food, pharmaceutical, etc.) and the previous pressure data of the substance are faded. In some embodiments, fading the one or more indicators is based on chronology of the previous temperature data of the substance or chronology of the previous pressure data of the substance.

In some embodiments, the system actively acquires real-time temperature data and real-time pressure data of the substance when a predefined time threshold is exceeded. For instance, if the time threshold is set at 15 seconds, the system collects updated temperature and pressure data at that interval. This proactive data acquisition ensures that the displayed indicators accurately reflect the most current state of the substance and its environment. In some embodiments, the system refrains from actively gathering real-time temperature data and real-time pressure data of the substance when a predefined time threshold is exceeded. For instance, if the time threshold is set at 15 minutes, the system might choose not to collect updated temperature and pressure data within that timeframe. This approach is beneficial in scenarios where the temperature and pressure changes of the substance are relatively gradual or less important to monitor in real time. This strategy can avoid frequent data collection, conserve computational resources, and potentially lead to improved system efficiency and performance.

To effectively distinguish between real-time and previous data, the indicators representing the real-time temperature data and the real-time temperature data of the substance exhibit visual differences from the previous temperature data. Similarly, the indicators representing the real-time pressure data of the substance feature distinct visuals compared to the previous pressure data. This differentiation helps in identifying and interpreting the most current information, ensuring that the recent changes or trends are readily recognizable. For instance, in a graphical representation where temperature and pressure data are displayed as blue circles for real-time data and red squares for previous temperature and pressure data, makes it easier to discern between the two datasets by observing color and/or shape of the indicators. This visual distinction aids in preventing confusion and misinterpretation, allowing for a focus on the most relevant and up-to-date insights while assessing the lyophilization process.

In some embodiments, the graphical representation employs dynamic visual cues that transition smoothly between the two datasets. For example, the indicators representing real-time temperature measurements could be depicted as circles with a gradient fill, where the color morphs from a vibrant hue (e.g., blue) for the latest data to a subdued hue (e.g., red) for the oldest data. This gradient effect provides a clear visual progression, allowing instant recognition of how recent the data is based on the changing color intensity. Likewise, a color gradient approach can be adopted for pressure data indicators. Here, the color of the indicators could shift gradually from one end of the color spectrum (e.g., green) to the other end (e.g., purple) as the data transitions from real-time to previous. This method ensures that the displayed information not only remains distinct but also offers a dynamic representation that intuitively conveys the chronological order and relevance of the data. Such gradient visuals enhance the interpretation of ongoing process dynamics and aids in making informed decisions based on the evolving state of the freeze-drying cycle.

The advanced freeze-dryer interface 200 also includes additional functionalities, including presenting an estimate for the quantity of solvent mass separated from the substance during the freeze-drying process. This estimation serves as a metric for assessing the composition of the substance throughout preservation. In some embodiments, the advanced freeze-dryer interface 200 displays a mass indicator on the screen, which correlates with the approximate solvent mass removed from the substance. This mass indicator offers valuable insights into the preservation process, enabling continuous monitoring of changes in the mass composition of the substance. As an illustration, the dashboard 260 features an indicator representing the estimated mass of solvent removed from the substance (e.g., denoted as H2O: 1.21 kg in FIG. 2A). After a predefined period, a measurement is conducted to gauge the alteration in mass, facilitating the determination of the estimated solvent mass extracted.

One approach for estimating the quantity of solvent mass involves weighing the substance, where the reduction in weight directly reflects the extracted mass of the solvent. Another approach for estimating the quantity of solvent mass involves weighing the trap, with increased weight indicating the accumulation of solvent (e.g., ice). One approach for estimating the quantity of solvent mass includes employing thermodynamic models that analyze the energy input and output during the process. Furthermore, image-based models can also be utilized, which correlate the volume of accumulated solvent (e.g., ice) on the trap to estimate the mass of the extracted solvent. For instance, the estimated solvent mass extracted from the substance can be modeled based on the energy applied to the substance. Similarly, in some embodiments, the estimation is based on a change in the weight of the substance or a change in the weight of the solvent. These diverse methodologies can be implemented together or separately to contribute to a comprehensive and accurate assessment of the extracted solvent mass during the freeze-drying process.

The advanced freeze-dryer interface 200 incorporates additional functionalities, including presenting real-time duty cycle information about the energy signal applied to the substance. When the real-time duty cycle information of the energy signal is received, the advanced freeze-dryer interface 200 displays relevant portions of this information on the display. This dynamic feature enhances the understanding of the energy modulation being applied to the substance throughout the freeze-drying process. The duty cycle adjusts the effective power delivered to the substance, as indicated by the environmental control variable setting indicator (e.g., PWM: 59 in FIG. 2A) within the dashboard 260. For instance, in some embodiments, the duty cycle measurement involves applying a pulse width modulation (PWM) to a direct current (DC) electrical power signal, resulting in a series of square or rectangular pulses. In some embodiments, the duty cycle is applied to an alternating current (AC) electrical power signal, generating a “PWM-modulated AC waveform” or a “PWM-modulated sinusoidal waveform”.

In various embodiments, the transient pressure plot 210, transient temperature plot 220, and phase plot 230 are updated every second to maintain the accuracy of real-time data representation. Moreover, to optimize visual clarity, some embodiments implement auto-scaling for these plots, ensuring that displayed data remains within an appropriate range. This facilitates a clear understanding of ongoing lyophilization processes and helps to rapidly assess operational conditions. Such features significantly enhance the utility of the status tab 201, offering a streamlined method to monitor and comprehend the dynamic behavior of the freeze-dryer 110 throughout the course of its operation.

Selecting the status tab 201, indicated by the contact 290A in FIG. 2A, displays the contents of the status tab 201. In some embodiments, activating the status tab 201 while its contents are already visible triggers an automatic refresh of one or more of the transient pressure plot 210, the transient temperature plot 220, and the phase plot 230. This can include requesting one or more of the real-time transient vacuum chamber pressure data 216A, the real-time transient temperature data 226A, and real-time transient trap temperature data 228A, to ensure that the information remains current and relevant. In some embodiments, selecting the status tab 201 when its contents are already displayed initiates an auto-scaling feature for one or more of the transient pressure plot 210, the transient temperature plot 220, and the phase plot 230, similar to the auto-scaled illustration in FIG. 2B. This auto-scaling adjusts the scales dynamically, ensuring that the data is consistently comprehensible and pertinent, even as the process dynamics evolve. This dual functionality of the status tab 201 facilitates up-to-date data presented in an optimally organized manner, enhancing the interaction with the interface.

As used herein, the term “affordance” refers to a user-interactive graphical user interface object that is, optionally, displayed on the display screen (e.g., display generation component, display 694) of devices (e.g., smartphones 692, computers 720). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad or touch-screen) while the cursor is over a particular user interface element (e.g., a button, window, slider, or other user interface element), the particular user interface element is adjusted in accordance with the detected input. In some implementations that include a touch screen display (e.g., touch screen of smartphones 692) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

FIGS. 3A-3G illustrate an advanced freeze-dryer interface utilized in the lyophilization processes, featuring a projected path for the equilibrium phase of matter within the run/setup tab. Upon selecting the run/setup tab 202, as indicated by the contact 290B in FIG. 3A, the display shifts its focus solely to the contents of the run/setup tab 202 while ceasing to show information from other tabs. In certain embodiments, the contact 290B in FIG. 3A is activated through a mouse click or contact with a touch-sensitive surface at a location corresponding to the run/setup tab 202. In the absence of a configured profile, the initial presentation encompasses key components such as dashboard 260 indicators, an initially blank phase plot 230 including phase curves for the solvent (sublimation line 234A, fusion line 234B, and vaporization line 234C), the interactive data navigation toolbar 240, the expansion button 252, the previous setup switcher button 244A, the next setup switcher button 244B, and an array of configuration settings. In some embodiments, the configuration settings include process targets, encompassing the set point (SP) 310A, signifying the desired temperature or pressure for the substance, the vacuum pump threshold temperature (Tᵢ) 310B indicating vacuum pump activation, the final temperature (T_{f}) 310C as the temperature objective during the process, and the final pressure 310D representing the targeted pressure upon operation completion, as depicted in FIG. 3A.

The configuration settings include PID coefficients, encompassing the proportional (P) 320A, integral (I) 320B, and derivative (D) 320C terms. The proportional coefficient (P) determines the immediate corrective action taken in response to the current error between the set point and the actual value. The integral coefficient (I) accumulates past errors over time, ensuring that the system effectively eliminates any long-term steady-state error. The derivative coefficient (D) anticipates future error trends by evaluating the rate of change of the error signal. Adjusting these coefficients allows the PID control system (i.e., PID controller 322) to achieve a balance between responsiveness, stability, and steady-state error, thereby contributing to the optimal performance of the lyophilization process.

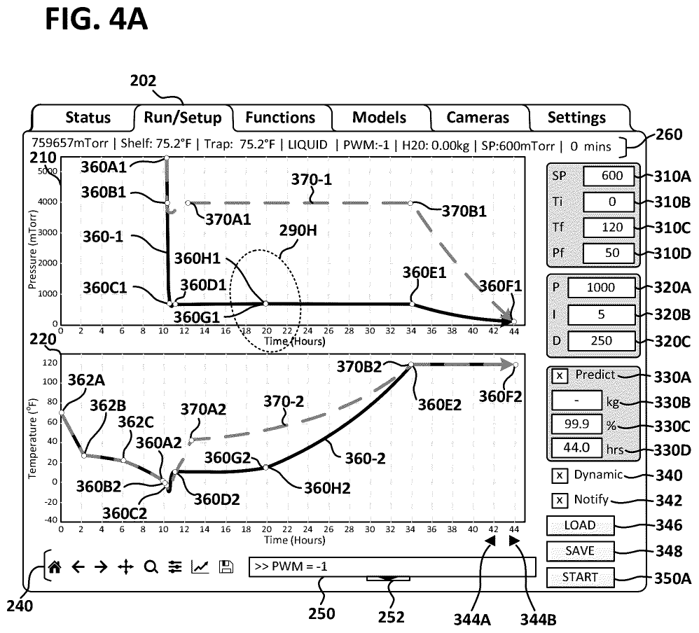

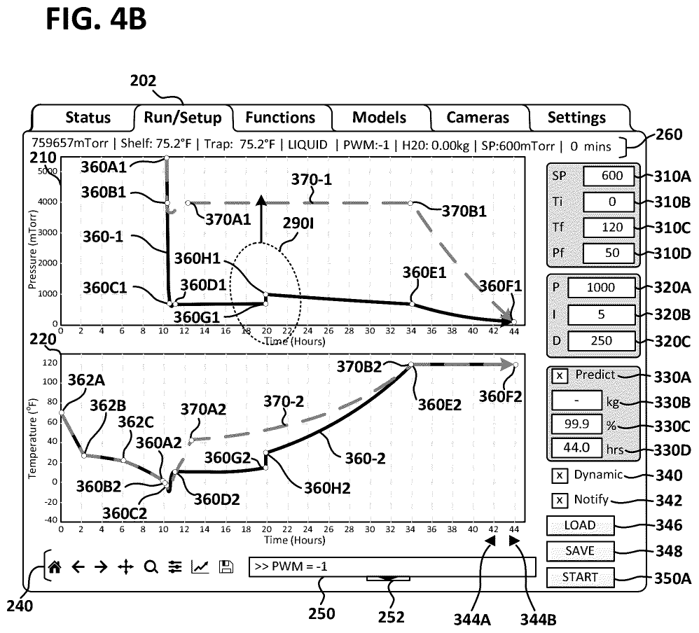

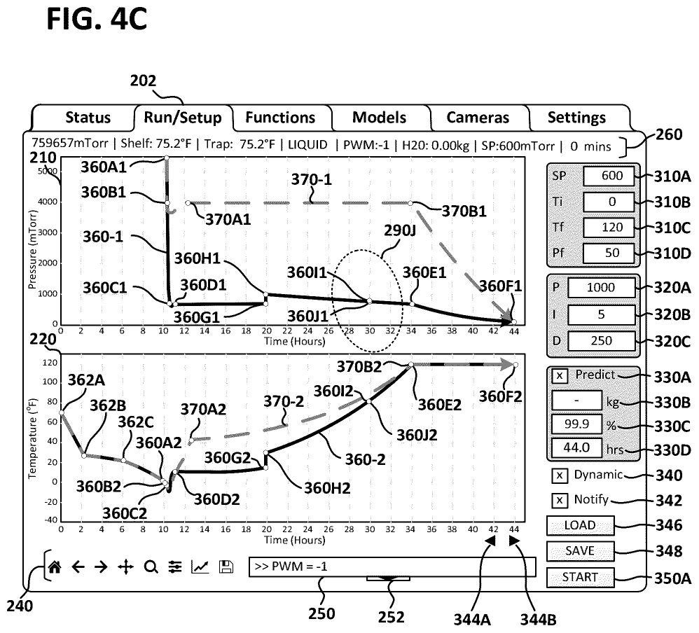

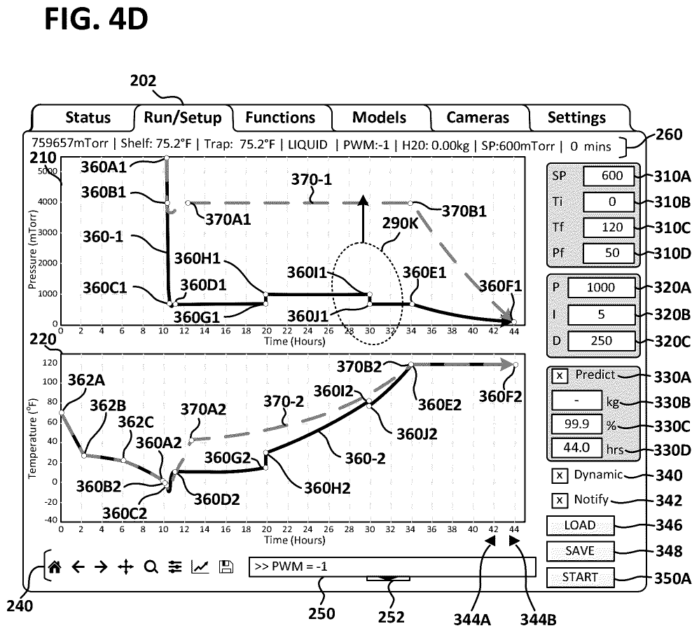

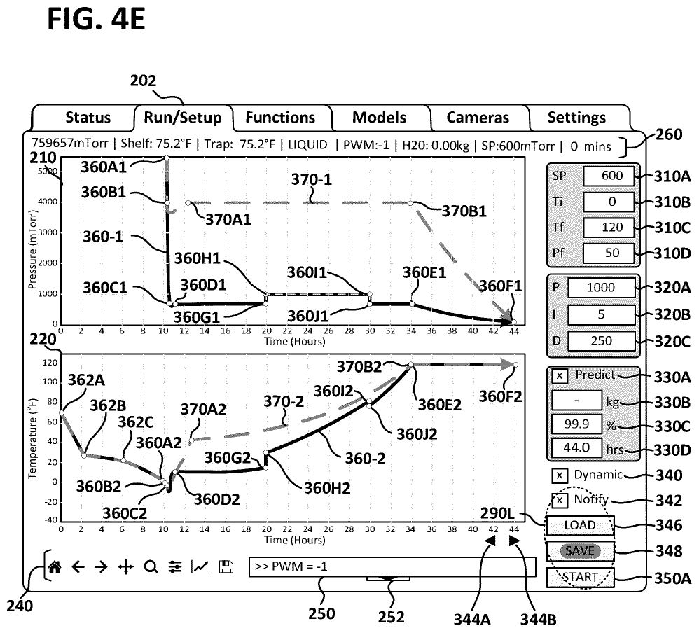

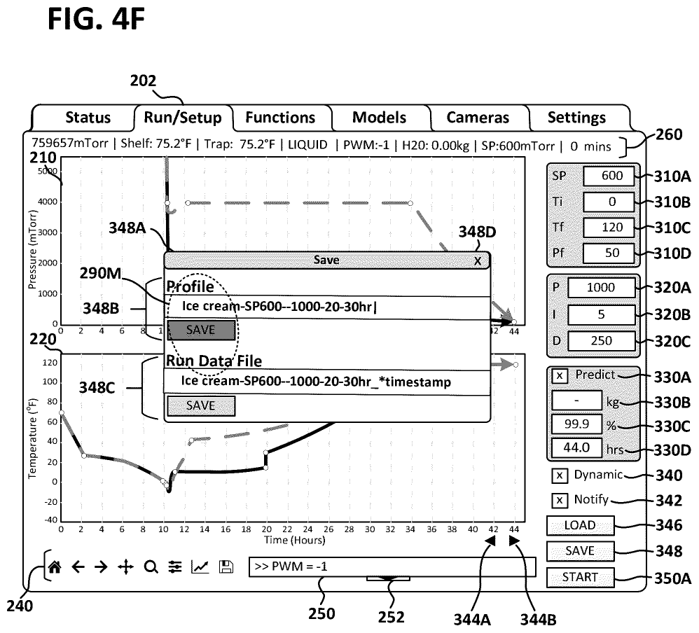

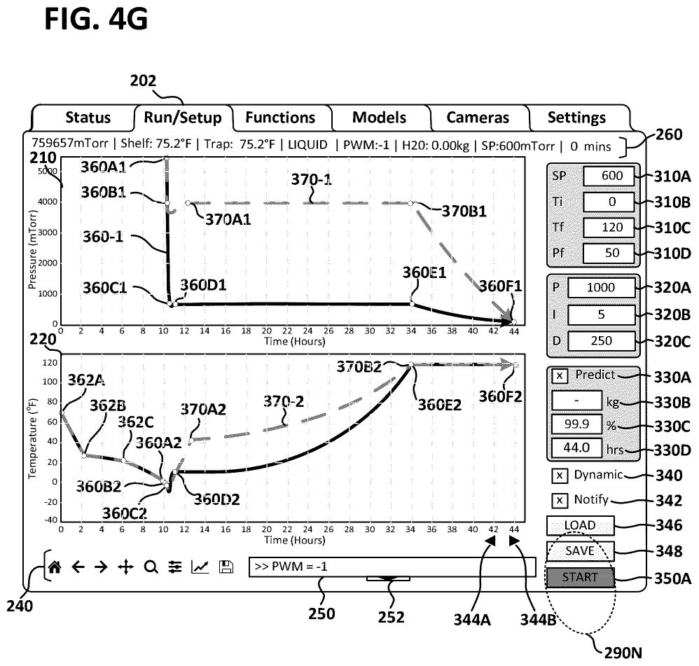

The configuration settings further include prediction parameters including a prediction enabling setting 330A, a mass estimate parameter 330B, a termination setting 330C, and process termination estimation 330D (also depicted as the estimated total process time of 44 hours of the transient final pressure set point 360F1 of FIGS. 4A-4D). The prediction enabling setting 330A, represented as a checkbox in FIG. 3A, facilitates the activation of prediction techniques to estimate the amount of solvent sublimated from the substance. The mass estimate parameter 330B provides an estimation of the mass of the solvent extracted from the substance, displayed in kilograms. In some embodiments, a mouse click or contact with a touch-sensitive surface at a location corresponding to the mass units (e.g., kg) changes the unit (e.g., from kg to lbs.).

The termination setting 330C designates a predetermined estimated amount of solvent sublimated from the substance as a trigger for the process termination. The termination setting 330C serves to establish a predefined threshold of solvent sublimation from the substance, serving as a criterion for initiating the process termination. For instance, setting the termination threshold at 99.9% could indicate the completion of the freeze-drying process, resulting in a fully freeze-dried product. On the other hand, if a desired outcome involves retaining a specific moisture content in the substance, a different termination threshold might be chosen. For example, setting the threshold at 90% solvent removal signifies the desired extent of drying, ensuring that the substance retains 10% moisture. In this manner, the termination setting facilitates a process outcome tailored to specific requirements.

The process termination estimation 330D provides an estimate of when the lyophilization process will be completed. In some embodiments, the process termination estimation 330D is presented as an enumerated value, which provides a discrete and straightforward indication of the estimated process completion time. In some embodiments, the process termination estimation 330D is displayed as a gauge similar to the real-time transient mass data indicator 272A, offering a visual representation of progress. For example, in some embodiments, the process termination estimation 330D is a progress bar, which gradually fills to indicate the percentage of completion.

In some embodiments, the process termination estimation 330D is a static estimate determined at the start of the process based on a loaded profile, as depicted in FIGS. 3C and 3D. This static estimate helps in planning by predicting how long the lyophilization process will take, allowing users to allocate resources and schedule subsequent steps accordingly. In some embodiments, the process termination estimation 330D is updated dynamically during the lyophilization process. For example, the system can calculate the total amount of water to be removed and model the sublimation rate. Based on these parameters, the system can dynamically adjust the estimate of when the process will finish, as depicted in FIGS. 6M-6R. This dynamic updating can incorporate real-time data, such as temperature, pressure, and mass changes, to refine the estimate continuously and provide more accurate predictions.

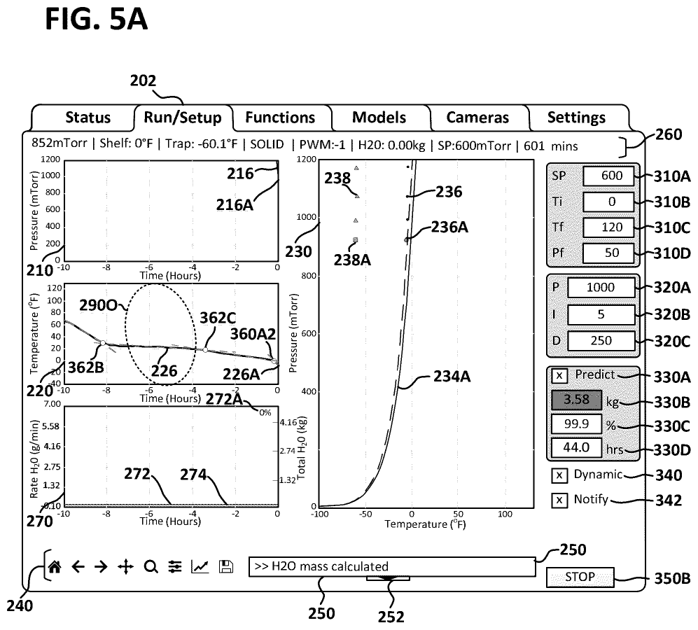

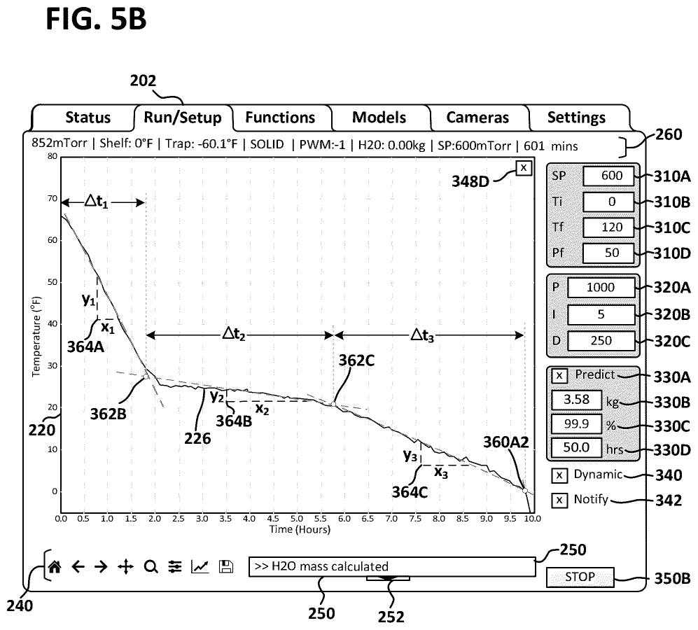

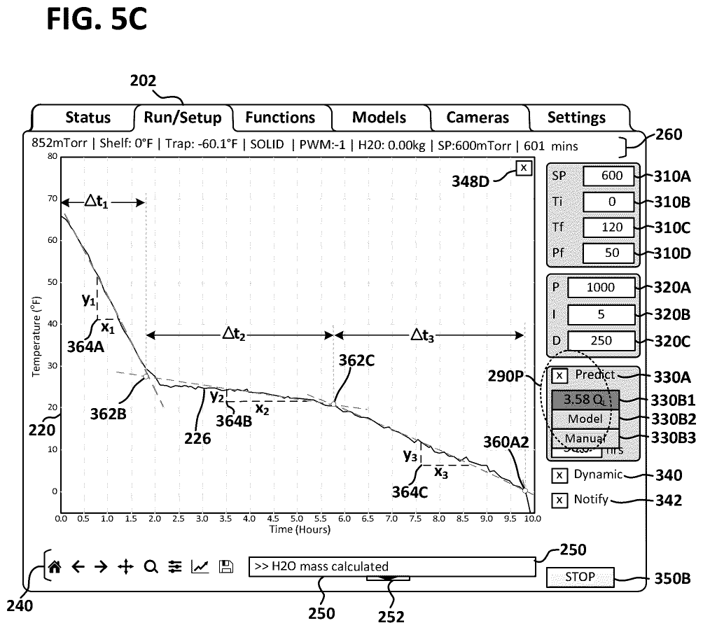

In some embodiments, the process termination estimation 330D displays a countdown of the time remaining until process completion. For example, the process termination estimation 330D can be configured to count down from 50 hours in FIG. 5B to 0 hours upon completion in FIG. 6R. This countdown feature can be beneficial for monitoring and managing the lyophilization process, enabling operators to prepare for the next stages of production or packaging.

In some embodiments, the process termination estimation 330D can include additional features to enhance usability and functionality. For example, the system may provide alerts or notifications when the estimated completion time changes significantly or when the process is nearing completion. In some embodiments, the system can integrate with external devices or software to log data, generate reports, or trigger automated actions based on the process termination estimation.

In some embodiments, the process termination estimation 330D can account for variations in the lyophilization process due to changes in batch size, initial moisture content, or other factors. In some embodiments, the system incorporates adaptive algorithms and machine learning techniques, which can improve its estimation accuracy over time, learning from past processes to better predict future outcomes.

The configuration settings further include a dynamic pump parameter 340, which adapts the process to the varying capabilities of the vacuum pump. Notably, with the passage of time, vacuum pumps may exhibit decreased efficiency, resulting in an inability to achieve extremely low vacuum pressures. However, it is possible to achieve vacuum levels below the triple point pressure of the solvent (e.g., for water, this is approximately 6.1 mTorr), where sublimation is possible. As such, the dynamic pump parameter 340, represented as a checkbox, allows the configuration to flexibly adjust the process targets (e.g., set point (SP) 310A, the vacuum pump threshold temperature (Tᵢ) 310B, the final temperature (T_{f}) 310C, etc.). This adjustment spans from the set point (SP) 310A to a higher pressure level that still permits sublimation below the triple point pressure. This dynamic adjustment mechanism offers a workaround for situations where an older or partially damaged pump cannot reach very low pressures, yet still is capable of lyophilization processes. Enabling dynamic pump parameter 340 further provides valuable feedback on the aging status of the pump as well as a diagnostic tool for troubleshooting non-optimal vacuum pressures.

The configuration settings further include a notification parameter 242, which is a versatile tool designed to inform and engage throughout the lyophilization process. This parameter serves as a comprehensive communication channel, capable of delivering notifications through various mediums, such as text messages, emails, alerts within a dedicated smartphone app, or direct notifications on the interface itself. Its purpose extends beyond mere updates, as it acts as a sentinel, vigilantly monitoring the progress of the process and communicating important milestones. For example, the notification parameter can be configured to send timely alerts when specific milestones, like reaching the desired temperature, pressure, or sublimation levels, are achieved. Conversely, it can also send notifications if the process does not seem to be progressing as anticipated, indicating a potential issue that requires attention. This multifaceted notification mechanism facilitates connecting with the freeze-drying operation, enabling any anomalies to be addressed promptly and facilitating an overall smoother and more efficient process.

The configuration settings include profile loading button 346 designed to facilitate the seamless retrieval of predefined freeze-drying profiles for different substances or scenarios. When the load button 346 is engaged, triggered by a mouse click or a contact 290C with a touch-sensitive surface at a location corresponding to load button 346 in FIG. 3B, it prompts the display of a profile prompt 346A as displayed in FIG. 3C. This prompt provides an array of lyophilization profiles 346B to choose from, each tailored to specific requirements or applications. These profiles offer a convenient way to optimize the freeze-drying process by selecting preconfigured settings that align with the desired outcome or substance characteristics. In specific embodiments, the selection of lyophilization profiles 346B within the profile prompt 346A can be tailored to accommodate a diverse range of substances and applications. These profiles can be configured to suit various requests, such as optimizing freeze-drying parameters for different types of substances like food products, pharmaceutical compounds, or biological materials. Additionally, the lyophilization profiles 346B offer a versatile range of options, including the capability to generate new profiles from scratch, enabling customized settings to specific requests.

One noteworthy feature among these lyophilization profiles 346B is the inclusion of advanced functions designed to provide intricate control over the freeze-drying process. One such function is the Heaviside step function U (t), which is designed to offer multiple target set points and ramp rates in a single equation. This feature provides more sophisticated manipulation of the system, allowing for precise adjustments to the freeze-drying parameters. As a result, the process can be finely tuned to meet intricate specifications, enhancing the adaptability and performance of the system.

It should be appreciated that these lyophilization profiles 346B encapsulate a comprehensive set of predefined parameters tailored to specific lyophilization scenarios, such as different types of food products, pharmaceutical compounds, or biological substances. Loading a profile effectively imports a meticulously designed roadmap for the freeze-drying process, encompassing various factors like temperature, pressure, phase equilibrium, and more. This predefined framework streamlines the setup process that saves time and reduces chances of human error, ensuring consistency and accuracy throughout the process. Furthermore, profiles offer the advantage of leveraging established best practices and expertise, which can lead to improved outcomes, higher product quality, and greater process efficiency. In essence, loading a profile provides a reliable and proven template to achieve optimal results while simplifying the operational complexity of freeze-drying.

Referring back to FIG. 3C, in response to clicking the mouse or by touching the corresponding area (indicated by contact 290D) on the touch-sensitive surface, the dedicated “ice cream” profile with parameters to generate an environmental control curve 360 is seamlessly loaded, displayed, and becomes the active configuration as depicted in FIG. 3D. The generated environmental control curve 360 includes a dynamic pressure set point 360A, a phase curve equilibrium set point 360B, an initial pressure set point 360C1, an equilibrium pressure set point 360D1, a final temperature set point 360E, and a final pressure set point 360F. The dynamic pressure set point 360A establishes the upper limit for pressure when the dynamic pump parameter 340 is enabled. This dynamic approach ensures that the pressure remains within the specified range, dynamically adapting to pump capabilities and conditions. The phase curve equilibrium set point 360B designates the equilibrium point on the phase diagram where changes in pressure have a corresponding effect on the temperature, aligning with the fundamental pressure-temperature (P-T) relationship. This equilibrium point optimizes the freeze-drying process by ensuring that the substance undergoes the phase transitions at the most suitable pressure-temperature conditions. The initial pressure set point 360C1 corresponds to the point on the phase diagram where the set point pressure is initially achieved. This set point establishes the baseline conditions for the entire operation, ensuring a controlled and effective process initiation. The equilibrium pressure set point 360D corresponds to the point on the phase diagram where equilibrium temperature is achieved at the set point pressure. The final temperature set point 360E indicates a decoupling point where the system transitions from a pressure set point to a temperature set point. This ensures that the temperature of the substance reaches and maintains a desired level while adjusting the pressure accordingly. The final pressure set point 360F sets the ultimate target pressure to indicate a conclusion of the process.

As illustrated in FIG. 3D, in response to a mouse click or contact 290E with a touch-sensitive surface at a location corresponding to the dynamic pump parameter 340, a dynamic environmental control curve 370 is displayed. As depicted in FIG. 3E, the dynamic environmental control curve 370 includes the dynamic pressure set point 360A (shared with the “ice cream” profile), a dynamic equilibrium pressure set point 370A, an equilibrium dynamic temperature set point 370B, a final pressure set point 360F, and the final pressure set point 360F (also shared with the “ice cream” profile). The dynamic equilibrium pressure set point 370A is positioned on the phase diagram where the equilibrium temperature is achieved, considering the dynamic pressure set point. The equilibrium dynamic temperature set point 370B marks the transition point from a pressure set point to a temperature set point. This decoupling point allows the system to shift seamlessly from pressure-focused control to temperature-focused control, ensuring precise temperature maintenance during the process.

Importantly, the dynamic equilibrium pressure set point 370A is dynamically determined based on the detected response of the vacuum pressure of the pump. This means that the dynamic equilibrium pressure set point 370A is not confined to the same pressure as the dynamic pressure set point 360A. Instead, the dynamic pressure set point 360A illustrated in FIG. 3E marks an upper pressure threshold and the dynamic equilibrium pressure set point 370A can fall at any pressure below the pressure of the dynamic pressure set point 360A. It should also be appreciated that this dynamic pump approach is not exclusive to the “ice cream” profile alone: rather, it is intended to be seamlessly applicable to all diverse profiles.

In the advanced freeze-dryer interface 200, the adaptability of the “ice cream” generated environmental control curve 360 and the dynamic environmental control curve 370 provides an extra layer of control and customization. These environmental control curves can be adjusted for specific requests. For instance, as depicted in FIG. 3F, simply selecting the environmental control curve and dragging it (e.g., a mouse click and drag input or a touch and drag gesture 290F) along the vertical axis, such as from around 20° F. to around 0° F. (as shown in FIG. 3G), shifts and adjusts the predefined settings.

FIGS. 4A-4F illustrate an advanced freeze-dryer interface utilized in the lyophilization processes, featuring a projected path for the transient pressure and transient temperature within the run/setup tab. In particular, the advanced freeze-dryer interface 200 offers versatile features for exploring and analyzing data from different perspectives. For instance, by performing a mouse click or touching the interface at the location corresponding to the advance button 344B (as indicated by contact 290G), the generated environmental control curve 360 shifts its focus. It moves from being displayed solely on the phase plot 230 to also appearing within the transient pressure plot 210 and the transient temperature plot 220.

These transient plots provide a comprehensive understanding of how the profile progresses over time during the freeze-drying process. The transient pressure control curve 360-1 depicted in the transient pressure plot 210 and transient temperature control curve 360-2 depicted in the transient temperature plot 220 outline its expected behavior concerning the timeline. In the transient pressure plot 210 of FIG. 4A, the transient pressure control curve 360-1 includes specific points such as a transient vacuum pump activation set point 360A1, a transient dynamic pressure set point 360B1, a transient initial pressure set point 360C1, a transient equilibrium pressure set point 360D1, a corresponding transient final temperature set point 360E1, and a corresponding final pressure set point 360F1. The transient dynamic pump pressure control curve 370-1 also contains some of these points, including the transient vacuum pump activation set point 360A1, the transient dynamic pressure set point 360B1, a transient dynamic equilibrium pressure set point 370A1, a corresponding dynamic transient final temperature set point 370B1, and a transient final pressure set point 360F1.

The transient temperature plot 220 in FIG. 4A illustrates the transient temperature control curve 360-2 and its response to the dynamic temperature control curve 370-2. This includes points like a start set point 362A, a liquidus point 362B, a solidus point 362C, a corresponding vacuum pump activation set point 360A2, a corresponding transient dynamic pressure set point 360B2, a corresponding transient initial pressure set point 360C2, a corresponding transient equilibrium pressure set point 360D2, a transient final temperature set point 360E2, and a corresponding final temperature set point 360F2. The transient dynamic environmental control curve 370 mirrors some of these points, including the start set point 362A, a liquidus point 362B, a solidus point 362C, a corresponding vacuum pump activation set point 360A2, a corresponding transient dynamic pressure set point 360B2, a corresponding transient initial pressure set point 360C2, a corresponding transient equilibrium pressure set point 360D2, a corresponding transient dynamic equilibrium pressure set point 370A2, a corresponding transient final temperature set point 370B2, and a corresponding transient final pressure set point 360F1.

Upon a mouse click or contact at 290H on a touch-sensitive surface on the transient pressure control curve 360-1 within the transient pressure plot 210, two set points appear. Set point 360G1 appears on the transient pressure plot 210, while set point 360G2 is concurrently added to the transient temperature control curve 360-2 within the transient temperature plot 220, as depicted in FIG. 4A. It should be appreciated that these transient plots, both the transient pressure plot 210 and the transient temperature plot 220, are inherently interconnected through the fundamental pressure-temperature (P-T) relationship. This relationship ensures that changes made in one plot are intuitively reflected in the other, facilitating a seamless understanding of the freeze-drying process as it unfolds over time.

Furthermore, as depicted in FIG. 4B, a drag input or a drag gesture within contact 290I, applied to set point 360G1 within the transient pressure plot 210, shifts set point 360H1 within the transient pressure plot 210 and set point 360H2 within the transient temperature plot 220. This interactive capability highlights the practical means to tailor and fine-tune the freeze-drying process according to specific requirements, enhancing control.

In some embodiments, a double mouse click or double tap generates additional set points on the transient pressure control curve 360-1 within the transient pressure plot 210 or the transient temperature profile 360-2 within the transient temperature plot 220. For instance, a tap and hold gesture at contact 290J on a touch-sensitive surface corresponding to a location on the transient pressure control curve 360-1 within the transient pressure plot 210, as depicted in FIG. 4C, generates set point 36011 and set point 360J1 on the transient pressure plot 210 while simultaneously incorporating set point 36012 and set point 360J2 into the transient temperature control curve 360-2 within the transient temperature plot 220. Subsequent drag inputs or drag gestures of contact 290K shift set point 36011 within the transient pressure plot 210 and set point 36012 within the transient temperature plot 220.

In addition to mouse clicks or touch contacts, the inputs to generate set points can encompass various types of interactions, enhancing the versatility of the interface. For instance, long press, double tap, hard press, and other touch-sensitive gestures are integrated into the system, facilitating intuitive interactions with the transient profiles. These diverse input methods provide flexibility in creating, modifying, and fine-tuning set points according to specific process requests. Similarly, when it comes to moving set points within the transient plots, drag gestures are not limited to a single type of input. The system accommodates a range of move inputs, including swipe, pinch, or multi-touch gestures. This diverse set of input methods ensures easy adjustments to set points within the transient pressure plot or the transient temperature plot to achieve precise control and tailor the freeze-drying process as desired.

FIG. 4E illustrates a mouse click or a contact at 290L on a touch-sensitive surface, directed towards the save button 348 within the advanced freeze-dryer interface 200. In response to the mouse click or a contact at 290L, a saving prompt 348A is displayed as depicted in FIG. 4F. The saving prompt 348A provides options for managing the profile data and includes a cancel element 348D, which if activated, closes the saving prompt 348A and cancels the current saving request, the save phase profile 348B, which saves the latest phase profile (depicted in FIG. 3G), and the save a transient profile 348C, which saves the latest transient profile (depicted in FIG. 4E). In some embodiments, the saving prompt 348A is simplified to include one of the save phase profile 348B and the save a transient profile 348C.

FIGS. 5A-5C illustrate an advanced freeze-dryer interface utilized in the lyophilization processes, featuring cooling curves within the run/setup tab. Cooling curves, in general, are graphical representations of temperature changes over time as a substance undergoes cooling. These provide insights into how a substance transitions through different phases of matter (e.g., from liquid to solid) and can provide mass estimates for a solvent.

Estimating the mass of the solvent from cooling curves involves analyzing the slopes of these curves during different phases of matter transitions. For instance, the slope of the cooling curve while the substance is in the liquid phase, the slope during the liquid-solid transition phase, and the slope during the solid phase can be compared to known values stored in a database for that specific substance. It is possible to estimate the mass of the solvent present in the substance at a particular point in time by aligning these slopes with the database. This estimation relies on the principle that the rate of temperature change is influenced by the amount and phase of the substance, making it a valuable technique for monitoring and controlling processes like lyophilization.

Referring to FIG. 5A, the setup depicts the cooling curve corresponding to a curve beginning at the start set point 362A to the vacuum pump activation set point 360A2 of the transient temperature plot 220. Importantly, the setup does not have a mass estimate for the amount of solvent as indicated by a blank mass estimate parameter 330B in FIG. 4G. In order to estimate the mass the system has to start the lyophilization process and gather temperature data while cooling the substance.

FIG. 5A depicts a mouse click or a touch-sensitive surface contact at 290N, a location corresponding to the start button 350A. In response to detecting the mouse click or a touch-sensitive surface contact at 290N, the start button 350A is activated thereby activating lyophilization process, which initiates a sequence of actions within the system.

Firstly, the system clears the transient pressure plot 210, transient temperature plot 220, the phase plot 230, and the transient mass plot 270 to provide a clean slate for real-time data representation.

Secondly, PID (Proportional-Integral-Derivative) control is initiated. This control system maintains the desired pressure and temperature conditions throughout the lyophilization process. It continuously samples the temperature and pressure data for monitoring the progress of the process.

As the lyophilization process progresses, the system calculates the estimated mass sublimated from the substance. This calculation is modeled or measured and can be reference based on estimated mass from the cooling curves. The estimated mass is then updated and reflected in the respective plots, ensuring real-time information on the progress of solvent removal.

FIG. 5B displays a snapshot of an active process after 10 hours from activating the start button 350A shown in FIG. 5A. During this time, the substance has had time to freeze, evident from the cooling curves in the transient temperature plot 220. To further scrutinize the data presented in the plot, the advanced freeze-dryer interface 200 is designed for user-friendly interactions. For instance, by selecting certain graphical elements within the interface, the advanced freeze-dryer interface 200 enlarges them for more detailed examination. A practical illustration of this feature can be seen when selecting the small transient temperature plot 220 in FIG. 5B, which is subsequently enlarged in FIG. 5C. This can be easily accomplished with a mouse click or a touch-sensitive surface contact at 2900, as shown in FIG. 5B.

Expanding the transient temperature plot 220, as shown in FIG. 5C, offers a comprehensive graphical representation of data that includes the sequence of temperature data of the substance, giving a visual insight into how the temperature changes over time during the freeze-drying process. Moreover, it displays the first linear regression, second linear regression, and third linear regression, which are mathematical models that fit the temperature data, making it easier to understand the trends and patterns in the data.

Additionally, the enlarged plot also includes graphical representations of the first intersection and the second intersection. The first intersection corresponds to the initial freezing temperature and time (e.g., liquidus point 362B) of the substance, indicating when the freezing phase begins. The second intersection represents the final freezing temperature and time (e.g., solidus point 362C), marking the conclusion of the freezing phase. These graphical representations provide an intuitive way to monitor and analyze the freeze-drying process, helping to identify events and ensuring that the process is proceeding as desired.

In some embodiments, the cooling curve is modeled to predict the mass of solvent in the substance, indicated by the mass estimate parameter 330B, as exemplified by the value of 3.58 kg. This predictive capability provides valuable information about the ongoing freeze-drying process.

To predict the mass of solvent in the substance the system compares the slopes of the cooling curves for each respective phase of matter transition. For example, the slope y₁/x₁ 364A of FIGS. 5B and 5C, the slope y₂/x₂ of the liquid-solid transition phase cooling curve 364B, and the slope y₃/x₃ of the solid phase cooling curve 364C can be compared to a database of respective cooling curve slopes for a particular substance. Each substance exhibits characteristic slope values for its phase transitions, allowing for identification and quantification. The system dynamically estimates the composition of the substance in real-time by matching the measured slopes with the closest matching slopes in the database. This estimation provides valuable insights into the progress of the freeze-drying process, enabling precise monitoring of solvent removal during each phase transition, and facilitating the production of high-quality freeze-dried products.

In some embodiments, the system receives real-time temperature data of a substance, which is then seamlessly integrated into a sequence of temperature data for the same substance. When the real-time temperature data surpasses a predetermined temperature threshold, the system employs a multifaceted approach. It fits a first linear regression to one portion of the temperature data sequence, a second linear regression to another portion, and a third linear regression to a distinct section. This provides a comprehensive understanding of the thermal behavior of the substance. Subsequently, the system identifies the first intersection point between the first and third linear regressions (corresponding liquidus point 362B) and the second intersection point between the second and third linear regressions (corresponding solidus point 362C). Leveraging the time difference between these intersections (Δt₂), the system dynamically estimates the solvent mass. This technique enhances precision and adaptability, ensuring accurate mass estimations during the freeze-drying process.

In some embodiments, it is important to note that the term “substance” encompasses a broader definition that incorporates the solvent within its scope. This expanded definition reflects the comprehensive nature of the freeze-drying process, acknowledging that the substance under consideration involves not only the solute but also the solvent itself. This distinction ensures that all relevant components and interactions within the system are duly accounted for, allowing for a more holistic and accurate approach to freeze-drying in these specific instances.

Often the parameters of either the first linear regression, the second linear regression, or the third linear regression are subject to adjustments. In some embodiments, these adjustments are meticulously fine-tuned with the objective of minimizing the sum of squared residuals derived from each of these regressions. This optimization process ensures that the linear models align as closely as possible with the actual temperature data points. In minimizing the sum of squared residuals, the accuracy and reliability of the subsequent estimations and predictions are significantly enhanced, ultimately leading to more precise and effective outcomes in the freeze-drying process. Furthermore, the estimation of the mass of the solvent involves additional considerations related to the parameters of the linear regressions. Specifically, in some embodiments, in this process, the estimation takes into account at least one parameter associated with either the first linear regression, the second linear regression, or the third linear regression.

When the substance includes the solvent, the determination of the mass of the substance is further influenced by factors such as the cooling rate exhibited by both the solvent and substance. In some embodiments, estimating the mass of the solvent is further based on the cooling rate of the substance, the solvent, or the combination of the substance and the solvent (e.g., the slope y₁/x₁ of FIGS. 5B and 5C 364A, the slope y₂/x₂ of the liquid-solid transition phase cooling curve 364B, and the slope y₃/x₃ of the solid phase cooling curve 364C).

The advanced freeze-dryer interface 200 is designed to be intuitive and versatile. For example, a simple mouse click or a contact at 290P on a touch-sensitive surface, directed toward the mass estimate parameter 330B, triggers the display of a list of options for estimating the mass of the substance. This feature provides flexibility in choosing the most suitable method for mass estimation under the specific lyophilization process.

One of the options, estimate parameter 330B1 represented as QL, leverages the latent heat concept using the slopes described in FIG. 5C. In considering the energy required for the phase transitions within the substance, this method provides an accurate estimate of the mass of the substance. It relies on the fundamental principles of thermodynamics to calculate the mass efficiently. Another option, estimate parameter 330B2 depicted as model, provides a customization of a model to fine-tune a mass estimation. This option is particularly valuable when additional data, such as the liquid cooling time (Δt₁) and solid cooling time (Δt₃), is available. Furthermore, the interface offers estimate parameter 330B3, which is depicted as manual. This option is ideal when specific knowledge of the properties and behavior of the substance is known such that the mass estimation can be set directly (with a simple equation).

The advanced freeze-dryer interface 200 further includes a stop button 350B that ensures the safety and integrity of the lyophilization process. The stop button 350B is typically activated through an interaction, such as a mouse click or a touch-sensitive surface contact, providing an accessible and immediate means for intervention, and halts the process. When activated, the stop button 350B immediately halts the active process and transitions the system to a safe state. This safe state is carefully designed to prevent any adverse effects on the system, the substance being freeze-dried, and the surrounding environment.

Upon activation of the stop button 350B, one or more of the system components and one or more processes can be deactivated to ensure safety. These components can include the freezing compressors (e.g., shelf enclosure compressor 513A, cold trap compressor 513B), which stops further cooling; the heating elements, which cease heating the chamber; and the vacuum pump 523, which discontinues the vacuuming process. The one or more processes can include data acquisition and notifications. Data acquisition is responsible for gathering real-time information about the substance being freeze-dried and is temporarily paused when the stop button 350B is activated. This ensures that no further data points are collected, preserving the existing dataset for analysis and record-keeping. Notifications include alerts or messages sent to remote devices or monitoring systems and are temporarily suspended when the stop button 350B is activated. This prevents any unnecessary notifications from being generated during the stopping process.

FIGS. 6A-6R illustrate an advanced freeze-dryer interface utilized in the lyophilization processes, featuring instances of a process under PID control within the run/setup tab. In FIG. 6A, a moment captured at 53 minutes into the process, the advanced freeze-dryer interface 200 displays a comprehensive snapshot of the freeze-drying process. Four plots are depicted: the transient pressure plot 210, the transient temperature plot 220, the phase plot 230, and the transient mass plot 270. The transient substance pressure data 216 exhibits a sharp decline, plummeting below 1200 mTorr, closely aligned with the real-time transient vacuum chamber pressure data 216A, which registers at 643 mTorr. Simultaneously, the transient temperature data 226 shows a significant drop, slipping below 0° F. consistent with the real-time transient temperature data 226A, indicating −8.9° F. Notably, the trap temperature, per the dashboard 260, is currently at −60.1° F.

Examining the substance temperature-pressure data 236 reveals that the temperature and pressure align seamlessly along the sublimation line (ice-to-water vapor line) 234A. This alignment corresponds with the absence of heater engagement, as indicated by PWM=−1 in the dashboard 260. Both the trap temperature-pressure data 238 and the real-time temperature-pressure data 238A reside within the SOLID phase region, further solidifying the freeze-drying progress of the process. Lastly, the transient sublimation mass rate data 274, the transient cumulative mass data 272, and the real-time transient mass data indicator 272A indicate that no solvent sublimation has occurred, in accordance with the matter state indicator on the dashboard 260, which currently signifies a SOLID state.

Importantly, at the moment of the process depicted in FIG. 6A, the vacuum is being applied, and as vacuum is applied, the substance temperature-pressure data 236 are being displayed. These data points trace a sublimation fit line 236B adjacent to the sublimation line 234A of water, illustrating the dynamic equilibrium between the solid and gas phases during the sublimation process. The sublimation fit line 236B is modeled according to a phase transition model, accurately reflecting the phase behavior of the substance under specific experimental conditions. This real-time derivation ensures that the sublimation fit line 236B closely follows the actual transition occurring in the substance, allowing for precise adjustments and monitoring throughout the process.

The sublimation fit line 236B is helpful because it accounts for deviations caused by impurities such as food particles in the substance, which alter its phase transition properties compared to pure water or solvent. These impurities can shift the equilibrium conditions, affecting the temperature and pressure at which sublimation occurs. For instance, the presence of food particles in frozen food alters the freezing and sublimation points, necessitating a tailored phase transition model that adjusts for these deviations. Accurately modeling the sublimation fit line 236B based on real-time substance temperature-pressure data 236 allows the system to compensate for these impurities, providing a more precise representation of the phase behavior of the substance. This capability ensures that freeze-drying processes maintain optimal conditions for product quality and consistency, despite variations caused by impurities.

In some embodiments, the sublimation fit line 236B is not displayed until a model is derived from the substance temperature-pressure data 236. In some embodiments, the sublimation fit line 236B is initially overlaid on the sublimation line 234A (of water) until the model is refined using substance temperature-pressure data 236. This iterative approach ensures that the model adapts to the specific characteristics of the substance, enhancing the accuracy of phase transition predictions in practical applications.

In some embodiments, the sublimation fit line 236B is displayed when specific phase transition conditions are met. For example, it may be shown when the substance temperature-pressure data 236 indicates proximity to phase boundaries or when approaching optimal sublimation conditions. This selective display helps focus operator attention on process phases, ensuring timely adjustments and control.

In FIG. 6B, a snapshot at 57 minutes into the process illustrates developments where the transient pressure plot 210, the transient temperature plot 220, the phase plot 230, and the transient mass plot 270 are updated. Of particular note is the transition in the substance temperature-pressure data 236 and the real-time temperature-pressure data 236A, which have advanced into the vapor matter phase region. This transformation aligns with the matter state indicator of the dashboard 260, now displaying “SUBLIME”. Simultaneously, the heating elements have engaged with an energy transmission of 62%, denoted by PWM=62 in the dashboard 260, corresponding to the active heating process. The shelf temperature, reflecting the temperature of the substance, has reached 23.7° F. Meanwhile, the trap temperature remains stable at −60.1° F.

Furthermore, the snapshot reveals the presence of the initial pressure set point 360C1, visually marked within the phase plot 230. The PID system is actively compensating for deviations from this set point by directing the response back toward the equilibrium pressure set point 360D. To illustrate these control efforts, corresponding transient points of 360C1 and 360D1 have been plotted in the transient pressure plot 210, while transient points of 360C2 and 360D2 have been incorporated into the transient temperature plot 220.

Notably, on the transient mass plot 270, the transient sublimation mass rate data 274 spikes to 7 grams per minute and settles on sublimation rate around 4 grams per minute at point 274A marking the beginning of primary drying. In addition, both the transient mass data 272 and the real-time transient mass data 272A exhibit a gradual increase, approaching 1% or 0.06 kg, as indicated by the dashboard 260.

FIG. 6C presents a snapshot of the advanced freeze-dryer interface 200 at 105 minutes into the process where the transient pressure plot 210, the transient temperature plot 220, the phase plot 230, and the transient mass plot 270 are updated. Continuing from the previous snapshot in FIG. 6B, the substance temperature-pressure data 236 and the real-time temperature-pressure data 236A persist in the vapor matter phase region, consistent with the matter state indicator of the dashboard 260 displaying “SUBLIME”. The heating elements remain actively engaged, with a consistent energy transmission of 61%, as indicated by PWM=61 in the dashboard 260, reflecting ongoing heating operations. The shelf temperature, representative of the temperature of the substance, has now reached 13.3° F., continuing the cooling process. Meanwhile, the trap temperature remains steady at −60.1° F.

Noteworthy is the performance of the PID system, which exhibits compensation efforts characterized by converging, second-order ringing responses. These responses are observed on the transient pressure plot 210, the transient temperature plot 220, and the phase plot 230 showing the control actions of the system to maintain equilibrium. Additionally, on the transient mass plot 270, the transient sublimation mass rate data 274 rings in accordance with a damped sinusoidal curve instep with the temperature and pressure states, which are tuned by the PID settings. Also, both the transient mass data 272 and the real-time transient mass data 272A depict a steady increase, reaching 5% or 0.18 kg, as indicated by the dashboard 260.

The next snapshots depicted in FIG. 6D and FIG. 6E show that the trends established in the previous figures continue to unfold. Notably, on the transient mass plot 270, the transient sublimation mass rate data 274 stabilizes at a constant rate around 4.16 grams per minute, while both the transient mass data 272 and the real-time transient mass data 272A increases to 12% corresponding to 0.43 kg according to the dashboard 260 and 19% corresponding to 0.70 kg, as reported by the dashboard 260. These figures clearly demonstrate the efficacy of the freeze-drying process, successfully removing a substantial portion of the solvent from the substance. These snapshots provide valuable insights into the dynamics of the process, enabling precise monitoring and control, ultimately ensuring the successful lyophilization of the substance.

In FIG. 6F, FIG. 6G, and FIG. 6H, the characteristic spiral and ringing patterns that were previously displayed have ceased, reducing clutter and facilitating rapid, accurate interpretation of ongoing process dynamics. The notable gauge of progress throughout these snapshots remains the transient mass plot 270, where the transient sublimation mass rate data 274 remains steady at 4.16 grams per minute until point 274B marking the end of primary dry and the beginning of secondary dry, where the transient sublimation mass rate data 274 begins to decay. Further, both the transient mass data 272 and the real-time transient mass data 272A exhibit 26% corresponding to 0.95 kg as reported by the dashboard 260 in FIG. 6F, 33%, corresponding to 1.21 kg in FIG. 6G, and 40%, corresponding to 1.46 kg according to the dashboard 260 in FIG. 6H.

In the snapshots from FIG. 6I to FIG. 6O, the freeze-drying process dynamics of temperature are exhibited. The temperature, which had been steady, now starts to rise as part of the efforts of the system to maintain the targeted pressure of 600 mTorr. This rise in temperature is remarkable, starting at 19.5° F. in FIG. 6I and increasing to 114.5° F. in FIG. 6O, according to the dashboard 260. This adjustment reflects the precision of the system in adhering to the desired conditions for effective lyophilization.

Simultaneously, the transient sublimation mass rate data 274 begins to decay from 4.16 grams per minute to 1.32 grams per minute, and the real-time transient mass data 272A shows the removal of solvent from the substance from 47%, equivalent to 1.72 kg according to the dashboard 260 in FIG. 6I, to 94%, corresponding to 3.42 kg, in FIG. 6O. This significant increase in the mass data signifies the substantial progress made in removing the solvent from the substance, aligning with the targeted outcome of the lyophilization process.

Additionally, in these snapshots, there are noticeable ripples in the temperature-pressure data 236. These ripples correspond to the variation of diffusion rate of the solvent as it exits the substance. These dynamic fluctuations further underscore the precision and responsiveness of the freeze-drying system, which adjusts parameters in real-time to ensure that the process unfolds according to the desired profile.

In the snapshots from FIG. 6P to FIG. 6Q, the temperature, regulated by the PID, continues to rise until it reaches the final temperature (T_{f}) of 120° F., corresponding to the final temperature set point 360E. This transition is notably marked on the phase plot 230 at the final temperature set point 360E, on transient pressure plot 210 at the corresponding transient final temperature set point 360E1, and on the transient temperature plot 220 at the transient final temperature set point 360E2. At this juncture, a significant change occurs as the set point shifts from 600 mTorr to 120° F. symbolizing a shift from pressure-based control to temperature-based control.

The phase plot 230 illustrates this turning point in the freeze-drying process, where the temperature-pressure data 236 takes a decisive turn, reflecting the transition from 600 mTorr at 120° F. to 357 mTorr at 121.8° F., according to the dashboard 260. This shift exhibits the precision of the system in managing the process parameters to adhere to the specified profile.

In parallel, transient pressure plot 210 captures this change as well, showing how the transient vacuum chamber pressure data 216 undergoes a distinct change at the corresponding transient final temperature set point 360E1. It transforms from an isobaric curve (e.g., constant pressure), as seen before this set point, into an isothermal curve (e.g., constant temperature). The transient temperature plot 220 mirrors this transformation, depicting how the transient temperature data 226 undergoes a distinct change at the transient final temperature set point 360E2. It transitions from an isobaric curve to an isothermal curve, mirroring the shift in set point control. Notably, the transient sublimation mass rate data 274 plummets to near zero and bounces while the PID controller switches from a set point of 600 mTorr to a set point of 120° F. This bounce is an artifact of the PID controller, and can be eliminated with the proper tuning. The transient sublimation mass rate data 274 then decays very slowly as the solvent (e.g., water) is very tightly bound and at point 274D, the transient sublimation mass rate data 274 crosses a sublimation rate threshold of 0.001, near zero. This is the point when the lyophilization process is complete at 99.9% of water removed. Meanwhile, the transient mass data 272 and the real-time transient mass data 272A steadily tick up, reaching 98%, corresponding to 3.53 kg according to the dashboard 260 in FIG. 6P, and 99%, corresponding to 3.56 kg, according to the dashboard 260 in FIG. 6Q.

FIG. 6R marks the characteristic infinitesimally small decline of the transient sublimation mass rate data 274 beyond the completion of the lyophilization process, where the solvent (e.g., water) is very tightly bound and reaching the termination point where over 99.9% of the solvent has been successfully removed from the substance, as set by the termination setting 330C. At the moment of termination, the final pressure set point 360F is prominently indicated on the phase plot 230, corresponding to a mere 37 mTorr, as reported by the dashboard 260. With the successful completion of the lyophilization process, the system immediately shifts into a safe state, designed to safeguard the integrity of the system, the substance being freeze-dried, and the surrounding environment. In this safe state, one or more processes are deactivated to prevent any adverse effects. Among these deactivated components are any one of the freezing compressors (e.g., shelf enclosure compressor 513A, cold trap compressor 513B), which ceases further cooling of the substance, the heating elements, which discontinue heating the chamber, and the vacuum pump, which halts the vacuuming process. This comprehensive approach ensures that the physical components of the system are in a stable state, ready for further use. For example, the heating elements have been deactivated in FIG. 6R, as indicated by PWM=−1 in the dashboard 260.

Additionally, the one or more processes linked to data acquisition and/or notifications are stopped and the data acquisition is put on hold. This action guarantees that no additional data points are collected, preserving the existing dataset for further analysis and record-keeping. In some embodiments, a notification is sent upon completion to inform relevant parties of the successful completion of the lyophilization process. This notification is displayed in the input/output terminal 250, as displayed in FIG. 6R.

In some embodiments, a completion indicator 380 is displayed, offering a visual confirmation of successful completion of the process. At this stage, the stop button 350B ceases to be displayed and a resume button 350C is displayed, which can be activated when inspection of the substance reveals that the process is not yet complete. This feature offers flexibility in instances where further refinement is desired.

FIGS. 7A-7K illustrate an advanced freeze-dryer interface utilized in the lyophilization processes, featuring operation control within the functions tab. Upon selecting the function tab 203, as indicated by the contact 290Q in FIG. 7A, the display shifts its focus solely to the contents of the function tab 203 while ceasing to show information from other tabs. In certain embodiments, the contact 290Q in FIG. 7A is activated through a mouse click or contact with a touch-sensitive surface at a location corresponding to the function tab 203. The functions tab 203 houses various operational controls, including relays 420, duty cycle 430, pressure sensor 450, the waveform plot 410, the interactive data navigation toolbar 240, the input/output terminal 250, the expansion button 252, and the dashboard 260.

Within the relays 420 section, operational components can be enabled by checking checkboxes. The condenser checkbox 420A activates the condenser, the vacuum checkbox 420B initiates the vacuum pump, and the heater checkbox 420C engages the heating elements. Additionally, there are spare checkboxes (e.g., spare 420D-420H) allowing activation of any of the following: spare0 420D, spare1 420E, spare2 420F, spare3 420G, and spare4 420H.

In the duty cycle 430 section, different energy sources for heating can be enabled. The electric option checkbox 430A directs electric energy to heat the substance (e.g., heating elements), while the radiative checkbox 430B utilizes radiative energy sources like UV light or microwave radiation. The PWM setting 430C controls the output energy applied to the substance, with values ranging from −1 (disabled) to 99 (maximum as a full sinusoidal wave). A watts indicator 430D displays the amount of output watts applied to the substance.

Within the pressure sensor 450 section, a choice can be made between two pressure sensors. Checking the first pressure sensor 450A enables the first pressure sensor, and checking the second pressure sensor 450B enables the second pressure sensor.

The waveform plot 410 displays two curves: a reference max curve 412 and an output voltage curve 414. The reference max curve 412 features rising zero intersections 412A and 412E, a falling zero intersection 412C, a voltage maximum 412B, and a voltage minimum 412D. The output voltage curve 414 shows zero voltage, corresponding to the disabled state of the PWM (−1). Importantly, the snapshot in FIG. 7A represents a point 45 minutes into the run/setup, occurring 8 minutes before the event depicted in FIG. 6A, where the substance begins cooling to 0° C. before the vacuum pump is enabled.

It should be appreciated that the output voltage curve 414 can be modulated to various waveforms, offering flexibility in controlling the electric energy source. For example, in some embodiments, the output voltage curve 414 is configured as a saw-tooth waveform, where the energy gradually increases until reaching the peak and then resets, creating a repeating pattern. In some embodiments, the output voltage curve 414 is a periodic exponential waveform, where the energy grows or decays exponentially over the period and then resets. In some embodiments, the output voltage curve 414 can be a triangular waveform, featuring linear growth to a peak, followed by linear descent to the baseline before resetting. In some embodiments, the output voltage curve 414 is a square wave, offering abrupt switches between high and low energy states, can offer another modulation option. Likewise, the reference max curve 412 can be adapted to correspond to various waveforms, providing versatility in controlling the electric energy source.

The checkboxes within the functions tab 203 serve as direct indicators of the current state of the corresponding system components. If, for example, the condenser checkbox 420A is enabled during an operation, it signifies that the condenser is actively running as part of the process. Similarly, when the vacuum checkbox 420B is selected, it indicates that the vacuum pump is operational, and enabling the heater checkbox 420C implies that the heating elements are actively heating the chamber.

Within the duty cycle 430 section, the checkboxes play a similar role. Checking the electric option checkbox 430A during an operation enables the use of electric energy to heat the substance, typically through heating elements. When the radiative checkbox 430B is selected, it indicates that radiative energy sources, such as UV light or microwave radiation, are in use to energize the substance. The PWM setting 430C, which ranges from −1 (indicating disabled) to 99 (representing maximum as full sinusoidal), sets the output energy applied to the substance during the process. Additionally, a watts indicator 430D provides a clear display of the actual output watts being applied to the substance, providing insight into the energy consumed for the operation.

In the pressure sensor 450 section, similar principles apply. Checking the first pressure sensor 450A enables the first pressure sensor, for monitoring pressure-related parameters in the system. Similarly, checking the second pressure sensor 450B indicates that the second pressure sensor is operational, providing redundancy and accuracy in pressure measurement.

These checkboxes also come with a degree of flexibility. During an operation, if manual intervention or an override of the default settings is desired, a manual override checkbox (which is not displayed in the interface) can be included and enabled. This manual override capability facilitates real-time adjustments, providing a level of control and adaptability to the lyophilization process.

FIG. 7B provides a snapshot of the advanced freeze-dryer interface during an important operational phase. At this moment, the interface displays contact 290R, representing a mouse click or a touch-sensitive surface contact that corresponds to the first pressure sensor 450A that enables the activation of the first pressure sensor. This activation is evident when observing the dashboard 260 that transitions from displaying “Disabled,” as seen in FIG. 7A, to indicating a specific pressure reading of 759657 mTorr in FIG. 7B, which serves as an immediate indicator of the activation of the first pressure sensor.

FIG. 7C depicts a snapshot of the functions tab 203 that corresponds to the operation corresponding to FIG. 6B, approximately 57 minutes into the freeze-drying process. This moment provides detailed views of how various components are actively engaged, reflecting the operation of the system.

Notably, the first pressure sensor checkbox is enabled, indicating that the first pressure sensor is actively enabled and functioning. This status is explicitly confirmed by the dashboard 260, which now displays a specific pressure reading. In this instance, the pressure level registers at 654 mTorr, which aligns closely with the set point of 600 mTorr. This synchronization between the set point and the actual vacuum pressure illustrates the efficiency of the system in maintaining the desired conditions during the lyophilization process.

Furthermore, both the vacuum checkbox 420B and the heater checkbox 420C are enabled, signaling that the vacuum pump and heating elements are in operation. The vacuum pressure, being near the set point, reflects the responsiveness of the system in maintaining the specified vacuum conditions. Regarding the heating elements, the interface provides precise control, with the PWM (Pulse Width Modulation) set at 62. This setting corresponds to an output energy level of 62% being applied to the substance being freeze-dried.

The waveform plot 410 exhibits the output voltage curve 414 over a period of 16.67 mHz (1/60 Hz). The waveform plot 410 further includes a first cutoff 414A and the second cutoff 414B representing the modulation of the reference max curve 412 effectively enabling ˜62% of the output of the reference curve.

FIG. 7D depicts a snapshot of the functions tab 203 corresponding to an operation that has been ongoing for approximately 405 minutes, as represented in FIG. 6F. At this point in the lyophilization process, the PWM is set to 59, which corresponds to 59% of the reference max curve 412 in the waveform plot 410.

The output voltage curve 414 in the same plot shows that the first cutoff 414A and the second cutoff 414B have been adjusted to align with the PWM setting of 59%. Further, the dashboard 260 provides a direct and real-time display of 596 mTorr, which is in close proximity to the set point of 600 mTorr.

In FIG. 7E, contact 290S representing either a mouse click or a touch-sensitive surface contact at a location corresponding to the PWM setting 430C is detected or the PWM setting 430C is adjusted to a value of 25. In response to detecting the contact 290S and adjusting the PWM setting 430C to 25, the output voltage curve 414 dynamically alters the positions of the first cutoff 414A and the second cutoff 414B within the output voltage curve 414. The real-time value of 25% of the reference max curve 412 is utilized.

In FIG. 7F contact 290T1 representing either a mouse click or a touch-sensitive surface contact at a location corresponding to the radiative checkbox 430B within the duty cycle is detected. In response, the radiative checkbox 430B is enabled, which toggles the electric option checkbox 430A, indicating a shift from using electric energy to utilizing radiative energy sources, such as UV light or microwave radiation, to energize the substance. Further, an irradiation waveform plot 440 replaces the waveform plot 410. This irradiation waveform plot is tailored specifically for representing the characteristics of radiative energy with two curves: the reference irradiation curve 442 and the output irradiation curve 444 over a period of 16.67 mHz (1/60 Hz).

The reference irradiation curve 442 serves as a visual reference, providing insights into the maximum level of the radiative energy. The output irradiation curve 444 includes the activation 444A and the deactivation 444B, which delineate the activation and deactivation phases of the radiative energy source over the period of 16.67 mHz (1/60 Hz). In some embodiments, the output irradiation curve 444 is modulated to a step function over the period, akin to a Heaviside function. In some embodiments, the output irradiation curve 444 can be modulated to various waveforms, offering flexibility in controlling the radiative energy source. For example, in some embodiments, the output irradiation curve 444 can be configured as a saw-tooth waveform, where the energy gradually increases until reaching the peak and then resets, creating a repeating pattern. In some embodiments, the output irradiation curve 444 can be a periodic exponential waveform that can be utilized, where the energy grows or decays exponentially over the period and then resets. In some embodiments, the output irradiation curve 444 can be a triangular waveform may be employed, featuring linear growth to a peak, followed by linear descent to the baseline before resetting. In some embodiments, the output irradiation curve 444 can be a square wave, characterized by abrupt switches between high and low energy states, can offer another modulation option.

It should be noted that the reference max curve 412 and the output voltage curve 414 for a square wave bear a striking resemblance to the reference irradiation curve 442 and output irradiation curve 444, respectively, as displayed in irradiation waveform plot 440. While the reference max curve 412 and the output voltage curve 414 for a square wave share similarities with the reference irradiation curve 442 and output irradiation curve 444 displayed in the irradiation waveform plot 440, they serve distinct functions. The output voltage curve 414 of a voltage square waveform operates within the electrical domain, controlling the electrical energy output. On the other hand, the output irradiation curve 444 of an irradiation waveform refers to the intensity of irradiation or light exposure, typically used in processes involving photosensitive materials.

Referring now to FIG. 7F, activation is detected at contact 290T2, which corresponds to the advance button 602B. This contact may be initiated via a mouse click or a touch-sensitive input on a touchscreen interface. In response to this selection, the interface transitions to the power functions, illustrated in FIG. 7G.

In FIG. 7G, a parameter view section 468 is presented. The parameter view section 468 includes a plurality of selectable checkboxes, including energy checkbox 468A, power checkbox 468B, voltage checkbox 468C, current checkbox 468D, power factor checkbox 468E, and frequency checkbox 468F. Each checkbox enables display of a corresponding graphical view, including energy view 460, power view 462, current view 464, voltage view 466, power factor view (not depicted), and frequency view (not depicted). Each enabled view displays a time-based plot of the associated electrical parameter, facilitating comparative analysis among the displayed metrics.

The configuration shown in FIG. 7G is operative to convey electrical performance characteristics of the freeze-dryer system. Visualization of parameters such as power draw, current, and voltage over time enables identification of operational phases and system behavior. For example, variations in power and current levels can correspond to activation of internal components, such as vacuum pumps or heating elements.

The energy view 460 further provides a cumulative total of energy consumed. This cumulative energy value is usable for determining batch-specific energy consumption and associated operational cost. The interface further includes an energy counter reset button 472, which, when activated, resets the cumulative energy value to zero. This permits tracking of energy usage beginning from a known reference point, such as the start of a processing batch.

In various embodiments, the parameter views 468 may be embedded within the functions tab 203, or alternatively, presented in a dedicated tab separate from the functions tab. In configurations where the views are embedded, the display adapts responsively based on which parameter checkboxes are selected. For instance, when four parameters are selected, four views are displayed; enabling additional parameters (e.g., power factor or frequency) results in additional views being rendered within the available space. In such embodiments, only the enabled views are presented, while non-enabled views remain suppressed. This dynamic presentation allows efficient allocation of display area to relevant data.

As further shown in FIG. 7G, an overlay controls section 470 is provided. The overlay controls section 470 includes a set of selectable checkboxes enabling the overlay of additional time-based process parameters onto one or more of the displayed electrical views. The checkboxes include a sublimation rate (e.g., “SubRate”) checkbox 470A, a cumulative product mass (e.g., “CumMass”) checkbox 470B, temperature checkbox 470C, and pressure checkbox 470D. When enabled, each corresponding checkbox displays a transient plot of the selected parameter overlaid across one or more of the displayed views, such as energy view 460, power view 462, current view 464, and voltage view 466.

These overlays are co-plotted along the time axis to facilitate temporal correlation between the selected process parameter and the electrical characteristics of the freeze-dryer system. For example, enabling the SubRate checkbox 470A overlays a time-based sublimation rate curve atop the electrical views, revealing relationships between drying activity and power draw or current consumption. Similarly, enabling the CumMass checkbox 470B adds a plot of cumulative product mass removed (e.g., cumulative water vaporized) over time, aiding in evaluating process efficiency and energy use per unit mass removed.

Upon further actuation of the advance button 602B by touching the test type selector (e.g., contact 290T3) in the function tab 203 of FIG. 7G, the interface transitions to the filtering and dashboard configuration view depicted in FIG. 7H. This view includes sensor filtering functions 480, where a plurality of sensor-specific filter interfaces are presented. These include: the primary pressure sensor filter 480A (P-Primary), the secondary pressure sensor filter 480B (P-Sensor2), five temperature sensor filters corresponding to T-Primary sensor filter 480C. TSensor2 sensor filter 480D, TSensor3 sensor filter 480E, TSensor4 sensor filter 480F, and TSensor5 sensor filter 480G, and two mass sensor filters corresponding to MSensor1 filter 480H and MSensor2 filter 480I.

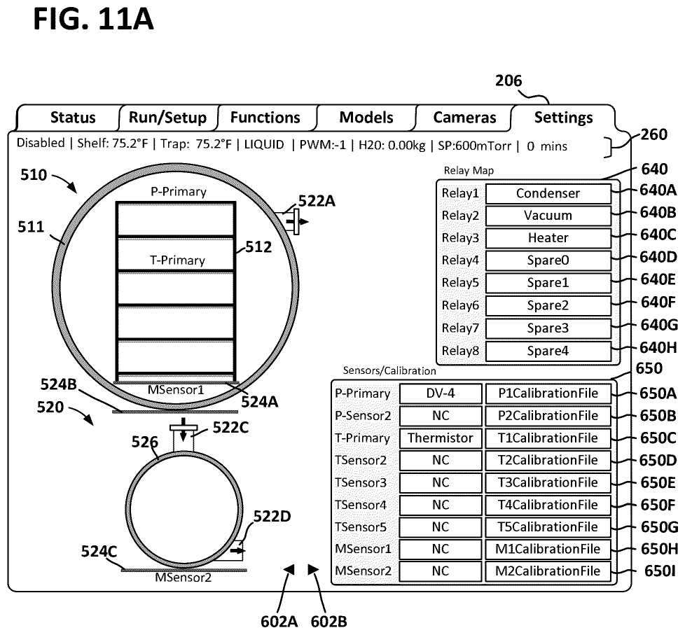

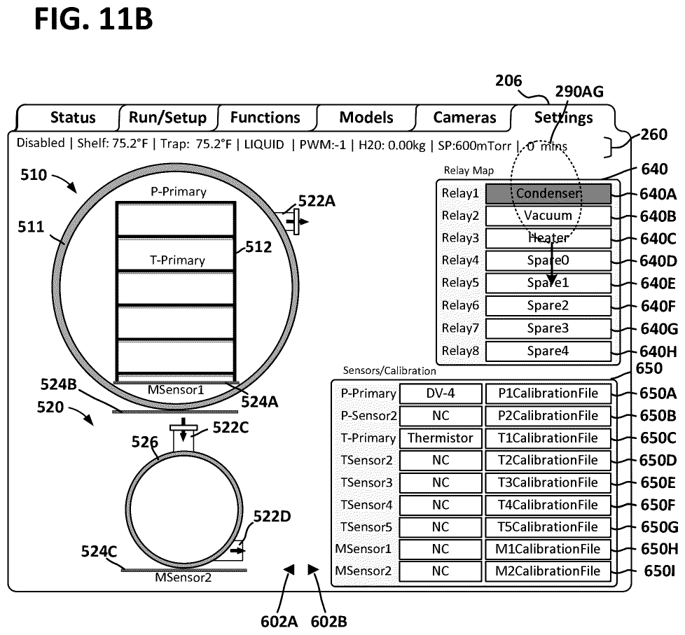

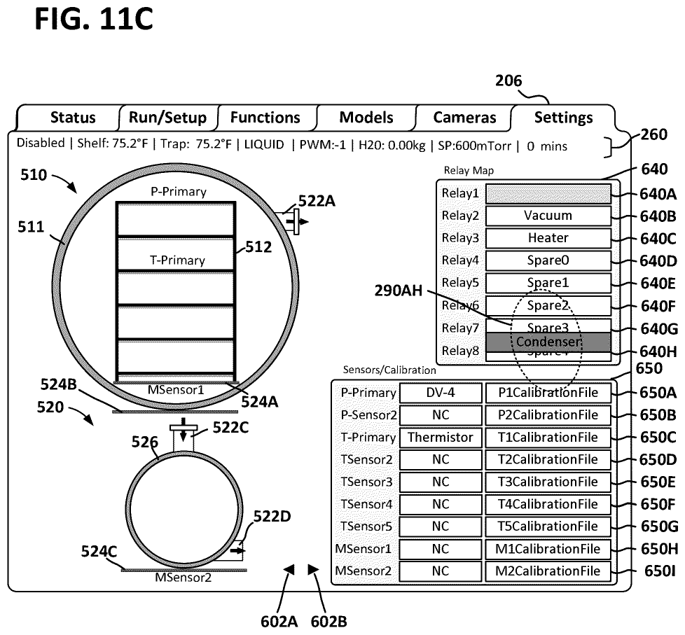

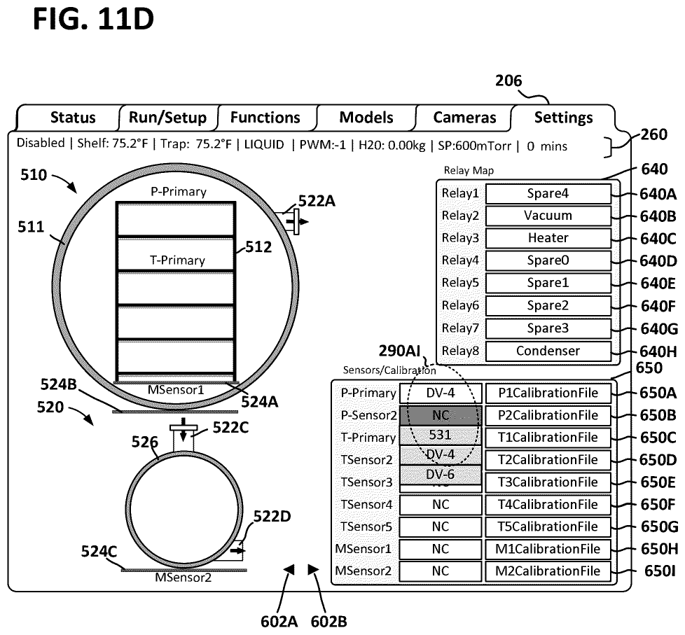

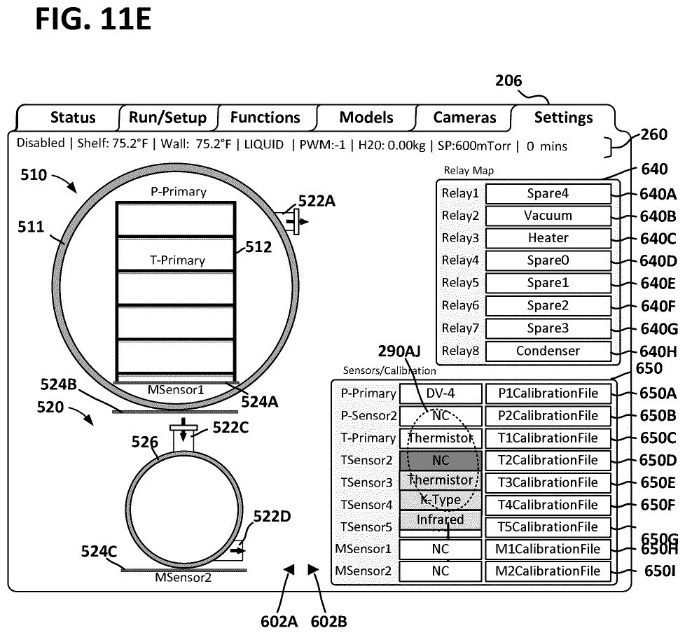

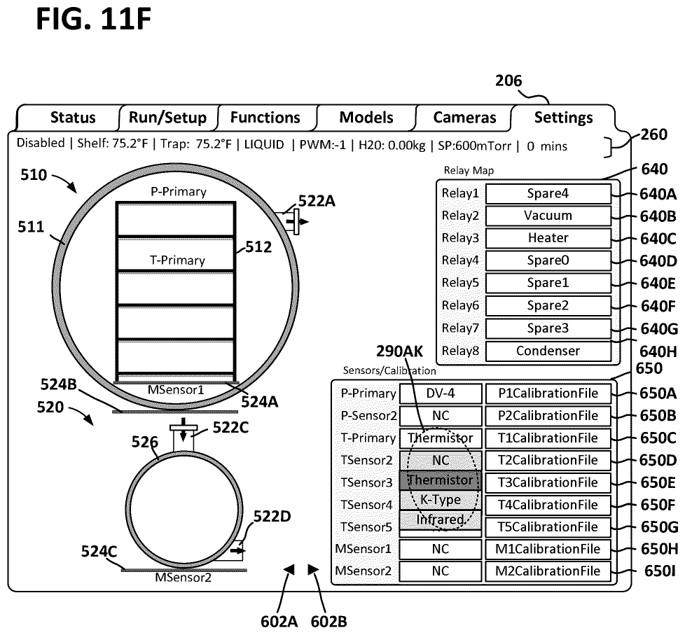

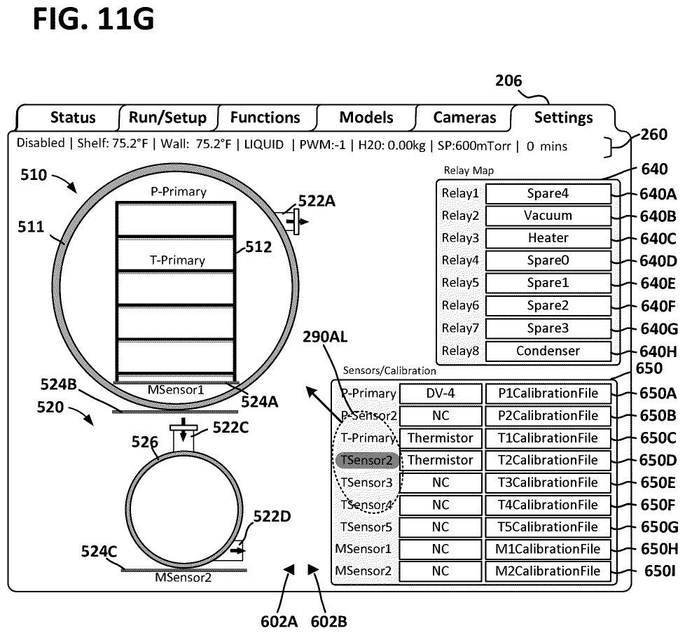

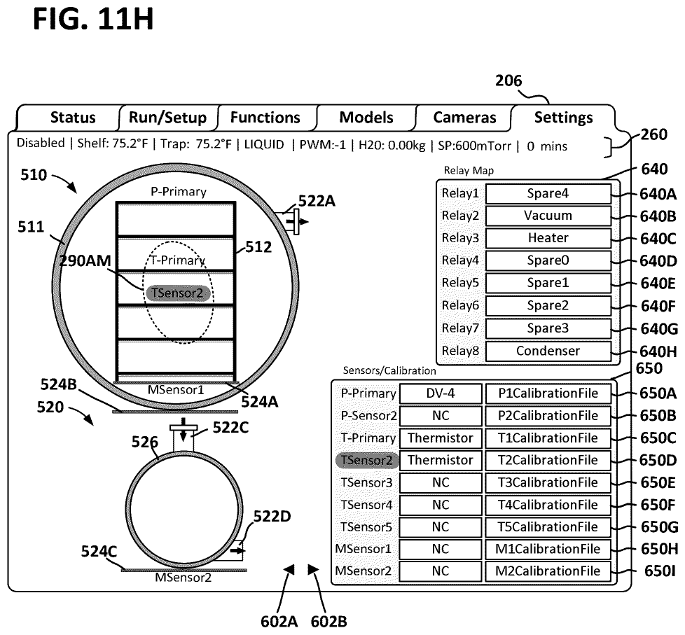

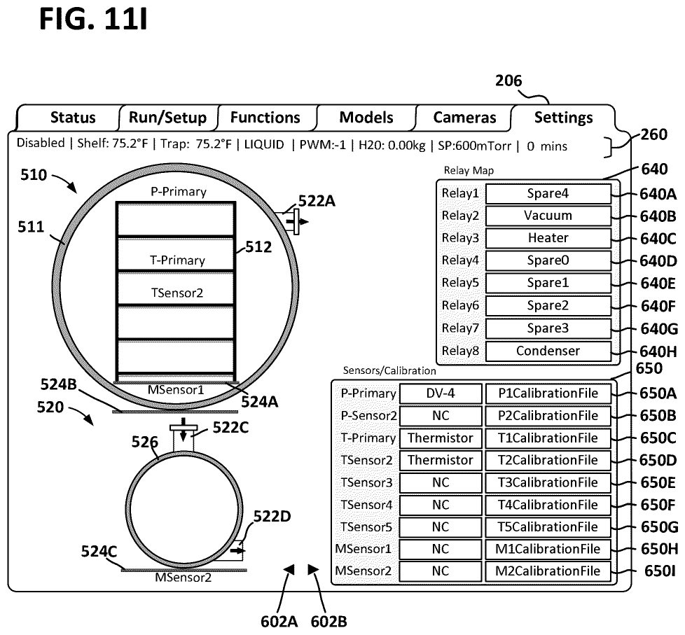

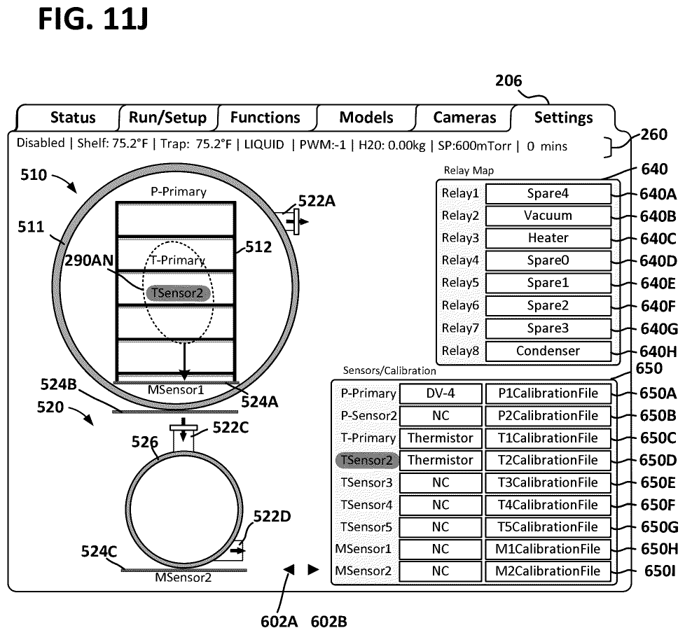

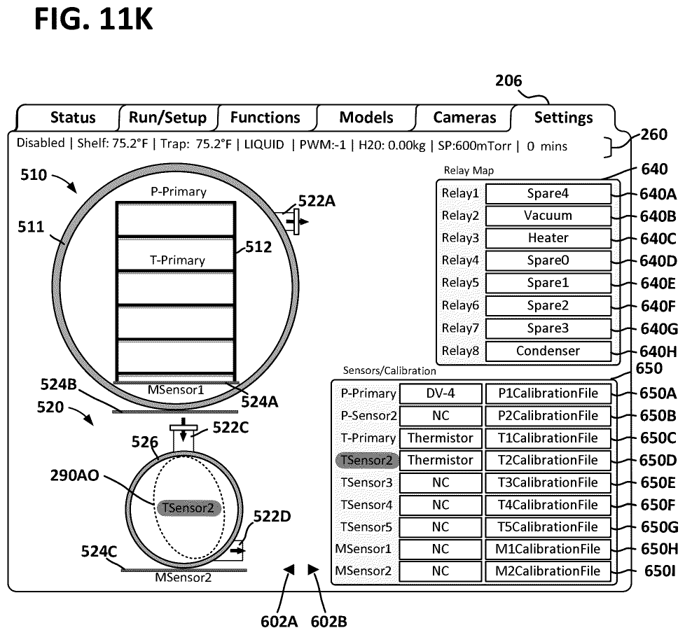

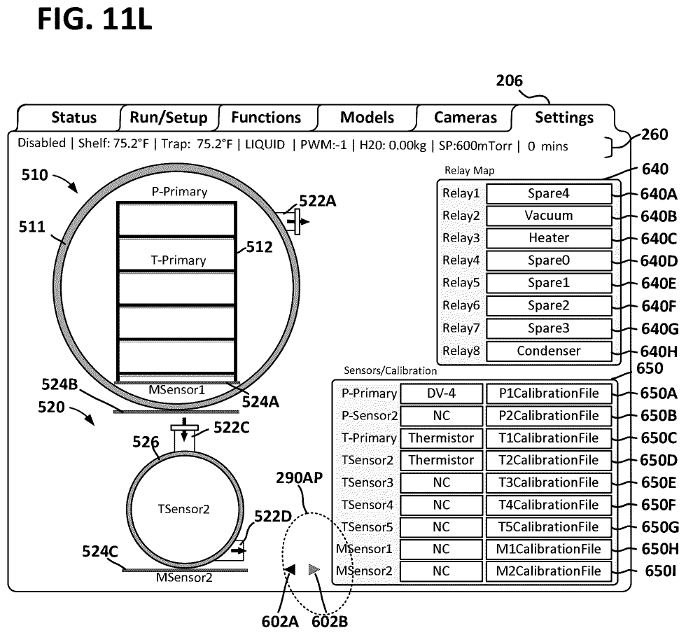

Each sensor filter 480A-480G includes functionality to define both the sensor type and the filter configuration. The sensor type may be selected from a predefined list and may also be mapped in the sensor calibration map 650 accessible through the settings tab 206 (see FIGS. 11A-11L). The filter type for each sensor may be independently selected and, in the embodiment shown, includes filtering methods such as Butterworth, Chebyshev, and Moving Average. However, in various embodiments, additional or alternative filter types may be available, such as Kalman filters, exponential smoothing, IIR, FIR, or other digital signal processing techniques.

Each sensor filter includes a control to define numeric filter parameters, including but not limited to filter order (e.g., first-order, second-order, third-order) and window size for moving average filters, taps, etc. Validation checks are contemplated to confirm compatibility of selected filters and parameters with the characteristics of the associated sensor output, ensuring robust operation.

Further, each sensor filter interface includes an interactive slider for tuning the filter strength or responsiveness, constrained within defined minimum and maximum values to maintain data fidelity. A checkbox is also provided for each sensor to enable or disable the filter dynamically. In some embodiments, this checkbox may also disable the sensor entirely, preventing its data from being used in any active processes or views.

Sensor filtering functions 480 are particularly useful in mitigating noise or signal distortion that arise from hardware placement or environmental artifacts. For instance, a temperature sensor placed in close proximity to a heating element may report artificially high readings that do not represent the shelf or product temperature accurately. While hardware placement cannot always be optimized, applying software-based filters via sensor filtering functions 480A-480I provides a dynamic and customizable means of improving data quality and reliability.

FIG. 7H further includes a dashboard configuration function 482 to select and arrange the indicators in the main indicators dashboard 260. Each indicator may be individually added or removed from the dashboard through corresponding checkboxes. Indicators that may be configured via function 482 include pressure, shelf temperature (e.g., Shelf:T1), trap temperature (e.g., Trap:T2), pump temperature (e.g., Pump:T3), ambient temperature (e.g., Ambient:T4), additional temperature sensors (e.g., T5), phase state (e.g., solid, liquid, sublime), cumulative product mass (e.g., H₂O Mass), sublimation rate (e.g., H₂O Rate), and various electrical parameters such as energy, power, current, voltage, power factor, and frequency. Additional indicators include PWM (pulse width modulation), set point temperature (e.g., Set Point), and total batch run time.

In some embodiments, each indicator (or the graphical objects representing each indicator) within dashboard configuration function 482 is draggable. This allows reordering of the indicators by dragging them to new positions, enabling a customized arrangement within the indicators dashboard 260. Such customization provides flexibility to prioritize the display of critical parameters based on the operational context or preferences.

In some embodiments, the dashboard configuration function 482 further includes an indicator add button, which enables the creation and inclusion of custom indicators into the indicators dashboard 260. For instance, a custom indicator may represent cumulative product mass (e.g., H₂O mass) derived from a near-infrared (NIR) camera or other sensor system not shown. This feature facilitates the integration of additional sensor-derived parameters, expanding the analytical and diagnostic capabilities of the freeze-dryer interface.

Actuation to manipulate the filter parameters such as by touching the filter type (e.g., “Notch”) of the T-Primary sensor filter 480C in contact 290T4 within the function tab 203 of FIG. 7H transitions the interface to that depicted in FIG. 7I. This view expands to show specific sensor filter tuning options. As shown, selecting the filter type (e.g., “Notch”) presents a dropdown selection menu for adjusting filter parameters. In this example, contact 290T5 is used to adjust parameters through the dropdown interface while maintaining the selected “Notch” filter type. The initial stopband frequency “f₁” and final stopband frequency “f₂” are adjustable via sliders, numeric input boxes, scroll wheels, or similar input controls.

In some embodiments, the system concurrently displays a plot response 484, where the filtered sensor signal is overlaid on the original time-sequenced data. The original data (shown in gray) may correspond to readings from a prior cycle in which the sensor was positioned in close proximity to a heating element. In such cases, the unfiltered signal exhibits sharp, periodic fluctuations (artifacts induced by the cyclical activation of the heater). These spikes do not represent the true thermal state of the shelf and can mislead the control algorithm, resulting in erratic or inefficient thermal regulation and control of a freeze-drying cycle.

The filtered signal (shown in black) represents the result of applying a digital notch filter to attenuate these periodic artifacts while preserving the underlying thermal trend. In this example, the notch filter is configured with a stopband spanning approximately 0.035 Hz to 0.2 Hz, targeting the dominant frequency components of the heater-induced interference. Changes to filter parameters result in real-time updates to the filtered curve, providing live visualization of the filtering effect and enabling precise tuning. This approach improves the stability and accuracy of the temperature signal, facilitating the controller to regulate heat delivery with greater reliability and fidelity to the true thermal behavior of the aluminum shelf.

Actuation of the advance button 602B by touching (e.g., contact 290T6) the test type selector in the function tab 203 of FIG. 7I transitions to the interface depicted in FIG. 7J, which illustrates the vacuum pump functions screen, including a dedicated interface for performing a vacuum pull down test. Upon activation of the start button 499, the vacuum pump is triggered to begin pulling a vacuum within the system. Once activated, the start button 499 dynamically changes to a stop button, enabling early termination of the test if desired. This start/stop behavior is consistent with the functionality of the start/stop button 350B illustrated in FIGS. 6A-6R.

The pull down test is visualized through a transient pressure plot 490, displaying logarithmic pressure (in mTorr) versus time (in minutes). A functioning vacuum pump typically exhibits a linear decay on this log-scale plot, transitioning from approximately 10⁶ m Torr to 10⁴ mTorr in about 4 minutes. FIG. 7J depicts both a previous test curve 490A and a latest test curve 490B for side-by-side comparison. Linear extrapolations of these curves are represented as dashed lines 490C and 490D, extending toward the 10² mTorr region. Comparison time constant marker 492B identifies when each extrapolated test curve intersects the 10² mTorr threshold. For example, 490A reaches the 10² mTorr of time constant marker 492B at approximately 7 minutes, while 490B reaches the same threshold at time constant marker 492C around 7.5 minutes, indicating progressive degradation in pump performance.

Test metrics are displayed in the test results section 498. The results variable selector 498A toggles between derived metrics including CFM (Cubic Feet per Minute), time constant, 6 Min, and 20 Min markers. When “6 Min” is selected, the pressures at the 6-minute markers 492D for test1 494A and 492E for test2 494B are approximately 4000 mTorr and 2000 mTorr, respectively. Test1 494A corresponds to a 6-minute short test, while test2 494B represents an extended 20-minute test ending at marker 492F.

Beyond the initial linear decay, molecular evacuation transitions to a non-linear regime due to reduced gas density. The curve for test2 490B drops to 10³ mTorr at approximately 13 minutes and then asymptotically approaches the vacuum pump's ultimate pressure limit. When the results variable 498A is toggled to “20 Min,” test1 results 498B display “N/A” or “-” (due to limited test duration), while test2 results 498C indicate a final pressure of approximately 800 mTorr.

A list of recorded tests 494 is shown, with test1 494A and test2 494B enabled for display in plot 490. An add test button 494C allows naming and storing of additional tests before or after execution for later recall and comparison. Test-specific parameters, such as test duration, are configured through the parameter settings section 496. Activating the parameter selector button 496A (e.g., labeled “duration”) reveals editable values for test1 parameter 496B and test2 parameter 496C. Additional parameter entries (e.g., for test3, test4, etc.) are appended as new tests are added to the test list 494.

The pump metrics section 497 tracks performance indicators such as total runtime and operational history. The metric type is toggled using selector 497A, which may include total runtime, number of test cycles, or other maintenance indicators. For example, metric 497B may display a total runtime of 1523 hours for the currently tracked pump. New pumps are added via add button 497C, allowing side-by-side lifetime performance comparisons.

In FIG. 7J, the vacuum test type can be selected by touching (e.g., contact 290T7) the test type selector, enabling toggling between available test modes such as Pull Down 493A and Hold 493B. Upon selecting Hold test 493B, the interface transitions to the Hold test screen of FIG. 7K. In this mode when the start button 499 is activated, the vacuum pump evacuates the chamber to a predetermined pressure threshold typically, 600 mTorr, which corresponds to the default batch processing pressure. Once the predetermined pressure threshold is reached, the vacuum pump is disabled, and the system enters a timed observation procedure, during which the chamber pressure is sampled over a predefined duration (e.g., 5 minutes or 300 seconds).

The resulting pressure curve is analyzed to determine leak rate, expressed in CFM (Cubic Feet per Minute). In a healthy system, the leak rate remains below −1.0 CFM, as exemplified by test1 curve 490E, which reports a leak rate of −0.31 CFM. In contrast, a system with a substantial leak or degraded sealing, whether from the vacuum pump or chamber, will exceed the threshold, as shown in test2 curve 490F, where the leak rate is calculated at −2.1 CFM. This Hold test is useful for identifying degraded system performance, pinpointing vacuum leaks, and comparing results to historical baselines or prior system configurations.

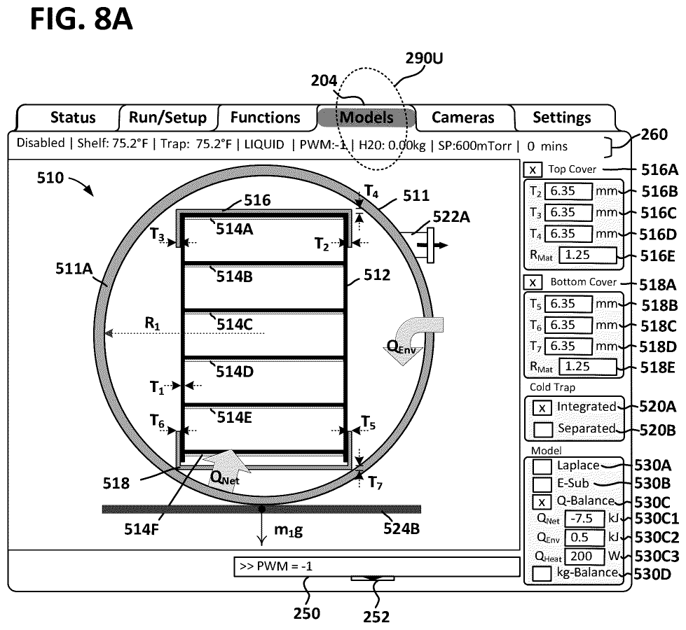

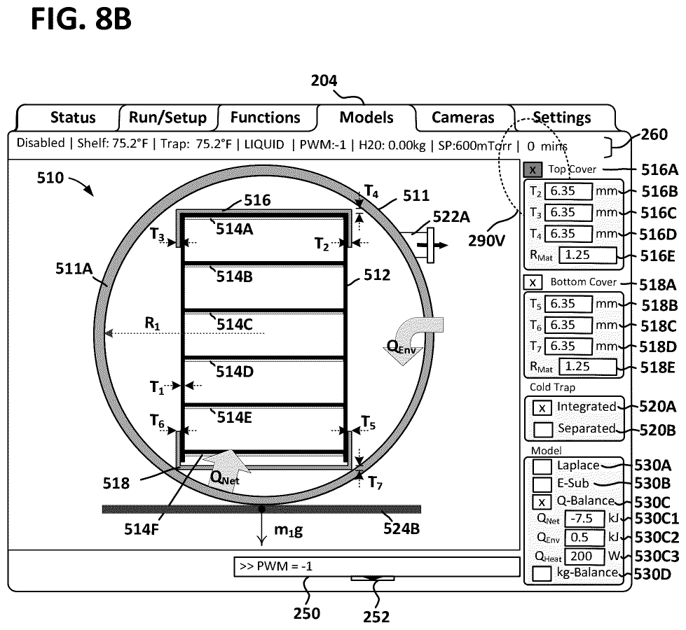

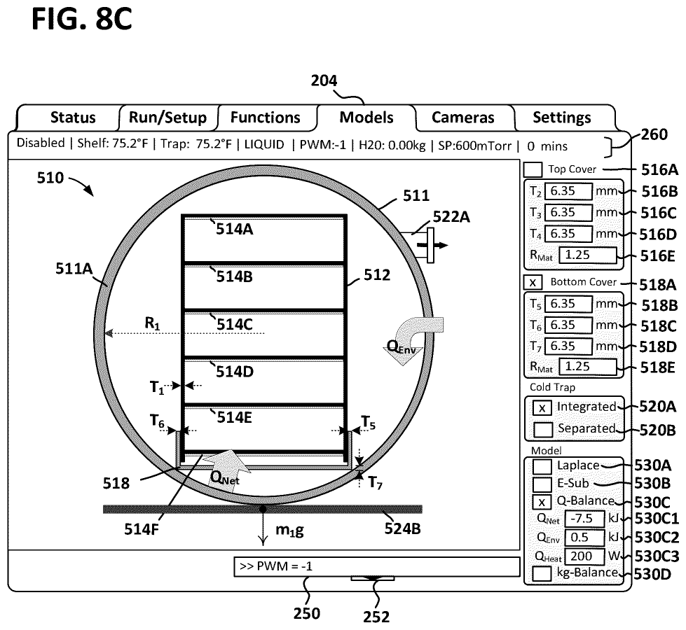

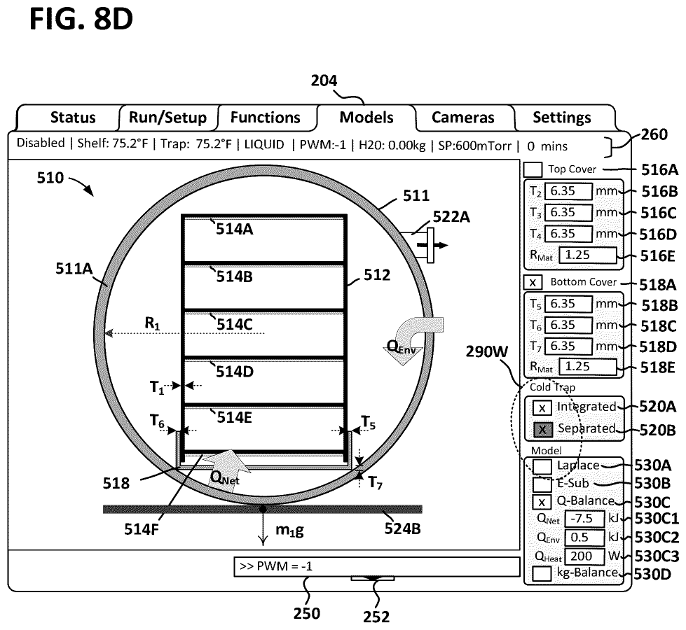

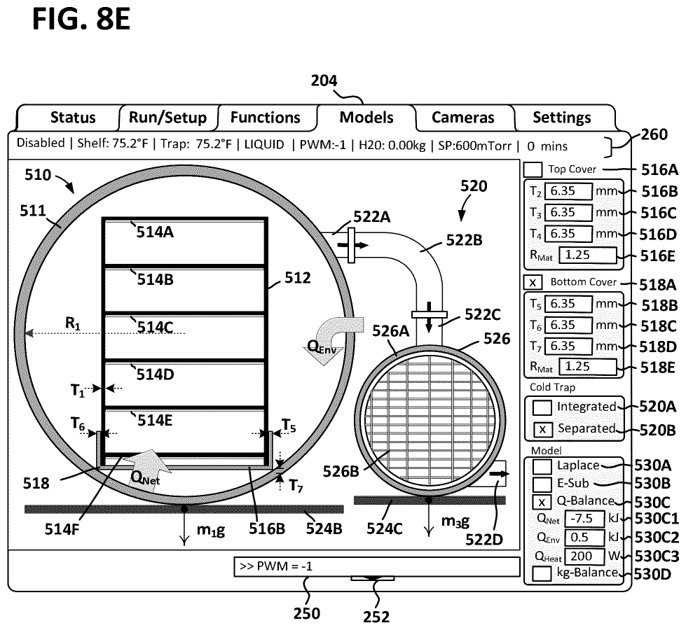

FIGS. 8A-8E illustrate an advanced freeze-dryer interface utilized in the lyophilization processes, featuring modeling parameters within the models tab. Upon selecting the models tab 204, as indicated by the contact 290U in FIG. 8A, the display shifts its focus solely to the contents of the models tab 204 while ceasing to show information from other tabs. In certain embodiments, the contact 290U in FIG. 8A is activated through a mouse click or contact with a touch-sensitive surface at a location corresponding to the models tab 204. The models tab 204 includes a configurable enclosure model 510 that simulates a freeze-drying setup featuring an insulated shelf enclosure 511, placed on an enclosure scale 524B. Inside the shelf enclosure 511, shelves 512 are neatly arranged and equipped with one or more heating elements (514A-514E) for precise temperature control during the freeze-drying process. In some embodiments, each shelf within the shelf enclosure 511 is equipped with a dedicated heater, ensuring precise control over the temperature distribution during the freeze-drying process. However, in some instances, one or more of these shelves may not be utilized to hold the substance being processed. Instead, they serve a different purpose-heating elements on these unused shelves are employed to encourage the sublimation of solvent and prevent its deposition in specific areas.

For instance, consider the scenario where the substance is intentionally not placed on the shelf adjoining heater 514A. In this case, the shelf adjacent to heater 514A serves as a thermal barrier. Its purpose is to redirect the flow of heat and vapor within the vacuum chamber, preventing excessive solvent deposition on the shelf and ensuring uniform sublimation and drying of the substance. This configuration allows for a more controlled and efficient freeze-drying process while minimizing the risk of uneven solvent buildup.

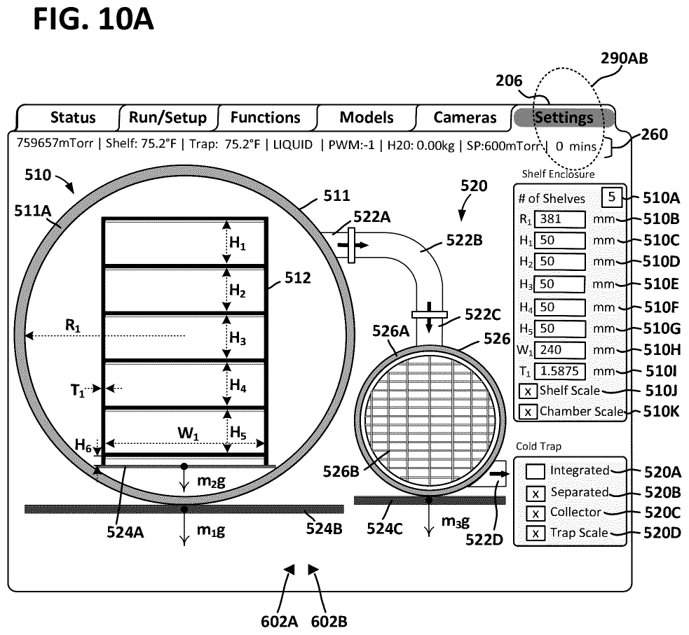

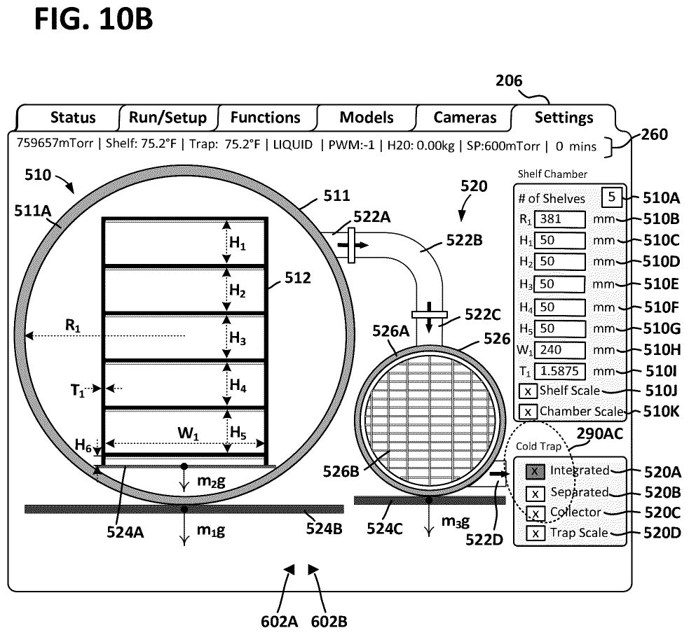

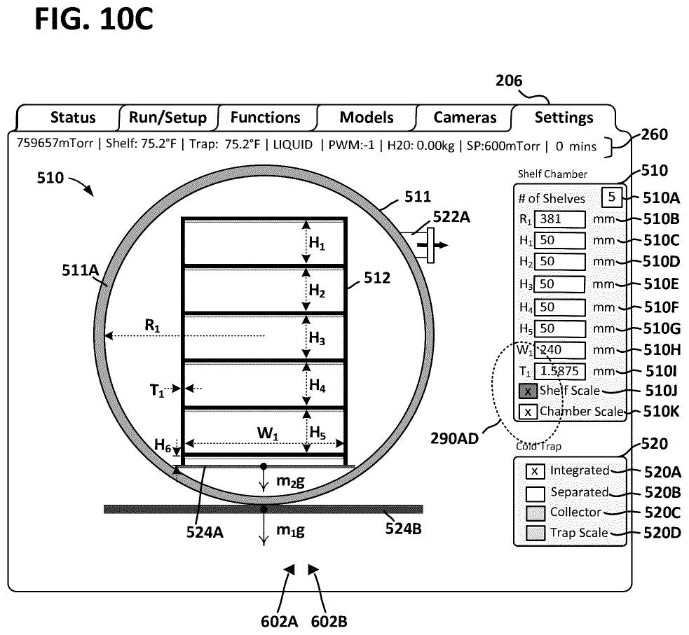

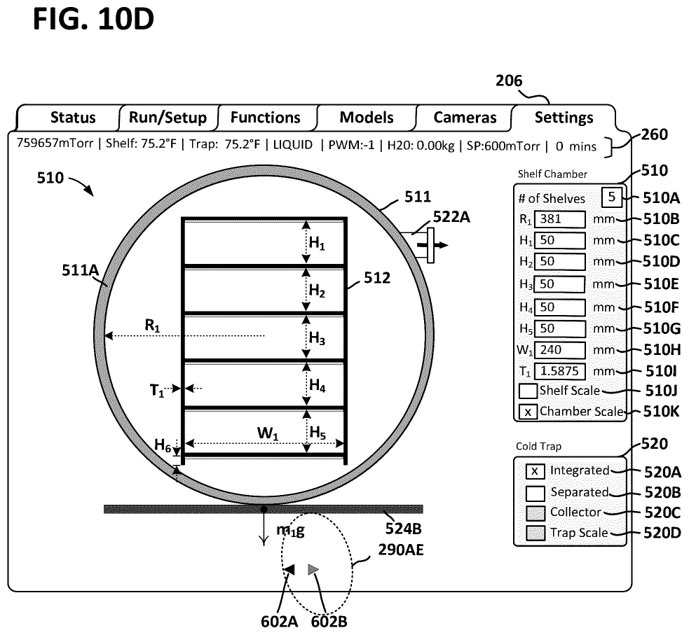

It should be appreciated that the shelf thickness T₁ can be adjusted in the settings tab 206 depicted in FIGS. 10A-10D. The settings tab 206 provides flexibility to fine-tune various parameters to tailor the freeze-drying process. Modifying the shelf thickness can optimize heat distribution, vapor flow, and overall system performance, ensuring that the freeze-drying process is both efficient and effective for the substances.

In FIG. 8A, the enclosure model 510 is tailored to include specific components enabled using a corresponding checkbox. For example, a top cover checkbox 516A is enabled, signifying the presence of a top cover 516 within the system model. Configurable parameters of the top cover include thickness on the T₂ edge of the top cover 516B, thickness on the T₃ edge of the top cover 516C, thickness on the T₄ edge of the top cover 516D, and top cover thermal resistance 516E. In some embodiments, the top cover 516 is a thermal insulator configured to reduce heat (e.g., thermal energy transfer) between shelves 512 and the shelf enclosure 511.

In some embodiments, adjusting the configurable parameters associated with the top cover checkbox 516A in the interface modifies the characteristics of the depicted top cover 516 within the system model. These configurable parameters include parameters like the thickness of different edges of the top cover, such as the T₂ edge, T₃ edge, and T₄ edge, as well as the thermal resistance of the top cover. In some embodiments, adjustments to these parameters directly impact the representation of the top cover 516 in the system model, enabling them to customize and fine-tune the characteristics and behavior of the system to align with specific conditions. This level of customization enhances the versatility and practicality of the advanced freeze-drying interface in accommodating various system configurations and scenarios.

Referring back to FIG. 8A, the bottom cover checkbox 518A is also enabled, indicating that a bottom cover 518 is part of the model. Configurable parameters of the bottom cover include thickness on the T₅ edge of the bottom cover 518B, thickness on the T₆ edge of the bottom cover 518C, thickness on the T₇ edge of the bottom cover 518D, and bottom cover thermal resistance 518E. In some embodiments, adjustments to these parameters directly impact the representation of the bottom cover 518 in the enclosure model 510, enabling customization and fine-tuning of the characteristics and behavior of the system to align with specific conditions. In some embodiments, the bottom cover 518 is a thermal insulator configured to reduce heat (e.g., thermal energy transfer) between shelves 512 and the shelf enclosure 511.

Additionally, the integrated cold trap checkbox 520A is checked, signifying the inclusion of an integrated cold trap in the system. In this context, the term “integrated” emphasizes that the cold trap 520 is seamlessly incorporated into the design and structure of the shelf enclosure model 510. Unlike a distinct or standalone component as depicted in FIG. 8E, the integrated cold trap is not a separate entity but rather an inherent feature of the shelf enclosure 511, designed to efficiently capture and collect the sublimated materials during the freeze-drying process.

Incorporating insulation, indicated as shelf insulation 511A, into the shelf enclosure 511 design provides significant benefits to the freeze-drying process. This insulation 511A acts as a thermal barrier, effectively reducing heat transfer between the internal and external environments of the shelf enclosure 511. By minimizing heat exchange with the surroundings, the insulation 511A helps maintain stable and controlled temperature conditions within the shelf enclosure 511. This ensures that the substance inside the chamber undergoes the desired phase transitions without excessive heat loss or gain.

Furthermore, the shelf enclosure 511 is equipped with an outlet 522A. This outlet 522A serves as the conduit through which fluids, including the sublimated materials and residual gases, are evacuated from the shelf enclosure 511 to the connected vacuum pump (not shown). Efficiently removing these materials facilitates maintaining the desired vacuum conditions within the shelf enclosure 511 and ensures that sublimation occurs efficiently, allowing the substance to transition from a solid to a gas phase with minimal hindrance.

The energy sublimation model (E-sub) checkbox 530B in FIGS. 8A-8E enables a physics-based estimation of sublimation behavior by leveraging real-time system energy input and process conditions. When selected, this model calculates sublimation dynamics using the measured temperature and pressure states, as well as other parameters such as the setpoints and thresholds 310A-310D. The output of the model is displayed in the transient sublimation mass rate data 274 and transient sublimation mass data 272 shown in FIGS. 6A-6R. The model reiterates that under constant pressure, the sublimation rate remains approximately stable unless the system diverts energy from sublimation to raise the product temperature, a condition often encountered as tightly bound water begins to sublimate. In contrast, loosely bound water sublimates with minimal thermal resistance, requiring less additional energy. Thus, deviations from a relatively flat sublimation rate curve under constant pressure can indicate increasing energy demand to maintain phase transition. Accordingly, the model correlates sublimation rate with real-time temperature, pressure, and heater energy input, offering insight into the thermodynamic efficiency of the drying process and the shifting moisture-binding characteristics of the product.

In FIG. 8A, the energy balance model (Q-balance) checkbox 530C is enabled, which enables a thermodynamics model focusing on energy balance. When the energy balance model (Q-balance) checkbox 530C is activated, it initiates a thermodynamics model based on the fundamental principle of heat transfer balance within the freeze-drying system. This model accounts for the conservation of energy, ensuring that the sum of various heat energy components is in equilibrium. Specifically, it considers the net heat energy (Q_{NET} 530C1) from the system, the environmental heat energy (Q_{ENV} 530C2) obtained from the external environment, the heat energy (Q_{HEAT} 530C3), delivered by one or more heating elements 514A-514F, and the energy transition associated with sublimation. In accordance with the conservation of energy, these components collectively balance to zero, enabling a comprehensive understanding of thermal dynamics governing the freeze-drying process.

In some embodiments, the energy balance model (Q-balance) estimates the initial mass of the substance. In some embodiments, the energy balance model (Q-balance) estimates the real-time mass of the substance sublimated during the freeze-drying process.

In some embodiments, Laplace equation model checkbox 530A is enabled. When the Laplace equation model checkbox 530A is enabled, it utilizes the Laplace equation to model temperature and pressure distribution within the freeze-drying chamber. This includes chamber geometry, structural components, initial conditions, and boundary conditions. The Laplace equation corresponds to a partial differential equation used to describe how a scalar field (like temperature or pressure) varies over space. It models the distribution of temperature and pressure within the shelf enclosure 511 and provides insight into how heat and pressure move and interact within the system. It offers a real-time understanding of heat and pressure dynamics within the chamber, considering factors like chamber shape, heater placement, and substance thickness. As the freeze-drying process progresses, the Laplace equation continuously calculates and updates temperature and pressure distribution, helping monitor substance freezing, drying, and phase transitions.

In some embodiments, the Laplace model estimates the initial mass of the substance. In some embodiments, the Laplace model estimates the real-time mass of the substance sublimated during the freeze-drying process.

Enabling the mass scale checkbox 530D activates a model based on the fundamental principle of mass conservation. This model operates by continually weighing one or both of the substance and the sublimated material. This real-time measurement allows for a precise assessment of how mass decreases within the substance and increases within the trap, offering a dynamic understanding of mass transfer. In particular, the difference between the real-time mass measurement and the previous mass measurement corresponds to the mass sublimation rate, as this change in mass over time indicates the rate at which mass is being added to or removed from the product.

In some embodiments, the mass scale model (kg-scale) estimates the real-time mass of the substance sublimated during the freeze-drying process. In some embodiments, the mass scale model (kg-scale) estimates the amount of water drawn into the vacuum pump, which not only helps gauge the wear and tear on the pump but also contributes to optimizing its maintenance schedule.

The Laplace model, the energy balance model (Q-balance), and the mass scale model (kg-scale) each offer precise timing capabilities with the capability of determining when a specified amount of mass has been transferred or when the process is complete.

Selecting the top cover checkbox 516A, as indicated by the contact 290V in FIG. 8B, results in disabling the top cover checkbox 516A. Consequently, the top cover 516 is removed from the system representation, and it ceases to be displayed within the enclosure model 510, as illustrated in FIG. 8C. In some embodiments, this action can be initiated through a mouse click or a touch-sensitive surface contact at the location corresponding to the top cover checkbox 516A. This capability dynamically modifies the enclosure model 510 to suit specific desires, enabling a more versatile and adaptable approach to freeze-drying simulations and experiments.

It should be appreciated that deactivating the bottom cover checkbox 518A (though not explicitly displayed), results in displaying the bottom cover checkbox 518A as disabled. Consequently, the bottom cover 518 is removed from the enclosure model 510 and ceases to be displayed within the enclosure model 510.

Selecting the separated cold trap checkbox 520B, denoted by contact 290W in FIG. 8D, disables the previously active integrated cold trap checkbox 520A while simultaneously enabling the separated cold trap checkbox 520B. In response to disabling the integrated cold trap checkbox 520A, the system removes the integrated cold trap configuration from the cold trap 520. In response to enabling the separated cold trap checkbox 520B, the system adds the separated cold trap configuration to the system model, as depicted in FIG. 8E.

It is important to note that, in certain embodiments, the separated cold trap checkbox 520B and the integrated cold trap checkbox 520A can be simultaneously enabled to reflect instances when both an integrated cold trap and a separated cold trap are implemented.

It should be appreciated that the separated cold trap configuration can be adjusted in the settings tab 206 depicted in FIGS. 10A-10D. The cold trap 520 presents an integrated design that incorporates connector 522B, which serves to connect the outlet 522A of the shelf enclosure 511 to the cold trap inlet 522C. This connector 522B ensures a seamless flow of sublimated materials from the shelf enclosure 511 to the cold trap 520 for efficient collection and deposition management.

The cold trap enclosure 526 is thermally insulated, employing insulation 526A to maintain an environment conducive to sublimation and deposition control. This insulation helps regulate the temperature within the cold trap, optimizing its performance during the freeze-drying process.

The cold trap enclosure 526 includes an outlet 522D, condensing surfaces 526B, and trap scale 524C. The outlet 522D serves as a conduit through which fluids, including the sublimated materials and residual gases, are evacuated to the connected vacuum pump. The condensing surfaces 526B increase the surface area available within the cold trap enclosure 526, which contributes to the efficiency in capturing and retaining sublimated materials. In some embodiments, the condensing surfaces 526B are removable. The trap scale 524C continually weighs the accumulated sublimated material and provides real-time measurement capability, which allows for accurate monitoring of the deposition process and valuable insights into the dynamics of sublimation and deposition during freeze-drying.

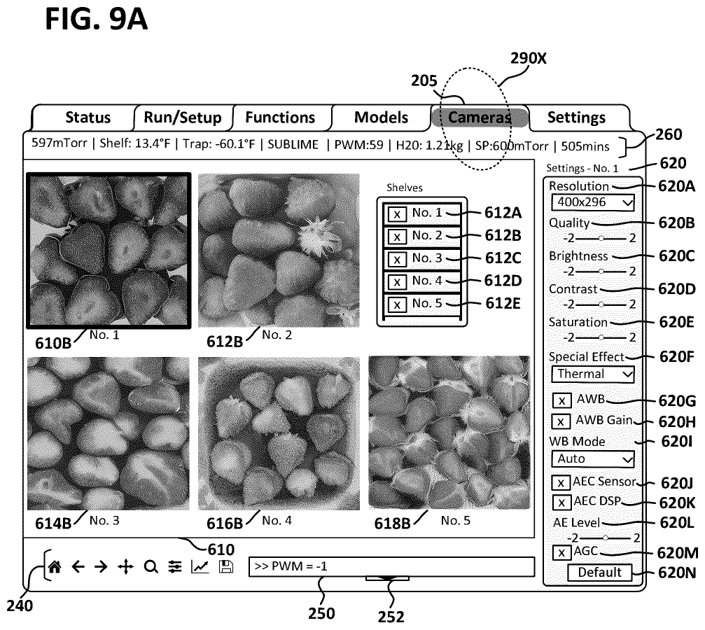

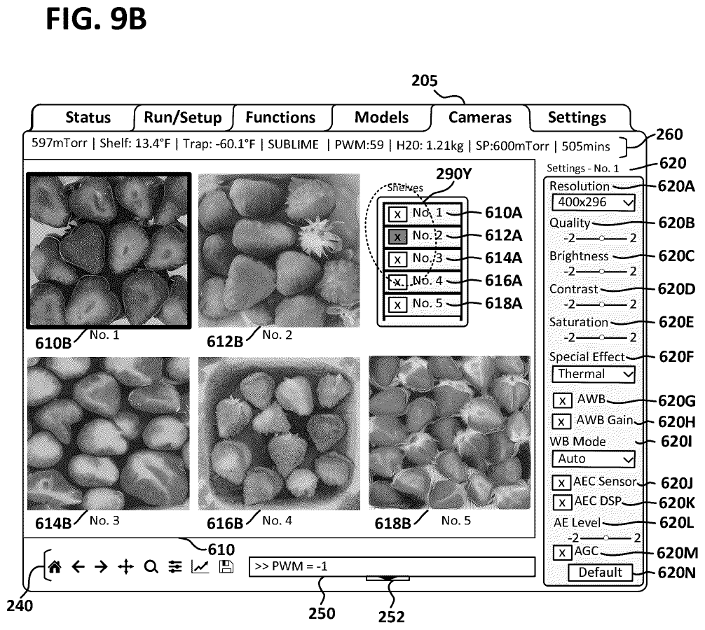

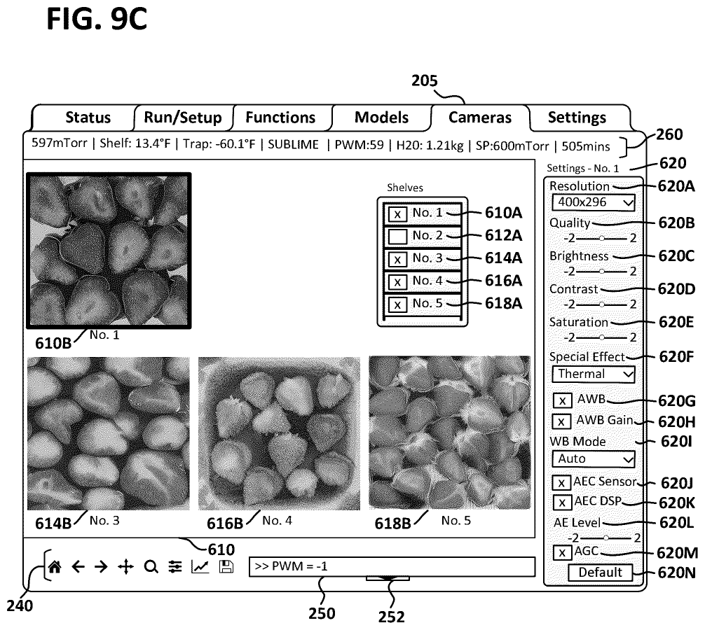

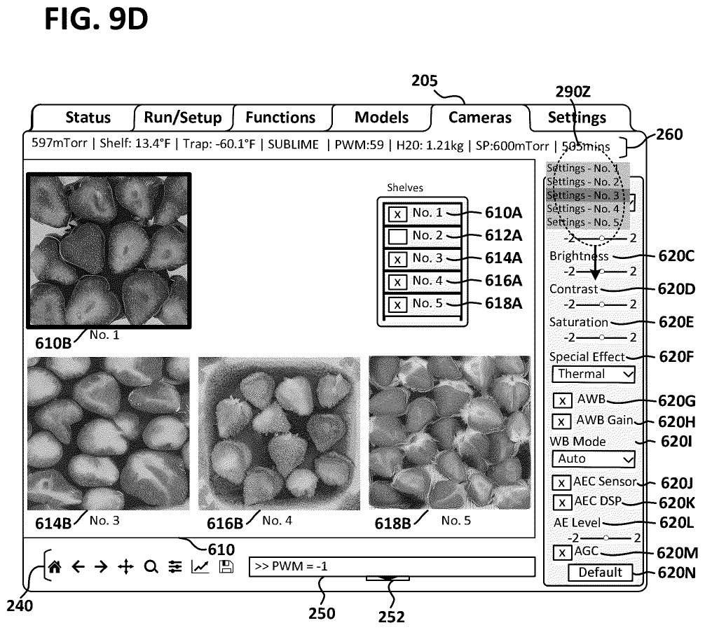

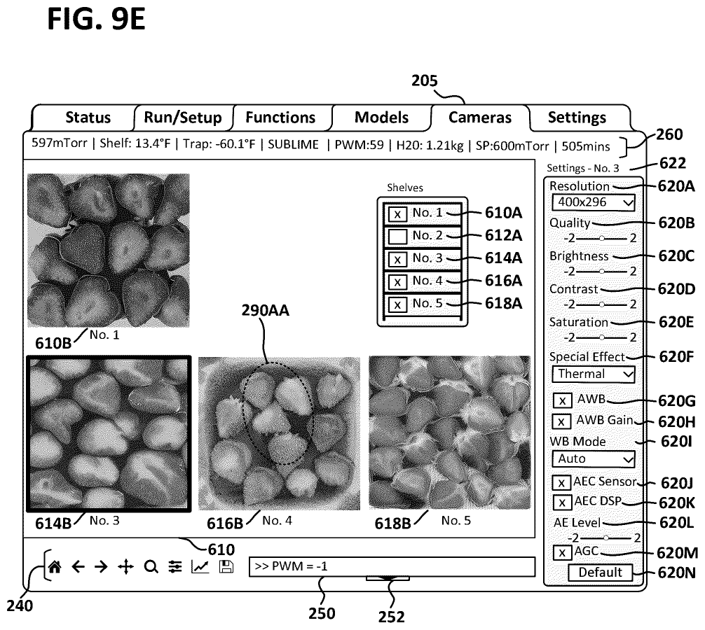

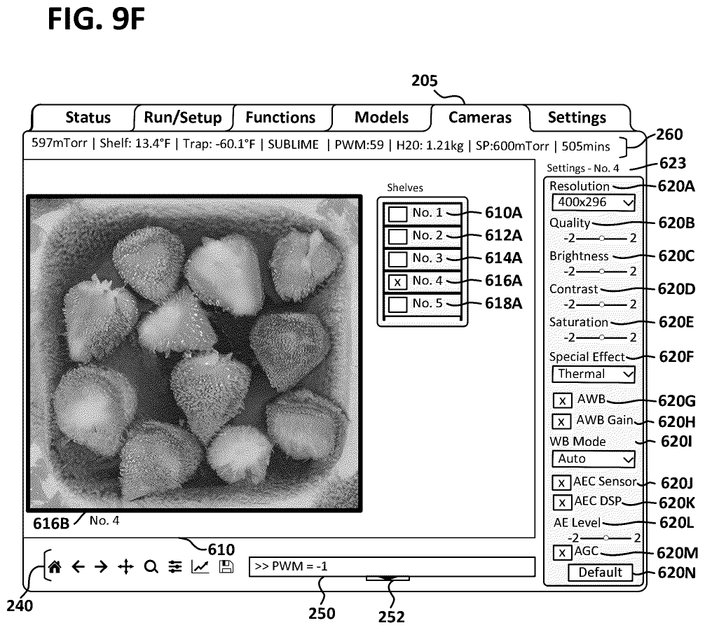

FIGS. 9A-9F illustrate an advanced freeze-dryer interface utilized in the lyophilization processes, featuring camera configurations within the camera tab 205. Upon selecting the cameras tab 205, indicated by the contact 290X in FIG. 9A, the interface reorients itself, dedicating its display exclusively to the contents of the cameras tab 205 while disengaging from other tabs. This transition is facilitated by interactions such as a mouse click or touch-sensitive surface contact at a location corresponding to the cameras tab 205, as evident in FIG. 9A.

Within the cameras tab 205, a graphical representation of the shelves 512 is presented, with each shelf housing at least one camera 604. The representation includes individual checkboxes associated with the camera 604 of each shelf, such as the first shelf checkbox 610A, second shelf checkbox 612A, third shelf checkbox 614A, fourth shelf checkbox 616A, and fifth shelf checkbox 618A. When a respective checkbox is enabled, a corresponding image for a camera 604 associated with the checkbox is displayed in the cameras tab 205. For example, selecting the second shelf checkbox 612A, as indicated by the contact 290Y in FIG. 9B, disables this second shelf checkbox 612A and, consequently, the second image 612B associated with the camera 604 on the second shelf. This means that the visual representation of the camera feed of the second shelf is no longer displayed in the cameras tab 205, as demonstrated in FIG. 9C. In some embodiments, the contact 290Y in FIG. 9B can be activated through a mouse click or a touch-sensitive surface contact at a location corresponding to the second shelf checkbox 612A, offering an intuitive way to control which camera feeds are displayed.

The images, denoted as the first image 610B, second image 612B, third image 614B, fourth image 616B, and fifth image 618B, provide real-time visual feedback from the cameras, granting insights into the conditions and contents of the shelves 512. The images offer insights into the conditions of the substance. For instance, these images enable visual inspection of the substance to determine if any solvent remnants persist within the substance. This inspection is further facilitated by utilizing a special effect 620F, such as thermal imaging (e.g., detecting infrared energy). Thermal imaging highlights temperature variations, showing areas that are colder. In the context of lyophilization, colder areas often correspond to regions where solvent is still present and frozen. By combining the visual images with thermal data, it is possible to pinpoint exactly where solvent remnants may exist, aiding in the decision-making process during the freeze-drying cycle.

To facilitate camera management and customization, the cameras tab 205 also provides specific camera settings for each shelf-associated camera. For example, in FIG. 9A, first camera settings 620 corresponds to the camera situated on the first shelf, while third camera settings 622 in FIG. 9E correspond to the camera 604 on the third shelf. In some embodiments, the cameras tab 205 provides an intuitive way to link these settings to the corresponding image. For instance, when accessing settings for a particular camera, such as the first image 620B as illustrated in FIGS. 9A-9C, the associated image can be visually highlighted or otherwise distinguished. This visual cue emphasizes which settings of the camera are currently presented for adjustment, streamlining the customization process and minimizing the risk of unintended changes to settings for other cameras.

The displayed settings encompass a range of parameters for optimizing the performance of these cameras. The settings include settings for resolution 620A, quality 620B, brightness 620C, contrast 620D, saturation 620E, special effect 620F, automatic white balance (AWB) 620G, AWB gain 620H, white balance (WB) mode 620I, Automatic Exposure Control (AEC) sensor 620J, AEC Digital Signal Processor (DSP) 620K, AE level 620L, automatic gain control (AGC) 620M, and a default button 620N.

Resolution 620A controls the size and clarity of the captured images. It facilitates image resolution adjustment, which can be particularly useful for managing storage space and transmission bandwidth. Quality 620B manages image compression and determines the resulting file size, which can be fine-tuned to balance image quality with file size. Brightness 620C adjusts image luminance, which ensures that images are not excessively dark or too bright. Contrast 620D modifies the difference between the brightest and darkest parts of an image, which can significantly impact its visual appeal and diagnostic value. Saturation 620E controls the intensity of colors within the image. Proper saturation adjustment ensures that colors are accurately represented. Special Effect 620F provides a suite of image enhancements or filters that can be applied as desired. These effects can be particularly valuable for specialized diagnostic or visual inspection purposes. Automatic AWB 620G is an automatic color correction feature that helps balance colors in the image, reducing the impact of color casts under varying lighting conditions. AWB Gain 620H fine-tunes the operation of AWB, ensuring accurate color reproduction in different lighting environments. WB Mode 6201 offers a selection of predefined white balance settings suitable for various lighting conditions. AEC Sensor 620J continually monitors ambient light levels to ensure optimal exposure settings, thus contributing to image clarity. AEC DSP 620K processes image data in real-time to maintain optimal exposure and image quality, regardless of changing conditions. AE Level 620L sets the desired exposure level for image capture, providing precise control over image brightness and contrast. AGC 620M adjusts image brightness by digitally amplifying the signal, which is especially useful in low-light scenarios. The default button 620N reverts settings to predefined defaults, simplifying the process of returning to a standard configuration. These settings collectively ensure that captured images meet the highest standards of clarity, color accuracy, and diagnostic utility, tailored to the specific requirements of different imaging scenarios.

In FIG. 9D, contact 290Z, activated through a mouse click or a touch-sensitive surface interaction with the first camera settings 620, displays a list of all available camera settings. Subsequently, by moving the contact, specific settings can be selected. For instance, the contact 290Z is moved to select third camera settings 622, which corresponds to the camera 604 located on the third shelf, as exemplified in FIG. 9E. As a result of this selection, the third image 614B is highlighted, visually signifying the camera 604 on the third shelf, and the corresponding third camera settings 622 are displayed, as depicted in FIG. 9F.

In some embodiments, an initiated contact 290AA depicted in FIG. 9E is triggered through a mouse click or a touch-sensitive surface interaction. In response to the initiated contact 290AA the fourth image 616B is highlighted and enlarged for enhanced visibility, making it more visible and prominent. Simultaneously, the corresponding fourth camera settings 623, corresponding to the camera 604 positioned on the fourth shelf, are displayed.

In certain advanced embodiments, the camera tab 205 can be enriched with a range of powerful features designed to enhance the experience and process control. These enhancements may include capabilities such as pan and zoom for detailed inspection, snapshot capture for documentation, synchronized camera feeds for comprehensive monitoring, image analysis tools for automatic anomaly detection, user-defined alerts for timely notifications, remote access for flexible control, historical data storage for quality assessment, and even augmented reality elements to provide real-time contextual information. It should be appreciated that these features could be seamlessly integrated into the interface through intuitive menus, buttons, or touch-sensitive controls, offering a versatile and comprehensive toolset to effectively manage and optimize their lyophilization processes.

FIGS. 10A-10D illustrate an advanced freeze-dryer interface utilized in the lyophilization processes, featuring shelf and cold trap configurations within the settings tab 206. Upon selecting the settings tab 206, indicated by the contact 290AB in FIG. 10A, the interface reorients itself, dedicating its display exclusively to the contents of the settings tab 206 while disengaging from other tabs. This transition is facilitated by interactions such as a mouse click or touch-sensitive surface contact at a location corresponding to the settings tab 206, as evident in FIG. 10A.

Within the settings tab 206, a graphical representation of the enclosure model 510 and the cold trap enclosure 526 with their associated configuration parameters is presented. The configuration parameters for the enclosure model 510 include individual text input fields describing the shelf enclosure configuration, such as the number of shelves text input field 510A, the shelf enclosure radial distance text input field 510B, first shelf height text input field 510C, second shelf height text input field 510D, third shelf height text input field 510E, fourth shelf height text input field 510F, fifth shelf height text input field 510G, shelf width text input field 510H, and shelf thickness text input field 510I. These text fields can be edited to make adjustments to the graphical representation of the enclosure model 510.

The shelf configuration parameters further include the shelf scale checkbox 510J and the shelf enclosure scale checkbox 510K. When the shelf scale checkbox 510J is enabled, it activates the shelf scale 524A, which is located within the enclosure model 510. This scale directly measures the weight of the shelves 512. As the freeze-drying process unfolds, and the solvent on the shelves gradually sublimates, the shelf scale 524A detects this change in weight. At the end of the freeze-drying process, it registers a lower weight compared to the initial reading, providing valuable data about the amount of solvent removed.

Conversely, the enclosure scale checkbox 510K, when enabled, activates the enclosure scale 524B, situated outside the enclosure model 510. This scale assesses the total weight of the entire enclosure. It is particularly accurate when a separated cold trap is in use, as any solvent collected on the external trap does not affect the measurements of the rest of the enclosure model 510. This differentiation between the shelf scale 524A and the enclosure scale 524B offers precise monitoring capabilities for various freeze-drying scenarios.

Both the shelf scale checkbox 510J and the shelf enclosure scale checkbox 510K offer flexibility in their activation within the freeze-drying interface. As shown in FIGS. 10A and 10B, these checkboxes can be enabled simultaneously, signifying that both the shelf scale 524A and the enclosure scale 524B are present and actively measuring weight changes during the freeze-drying process.

It should be appreciated that these checkboxes can be individually selected. For instance, initiating a contact 290AD, as illustrated in FIG. 10C, disables the shelf scale checkbox 510J, resulting in the removal of the shelf scale 524A from the configuration, as seen in FIG. 10D. This interaction, which can be triggered through a mouse click or a touch-sensitive surface, provides the freedom to customize scale measurements according to specific process requirements. Similarly, the enclosure scale checkbox 510K can be disabled, consequently removing the enclosure scale 524B from the configuration. This dynamic functionality ensures that the interface caters to a wide range of freeze-drying scenarios and measurement preferences.

The configuration parameters for the cold trap enclosure 526 of the setting tab 206 include individual text input fields describing the integrated cold trap configuration, which is activated when the integrated cold trap checkbox 520A is selected and separated cold trap configuration, which is activated when the separated cold trap checkbox 520B is selected. The term “integrated” emphasizes that the cold trap enclosure 526 is seamlessly incorporated into the design and structure of the enclosure model 510. Unlike a distinct or standalone component, the integrated cold trap is not a separate entity but rather an inherent feature of the shelf enclosure 511, designed to efficiently capture and collect the sublimated materials during the freeze-drying process.

Selecting the integrated cold trap checkbox 520A, as indicated by contact 290AC in FIG. 10B, deactivates the previously selected separated cold trap checkbox 520B while activating the integrated cold trap checkbox 520A. When the separated cold trap checkbox 520B is disabled, the cold trap 520 is removed from the setup. This includes the removal of specific components related to the cold trap 520, such as the collector 520C and the trap scale 520D, as shown in FIG. 10C. It is important to note that, in certain embodiments, the separated cold trap checkbox 520B and the integrated cold trap checkbox 520A can be simultaneously enabled to reflect instances when both an integrated cold trap and a separated cold trap are implemented.

FIGS. 11A-11L illustrate an advanced freeze-dryer interface utilized in the lyophilization processes, featuring a relay map and sensors/calibration configurations within the settings tab 206. In response to selecting the advance button 602B of the settings tab 206, indicated by the contact 290AE in FIG. 10D, the relay map 640 and the sensors/calibration map 650 are displayed. The relay map depicted in FIG. 11A features eight distinct relays: relay1 640A, relay2 640B, relay3 640C, relay4 640D, relay5 640E, relay6 640F, relay7 640G, and relay8 640H. Each relay is dynamically mapped to specific components of the enclosure model 510. In the default mapping depicted in FIG. 11A, relay1 640A corresponds to the condenser relay (e.g., “Condenser”), relay2 640B corresponds to the vacuum pump relay (e.g., “Vacuum”), relay3 640C corresponds to the heater relay (e.g., “Heater”), relay4 640D corresponds to the spare0 relay (e.g., “Spare0”), relay5 640E corresponds to the spare1 relay (e.g., “Spare 1”), relay6 640F corresponds to the spare2 relay (e.g., “Spare2”), relay7 640G corresponds to the spare3 relay (e.g., “Spare3”), and relay8 640H corresponds to the spare4 relay (e.g., “Spare4”).

The dynamic mapping ability facilitates real-time reassignment of physical relays to different software functions, providing heightened flexibility for relay troubleshooting and replacement scenarios. This ability proves particularly advantageous when a relay malfunctions and requires substitution. For instance, if relay1 640A ceases to function, it can seamlessly be replaced with any of the available spare relays (relay4-relay8). The remapping process involves reassigning the functions (e.g., condenser, vacuum, heater, spare0, spare1, spare2, spare3, spare4) of the relays to different physical relay components (e.g., relay1 640A, relay2 640B, relay3 640C, relay4 640D, relay5 640E, relay6 640F, relay7 640G, relay8 640H). This real-time adaptability ensures efficient maintenance and operational continuity in the freeze-drying system.

As an illustrative example, to remap the condenser function “Condenser” from relay1 640A to relay8 640H, the condenser function “Condenser” is selected as indicated by the contact 290AG in FIG. 11B. While maintaining contact with the touch-sensitive surface the selected condenser function “Condenser” moves with contact and overlaps with the fourth spare function “Spare4.” corresponding to the mapped location of relay8 640H, as depicted by the contact 290AH in FIG. 11C. Upon breaking contact with the touch-sensitive surface the condenser function “Condenser” is remapped to relay8 640H and the fourth spare relay “Spare4” is remapped to relay1 640A.

It should be appreciated that other remapping techniques can be employed. For example, in an alternative embodiment a drop-down menu (not illustrated) is implemented to select a specific relay destination (e.g., “Spare4”), which triggers the display of a drop-down menu containing all relay functions. After choosing a relay function from the menu, the relay functions are remapped accordingly. For instance, choosing relay8 640H from the menu provides access to a list of functions (e.g., condenser, vacuum, heater, spare0, spare1, spare2, spare3, spare4). Selecting “Condenser” from the menu remaps it to relay8 640H, while “Spare4” is remapped to relay1 640A when relay8 640H is chosen from the drop-down list.

In some embodiments, the configuration of relays is read from a dedicated configuration file. A configuration parser is employed to interpret and map the relay functions, providing a versatile and streamlined alternative to using the graphical user interface (GUI). This approach facilitates specific mapping settings to be stored, loaded, and adjusted independently or in synchronization with other functions, both locally and remotely. In some instances, the parser can be triggered from selection of various tabs, including the status tab 201, run/setup tab 202, functions tab 203, models tab 204, cameras tab 205, and settings tab 206. In some instances, the parser may activate during system boot, GUI initiation, system updates, maintenance, or calibration procedures. This flexibility ensures adaptability to diverse operational scenarios, optimizing the configuration of relays for efficient freeze-drying processes. Additionally, it is worth noting that, although not explicitly depicted, the parser can be directly activated from advanced settings accessible in the settings tab 206.

The sensors/calibration map 650 within the settings tab 206 facilitates the customization of sensor categories (e.g., P-primary, P-sensors, T-primary, T-sensor2, T-sensor3, T-sensor4, and T-sensor5). These sensor categories are tailored to specific sensor types with an optional link to a calibration file for calibration data for each sensor, as depicted in FIG. 11A-FIG. 11L. Temperature sensors include thermistors, thermocouples, Thermopiles, K-type sensors, infrared sensors, RTD (Resistance Temperature Detector), IC Temperature Sensors, Bimetallic Temperature Sensors, Fiber Optic Temperature Sensors, and the like. Pressure sensors encompass a variety of types, including vacuum tube thermocouples like DV-6, DV-4, and 531, as well as piezoelectric strain sensors, piezoresistive pressure sensors, capacitive pressure sensors, optical pressure sensors, resonant solid-state pressure sensors, magnetic pressure sensors, and strain gauge pressure sensors, among others.

It is contemplated that the system at least includes a primary pressure sensor, corresponding to “P-primary.” (650A) and a primary temperature sensor corresponding to “T-primary” (650C) both relevant for determining the phase states (e.g., solid, liquid, gas) of the solvent. In addition to these primary sensors, in some embodiments, the map integrates supplementary sensors for redundancy and comprehensive monitoring, including backup pressure sensors (e.g., P-sensor2 [650B]) and multiple temperature sensors (e.g., T-sensor2 [650D], T-sensor3 [650E], T-sensor4 ([650F], and T-sensor5 [650G]). In some embodiments, the primary pressure sensor (e.g., “P-Primary” [650A]) is positioned within the insulated shelf enclosure 511 and the secondary pressure sensor (e.g., “P-Sensor2” [650B]) is positioned within the trap enclosure 526. In some embodiments, the primary pressure sensor (e.g., “P-Primary” [650A]) is positioned within the trap enclosure 526 and the secondary pressure sensor (e.g., “P-Sensor2” [650B]) is positioned within the insulated shelf enclosure 511.

In some embodiments, the primary temperature sensor (e.g., “T-Primary.” [650C]) is operatively coupled to the shelves 512 at a thermally centered shelf location (e.g., second shelf as depicted in FIG. 11A). This thermally centered shelf location provides an average temperature value representative of the temperature of the solvent positioned on the shelves 512. In some embodiments, the primary temperature sensor (e.g., “T-Primary” [650C]) is operatively coupled to the shelves 512 at a non-thermally centered shelf location (e.g., first shelf, third shelf, fourth shelf, fifth shelf) that is more representative of the average temperature value of the solvent. In some embodiments, the secondary temperature sensors (e.g., “T-Sensor2” [650D], “T-Sensor3” [650E], “T-Sensor4” [650F], and “T-Sensor5” [650G]) are operatively coupled to each shelf.

In FIG. 11D, the initiation of sensor type selection includes an initiated action like a long press, double press, or other touch-sensitive input on the displayed sensor category type. This action prompts the appearance of a list of sensor type options, intelligently filtered based on the chosen sensor category. For example, opting for a pressure sensor category (e.g., P-primary or P-Sensor2) refines the options to pressure sensors like DV-6, DV-4, and 531. Conversely, selecting a temperature sensor category (e.g., T-primary or T-Sensor2, T-Sensor3, T-Sensor4, T-Sensor5) narrows down the choices to temperature sensors such as thermistors, thermocouples, and K-type sensors. Referring to FIG. 11D, contact 290AI displays a list, including “NC” (no connect), 531, DV-4, and DV6 for P-Sensor2. In FIG. 11E, with contact 290AJ, the list reveals options like “NC” (no connect), thermistor, K-type, and infrared for T-Sensor2. The subsequent action in FIG. 11F, with contact 290AK selecting “Thermistor,” results in modifying the second temperature sensor (T-sensor2) from being not connected (“NC”) to “thermistor”. It is worth noting that, for accurate readings, a thermistor should be connected, and a calibration file should be linked, although not explicitly depicted, similar methods can be referenced. These calibration files enhance measurement accuracy and reliability, ensuring that the freeze-drying process maintains precision and control.

FIG. 11G-11I illustrates the process of selecting and relocating a sensor, primarily for thermodynamic modeling purposes. As depicted in FIG. 11G, contact 290AJ selects “T-Sensor2” (650D), which is then dragged to a new position on the third shelf, as shown at contact 290AM in FIG. 11H. In some embodiments, “T-Sensor2” (650D) is highlighted within the sensors/calibration map 650. In some embodiments, a representation of “T-Sensor2” (650D) moved when dragged to a new position.

Upon releasing the touch-sensitive surface at contact 290AM, the position of “T-Sensor2” (650D) is dynamically remapped for the model utilized in FIGS. 8A-8E, now positioned on the third shelf. This strategic relocation serves thermodynamic modeling by providing insights into temperature variations at different locations within the freeze-dryer 110. It is noteworthy that the third shelf, being thermally centered, offers an additional advantage, serving as a reliable backup sensor in case the primary sensor “T-Primary” (650C) located on the second shelf encounters a malfunction. This dynamic capability enhances adaptability and ensures robust temperature monitoring for effective freeze-drying processes.

FIG. 11J-11L demonstrates the dynamic capability of relocating sensors within the settings tab 206. In FIG. 11J, the sensor “T-Sensor2” (650D), positioned on the third shelf, is selected using contact 290AN. Subsequently, the sensor is moved to the cold trap enclosure 526 as shown at contact 290AO depicted in FIG. 11K. This relocation capability provides strategic placement of sensors to monitor temperature variations in different zones of the freeze-dryer. The adaptability to move sensors from one location to another enhances the flexibility of the system, enabling the capability to optimize sensor positions based on specific process requirements.

FIGS. 12A-12D illustrate the remote access configuration of the advanced freeze-dryer along with a preview providing a visual representation of the interface on a remote device such as a smartphone. The remote access configuration includes a Wi-Fi/LAN configuration 660, a remote access configuration 670, and a webserver configuration 680 that are displayed in response to selecting the advance button 602B of the settings tab 206 while displaying the relay map 640 and the sensors/calibration map 650, as indicated by the contact 290AP in FIG. 11L. The Wi-Fi/LAN configuration 660, establishes network connections, enabling access to the internet and external servers for system updates and maintenance. It features a set of parameters, including a Wi-Fi/LAN enable toggle switch 660A for activating or deactivating the network, SSID 660B for the network name, Wi-Fi password 660C, IP address 660D, DNS server 660E, gateway 660F, subnet 660G, and RSSI (Received Signal Strength Indicator) 660H to gauge the strength of the Wi-Fi signal.

The remote access configuration 670 extends the capabilities of the system by enabling remote monitoring of the freeze-drying process. The remote access configuration 670 includes a remote access enable toggle switch 670A, which serves as a primary control for activating or deactivating remote access to the freeze-dryer. For enhanced security, the remote access configuration 670 further includes a userID 670H and password 670I. Additionally, the remote access configuration 670 includes menu toggle switches (e.g., remote status 670B, remote run/setup 670C, remote functions 670D, remote models 670E, remote camera 670F, and remote settings 670G) to selectively enable or disable remote access to specific menu tabs (e.g., the status tab 201, run/setup tab 202, functions tab 203, models tab 204, cameras tab 205, and settings tab 206).

In certain embodiments, the remote access configuration 670 incorporates a preview 690, enhancing the understanding of how remote access is presented on a mobile device, such as a smartphone 692 (with a display generation component) or computer 720 (with a display generation component). This preview facilitates efficient navigation through the menu tabs and items with gestures similar to the configuration on the remote device like swipe left, swipe right, swipe down, and swipe up (or scroll left, scroll right, scroll up, scroll down as is the case for a computer).

Swipe/scroll gestures (e.g., swipe left/right and up/down, scroll left/right and up/down) facilitate seamless navigation through menu tabs and items, accommodating limited screen real estate on smaller devices. For instance, in FIGS. 12A and 12B, the results of a left swipe gesture, demonstrated by the contact 290AQ, initiates the sequence menu tab switch. This provides a smooth transition from the remote display of the status menu to the preview of the remote device displaying the run/setup tab menu. Similarly, a right swipe gesture (not explicitly shown) switches the display from the remote display of the run/setup tab on the preview of the remote device to the status tab menu.

FIGS. 12B and 12C depict the results of a downward swipe gesture, exemplified by the contact 290AR, facilitates the switch between sequence items within a menu tab. For instance, fluidly transitioning from the phase plot 230 to the transient pressure plot 210, transient temperature plot 220, and transient mass plot 270 of the run/setup tab menu on the preview of the remote device. This offers a practical solution for devices with limited screen space, facilitating navigation through detailed configurations effortlessly.

FIGS. 12C and 12D depict the result of an upward swipe gesture, exemplified by the contact 290AS that reverts to the previous sequence in the menu item tab, essentially navigating the preview back to the prior configuration settings on the remote device. These intuitive gestures significantly enhance the accessibility of the freeze-dryer control system, ensuring a user-friendly and efficient experience for monitoring and controlling the freeze-drying process from a distance.

The webserver configuration 680 involves settings related to a webpage that updates and monitors the functionality of the lyophilization processes. The webserver is enabled or disabled by toggling the webserver enable toggle switch 680A and includes information such as the webserver IP address 680B. Although not explicitly depicted, the webserver configuration 680 may include parameters like port numbers, security settings, and communication protocols for accessing the freeze-dryer remotely through a web interface. The interplay of these configurations collectively ensures efficient network connectivity, secure remote access, and friendly webserver interactions within the freeze-dryer control system.

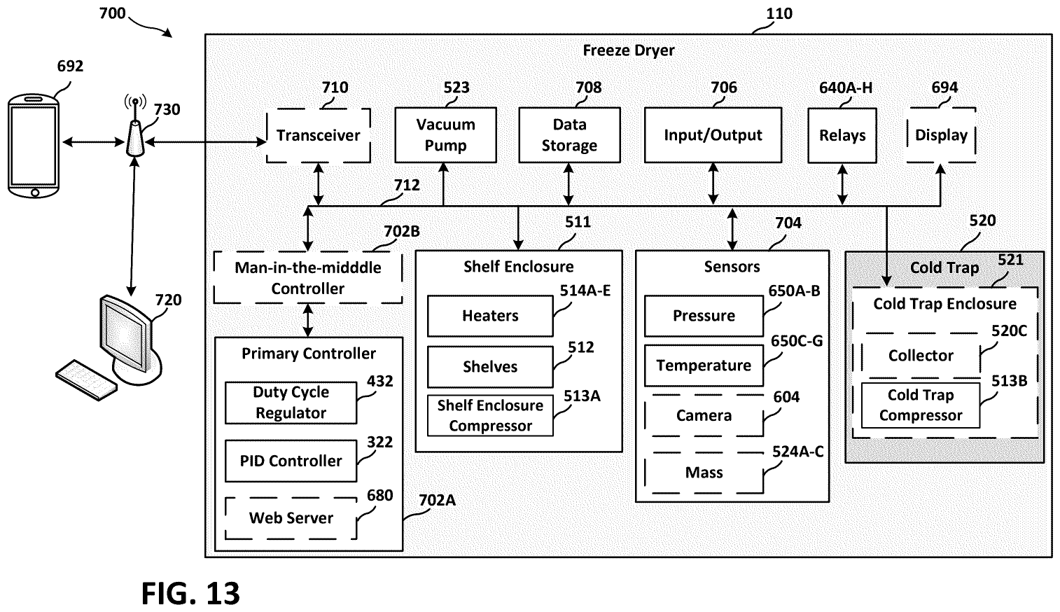

FIG. 13 illustrates a conceptual data flow diagram illustrating the connections between different means/components of a freeze-drying system 700. In some embodiments, the freeze-drying system corresponds to a standalone freeze-dryer 110. In some embodiments, the freeze-drying system corresponds to a freeze-dryer 110 networked through an access point 730 to remote devices such as a smartphone 692 or a computer 720.

The freeze-dryer 110 optionally includes a transceiver 710 enabling wireless communication with the external devices (smartphone 692, computer 720, etc.) through the access point 730. The transceiver 710 is designed to support various forms of wireless communication technologies, providing flexibility in how the system interacts with these devices. For instance, in some embodiments, transceiver 710 provides means to enable connectivity through Wi-Fi, suitable for transmitting detailed data and control commands. Alternatively, in some embodiments, the transceiver 710 provides means to enable connectivity through Bluetooth technology, beneficial over shorter distances, offering a convenient option for nearby monitoring and control. In some embodiments, transceiver 710 provides means to enable connectivity through other wireless standards and frequencies, including but not limited to Zigbee, Z-Wave, or other proprietary protocols, allowing it to adapt to different operational environments and preferences. This diversity in wireless communication options facilitates versatile interactions with the freeze-dryer, accommodating various scenarios without being restricted to a single mode of connectivity.

The freeze-dryer 110 includes a data storage component 708 that manages and stores relevant information for the operation, such as configurations and logs. In various embodiments, the data storage 708 means includes non-volatile memory such as flash memory, hard disk drives, solid-state drives, or other suitable storage media. The stored data can include system settings, historical process data, sensor readings, and other information relevant to the freeze-drying process. The versatility of data storage options allows for efficient record-keeping and retrieval, contributing to the overall functionality and adaptability of the freeze-drying system. The data stored serves as a valuable resource for system monitoring, analysis, and optimization, enhancing the ability to manage and control the freeze-drying process effectively.

The freeze-dryer 110 incorporates input/output interfaces (I/O) 706, providing a means for communication between the freeze-drying system and external devices. These I/O interfaces serve as versatile conduits for bidirectional communication with external devices. These interfaces enable seamless data exchange, command input, and information transfer. The I/O interfaces include standard ports such as USB, Ethernet, GPIO, displays, keyboards, mice, and touchscreens (e.g., a display generation component). In some embodiments, the freeze-dryer 110 includes serial ports like RS-232 and RS-485, facilitating reliable communication with older equipment or devices requiring point-to-point connections. In some embodiments, the input/output interfaces (I/O) 706 include wireless communication modules, including Wi-Fi, Bluetooth, NFC (Near Field Communication), RFID (Radio-Frequency Identification), and ZigBee, enhance connectivity options in diverse industrial contexts. In some embodiments, the input/output interfaces (I/O) 706, includes analog and digital I/O ports that support the integration of various sensors and control devices, ensuring precise monitoring and control in freeze-drying processes. In some embodiments, the input/output interfaces (I/O) 706 includes audio/visual interfaces such as HDMI, VGA, and audio jacks that enable connections to external displays, projectors, or sound systems for effective communication. In some embodiments, the input/output interfaces (I/O) 706 includes data acquisition systems (DAQ) configured to enhance sophisticated data gathering and analysis, beneficial for research or industrial applications with stringent monitoring requirements. In some embodiments, the input/output interfaces (I/O) 706 include expansion ports or slots for future enhancements, allowing the freeze-dyer 110 to adapt and grow. In some embodiments, the input/output interfaces (I/O) 706 includes a display generation component, such as a liquid crystal display (LCD), organic light-emitting diode (OLED), electronic paper display (ESP), active matrix OLED, (AMOLED), thin-film transistor LCD (TFT-LCD) light-emitting diode (LED), micro LED, etc. In some embodiments, the display generation component is integrated into the freeze-dyer 110 or is separate as a display (e.g., computer display).

The freeze-dryer 110 utilizes one or more controllers (e.g., primary controller 702A, man-in-the-middle controller 702B, microcontroller, etc.) as central processing units, each adept at managing various functions for an efficient freeze-drying process. These controllers may encompass a diverse range of models, including but not limited to ESP8266, ESP32 for their Wi-Fi capabilities; ARM processors for their balance of performance and power efficiency; Intel Core i5 and Core i7 processors for demanding computing tasks; as well as other processors like the Raspberry Pi Broadcom SoCs, Atmel AVR series, Texas Instrument MSP430, STM32 microcontrollers, and Qualcomm Snapdragon SoCs, etc. The choice of controllers is dependent on the specific operational needs, such as wireless communication, processing power, energy efficiency, or interface compatibility. The one or more microcontrollers integrate a duty cycle regulator 432, a PID (Proportional-Integral-Derivative) controller 322, and web server 680. The duty cycle regulator 432 optimizes the power output of heating elements 514A-514F for energy efficiency and precision in temperature control. The PID (Proportional-Integral-Derivative) controller 322 is included for enhancing temperature regulation, adjusting parameters dynamically based on real-time sensor feedback, ensuring stable and accurate control within the freeze-drying environment. Furthermore, the optional web server 680 is incorporated, offering remote access and monitoring capabilities. This allows for seamless communication with external devices like smartphones 692 (with a display generation component) or computers 720 (with a display generation component), enabling the ability to remotely monitor, control, and receive updates on the freeze-drying process through a network connection.

As depicted in FIG. 13, the man-in-the-middle controller 702B is interposed between the primary controller 702A and one or more system peripherals, including but not limited to sensors 704, relays 640A-640H, display generation components (e.g., display 694, smartphones 692, computers 720), and actuators associated with the system bus 712, pressure sensors 650A-650B, and temperature sensors 650C-650G. This placement enables the man-in-the-middle controller 702B to intercept, modify, override, or supplement control signals and data exchanges between the primary controller 702A and the connected peripherals. The primary controller 702A typically comprises a factory-installed control unit with locked or non-configurable firmware, intended to manage the freeze-drying process according to fixed logic or proprietary instructions. In contrast, the man-in-the-middle controller 702B is a configurable module, capable of running custom firmware, user-defined control algorithms, and dynamic override logic based on real-time sensor data or external inputs. This configurability allows operators or system integrators to augment the capabilities of the freeze-dryer 110 without requiring modification to the factory-supplied firmware or hardware of the primary controller 702A. Additionally, the man-in-the-middle controller 702B may act as a supervisory controller, implementing higher-order control schemes (e.g., predictive, adaptive, or AI-assisted control) layered on top of the base operations performed by the primary controller 702A. It should be appreciated that the man-in-the-middle controller 702B can include all the features of the primary controller 702A (e.g., duty cycle regulator 432, PID controller 322, webserver 680, etc.).

The shelf enclosure 511 of the freeze-dryer 110 is designed to facilitate the freeze-drying process. The shelf enclosure 511 includes one or more heating elements 514A-514F placed to ensure uniform heat distribution across all enclosed shelves 512. The one or more heating elements 514A-514F provide thermal energy to sublimate the solvent, although the precise configuration and number of heating elements 514A-514F may vary according to specific design requirements. The one or more heating elements 514A-514F are thermally coupled to a set of shelves 512, which are arranged to efficiently accommodate the items to be freeze-dried. These shelves 512 are designed for optimal placement and spacing to maximize surface area exposure and ensure even freeze-drying of the second substance (e.g., food, pharmaceutical, etc.). Additionally, the shelf enclosure is equipped with a shelf enclosure compressor 513A to cool/freeze the product within the enclosure environment.

The shelf enclosure 511 within the freeze-dryer 110 functions as a versatile vacuum chamber, sustaining a high vacuum environment during freeze-drying. The enclosure design, adaptable to various shapes such as a cylinder (chosen for material efficiency), may incorporate features like viewports or access ports for monitoring and maintenance. Crafted from materials like aluminum, stainless steel, or other alloys, the shelves 512 ensure optimal accommodation of items designated for freeze-drying, featuring designs that, in some embodiments, include specific coatings for enhanced thermal conductivity or anti-corrosive properties.

The shelf enclosure 511 includes one or more heating elements 514A-514F positioned for consistent thermal energy distribution across all shelves 512. Heater types may include electrical resistance heating elements, UV heating elements, thermal radiation heating elements, induction heating elements, Peltier elements, and the like, offering flexibility in the freeze-drying process. Additionally, the enclosure integrates a shelf enclosure compressor 513A, exemplified by a freezer unit capable of reaching low temperatures below 40° F. The shelf enclosure compressor 513A, in various embodiments, includes a single-stage or multi-stage unit, ensures efficient cooling, contributing to the controlled freeze-drying environment.

The vacuum-tight features of the enclosure, including seals and vacuum-rated materials, contribute to sustaining the high vacuum for effective freeze-drying. The design, not limited to a specific shape, offers scalability and adaptability to different operational scales. This comprehensive configuration encompasses various heater types, shelf designs, enclosure shapes, and compressor capabilities, ensuring a flexible and efficient freeze-drying process within the freeze-dryer 110.

Within the freeze-dryer 110, an array of sensors 704 monitors various aspects of the freeze-drying process. The sensors 704 include, but are not limited to, pressure sensors (650A-650B), temperature sensors (650C-650G), cameras 604, and mass sensors (524A-524C). The pressure sensors (650A-650B), such as vacuum tube thermocouple types (e.g., 531, DV-4, DV-6, etc.), and capacitance manometers, are instrumental in accurately gauging the vacuum levels within the freeze-dryer 110. Temperature sensors (650C-650G), including thermistors, thermocouples, RTDs (Resistance Temperature Detectors), and infrared sensors, provide precise temperature readings for process control. Cameras 604, potentially comprising digital or infrared variants, offer real-time visual monitoring of the product and interior conditions. Mass sensors (524A-524C), like strain gauges, piezoelectric gauges, and load cells, are for assessing the change in mass of the product during drying, offering insights into the drying progress. The integration and variety of these sensors 704 facilitate a comprehensive and nuanced understanding of the freeze-drying process, enabling fine-tuned control and optimization of the lyophilization cycle.

The freeze-dryer 110 features a cold trap 520 configured to provide and may be separate or integrated with the shelf enclosure 511. The cold trap 520, in certain embodiments, corresponds to an external component, comprising an optional cold trap enclosure 526, an optional collector 520C, and an optional cold trap compressor 513B. The cold trap enclosure 526 is designed to house the freezing apparatus and may be separate or integrated with the shelf enclosure 511. In specific configurations, the shelf enclosure 511 doubles as the cold trap enclosure 526, streamlining the design. The optional collector 520C aids in trapping and collecting volatile substances during the drying process. The optional cold trap compressor 513B, akin to the shelf enclosure compressor 513A, is responsible for cooling or freezing the environment within the cold trap 520. This multifaceted system, with optional components, ensures the effective removal of vapors from the freeze-drying chamber, contributing to the overall success of the freeze-drying operation.

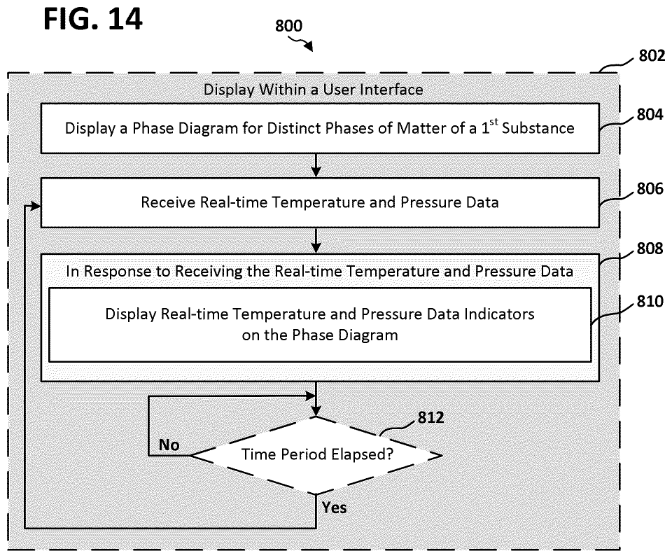

FIG. 14 depicts a flow diagram outlining method 800, for the dynamic visualization of real-time temperature and pressure readings for a second substance (e.g., food, pharmaceutical, etc.) on a phase diagram representing a first substance (e.g., water, solvent, etc.).

The system interfaces with a display generation component to initiate the lyophilization process, presenting the outcomes within a distinct graphical user interface 802 such as the run/setup tab 202. In some embodiments, the graphical user interface 802 operates independently of the underlying operating system, providing the capability to halt or restart the interface without affecting core operating system functionality.

At step 804, the system displays a phase diagram that offers a comprehensive illustration of the equilibrium states of temperature and pressure, delineating distinct phases of matter (e.g., solid, liquid, gas, etc.) pertaining to the first substance (e.g., solvent, water, etc.).

The system receives real-time temperature data of a second substance (e.g., food, pharmaceutical, etc.) and real-time pressure data of the second substance (e.g., food, pharmaceutical, etc.) from one or more sensors (e.g., pressure sensors, temperature sensors), as at step 806. In response to receiving real-time temperature data of a second substance (e.g., food, pharmaceutical, etc.) and real-time pressure data of the second substance (e.g., food, pharmaceutical, etc.), at step 808 the system displays, via the display generation component, one or more indicators (e.g., markers, graphical elements) overlaid on the phase diagram of the first substance (e.g., water, solvent, etc.), where at least one indicator of the one or more indicators represents the real-time temperature data of a second substance and real-time pressure data of the second substance as a coordinate point on the phase diagram, as depicted in step 810.

In some embodiments, the temperature and pressure data of the second substance function analogously to spatial coordinates (e.g., latitude and longitude), and the phase diagram operates analogously to a map. In this sense, the interface acts like a navigator (or a tracker), where the indicator represents the “location” of the second substance in phase space relative to equilibrium boundaries of the first substance. Just as a GPS system shows a moving position on a geographic map, the display component shows how the second substance moves through different phase regions (e.g., solid, liquid, vapor) over time based on real-time sensor data. This analogy helps visualize the second substance's thermodynamic journey and provides intuitive insight into whether the current processing conditions (e.g., sublimation, desorption) are within desired phase states for the first substance.

In step 806, the system acquires real-time temperature and pressure measurements of the second substance (e.g., food, pharmaceutical, etc.), facilitated by one or more sensors such as pressure sensors or temperature sensors. These sensors ensure precise data collection, for subsequent analysis. In step 808, the system processes the received real-time temperature and pressure data of the second substance (e.g., food, pharmaceutical, etc.). Upon completion of this data processing, the system proceeds to step 810, where it dynamically generates and displays via the display generation component, one or more graphical indicators. These indicators visually represent the real-time temperature and pressure data of the second substance (e.g., food, pharmaceutical, etc.), juxtaposed against the phase diagram of the first substance (e.g., water, solvent, etc.). This graphical representation offers immediate insight into the current state of the second substance (e.g., food, pharmaceutical, etc.) within the context of the phase diagram, aiding in monitoring and decision-making processes.

In practice, receiving real-time data and displaying one or more indicators representing the real-time data in on the phase diagram is continuously refreshed periodically after a predetermined time period (e.g., 1 second, 5, seconds, 15 seconds, etc.) as depicted in step 812, which provides the status of the process (e.g., lyophilization process). This ensures timely and consistent monitoring of the ongoing process.

In some embodiments, the system further displays one or more indicators representing previous temperature and pressure data of the second substance (e.g., food, pharmaceutical, etc.) in relation to the phase diagram. In integrating historical temperature and pressure data with the phase diagram, valuable insight is gained into the process dynamics and historical performance as it facilitates tracking the evolution of temperature and pressure conditions over time to provide a more comprehensive understanding of the behavior and trends of the process. This augments the ability to make informed decisions and adjustments and facilitates improved process control and optimization.

Upon receiving real-time temperature and pressure data of the second substance (e.g., food, pharmaceutical, etc.), the system integrates this information into one or more lists containing previous temperature and pressure data of the second substance (e.g., food, pharmaceutical, etc.). This systematic accumulation of data enables comprehensive tracking of temperature and pressure conditions throughout the process. Moreover, it facilitates comparative analysis between current and past data points, providing insights into trends, patterns, and potential anomalies. Ultimately, this data-driven approach enhances the capacity to monitor and optimize the process, ensuring precision and efficiency in managing temperature and pressure parameters.

The system further accommodates receiving and displaying additional substances. For example, in some embodiments, the system optionally receives real-time temperature and pressure data of the third substance. In certain embodiments, third substance corresponds to the first substance (e.g., water, solvent, etc.) or the second substance (e.g., food, pharmaceuticals, etc.). In certain embodiments, third substance corresponds to a substance distinct from the first substance (e.g., water, solvent, etc.) or the second substance (e.g., food, pharmaceuticals, etc.) such as the surface of a cold trap.

In response to receiving real-time temperature and pressure data from a third substance, such as the surfaces of the cold trap, the system displays, via the generation component, one or more indicators representing the real-time temperature and pressure data of the third substance in relation to (or overlaid on) the phase diagram. Notably, throughout most of the lyophilization process, the surfaces of the cold trap typically reside within the “solid” phase of the equilibrium phase diagram of the first substance (e.g., water, solvent, etc.). This positioning signifies a favorable location for vapor condensation of the first substance (e.g., solvent, water, etc.).

In some embodiments, the system displays, via the display generation component, one or more indicators overlaid on the phase diagram of the first substance (e.g., water, solvent, etc.), where at least one indicator represents the real-time temperature data and real-time pressure data of the third substance as a coordinate point on the phase diagram. In some embodiments, the third substance corresponds to a condensate of the first substance (e.g., water, solvent, etc.) collected at a location remote from the second substance such as the condensate (e.g., ice, glacier) of the trap measured by the temperature-pressure data 238 (FIGS. 6A-6R). This contextualization of previous temperature and pressure data of the third substance can assist in identifying trends, patterns, and potential deviations from expected behavior particularly when juxtaposing with the phase diagram of the first substance (e.g., water, solvent, etc.).

In some embodiments, the system adds the real-time temperature and pressure data of the third substance to one or more lists that include previous temperature and pressure data of the third substance. This systematic aggregation of data allows for the creation of comprehensive records that capture the temporal evolution of temperature and pressure conditions within the system. For instance, as the process unfolds, the system continuously updates these lists with new measurements, thus providing a historical perspective on thermal and pressure dynamics. By maintaining such detailed records, it is possible to analyze how temperature and pressure profiles have evolved over time, identify recurring patterns, and pinpoint any irregularities or anomalies that may require attention.

In some embodiments, the system displays, via the display generation component, a first equilibrium phase of matter indicator representing a first equilibrium phase of matter of the first substance (e.g., water, solvent, etc.). For instance, when the phase diagram of water indicates that the real-time temperature and pressure corresponds to the presence of water in its solid state, the system promptly displays a corresponding indicator “solid” in the dashboard 260 to signify the current phase is “solid”. This visual cue serves to provide instantaneous feedback regarding the current state of the first substance (e.g., water, solvent, etc.), derived from the real-time temperature and pressure data of the second substance (e.g., food, pharmaceutical, etc.), which includes food, pharmaceuticals, and more. Further, this removes any ambiguity from the real-time temperature and pressure data of the second substance (e.g., food, pharmaceutical, etc.) overlaid on the phase diagram of the first substance (e.g., water, solvent, etc.) that corresponds to the first equilibrium phase of matter (e.g., “solid”) of the first substance (e.g., water, solvent, etc.). In aligning these displayed indicators with the phase diagram, it is possible to quickly interpret thermal and pressure conditions relative to the equilibrium phases of the first substance (e.g., water, solvent, etc.), thereby fostering a more intuitive grasp of the process dynamics.

These real-time updates are dynamic. For example, in some embodiments, upon detecting a transition in the real-time temperature and pressure data of the second substance (e.g., food, pharmaceutical, etc.) indicating a crossing of a phase boundary delineating distinct phases of matter of the first substance (e.g., water, solvent, etc.), the system dynamically adjusts the displayed indicators to reflect this change. Specifically, the system discontinues the presentation of the first equilibrium phase of matter indicator, such as “solid”, and promptly replaces it with a corresponding indicator representing the newly attained equilibrium phase of matter or phase transition of matter, for instance, “gas” or “sublime”. This seamless transition in the displayed indicators facilitates prompt information of the evolving state of the first substance (e.g., water, solvent, etc.) as it transitions between different phases in response to variations in temperature and pressure. In providing real-time updates aligned with phase transitions, the system enhances the ability to monitor and interpret the dynamic behavior of the substances involved, facilitating informed decision-making during the process.

In accordance with some embodiments, the system dynamically manages the display of historical temperature and pressure data to maintain relevance and clarity over time. This adaptive approach involves ceasing the display of specific temperature and pressure data portions after a predefined time period has elapsed since their reception. For example, as illustrated in FIGS. 2A and 2B, historical pressure and temperature data may be depicted for a limited duration, such as 60 seconds, ensuring that the status of only recent and pertinent information remains visible. Additionally, indicators corresponding to data older than a designated threshold, such as 5 hours, are removed from display, as depicted in FIGS. 5B-6R. This systematic removal of outdated data segments optimizes the visual representation, preventing clutter and enabling a focus on the most relevant and current information pertaining to the phase diagram of the first substance (e.g., water, solvent, etc.) and its associated dynamics with the second substance (e.g., food, pharmaceutical, etc.).

In some embodiments, the system employs a fading mechanism to gradually diminish the display of historical temperature and pressure data over time, enhancing visual continuity and experience. When a predetermined time period has passed since the reception of previous temperature and pressure data of the second substance (e.g., food, pharmaceutical, etc.), the system initiates a fading process (not shown in the figures). That is, rather than abruptly removing indicators as outlined in FIGS. 5B-6R, the fading technique gradually reduces their visibility, providing a smoother transition and preserving contextual awareness of time. This approach ensures that recent data remains prominent while subtly indicating the age of older data segments. By fading out outdated information in accordance with elapsed time, the system optimizes the display presentation, maintaining clarity and facilitating intuitive interpretation of the phase diagram dynamics and process evolution.

In some embodiments, the system implements a fading mechanism for the display of previous temperature and pressure data, with the degree of fading determined by the chronology of the data. As conceptually described, indicators corresponding to older temperature and pressure data are faded gradually, with the intensity of fading increasing as the data becomes more dated. This chronological fading approach ensures that recent data retains prominence, appearing less faded, while older data gradually fades into the background. By aligning the degree of fading with the chronological order of the data, the system effectively prioritizes the visibility of recent information, maintaining clarity and facilitating informed decision-making based on the most relevant and up-to-date data.

The system employs visual differentiation techniques to distinguish between current and previous temperature and pressure indicators. For instance, in some embodiments, the current temperature and pressure indicators, depicted as large grey circles for clarity, stand out prominently from the smaller black circles representing previous data, as shown by indicator 236A in FIGS. 5B-6R. This visual contrast enhances the discernibility of real-time data points from historical ones, enabling quick identification of the most recent measurements. Adopting distinct shapes or colors for current and previous indicators helps the system enhance visual clarity that aids in interpreting the displayed information with precision and efficiency.

It is important to note that the phases of the phase diagram of water depicted in the FIGS. 5A-6D are for clarity only. That is, although not all the phases of matter are depicted, the system accounts for all the distinct phases of matter. For example, the first being phase “solid”, such as “ice”, the second phase a “gas”, such as “water vapor”, and a third phase of “liquid”, or simply “water”. These phase classification delineates the equilibrium conditions of the first substance (e.g., water, solvent, etc.), illustrating transitions between different phases based on variations in temperature and pressure. Acknowledgement of the diverse phases of matter involved, including solid, liquid, and gas, the system provides a comprehensive framework for understanding the dynamic interplay between temperature, pressure, and phase. This characterization enhances the applicability of the system across various applications from cryogenics to vaporization processes.

In some embodiments, first substance (e.g., water, solvent, etc.) is a pure substance, exemplified by substances such as water. This designation emphasizes the homogeneity and chemical composition of the first substance (e.g., water, solvent, etc.), establishing a clear reference point for analyzing its behavior in relation to temperature and pressure variations. Often, for simplicity, specific reference is made to water as the first substance (e.g., water, solvent, etc.), underscoring its significance and prevalence in various applications.

In some embodiments, the second substance (e.g., food, pharmaceutical, etc.) includes the first substance. Frozen food exemplifies these substances, as the first substance (e.g., water, solvent, etc.) is an integral part of food, particularly when understanding food preservation. As such, understanding the interplay of the first substance (e.g., water, solvent, etc.) within the second substance (e.g., food, pharmaceutical, etc.) is important for phases of matter processes.

As an example, the cooling curves between pure substances and systems comprising two or more components are different. In a one-component system (e.g., water), the melting/freezing temperature of any pure material remains singular and constant at a specific value under constant pressure. At this temperature, the coexistence of the liquid and solid phases occurs in equilibrium. As the substance undergoes cooling, its temperature gradually decreases until reaching the melting/freezing point. Upon reaching this temperature, the material initiates the crystallization process, accompanied by the release of latent heat at the interface between the solid and liquid phases. This latent heat maintains a consistent temperature throughout the material. Subsequently, as solidification concludes, the cooling process resumes steadily. The interruption in the cooling process during solidification serves as a marker for identifying the melting/freezing point of a material on a time-temperature curve.

In contrast, for systems comprising two or more components, the temperature range over which the solid and liquid phases coexist is broader. Instead of a single melting temperature, the system now features two distinct temperatures: the liquidus temperature (point 362B) and the solidus temperature (point 362C) as depicted in FIG. 5B-5C. The liquidus temperature (point 362B) represents the temperature at which the system is entirely liquid, while the solidus temperature (point 362C) indicates the temperature at which the system is completely solid. Between these two distinct points, the liquid and solid phases coexist in equilibrium.

When the liquidus temperature (point 362B) is reached, solidification initiates, leading to a reduction in the cooling rate due to latent heat evolution. This reduction in cooling rate alters the gradient of the cooling curve, as illustrated in the bent curve in FIGS. 5B-5C between the liquidus temperature (point 362B) and solidus temperature (point 362C). After solidification is complete at the solidus temperature (point 362C), the cooling rate changes again, allowing the temperature of the solidus to be determined. These variations in the gradient of the cooling curve facilitate the identification of the liquidus and solidus temperatures, as illustrated in FIGS. 5B-5C.

The amount of the first substance (e.g., water, solvent, etc.) in the second substance (e.g., food, pharmaceutical, etc.) is an important interplay to understand as this will affect the amount of freezing time and lyophilization time. The system employs various methodologies to estimate the water content removed from the food, a particularly pertinent aspect for the lyophilization process and displays this estimate as a metric. That is, the system estimates a quantity of mass of the first substance (e.g., water, solvent, etc.) extracted from the second substance (e.g., food, pharmaceutical, etc.) and displays a mass indicator in the dashboard 260 (e.g., 0.00 kg in FIG. 5A-5C) corresponding to the estimated quantity of mass of the first substance (e.g., water, solvent, etc.) extracted from the second substance (e.g., food, pharmaceutical, etc.). This mass indicator offers valuable insights into the progress of the lyophilization process, enabling informed decision-making regarding subsequent steps in the procedure.

In some embodiments, the estimation of the mass of the first substance (e.g., water, solvent, etc.) extracted from the second substance (e.g., food, pharmaceutical, etc.) is modeled based on the energy applied to the second substance (e.g., food, pharmaceutical, etc.). This modeling approach accounts for thermodynamics of the energy applied to the frozen food, demonstrating that a portion of the energy is directed towards sublimation while another portion is dissipated as entropy. The setup of this modeling framework is illustrated in transient mass plot 270 of FIGS. 6A-6R, providing a visual representation of the cumulative mass distribution during the lyophilization process. By integrating energy considerations into the estimation process, the method offers a comprehensive understanding of the dynamics involved in substance extraction during the lyophilization process.

In some embodiments, the estimation of the mass of the first substance (e.g., water, solvent, etc.) extracted from the second substance (e.g., food, pharmaceutical, etc.) is modeled based on changes in weight, either of the food itself or of the water. For instance, direct measurements from the shelf scale 524A, as depicted in FIGS. 10A-10C, during the lyophilization process reveal a gradual decrease in weight as water sublimates off. Similarly, measurements from the enclosure scale 524B, as depicted in FIGS. 10A-10C, will reflect this change if the cold trap 520 is decoupled from the mass of the food. Conversely, the trap scale 524C, as depicted in FIGS. 10A-10C, will register an increase in mass of the water directly during the lyophilization process, indicating a heavier load. By monitoring these alterations in weight, the system can deduce the amount of the first substance (e.g., water, solvent, etc.) that has been extracted during the process. This modeling technique offers a practical and efficient means of estimating substance extraction, empowering the system to assess the progress of the lyophilization process and make informed decisions about subsequent steps. Moreover, by relying on changes in weight as a basis for estimation, the method ensures a straightforward and reliable approach to quantifying substance extraction dynamics.

In addition to the mass estimate in the dash board 260, the duty cycle information is another important aspect to understand and display. As part of thermodynamics process, the system promotes the sublimation of the first substance (e.g., water, solvent, etc.) by effectively shifting the real-time temperature of the second substance (e.g., food, pharmaceutical, etc.) from the “solid” or “ice” side to the “gas” or “water vapor” of the phase diagram of the first substance (e.g., water, solvent, etc.). To realize this “shift” the system applies power to power diffusers that are exemplified by one or more heating elements 514A-514F positioned for consistent thermal energy distribution across all shelves 512, as illustrated in FIGS. 8A-8E. The amount of energy applied to the one or more heating elements 514A-514F is characterized in real time as PWM (Pulse Width Modulation): a metric displayed in the dashboard 260, corresponding to real-time duty cycle information concerning the energy signal applied to the second substance (e.g., food, pharmaceutical, etc.). In practice, this PWM signal can vary from −1 (disabled) to 99, representing 100% power. Notably, other ranges are equally valid.

In some embodiments, the system receives real-time duty cycle information of an energy signal applied to the second substance (e.g., food, pharmaceutical, etc.). The system then displays, via the display generation component, at least a portion of the real-time duty cycle information corresponding at least to the PWM metric in the dashboard 260. This real-time duty cycle metric provides an important insight into the operational characteristics of the energy source utilized in the process as it can indicate how “hard” the system is “pushing” the lyophilization process.

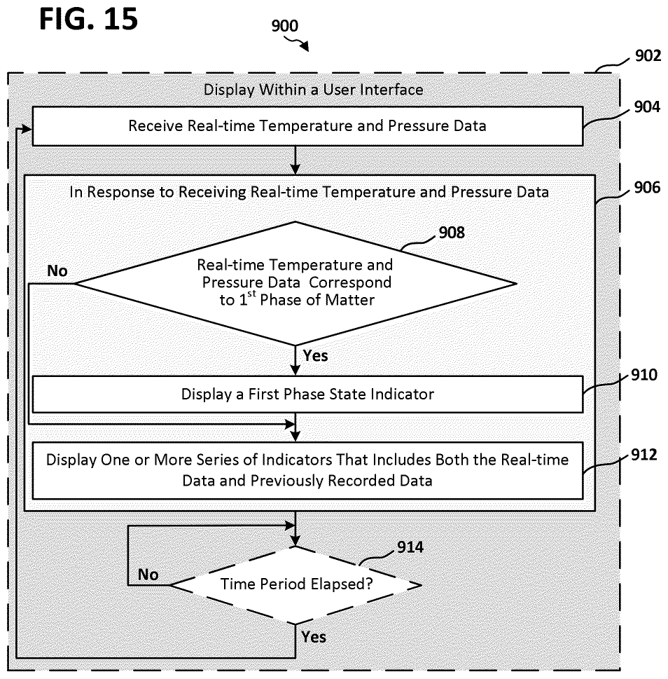

FIG. 15 illustrates a flow diagram outlining method 900, which dynamically visualizes real-time temperature and pressure readings for a second substance (e.g., food, pharmaceuticals, etc.), along with one or more previous temperature and pressure readings for the second substance (e.g., food, pharmaceutical, etc.), and a current equilibrium phase of matter indicator of a first substance (e.g., solvent, water, etc.). The system interfaces with a display generation component to initiate the lyophilization process, presenting the outcomes within a distinct graphical user interface 902. In some embodiments, the graphical user interface 902 operates independently of the underlying operating system, providing the capability to halt or restart the interface without affecting core operating system functionality.

At step 904, the system receives real-time temperature data and pressure data of the second substance (e.g., food, pharmaceutical, etc.). In some embodiments, the system acquires real-time temperature and pressure data of the second substance (e.g., food, pharmaceutical, etc.) from one or more sensors (e.g., pressure sensors, temperature sensors). In response to receiving the real-time data, the system displays as at step 906, via the display generation component, one or more series of indicators as depicted in step 912. Each indicator represents a point in one or more sequences of data of the second substance, (e.g., food, pharmaceutical, etc.) which includes both the real-time data and previously recorded data.

In some embodiments, displaying the series of indicators corresponds to a single set of data, such as the phase data (e.g., indicators representing the temperature-pressure data 236) of the phase plot 230 depicted in FIGS. 6A-6R. These indicators can be distinguished by at least one visual attribute or animation, providing a visual representation of chronology in the sequences of temperature and pressure data of the second substance (e.g., food, pharmaceutical, etc.) on the display generation component. For instance, indicators representing the temperature-pressure data 236, although not explicitly depicted, can include fading or colorization based on chronology.

In some embodiments, displaying the one or more series of indicators corresponds to multiple sets of data. For example, displaying the one or more series of indicators corresponds to displaying the pressure data (e.g., the indicators representing the pressure data 216) independent of the temperature data (e.g., the indicators representing the temperature data 226). As depicted in FIGS. 6A-6R one or more series of indicators are distinguished by positions with the pressure data (e.g., the indicators representing the pressure data 216) depicted in transient pressure plot 210 and the temperature data (e.g., the indicators representing the temperature data 226) depicted in transient temperature plot 220. In some embodiments, the one or more series of indicators are distinguished by at least one visual attribute, position, or animation, providing a visual representation of chronology in the sequences of temperature and pressure data of the second substance (e.g., food, pharmaceutical, etc.) on the display generation component.

At step 908 the system has to determine whether the real-time temperature and pressure data of the second substance (e.g., food, pharmaceutical, etc.) corresponds to the first equilibrium phase of matter (e.g., “solid”, “liquid”, or “gas”) of the first substance (e.g., water, solvent, etc.). If the real-time temperature and pressure data of the second substance (e.g., food, pharmaceutical, etc.) corresponds to the first equilibrium phase of matter of the first substance (e.g., water, solvent, etc.) the system displays, via the display generation component, a first equilibrium phase of matter indicator corresponding to the first equilibrium phase of matter of the first substance (e.g., water, solvent, etc.), as depicted in step 910. For example, if the real-time temperature and pressure data of the second substance (e.g., food, pharmaceutical, etc.) corresponds to the pressure and temperature of “ice” (e.g., solid phase of mater of the first substance) then the system displays “solid” or “ice” in the dashboard 260 for the first equilibrium phase of matter indicator.

In practice, the system receives real-time temperature and pressure data of the second substance (e.g., food, pharmaceutical, etc.) after a predefined time interval has passed. This process involves periodically refreshing the reception of real-time temperature data and pressure data from one or more sensors, such as a pressure sensor 450 and temperature sensors 650A-650G. This periodic refresh, depicted in step 914, ensures the continuous acquisition of real-time data throughout the operation, such as a lyophilization process. The time interval for refreshing the data can be predefined, for instance, as 1 second, 5 seconds, 15 seconds, or any other suitable duration.

In some embodiments, the one or more series of indicators provide a chronological account of the changes observed in the second substance (e.g., food, pharmaceutical, etc.) concerning the phases of matter exhibited by the first substance (e.g., water, solvent, etc.). For example, the phase data (e.g., temperature-pressure data 236) of the phase plot 230 of FIGS. 6A-6R offer a sequential history, illustrating how the temperature and pressure, representative of its “solid” phase, dynamically shift to reflect the temperature and pressure corresponding to the transition to the “gas” phase of the first substance (e.g., water, solvent, etc.). This chronological representation facilitates monitoring the progression of the second substance (e.g., food, pharmaceutical, etc.) relative to the phases of the first substance (e.g., water, solvent, etc.).

In some embodiments, the system incorporates the real-time temperature and pressure data into the sequences of data of the second substance (e.g., food, pharmaceutical, etc.) in response to receiving the real-time temperature and pressure data of the second substance (e.g., food, pharmaceutical, etc.). For instance, the phase data (e.g., temperature-pressure data 236) of the phase plot 230 of FIGS. 6A-6R show that upon receiving the real-time temperature and pressure data, these real-time data points are seamlessly integrated into the display of ongoing sequences of temperature and pressure readings associated with the frozen food. As the lyophilization progresses, the system continuously updates these sequences, capturing the evolving temperature and pressure experienced by the food. This integration of real-time data into sequence data ensures that the historical context is preserved.

The system employs two primary techniques to detect phases or phase transitions. First, it directly compares the observed data with a phase diagram to identify phase transitions. Alternatively, the system utilizes equations derived using the Clausius-Clapeyron relation of the first substance (e.g., water, solvent, etc.) to recognize phase transitions.

During the (lyophilization) process, the system evaluates whether the real-time temperature and pressure data of the second substance (e.g., food, pharmaceutical, etc.) align with a transition between phases of the first substance (e.g., water, solvent, etc.). For example, if the temperature and pressure readings of frozen food indicate a transition from the “solid” phase (see FIG. 6A) to the “gas” phase (see FIG. 6B) of water, the system detects this phase shift in real-time.

Subsequently, upon confirming the transition to a different phase of the first substance (e.g., water, solvent, etc.), the system ceases the display of “solid” (e.g., first equilibrium phase of matter indicator) and displays “gas” or “sublime” (e.g., the second equilibrium phase of matter indicator corresponding to the second equilibrium phase of matter of the first substance). This adaptive adjustment in phase indicators ensures that the displayed information accurately reflects the real-time phase changes of the first substance (e.g., water, solvent, etc.) as it progresses through different phases during the lyophilization process.

When the system detects a transition between different phases of matter of the first substance (e.g., water, solvent, etc.) based on the real-time temperature and pressure data of the second substance (e.g., food, pharmaceutical, etc.), the system dynamically replaces one or more indicators in the one or more series of indicators corresponding to the real-time temperature and pressure data on the display generation component with one or more specialized phase transition indicators. For example, the small circle of the substance temperature-pressure data 236 is replaced with a larger white circle (also identified as the pressure set point 360C1) of FIG. 6B to depict that the equilibrium phase of matter changed from “solid” to “gas”.

Upon confirming a transition to a different phase of the first substance (e.g., water, solvent, etc.), the system dynamically updates the display by replacing existing indicators with specialized phase transition indicators. These indicators serve as visual cues, highlighting significant changes in the phase state of the first substance (e.g., water, solvent, etc.).

In some embodiments, the system proactively notifies remote devices when a transition between different phases of the first substance (e.g., water, solvent, etc.) is detected. For instance, if the system identifies a shift in the phase state of the first substance (e.g., water, solvent, etc.), such as the transition from “solid” to “gas”, it initiates an automatic notification mechanism delivered via various means, such as visual alerts, auditory signals, or text messages.

To differentiate between real-time data and non-real-time data, the system displays distinct indicators within the series of indicators. For example, the system displays large grey circles for the real-time data and smaller black circles for non-real-time data, as depicted in the phase plot 230 of FIGS. 6A-6R. In some embodiments, the system utilizes other unique visual cues to represent each type of data. For example, real-time data indicators could be highlighted in a vibrant color or marked with a specific symbol, while indicators corresponding to non-real-time data might be displayed differently to signify their retrospective nature.

The system includes functionality to track the passage of time during the lyophilization process. After a predetermined time period has elapsed, the system ceases to display indicators corresponding to older data, ensuring that the display remains focused on the most relevant and recent data points. For example, the transient temperature plot 220, transient pressure plot 210, and the transient mass plot 270 of FIGS. 6A-6R depict that the indicators representing temperature and pressure readings older than 10 hours are automatically removed. In some embodiments, this predetermined time period to remove older data is a customizable feature accessible through the graphical user interface 902.

Additionally, the system optimizes data visualization by forgoing the display of any pressure or temperature data exceeding certain thresholds. For example, the system forgoes displaying pressure data (e.g., in the series of indicators) exceeding 4588 mTorr in the one or more series of indicators as pressures exceeding the triple point (e.g., 4588 mTorr) of water, where sublimation of water is not possible at any temperature. In some embodiments, the system forgoes displaying pressure data exceeding 5500 mTorr (e.g., in the series of indicators), which provides visibility of the triple point.

In some embodiments, the system estimates a quantity of the mass of the first substance (e.g., water, solvent, etc.) extracted from the second substance (e.g., food, pharmaceutical, etc.) during the lyophilization process. Once this estimation is derived, the system presents an indicator that signifies the estimated quantity of mass of the water extracted from the second substance (e.g., food, pharmaceutical, etc.). This indicator serves as a valuable metric, providing real-time insights into the extent of water extraction during the lyophilization process.

In some embodiments, during the lyophilization process, the system continuously tracks the extraction of the first substance (e.g., water, solvent, etc.) from the second substance (e.g., food, pharmaceutical, etc.). As part of this monitoring, the system adds the quantity of mass of the water extracted from the second substance (e.g., food, pharmaceutical, etc.) to a sequence of estimated mass data as depicted in the transient mass plot 270 of FIGS. 6A-6R. For example, if 0.43 kg of water is estimated to have been extracted from the frozen food over 205 min, as depicted in FIG. 6D, this value is incorporated into the ongoing sequence of the transient sublimation mass rate data 274 and the transient mass data 272.

Subsequently, via the display generation component, the system presents a series of mass indicators on the graphical user interface (e.g., transient sublimation mass rate data 274 and transient mass data 272 of FIGS. 6A-6R). Each indicator within this series represents a point in the sequence of estimated mass data of the water. This sequence encompasses both the recently added mass data, such as the 0.43 kg of water extracted, and previously recorded mass data of the water.

Using the cooling curves depicted in the transient temperature plot 220 of FIG. 5B, the system estimates that the mass of water in the frozen food is approximately 3.58 kg. In some embodiments, this estimation is derived from a thermodynamic model of the cooling curve. In some embodiments, this estimation is derived from an image-capturing system (e.g., near-infrared spectroscopy (NIR)). In some embodiments, this estimation is derived from profile parameters of the second substance (e.g., food, pharmaceutical, etc.).

Once this estimation is calculated, the system displays an indicator (e.g., estimate parameter 330B1) on the graphical user interface generated by the display generation component. This indicator represents the estimated quantity of mass of water included in the frozen food.

In some embodiments, the system includes safe operational limits for the lyophilization equipment and the integrity of the frozen food corresponding to predetermined maximum or minimum threshold boundaries for both temperature and pressure. If the system detects that either the real-time temperature or pressure data exceeds these predetermined threshold boundaries, an automatic alert mechanism is triggered to display a visual notification on the graphical user interface or send an electronic notification (e.g., email, social media, etc.).

As depicted in FIGS. 6A-6R the system displays a phase diagram (e.g., phase plot 230) that illustrates the equilibrium conditions of temperature and pressure corresponding to distinct phases of matter of the first substance (e.g., water, solvent, etc.). Upon receiving the real-time data, the system displays the one or more series of indicators (e.g., real-time temperature-pressure data 236A) in relation to the phase diagram (e.g., phase plot 230).

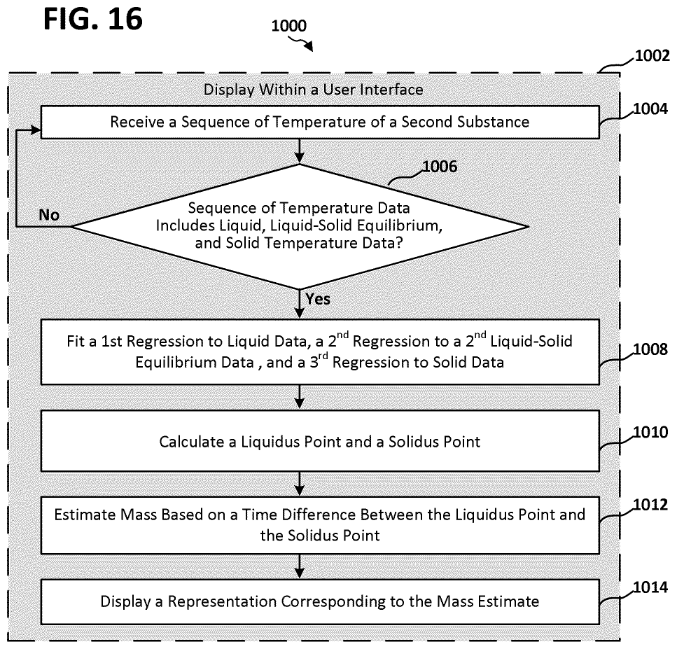

FIG. 16 illustrates a flow diagram outlining method 1000, which fits regression models to temperature data (e.g., cooling curves) of a second substance (e.g., food, pharmaceuticals, etc.) to determine liquidus and solidus points and derive and display a mass estimate of the first substance (e.g., solvent, water, etc.). The system interfaces with a display generation component to initiate the (lyophilization) process, presenting the outcomes within a distinct graphical user interface 1002. In some embodiments, the graphical user interface 1002 operates independently of the underlying operating system, providing the capability to halt or restart the interface without affecting core operating system functionality.

The system receives real-time temperature data and pressure data of the second substance (e.g., food, pharmaceutical, etc.), as displayed at step 1004. For example, the system acquires real-time temperature and pressure data of the second substance (e.g., food, pharmaceutical, etc.) from one or more sensors (e.g., pressure sensors, temperature sensors).

To address potential inaccuracies due to sensor noise or environmental factors, the system employs a filtering algorithm to refine the raw temperature data before integrating it into the temperature sequence. An example of this is the implementation of a moving average filter, which calculates the average temperature over a defined time window, effectively smoothing out fluctuations and minimizing data noise. This filtering process enhances the stability and reliability of the temperature trend representation over time.

At step 1006, the system determines whether the temperature data sequence (e.g., temperature data 226) includes distinct phases of the first substance (e.g., water, solvent, etc.), including liquid, liquid-solid equilibrium, and solid phases. This comprehensive temperature data (e.g., transient temperature data 226 of FIGS. 5B and 5C) spanning multiple phases provides a basis for accurately fitting regression models. It should be appreciated that insufficient or limited temperature data could result in imprecise model fits, thereby compromising the accuracy of the mass estimate.

In some embodiments, the sequence of temperature data of the second substance (e.g., food, pharmaceutical, etc.) is organized chronologically, ensuring that data points are arranged in the order they were recorded. For example, in a lyophilization process, the temperature readings are arranged sequentially as they occur, providing a clear timeline of the process.

In some embodiments, a predetermined time period separates adjacent points of the temperature data sequence of the second substance (e.g., food, pharmaceutical, etc.). For example, temperature readings may be captured every 10 seconds during the lyophilization process. This periodicity ensures consistent spacing between data points and facilitates uniform analysis.

At step 1008, after the system confirms that the temperature data (transient temperature data 226) include a sequence of liquid temperature data, a sequence of liquid-solid equilibrium temperature data, and a sequence of solid temperature data of the first substance (e.g., water, solvent, etc.), the system fits a first regression model to the liquid temperature data, a second regression model to the liquid-solid equilibrium temperature data, and a third regression model to the solid temperature data. For example, the system fits a linear regression to the liquid phase cooling curve 364A, a linear regression to the liquid-solid transition phase cooling curve 364B, and a linear regression to the solid phase cooling curve 364C, as depicted in FIGS. 5B and 5C.

In some embodiments, the system fine-tunes (e.g., adjusts) parameters within the first, second, or third regression models to minimize either the sum of squared residuals or the root mean square of residuals generated by these models. For example, during the fitting process, the system can adjust coefficients within each regression model to reduce the discrepancies between the actual temperature data points and the predicted values generated by these models. This adjustment aims to improve the overall accuracy of the regression models in capturing the underlying trends and patterns within the temperature data.

The system also calculates a confidence score for the mass estimate by evaluating the sum of squared residuals or root mean square of residuals generated by the regression models. This confidence score provides an indication of the reliability of the mass estimate, helping gauge the accuracy of the calculated value. For instance, a higher confidence score indicates that the regression models closely align with the observed temperature data, increasing confidence in the mass estimate. Conversely, a lower confidence score indicates greater variability or uncertainty in the temperature data, prompting caution when interpreting the mass estimate. The system then presents this confidence score alongside the mass estimate on the graphical user interface, enabling informed decisions based on the level of confidence in the estimated mass.

In some embodiments, fitting the regression models entails the utilization of a machine learning algorithm trained on historical temperature data of the second substance (e.g., food, pharmaceutical, etc.) or analogous substances. For example, the system may employ a neural network trained on a dataset comprising temperature profiles from previous lyophilization runs or similar processes involving phase transitions. This approach leverages the wealth of historical data to enhance the accuracy and robustness of the regression models, enabling them to capture complex relationships and patterns in the temperature data. By incorporating machine learning techniques, the system can adaptively adjust the regression models based on the specific characteristics of the temperature data, leading to more precise estimations of the liquidus and solidus points.

At step 1010, the system calculates a liquidus point 362B corresponding to the intersection of the first regression model and the second regression model, along with a solidus point 362C, corresponding to the intersection of the second regression model and the third regression model. In the context of a lyophilization process, the liquidus point 362B represents the temperature at which the substance transitions from a liquid to a solid state, while the solidus point 362C represents the temperature at which the substance transitions entirely to a solid phase. These points serve as markers in delineating the boundaries between different phases of the substance, allowing for precise estimation of mass and facilitating informed decision-making during the process.

At step 1012, the system calculates the mass of the first substance (e.g., water, solvent, etc.) based on the time difference between the liquidus point 362B and the solidus point 362C. In the lyophilization process, this calculation determines the amount of water extractable from the substance during freezing, guiding control of process parameters and ensuring the desired product quality.

In some embodiments, the system estimates the mass of the first substance (e.g., water, solvent, etc.) based on at least one parameter of one of the first regression model, second regression model, and the third regression model. In some embodiments, the at least one parameter of one of the regression models includes a slope or a y-intercept of the first regression model, the second regression model, and the third regression model. These parameters may include the slope or y-intercept of the first, second, or third regression models, allowing for a precise determination of mass. For instance, in a lyophilization process, the slope of the regression models often indicates the rate of temperature change, which directly correlates with the amount of substance undergoing phase transition. Similarly, the y-intercept may represent a temperature metric of the phase transition, providing data for accurate mass estimation.

In some embodiments, the system determines the mass of the first substance (e.g., water, solvent, etc.) by analyzing the cooling rate, represented by parameters such as the slope, of either the second substance (e.g., food, pharmaceutical, etc.) or the first substance (e.g., water, solvent, etc.) itself. In a lyophilization process, a rapid decrease in temperature may indicate a higher rate of water extraction from the substance, influencing the estimated mass. This approach provides for a more dynamic assessment of mass changes during the process, offering valuable insights into the efficiency and progress of substance transformation.

In some embodiments, the system imports a profile of the second substance (e.g., food, pharmaceutical, etc.), such as through a profile prompt (e.g., profile prompt 346A as depicted in FIG. 3C). It then utilizes the parameters from this profile to evaluate the cooling rate of either the first substance (e.g., water, solvent, etc.) or the second substance (e.g., food, pharmaceutical, etc.). This evaluation involves comparing the observed cooling rate with a predefined cooling rate profile specific to the substance being analyzed. For instance, during a freeze-drying process, comparing the cooling rate of the substance with an established cooling rate profile helps assess the adherence of the process to predefined standards, ensuring optimal conditions for product quality and consistency.

In some embodiments, the system receives real-time pressure data of the second substance (e.g., food, pharmaceutical, etc.) and adds the real-time pressure data to a sequence of pressure data of the second substance (e.g., food, pharmaceutical, etc.). Notably, the cooling rate of the second substance (e.g., food, pharmaceutical, etc.) is influenced, at least partially, by the variations observed in this sequence of pressure data. For example, in the lyophilization process, pressure can directly impact the rate at which the substance cools down. Monitoring and analyzing these pressure data points in real time provide insights into the cooling dynamics of the substance, aiding in process optimization and quality control.

At step 1014, the system utilizes the display generation component to present a visual representation of the mass estimate for the first substance (e.g., water, solvent, etc.). This representation offers a clear visualization of the estimated quantity of the substance, aiding in monitoring and adjusting the lyophilization process parameters as needed for optimal results. For example, the estimate parameter 330B in FIGS. 5A-5C, depicted on the graphical user interface, provides feedback on the mass estimate (e.g., 3.58 kg) during the process.

In some embodiments, the second substance (e.g., food, pharmaceutical, etc.) encompasses the first substance (e.g., water, solvent, etc.). For instance, in a lyophilization process, the second substance (e.g., food, pharmaceutical, etc.) may refer to a food item, with water being the first substance (e.g., water, solvent, etc.). Here, the estimated mass corresponds to the water content within the food, providing valuable insights into its composition. Similarly, in pharmaceutical applications, the second substance (e.g., food, pharmaceutical, etc.) may consist of solutes and solvents. In such cases, the mass estimation pertains to the estimation of solute content within the pharmaceutical product, aiding in dosage accuracy and formulation optimization.

The system verifies the completeness of temperature data during the cooling phase of the lyophilization process, ensuring that it spans from the liquid temperature data through the liquid-solid temperature data including solid temperature data of the first substance (e.g., water, solvent, etc.). If the sequence of temperature data is incomplete but not disjoint, the system continues to cool the second substance (e.g., food, pharmaceutical, etc.), receives/monitors real-time temperature data of the second substance (e.g., food, pharmaceutical, etc.), and adds the real-time temperature data to the sequence of temperature data of the second substance (e.g., food, pharmaceutical, etc.). However, if the temperature data is disjoint, meaning that further cooling the first substance (e.g., water, solvent, etc.) cannot provide the missing temperature data ranging from the liquid temperature data through the liquid-solid temperature data including solid temperature data of the first substance (e.g., water, solvent, etc.) to the sequence of temperature data, the system forgoes estimating the mass and/or displays a notification that mass estimation is omitted due to disjoint temperature data.

In some embodiments, the system presents a graphical representation via the display generation component, illustrating the sequence of temperature data of the second substance (e.g., food, pharmaceutical, etc.) alongside the first, second, and third regression models, as depicted in FIGS. 5B-5C. In some embodiments, the system also displays graphical representations of the liquidus point 362B and the solidus point 362C.

In some embodiments, the system dynamically adjusts a temperature threshold based on various characteristics of either the first or second substance (e.g., food, pharmaceutical, etc.), which may encompass physical properties, chemical composition, or thermodynamic behavior. For instance, if the system detects that the temperature threshold for determining the solidus point 362C is too high, it adjusts accordingly. Moreover, in some embodiments, if the real-time temperature data exceeds the temperature threshold, the system sends a notification to indicate this occurrence.

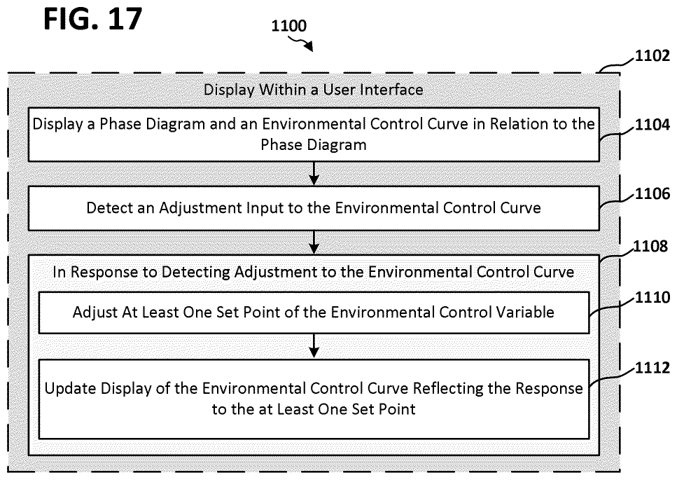

FIG. 17 illustrates a flow diagram outlining a method 1100 for displaying a phase diagram representing temperature and pressure equilibrium conditions, accompanied by an environmental control curve 360 illustrating connections between set points and an environmental variable. The system interfaces with a display generation component to initiate the (lyophilization) process, presenting the outcomes within a distinct graphical user interface 1102. In some embodiments, the graphical user interface 1102 operates independently of the underlying operating system, providing the capability to halt or restart the interface without affecting core operating system functionality.

At step 1104, the system displays, via the display generation component, both a phase diagram illustrating the equilibrium conditions of temperature and pressure for distinct phases of a first substance (e.g., water, solvent, etc.) and an environmental control curve 370 for a second substance (e.g., food, pharmaceutical, etc.), depicting connections between set point responses and an environmental control variable. For example, prior to loading a profile with parameters to generate an environmental control curve 360 the system displays a phase diagram (e.g., phase plot 230) as illustrated in FIGS. 3A-3C.

The environmental control curve 360 of the second substance (e.g., food, pharmaceutical, etc.) includes at least one of an isobaric set point and an isothermal set point. For example, the environmental control curve 360 depicted in FIG. 3G includes an isobaric (constant pressure) set point 360C and an isothermal (constant temperature) set point 360E. Incorporating isobaric and isothermal set points into the environmental control curve 360 offers significant advantages. These set points simplify modeling, stabilize process conditions, and allow for precise parameter control. These results in predictable outcomes, improved product quality, and enhanced reproducibility, especially in delicate lyophilization processes. The isobaric set point 360C and the isothermal set point 360E depicted in FIG. 3G demonstrate the strategic application of these controls to optimize process performance and product attributes.

The one or more set point responses to the environmental control variable include a second-order dynamic response associated with an isobaric (constant pressure) set point. For example, as depicted in FIG. 3G the system generates a second-order response between the set point 360C and 360D for the environmental control curve 360. In some embodiments, the system generates a second-order response between set points 360C and 360D for the environmental control curve 360, a result of the PID implementation. This response results from the PID implementation, particular, in response to the pressure drop caused by enabling the vacuum pump.

The one or more set point responses to the environmental control variable include a second-order dynamic response associated with an isothermal set point. For example, as depicted in FIG. 3G the system generates a second-order response between the set point 360E and 360F for the environmental control curve 360. In some embodiments, the system generates a second-order response between set point 360E and 360F for the environmental control curve 360, a result of the PID implementation. In particular, the second-order response at the final temperature set point 360E in response to compensating for the change from constant pressure to constant temperature.

The environmental control curve 360 includes a baseline set point defining an initial state of the second substance (e.g., food, pharmaceutical, etc.), a transition set point indicating a change in conditions, and a target set point representing a desired final state of the second substance (e.g., food, pharmaceutical, etc.). For example, as depicted in FIG. 3G, the generated environmental control curve 360 includes a baseline set point corresponding to the set point 360C of the initial target pressure point, a transition set point corresponding to a set point between set point 360C and set point 360D where the pressure surpasses the initial target pressure to a stable pressure, and a target set point corresponding to a target pressure at set point 360D representing the stable pressure of the second substance (e.g., food, pharmaceutical, etc.) during the lyophilization process.

At step 1106, the system detects an adjustment input to the environmental control curve 360. In some embodiments, the system includes a touch-sensitive surface that is used to detect the adjustment input, such as a drag input at a location on the touch-sensitive surface associated with the environmental control curve 360 of the second substance (e.g., food, pharmaceutical, etc.). For example, the drag input 290F of FIG. 3F moves the phase curve equilibrium set point 360B.

At least a portion of the environmental control curve 360 of the second substance (e.g., food, pharmaceutical, etc.) aligns with or closely approximates a boundary line in the phase diagram that demarcates distinct phases of matter of the first substance (e.g., water, solvent, etc.). For example, some of the environmental control curve 360 as depicted in FIGS. 3F and 3G tracks the phase curve corresponding to the path between set point 360B and set point 360C.

At step 1108, in response to detecting the adjustment input to the environmental control curve 360, the system performs step 1110 and step 1112. In step 1110, the system adjusts at least one set point of the environmental control variable. For example, in response to detecting the touch and drag gesture 290F, the system adjusts positions of the pressure set point 360A of the environmental control curve 360, as depicted in FIG. 3G. In step 1112, the system updates displaying, via the display generation component, the environmental control curve in relation to the phase diagram reflecting a response to the at least one set point. For example, in response to detecting the touch and drag gesture 290F, the system displays the adjusted environmental control curve 360, as depicted in FIG. 3G.

The system further detects an input selecting a dynamic environmental control. For example, the system detects a mouse click or contact 290E with a touch-sensitive surface to select the dynamic pump parameter 340. In response to detecting the input selecting the dynamic environmental control, the system displays, via the display generation component, a dynamic environmental control curve 370 of the second substance (e.g., food, pharmaceutical, etc.) in relation to the graphical representation of the first substance (e.g., water, solvent, etc.). For example, in response to detecting selection of checkbox 340, the system displays the dynamic environmental control curve 370 as depicted in FIG. 3E. The dynamic environmental control curve 370 of the second substance (e.g., food, pharmaceutical, etc.) corresponds to connections of one or more threshold set point responses to a second environmental control variable. At least a portion of the dynamic environmental control curve 370 of the second substance (e.g., food, pharmaceutical, etc.) is configured to overlap with the existing environmental control curve 360.

The system further detects an adjustment input to the dynamic environmental control curve 370. For example, the system detects a mouse click and drag input or a touch and drag gesture 290F with the dynamic environmental control curve 370, as shown in FIG. 3G. In response to the detected adjustment input, the system adjusts at least one threshold set point response to the second environmental control variable and updates the display, via the display generation component, of the dynamic environmental control curve 370 of the second substance (e.g., food, pharmaceutical, etc.) reflecting the adjusted threshold set point response. For example, in response to detecting the touch and drag gesture 290F, the system adjusts positions of the dynamic pressure set point 360A of the dynamic environmental control curve 370 and displays the adjusted dynamic environmental control curve 370, as depicted in FIG. 3G.

In some embodiments, the system includes a touch-sensitive surface that is used to detect the adjustment input, such as a drag input at a location on the touch-sensitive surface associated with the dynamic environmental control curve. For example, the drag input 290F of FIG. 3F is used to move the dynamic pressure set point 360A.

As depicted in FIGS. 3E-3G, the dynamic environmental control curve 370 diverges from the environmental control curve 360 of the second substance (e.g., food, pharmaceutical, etc.) at a pressure threshold. In practice, this dynamic is associated with a weaker or failing vacuum pump, where a higher pressure threshold is a symptom. This pressure threshold corresponds to an acceptable pressure where sublimation occurs, such as pressure below the triple point (e.g., 4588 mTorr) of water.

The dynamic environmental control curve 370 of the second substance (e.g., food, pharmaceutical, etc.) includes at least one of an isobaric set point or an isothermal set point. For example, the dynamic environmental control curve 370 includes an isobaric (constant pressure) set point (e.g., set point at 370A of FIG. 3F) and an isothermal (constant temperature) set point (e.g., set point at 370B of FIG. 3F).

The one or more set point responses to a second environmental control variable include a second-order dynamic response associated with an isobaric (constant pressure) set point (e.g., set point at 370A of FIG. 3F). For example, as depicted in FIG. 3F, the system generates a second-order response between the set point 370A and 370B for the dynamic environmental control curve 370.

In some embodiments, the system additionally employs one or more machine learning algorithms or artificial intelligence techniques trained on historical temperature and pressure data of the second substance (e.g., food, pharmaceutical, etc.) or similar substances to generate the environmental control curve 360. For example, the system can learn complex patterns and relationships between environmental variables and substance behavior by analyzing past temperature and pressure data collected during various stages of lyophilization. Subsequently, this trained machine learning model can be employed to generate the environmental control curve 360, enabling the system to anticipate and adjust environmental conditions in real-time during subsequent lyophilization runs based on learned patterns and historical data.

In some embodiments, the system further utilizes a thermodynamic model of the second substance (e.g., food, pharmaceutical, etc.) or similar substances to generate the environmental control curve 360. In principle, this thermodynamic model incorporates fundamental principles of thermodynamics, such as heat transfer and phase transitions, to simulate the behavior of the second substance (e.g., food, pharmaceutical, etc.) under varying pressure and temperature conditions during lyophilization. By inputting parameters such as initial substance composition, chamber pressure, and shelf temperature, the system can simulate how the substance will respond to different environmental conditions over time. This enables the system to predict optimal pressure and temperature settings for the lyophilization process, ensuring efficient and effective dehydration of the second substance (e.g., food, pharmaceutical, etc.).

In some embodiments, the system calculates an error parameter based on the difference between the generated environmental control curve 360 and the actual environmental data. Subsequently, the system automatically adjusts the environmental control curve 360 based on the error parameter during a (lyophilization) process. This error parameter quantifies the discrepancies between the predicted and actual environmental responses. For example, if the predicted temperature decreases are not aligning with the actual temperature decreases observed during the lyophilization process, the error parameter may indicate the extent of this discrepancy. Subsequently, the system employs an automatic adjustment mechanism that dynamically modifies the environmental control curve 360 based on the calculated error parameter. This adaptive process allows the system to fine-tune and optimize the environmental control variables in real-time, ensuring that the lyophilization process aligns closely with the desired outcomes.

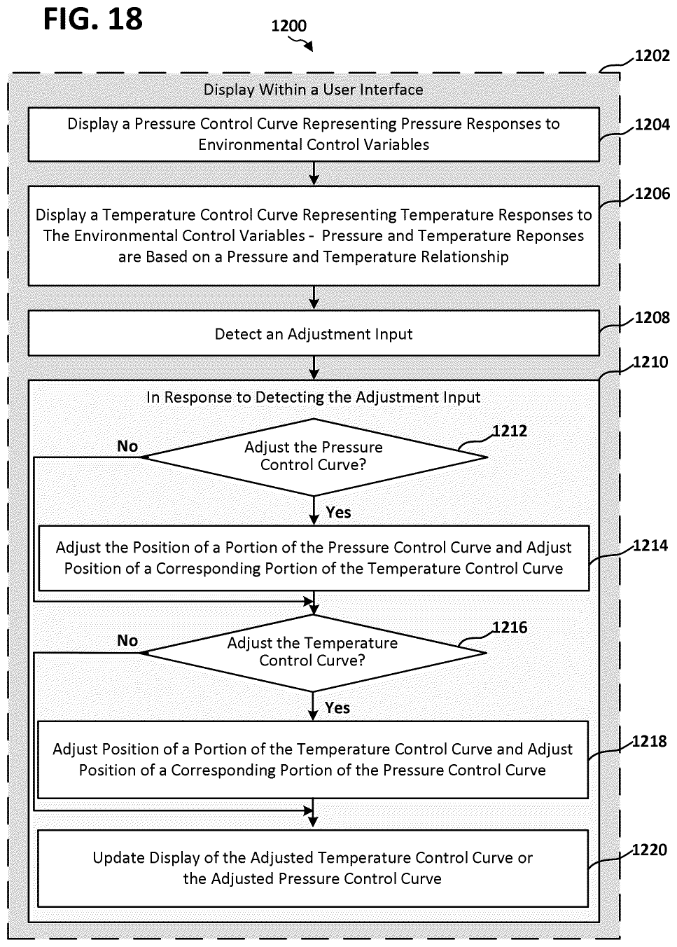

FIG. 18 illustrates a flow diagram outlining a method 1200 for displaying pressure and temperature control curves of a second substance (e.g., food, pharmaceutical, etc.) and dynamically adjusting the curves while maintaining a pressure-temperature relationship. The system interfaces with a display generation component to initiate the (lyophilization) process, presenting the outcomes within a distinct graphical user interface 1202. In some embodiments, the graphical user interface 1202 operates independently of the underlying operating system, providing the capability to halt or restart the interface without affecting core operating system functionality.

Beginning at step 1204, the system displays the transient pressure plot 210 via the display generation component, a pressure control curve 360-1 of the second substance (e.g., food, pharmaceutical, etc.), representing one or more pressure responses to one or more environmental control variables. Notably, the second substance (e.g., food, pharmaceutical, etc.) includes the first substance (e.g., water, solvent, etc.).

Continuing at step 1206, the system displays, on the transient temperature plot 220 via the display generation component, a temperature control curve 370-2 of the second substance (e.g., food, pharmaceutical, etc.), representing one or more temperature responses to the one or more environmental control variables. Notably, the interrelationship between the one or more pressure responses and the one or more temperature responses is based on a pressure and temperature relationship of the first substance (e.g., water, solvent, etc.).

In step 1208, the system detects an adjustment input, which is utilized to modify parameters associated with environmental control variables. Adjustment inputs can encompass various interactions, including touch gestures on a touch-sensitive surface like taps, swipes, or drags, as well as inputs from other input devices such as mice, keyboards, or styluses. These inputs are aimed at altering the pressure control curve or the temperature control curve. For instance, a drag input involves a finger or stylus touching the touch-sensitive surface at a point or along a line on a graphical interface representing the pressure control curve or the temperature control curve, then dragging the point or line, as depicted in contacts 290I and 290K, FIGS. 4B and 4D.

Responding to detected adjustments, the system determines in step 1212 whether the adjustment input corresponds to adjusting the pressure control curve 360-1 in accordance with step 1212 and/or in step 1216 whether the adjustment input corresponds to adjusting the temperature control curve 360-2.

In accordance with a determination that the adjustment input corresponds to adjusting the pressure control curve 360-1, the system adjusts the position of at least a portion of the pressure control curve 360-1 and adjusting position of at least a portion of a corresponding portion of the temperature control curve 360-2 based on the pressure and temperature relationship of the first substance (e.g., water, solvent, etc.), as depicted in step 1214.

In accordance with a determination that the adjustment input corresponds to adjusting the temperature control curve 360-2, the system adjusts the position of at least a portion of the temperature control curve 360-2, as depicted in step 1218. Simultaneously, the system adjusts at least a portion of a corresponding portion of the pressure control curve 360-1. These adjustments are made in accordance with the pressure and temperature relationship of the first substance (e.g., water, solvent, etc.). For example, adjusting the temperature set point downwards (e.g., below 120° F.) to reduce the temperature, the system will appropriately adjust the pressure set point to maintain equilibrium, ensuring that the system operates within the desired parameters.

The system updates displaying at step 1220, via the display generation component, the adjusted pressure control curve 360-1 in the transient pressure plot 210 or the adjusted temperature control curve 360-2 in the transient temperature plot 220 of the second substance (e.g., food, pharmaceutical, etc.).

The system displays, via the display generation component, an isobaric set point 360D1 on the transient pressure control curve 360-1 of the transient pressure plot 210 and a corresponding isobaric set point 360D1 on the temperature control curve of the transient temperature plot 220 of the second substance (e.g., food, pharmaceutical, etc.), as depicted in FIGS. 4A-4D. This isobaric set point sets the system to constant pressure levels that simplify modeling, optimize stability of the process, and facilitate precise control over environmental parameters.

In some embodiments, the one or more environmental control variables include a second-order dynamic response to the isobaric set point 360D1, and the one or more temperature responses to the one or more environmental control variables include a corresponding response to the isobaric set point 360D2 based on the pressure and temperature relationship of the first substance (e.g., water, solvent, etc.), as depicted in FIGS. 4A-4D. In some embodiments, the environmental control variables exhibit a second-order dynamic response to the isobaric set point on the transient pressure control curve 360-1 and the corresponding response on the transient temperature control curve 360-2. This dynamic response enables the system to effectively dampen oscillations, minimize ringing effects, and optimize performance metrics such as rise time and overshoot, ensuring smooth transitions to isobaric conditions.

As depicted in FIGS. 4A-4D, the system displays, via the display generation component, an isothermal set point 360E2 on the transient temperature control curve 360-2 of the transient temperature plot 220 of the second substance (e.g., food, pharmaceutical, etc.) and a corresponding isothermal set point 360E2 on the transient pressure control curve 360-1 of the transient pressure plot 210 of the second substance (e.g., food, pharmaceutical, etc.). This isothermal set point establishes constant temperature levels, simplifying modeling, enhancing process stability, and enabling precise control over environmental parameters.

In some embodiments, the one or more temperature responses to the one or more environmental control variables include a second-order dynamic response to an isothermal set point on the transient temperature control curve 360-2 of the transient temperature plot 220 and the one or more pressure responses to the one or more environmental control variables include a corresponding response to the isothermal set point on the transient pressure control curve 360-1 of the transient pressure plot 210 based on the pressure and the temperature relationship of the first substance (e.g., water, solvent, etc.), as depicted in FIGS. 4A-4D. In some embodiments, the environmental control variables exhibit a second-order dynamic response to the isothermal set point on the transient temperature control curve 360-2 and the corresponding response on the transient pressure control curve 360-1. This dynamic response effectively dampens oscillations, minimizes ringing effects, and optimizes performance metrics such as rise time and overshoot, ensuring smooth transitions to isothermal conditions while leveraging the pressure and temperature relationship of the first substance (e.g., water, solvent, etc.).

As depicted in FIGS. 4A-4D, the transient pressure control curve 360-1 of the second substance (e.g., food, pharmaceutical, etc.) features a pressure target set point 360D1, marking the point where the pressure response aligns with the desired pressure level. Correspondingly, the transient temperature control curve 360-2 of the second substance (e.g., food, pharmaceutical, etc.) includes a temperature set point 360D2 that correlates with the pressure target set point 360D1.

As depicted in FIGS. 4A-4D, the temperature control curve 360-2 of the second substance (e.g., food, pharmaceutical, etc.) features a temperature target set point 360D2, indicating the point where the temperature response aligns with the desired temperature level. Correspondingly, the transient pressure control curve 360-1 of the second substance (e.g., food, pharmaceutical, etc.) includes a pressure set point 360D1 that corresponds to the temperature target set point 360D2.

In some embodiments, the adjustment input corresponds to altering a set point value either on the pressure control curve 360-1 or the temperature control curve 360-2. For example, as illustrated in FIG. 4B, a drag input at contact 290I on a touch-sensitive surface, at set point 360G1 within the transient pressure plot 210, results in the adjustment of set point 360H1 within the transient pressure plot 210 and set point 360H2 within the transient temperature plot 220.

In some embodiments, the pressure and temperature relationship of the first substance (e.g., water, solvent, etc.) relies on either experimental measurements or thermodynamic models. Experimental measurements involve observing how pressure and temperature interact during different lyophilization stages, offering insights into their mutual influence and enabling more precise control strategies. Conversely, thermodynamic models utilize principles of thermodynamics to forecast the behavior of the substance under varying pressure and temperature conditions, providing valuable insights into its phase transitions and stability. These approaches collectively aid in optimizing lyophilization processes.

The system detects input signaling the selection of dynamic environmental control, such as a mouse click or contact 290E with a touch-sensitive surface to choose the dynamic pump parameter 340. In response, the system displays a dynamic pressure control curve 370-1 on the transient pressure plot 210 via the display generation component. This curve represents one or more pressure threshold set point responses to the second environmental control variable.

Simultaneously, upon detecting the input for dynamic environmental control selection, the system displays a dynamic temperature control curve 370-2 on the transient temperature plot 220. This curve depicts one or more temperature threshold set point responses related to the second environmental control variable. Notably, the system maintains the interrelationship between these pressure and temperature threshold set point responses based on the pressure and temperature relationship of the first substance (e.g., water, solvent, etc.).

In some embodiments, segments of the dynamic pressure control curve 370-1 and dynamic temperature control curve 370-2 of the second substance (e.g., food, pharmaceutical, etc.) align with corresponding segments of the static pressure control curve 360-1 and temperature control curve 360-2, respectively. For instance, a portion of the dynamic pressure control curve 370-1 coincides with a segment of the pressure control curve 360-1 between the vacuum pump activation set point 360A1 and the transient dynamic pressure set point 360B1, and similarly, the dynamic temperature control curve 370-2 aligns with the temperature control curve 360-2.

The dynamic pressure control curve 370-1 of the second substance (e.g., food, pharmaceutical, etc.) diverges from the pressure control curve 360-1 of the second substance (e.g., food, pharmaceutical, etc.) at a pressure threshold corresponding to the transient dynamic pressure set point 360B1. As depicted in FIGS. 4A-4G, this pressure threshold corresponds to 4000 mTorr. In some embodiments, the pressure threshold corresponds to a pressure below the triple point of the first substance (e.g., water, solvent, etc.) or 4588 mTorr of water.

As depicted in FIGS. 4A-4G, the dynamic pressure control curve 370-1 of the second substance (e.g., food, pharmaceutical, etc.) includes a dynamic isobaric set point 370A1 and the dynamic temperature control curve 370-2 of the second substance (e.g., food, pharmaceutical, etc.) includes a set point corresponding to the dynamic isobaric set point 370A2.

Similarly depicted in FIGS. 4A-4G, the dynamic temperature control curve 370-2 of the second substance (e.g., food, pharmaceutical, etc.) includes a dynamic isothermal set point 370B2 and the dynamic pressure control curve 370-1 of the second substance (e.g., food, pharmaceutical, etc.) includes a set point corresponding to the dynamic isothermal set point 370B1.

In some embodiments, the one or more pressure threshold set point responses exhibit a second-order dynamic response to a dynamic isobaric set point 370A2. For example, this response is represented by the portion of the pressure control curve 370-1 between the transient dynamic pressure set point 360B1 and the dynamic isobaric set point 370A1. This dynamic response effectively dampens oscillations, minimizes ringing effects, and optimizes performance metrics such as rise time and overshoot, ensuring smooth transitions to isobaric conditions while maintaining the pressure and temperature relationship of the first substance (e.g., water, solvent, etc.).

In some embodiments, the one or more temperature threshold set point responses include a second-order dynamic response to an isothermal set point 370B2. For example, the second-order dynamic response to the dynamic isothermal set point 370B2 corresponds to the response depicted in the portion of the transient temperature control curve 370-2 between the dynamic isothermal set point 370B2 and the final temperature set point 360F2. This dynamic response effectively dampens oscillations, minimizes ringing effects, and optimizes performance metrics such as rise time and overshoot, ensuring smooth transitions to isothermal conditions while maintaining the pressure and temperature relationship of the first substance (e.g., water, solvent, etc.).

In some embodiments, the adjustment input corresponds to a drag input on a touch-sensitive surface associated with either the dynamic pressure control curve 370-1 or the dynamic temperature control curve 370-2 of the second substance (e.g., food, pharmaceutical, etc.). For example, an upwards drag input on the dynamic pressure control curve 370-1 between the dynamic isobaric set points 370A1 and 370B1 may adjust the pressure threshold within a specified range, such as above 4000 mTorr and below the triple point of water (e.g., 4588 mTorr).

In some embodiments, the system additionally employs one or more machine learning algorithms or artificial intelligence techniques trained on historical temperature and pressure data of the second substance (e.g., food, pharmaceutical, etc.) or similar substances to generate the pressure control curve 360-1 and the temperature control curve 360-2. For example, by analyzing past temperature and pressure data collected during various stages of lyophilization, the system can learn complex patterns and relationships between environmental variables and substance behavior. Subsequently, this trained machine learning model can be employed to generate the pressure control curve 360-1 and the temperature control curve 360-2, enabling the system to anticipate and adjust environmental conditions in real-time during subsequent lyophilization runs based on learned patterns and historical data.

In some embodiments, the system further utilizes a thermodynamic model of the second substance (e.g., food, pharmaceutical, etc.) or similar substances to generate the pressure control curve 360-1 and the temperature control curve 360-2. In principle, this thermodynamic model incorporates fundamental principles of thermodynamics, such as heat transfer and phase transitions, to simulate the behavior of the substance under varying pressure and temperature conditions during lyophilization. By inputting parameters such as initial substance composition, chamber pressure, and shelf temperature, the system can simulate how the substance will respond to different environmental conditions over time. This enables the system to predict optimal pressure and temperature settings for the lyophilization process, ensuring efficient and effective dehydration of the second substance (e.g., food, pharmaceutical, etc.).

In some embodiments, the system calculates one or more error parameters based on the difference between the generated pressure control curve 360-1 and the temperature control curve 360-2. Subsequently, the system automatically adjusts the pressure control curve 360-1 and temperature control curve 360-2 based on the one or more error parameters during a (lyophilization) process. These one or more error parameters quantify the discrepancies between the predicted and actual environmental responses. For example, if the predicted temperature decreases do not align with the actual temperature decreases observed during the lyophilization process, the one or more error parameters may indicate the extent of this discrepancy. Subsequently, the system employs an automatic adjustment mechanism that dynamically modifies the pressure control curve 360-1 and temperature control curve 360-2 based on the calculated one or more error parameters. This adaptive process allows the system to fine-tune and optimize the environmental control variables in real-time, ensuring that the lyophilization process aligns closely with the desired outcomes.

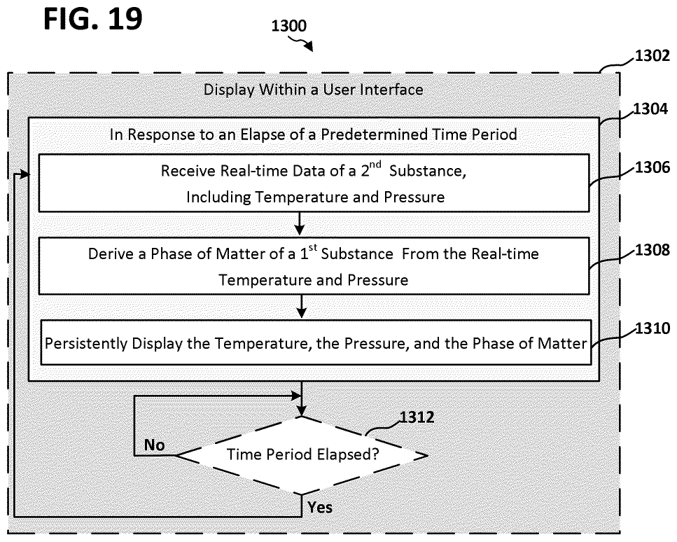

FIG. 19 illustrates a flow diagram outlining a method 1300 for persistently displaying real-time temperature and pressure of a second substance (e.g., food, pharmaceutical, etc.), and equilibrium phase of matter of a first substance (e.g., water, solvent, etc.) after periodically determining the equilibrium phase of matter of the first substance (e.g., water, solvent, etc.) based on real-time temperature and pressure measurements of the second substance (e.g., food, pharmaceutical, etc.). The system interfaces with a display generation component to initiate the (lyophilization) process, presenting the outcomes within a distinct graphical user interface 1302. In some embodiments, the graphical user interface 1302 operates independently of the underlying operating system, providing the capability to halt or restart the interface without affecting core operating system functionality.

At step 1304, in response to an elapse of a predetermined time, the system initiates a sequence of actions to refresh the display of real-time data typically occurring at regular intervals (e.g., every 1 second, 5 seconds, 15 seconds, etc.). Initially, at step 1306, the system begins by receiving real-time data, the real-time temperature measurement and the real-time pressure measurement of a second substance (e.g., food, pharmaceutical, etc.).

Proceeding to step 1308, the system derives the real-time equilibrium phase of matter of a first substance (e.g., water, solvent, etc.). Utilizing the real-time temperature and pressure measurements obtained in the preceding step, the system applies predetermined algorithms or models to ascertain the instantaneous phase state of the first substance (e.g., water, solvent, etc.).

In some embodiments, the equilibrium phase of matter of the first substance (e.g., water, solvent, etc.) corresponds to an equilibrium phase, including but not limited to liquid, solid, and gas. Additionally, in some embodiments, the equilibrium phase of matter of the first substance (e.g., water, solvent, etc.) corresponds to phase transitions such as thawing, melting, freezing, condensing, sublimating, sublime, vaporization, and deposition.

In some embodiments, the system utilizes the Clausius-Clapeyron relation to determine the equilibrium phase of matter of the substances, particularly the first substance (e.g., water, solvent, etc.). This relation characterizes the pressure-temperature relationship during phase transitions, such as from liquid to gas, liquid to solid, or solid to gas. Mathematically, it is expressed as dP/dT=ΔH/TΔV, where dP/dT represents the rate of pressure change with temperature, ΔH is the enthalpy change associated with the transition, T is temperature, and ΔV is the change in volume. Simplifying this relation to describe a vapor pressure curve, also known as the phase line, on a phase diagram for a transition between two phases (e.g., liquid and vapor), yields ln(P₂/P₁)=(−ΔH)/R (1/T₂−1/T₁). Here, P₂ and P₁ are pressures at temperatures T₂ and T₁, ΔH is the enthalpy of vaporization. R is the gas constant, and T₂ and T₁ are temperatures along the phase line. It is important to ensure accurate values for the enthalpy of the phase transition to maintain consistency between temperatures and pressures for each specific phase transition.

In some embodiments, the Clausius-Clapeyron relation is implemented within a pressure range of 1 μTorr to 1000 Torr. In some embodiments, the Clausius-Clapeyron relation is implemented within a pressure range not exceeding 250 Torr.

Subsequently, at step 1310, the system persistently displays, via the display generation component, the real-time data including the real-time temperature and pressure of the second substance (e.g., food, pharmaceutical, etc.), and the real-time equilibrium phase of matter of the first substance (e.g., water, solvent, etc.).

In some embodiments, the system detects an interface switch input, such as transitioning from the status tab 201 to the run/setup tab 202. Upon detecting this interface switch input, the system seamlessly switches to a different interface view while maintaining the persistent display, via the display generation component, of parameters including the temperature measurement of the second substance (e.g., food, pharmaceuticals, etc.), the pressure measurement of the second substance (e.g., food, pharmaceuticals, etc.), and the equilibrium phase of matter of the first substance (e.g., water, solvent, etc.). For example, when transitioning from the run/setup tab 202 depicted in FIG. 6B to the functions tab 203 depicted in FIG. 7C, the dashboard 260 persistently displays the temperature, pressure, and equilibrium phase of matter information.

In some embodiments, the temperature (Shelf), pressure (mTorr), and phase (SUBLIME) are persistently displayed in fixed locations on the display generation component. For instance, the precise positioning of these elements on the dashboard 260 remains consistent, enhancing consistency in the graphical user interface.

In some embodiments, the temperature (Shelf), pressure (mTorr), and phase (SUBLIME) are persistently displayed as fixed elements on the display generation component. This ensures that regardless of changes in the graphical user interface (window) or system interface (desktop), these parameters remain consistently visible on the dashboard 260.

In some embodiments, the system persistently displays the temperature (Shelf), pressure (mTorr), and phase (SUBLIME) as integral components within the graphical user interface 1302.

In some embodiments, the system receives real-time data, including a real-time environmental control variable setting. This setting, corresponding to the duty cycle (the amount of pulse width modulation applied to the power diffusers, e.g., electrical heating elements 514A-514F), is persistently displayed via the display generation component. For example, the dashboard 260 in FIGS. 2A-12D includes the real-time environmental control variable setting (e.g., PWM).

In some embodiments, the system receives real-time data, including a real-time set point of the environmental control variable. This set point, defined in the setup to establish a target for either a pressure measurement or a temperature of the second substance (e.g., food, pharmaceutical, etc.), is also persistently displayed via the display generation component. For example, the dashboard 260 in FIGS. 2A-12D includes the real-time set point of the environmental control variable (e.g., SP).

In some embodiments, the system receives real-time data, including a second real-time temperature of the first substance (e.g., water, solvent, etc.) or a third substance different from the first and second substances. In some embodiments, this second real-time temperature corresponds to the cold trap temperature as depicted in FIGS. 2A-12D. The second real-time temperature is also persistently displayed via the display generation component. For example, the dashboard 260 in FIGS. 2A-12D includes the second real-time temperature (e.g., Trap).

In some embodiments, the system receives real-time data, including a real-time mass estimate. This estimate corresponds to the amount of the first substance (e.g., water, solvent, etc.) removed from the second substance (e.g., food, pharmaceutical, etc.) as depicted in FIGS. 2A-12D. The real-time mass estimate is also persistently displayed via the display generation component. For example, the dashboard 260 in FIGS. 2A-12D includes the real-time mass estimate (e.g., H2O). In some embodiments, the mass estimate corresponds to the amount of the first substance (e.g., water, solvent, etc.) remaining in the second substance (e.g., food, pharmaceutical, etc.).

The system detects a unit conversion request, typically initiated by a touch on a touch-sensitive surface linked to displaying temperature, pressure, or mass estimate data. For example, the unit conversion request may be triggered by touching areas of the dashboard 260 corresponding to temperature (Shelf or Trap), pressure (mTorr), and mass estimate (H2O).

In response to detecting the unit conversion request and in accordance with a determination that the unit conversion request corresponds to a request to convert the real-time temperature measurement of the second substance (e.g., food, pharmaceutical, etc.) from a first measurement category to a second measurement category different from the first measurement category, the system first converts the real-time temperature measurement of the second substance (e.g., food, pharmaceutical, etc.) from the first measurement category to the second measurement category and updates the display of the real-time temperature measurement of the second substance (e.g., food, pharmaceutical, etc.) in the second measurement category.

In response to detecting the unit conversion request and in accordance with a determination that the unit conversion request corresponds to a request to convert the real-time pressure measurement of the second substance (e.g., food, pharmaceutical, etc.) from a third measurement category to a fourth measurement category different from the third measurement category, the system converts the real-time pressure measurement of the second substance (e.g., food, pharmaceutical, etc.) from the third measurement category to the fourth measurement category and updates the display of the real-time pressure measurement of the second substance (e.g., food, pharmaceutical, etc.) in the fourth measurement category.

In response to detecting the unit conversion request and in accordance with a determination that the unit conversion request corresponds to a request to convert the real-time mass estimate from a fifth measurement category to a sixth measurement category different from the fifth measurement category, the system converts the real-time mass estimate from the fifth measurement category to the sixth measurement category and updates the display of the real-time mass estimate in the sixth measurement category.

At step 1312, the system determines whether a predetermined time period has elapsed. If the system determines that the predetermined time period has elapsed, it adds the real-time temperature measurement of the second substance (e.g., food, pharmaceuticals, etc.) to a sequence of temperature data for the second substance (e.g., food, pharmaceuticals, etc.). The sequence of temperature data is maintained in chronological order. For example, one approach to displaying the temperature data is to arrange it chronologically such that the real-time temperature corresponds to an endpoint (e.g., initial or final position) of the sequence.

If the system determines that the predetermined time period has elapsed, it persistently displays the temperature, pressure, and equilibrium phase of matter of the first substance (e.g., water, solvent, etc.), along with at least one element of a sequence of temperature data representing historical temperatures. For example, during a lyophilization process the dashboard 260 may incorporate historical temperature data to offer process context, such as indicating a relative temperature maximum or minimum.

In response to determining that the predetermined time period has elapsed, the system projects a temperature target for the second substance (e.g., food, pharmaceutical, etc.) for an upcoming period and persistently displays the current temperature measurement, pressure measurement, and equilibrium phase of matter of the first substance (e.g., water, solvent, etc.), alongside the estimated temperature target. For example, in a lyophilization process, the system might anticipate that within the next hour, the substance should reach a specific temperature to ensure optimal conditions. Consequently, the system continues to display the ongoing temperature and pressure measurements, along with the equilibrium phase of matter of the substance, while including the estimated temperature target, thereby displaying the anticipated temperature trend.

In response to determining that the predetermined time period has elapsed, the system includes the real-time pressure measurement of the second substance (e.g., food, pharmaceutical, etc.) into a chronological sequence of pressure data for the second substance (e.g., food, pharmaceutical, etc.). This sequence of pressure data is arranged in chronological order, ensuring that the real-time pressure measurement aligns with an endpoint (e.g., initial or final position) of the sequence. For example, a common method for presenting pressure data involves organizing it chronologically to reflect the position of the real-time pressure measurement within the sequence.

In response to determining that the predetermined time period has elapsed, the system persistently displays the temperature, pressure, equilibrium phase of matter, and at least one element from the sequence of pressure data corresponding to a historical pressure measurement. For example, the dashboard 260 may feature historical pressure data, offering contextual information for the process, such as relative pressure maximums or minimums.

In response to a determination that the predetermined time period has elapsed, the system estimates a pressure target of the second substance (e.g., food, pharmaceutical, etc.) for a future time period, and persistently displays, the temperature, the pressure, the equilibrium phase of matter of the first substance (e.g., water, solvent, etc.), and the pressure target. For example, in a lyophilization process, the system estimates a pressure target for the second substance (e.g., food, pharmaceutical, etc.) over the next hour to maintain optimal processing conditions. Consequently, the system persistently displays the current temperature and pressure measurements, along with the equilibrium phase of matter of the substance, and incorporates the projected pressure target, thereby displaying the pressure trend.

In some embodiments, in response to detecting a customization input, the system customizes one or more preferences of the persistent display, which includes the temperature, pressure, and equilibrium phase of matter. For example, if the color scheme or font size on the display is adjusted, the system modifies these preferences accordingly.

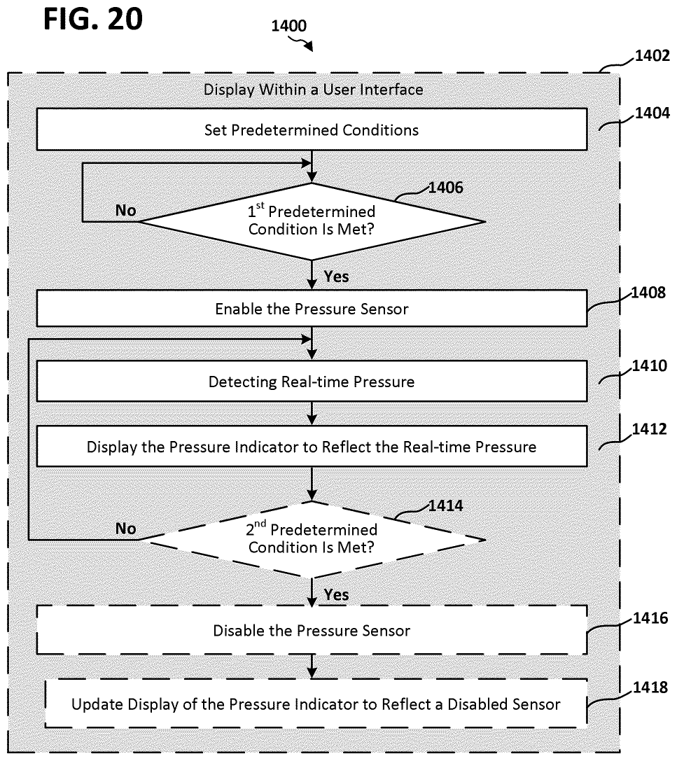

FIG. 20 illustrates a flow diagram outlining a method 1400 for enabling a pressure sensor upon meeting conditions and displaying real-time pressure using the sensor. The system interfaces with both the pressure sensor and a display generation component. In some embodiments, the pressure sensor is a thermocouple vacuum sensor like DV-6, DV-4, and 531. Other types include piezoelectric strain sensors, piezo-resistive pressure sensors, capacitive pressure sensors, optical pressure sensors, resonant solid-state pressure sensors, magnetic pressure sensors, and strain gauge pressure sensors, among others.

The system displays a process within a distinct graphical user interface 1402. In some embodiments, the graphical user interface 1402 operates independently of the underlying operating system, providing the capability to halt or restart the interface without affecting core operating system functionality.

In some embodiments, the pressure sensor is enabled or disabled based on one or more phases of the process. For example, a lyophilization process encompasses distinct phases, such as freezing, which primarily focuses on solidifying the second substance (e.g., food, pharmaceuticals) and is typically pressure-insensitive. Subsequent phases, such as primary and secondary drying, emphasize the removal of the first substance (e.g., water, solvent), which is pressure sensitive.

At step 1404, a first and a second predetermined condition are established. In general, these conditions focus on lifecycle management of the pressure sensor and its associated circuitry, which, akin to the filament of a lightbulb, have a finite operational lifespan. The first predetermined condition, when met, initiates the activation of the pressure sensor, allowing it to commence its monitoring function. Conversely, the second predetermined condition, when satisfied, triggers the deactivation of the pressure sensor, effectively suspending its operation. This proactive approach of enabling and disabling the pressure sensor serves to prolong its longevity, safeguarding against premature wear.

At step 1406, the system determines if a first predetermined condition is satisfied. If the first predetermined condition is satisfied, the system initiates a series of actions to read the pressure sensor. Satisfying the first predetermined condition may consist of meeting a single component or a combination of components. For example, in some embodiments, the first predetermined condition at is satisfied when the process is initiated, such as by selecting the start button 350A in FIG. 4G. Initiating the process ensures continuous capture of pressure data throughout its entirety.

Likewise, in some embodiments, the first predetermined condition is satisfied solely when the system receives a request to detect pressure. For example, the first predetermined condition is satisfied when the system requests pressure data at the vacuum pump activation set point 360A2 depicted in FIGS. 5B and 5C, which is after freezing the second substance (e.g., food, pharmaceuticals) well into the lyophilization process.

Alternatively, satisfying the first predetermined condition could involve a combination of components such as detecting the initiation of the process to start a timer, which completes when it reaches a predetermined duration. For example, the first predetermined condition can be satisfied after 9 hours of freezing time since the process initiation (near the vacuum pump activation set point 360A2 shown in FIGS. 5B and 5C).

In some embodiments, the first predetermined period of time is dynamically adjusted based on one or more process parameters. For example, the system may monitor the cooling curve, as depicted in FIGS. 5B-5C, to determine the solidus temperature (point 362C). Once there is a high confidence level, such as 99%, that the second substance (e.g., food, pharmaceutical, etc.) is frozen based on this temperature, the first predetermined time period for the freezing phase is adjusted accordingly.

The first predetermined period of time is configurable, enabling adjustments to the duration (e.g., 15 minutes, 30 minutes, 1 hour). This configurability feature facilitates timing either before the process is initiated or during its execution, providing flexibility for real-time adjustments.

Additionally, the first predetermined condition might be contingent on a specific temperature or pressure threshold. For example, the first predetermined condition might be satisfied when temperature reaches 0° C. corresponding to the vacuum pump activation set point 360A2 shown in FIGS. 5B and 5C.

The system also implements an enablement override that fully satisfies the first predetermined condition by receiving an activation input associated with the pressure sensor. For example, checking the first pressure sensor 450A of FIG. 7B fully satisfies the first predetermined condition.

Upon satisfying the first predetermined condition, the system enables the pressure sensor as at step 1408. For vacuum tube thermocouples, the system activates the pressure sensor by delivering a predetermined electrical current through one or more filaments within the sensor. In some embodiments, this current is initiated using a Heaviside function, followed by a constant current applied through the filament. Alternatively, in other embodiments, the system gradually increases the electrical current through the filaments to achieve a predetermined level, following a specified ramping pattern. For other types of sensors, such as piezoelectric strain sensors or piezo resistive pressure sensors, the system may enable them by providing an appropriate voltage or current signal to activate their sensing elements.

While the pressure sensor is enabled, the system displays, via the display generation component, a graphical object in an enabled state, which represents active pressure measurements. For example, the first pressure sensor 450A includes a checkmark when the first pressure sensor is enabled, as depicted in FIGS. 7B-7F.

If the system detects deactivation of a control element associated with the graphical object while the pressure sensor is active, it promptly disables the sensor and alters the graphical representation to a distinct disabled state. For example, deactivation of the first pressure sensor 450A removes the checkmark and displays it without the indicator, as shown in FIG. 7A.

Upon detecting deactivation of the control element associated with the graphical object, the system updates the display of the pressure indicator, via the display generation component, to reflect that the pressure sensor is disabled. For example, “DISABLED” is displayed on the dashboard 250 as depicted in FIG. 7A to convey that the pressure sensor is indeed disabled.

The system may detect an error condition associated with the pressure sensor, such as a pressure malfunction, indicated by irregular readings or sensor failure. In response to detecting the error condition associated with the pressure sensor, the system displays, via the display generation component, an alert indicating the error condition and disables the pressure sensor if it is enabled.

In some embodiments, the system is in communication with a remote device equipped with a second display component, such as smartphones 692 (with a display generation component) or computers 720 (with a display generation component). Upon detecting the error condition the system triggers the remote device to display, via the second display component, the alert indicating the error condition.

In some embodiments, upon detecting the error condition the system adjusts one or more process parameters. This adjustment involves disabling one or more devices integral to the lyophilization process, such as the heating elements 514A-514F, the vacuum pump, shelf enclosure compressor 513A, cold trap compressor 513B, etc. By disabling these devices, the system ensures they are placed in a safe state, effectively suspending the lyophilization process to prevent potential harm to both the system and the substances being processed.

For redundancy, the system often is in communication with a second pressure sensor such as the 450B depicted in FIGS. 7A-7F. Upon detecting the error condition, the system switches to the secondary pressure sensor and verifies its activation status. If the second pressure sensor is disabled the system enables it and continues the process. Conversely, if it is already enabled the system forgoes enabling the second pressure sensor.

At step 1410, the system detects real-time pressure using the enabled pressure sensor. Typically, the system actively monitors real-time pressure utilizing the enabled pressure sensor throughout the duration of the process.

At step 1412 the system displays, via the display generation component, a pressure indicator to reflect the real-time pressure. The pressure indicator may feature numerical values representing real-time pressure measurement. For example, a pressure of 759657 mTorr is displayed on the dashboard 250 as depicted in FIG. 7B in contrast to “DISABLED” as depicted in FIG. 7A. Furthermore, it is important to note that the format of the pressure indicator can be customized to accommodate user preferences. This customization may include incorporating color-coded visual cues that correspond to specific pressure level thresholds.

At step 1414, the system determines if a second predetermined condition is met. If the second predetermined condition is satisfied, the system initiates a series of actions to deactivate the pressure sensor in order to prolong its longevity. The second predetermined condition can be satisfied through a single component or a combination of components. For example, the second predetermined condition is satisfied when the lyophilization process terminates such as in response to selecting the start button 350B in FIG. 5A.

Likewise, in some embodiments, the second predetermined condition is satisfied solely when the system receives a request to cease detecting pressure. For example, a request to cease detecting pressure is sent when the detected pressure drops below the tolerance of the pressure sensor (e.g., 1 mTorr) (not shown), thereby triggering the second predetermined condition to be satisfied.

Satisfying the second predetermined condition could also involve a combination of components such as detecting the termination of the process to start a timer that completes after a second predetermined period has elapsed. That is, the second predetermined condition can be satisfied 15 minutes or more after the process has terminated. This gives time to check and resume the process without cycling the pressure sensor.

In some embodiments, the second predetermined period of time is dynamically adjusted based on one or more process parameters. The system may monitor the second mass indicator corresponding to the estimated quantity of mass and once there is a high confidence level that over 99% of the first substance (e.g., water, solvent, etc.) has been removed from the second substance (e.g., food, pharmaceutical, etc.), the second predetermined time period for the freezing phase is adjusted to extend and provide a buffer to ensure that the process is complete.

The second predetermined period of time is configurable, enabling adjustments to the duration (e.g., 15 minutes, 30 minutes, 1 hour). This configurability feature facilitates timing either after or before the process is terminated, providing flexibility for real-time adjustments.

In some embodiments, the second predetermined condition is satisfied upon exceeding a specific temperature or pressure threshold. For example, the second predetermined condition might be satisfied when pressure reaches 1 mTorr corresponding to the tolerance of the pressure sensor.

The system also implements a disablement override that fully satisfies the second predetermined condition by receiving a deactivation input associated with the pressure sensor. For example, unchecking the first pressure sensor 450A as depicted in FIG. 7A fully satisfies the second predetermined condition.

Upon satisfying the second predetermined condition, the system disables the pressure sensor as at step 1416. For vacuum tube thermocouples, the system deactivates the pressure sensor by ceasing the flow of a predetermined electrical current through one or more filaments within the sensor. In some embodiments, this current is initiated using a Heaviside function, followed by cessation of current (not including leakage current) through the filament. In some embodiments, the system progressively decreases the electrical current through the filaments to achieve a minimal level, following a specified ramping pattern. For other types of sensors, such as piezoelectric strain sensors or piezo resistive pressure sensors, the system may disable them by ceasing voltage or current signals that deactivate their sensing elements.

While the pressure sensor is disabled, the system displays, via the display generation component, a graphical object in a disabled state, which represents inactive pressure measurements. For example, the first pressure sensor 450A lacks a checkmark when the first pressure sensor is disabled, as depicted in FIG. 7A.

If the system detects activation of a control element associated with the graphical object while the pressure sensor is inactive, it promptly enables the sensor and alters the graphical representation to a distinct enabled state. For example, activation of the first pressure sensor 450A displays the checkmark, as depicted in FIGS. 7B-7F.

Upon detecting activation of the control element associated with the graphical object, the system updates the display of the pressure indicator, via the display generation component, to reflect that the pressure sensor is enabled. For example, the dashboard 250 can display “ENABLED” when not actively sensing pressure or display the real-time pressure like “759657 mTorr” as depicted in FIG. 7B to convey that the pressure sensor is enabled.

The system updates the display, via the display generation component, of the pressure indicator to reflect that the pressure sensor is disabled, as at step 1418. For example, the dashboard 250 in FIG. 7B displays “DISABLED” as depicted in FIG. 7A.

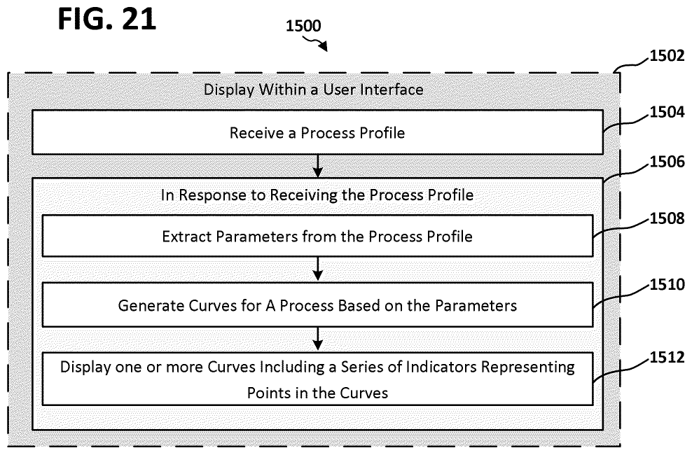

FIG. 21 illustrates a flow diagram outlining a method 1500 for extracting parameters from a substance profile, generating process curves based on the extracted parameters, and displaying the generated process curves. The system interfaces with a display generation component to initiate the (lyophilization) process, presenting the outcomes within a distinct graphical user interface 1502. In some embodiments, the graphical user interface 1502 operates independently of the underlying operating system, providing the capability to halt or restart the interface without affecting core operating system functionality.

At step 1504, the system receives a profile of a second substance (e.g., food, pharmaceutical, etc.), which is typically imported through a profile prompt 346A as depicted in FIG. 3C. The profile provides thermodynamic parameters, previous process data, material composition, physical properties, etc. applicable to characterizing the process. In some embodiments, the profile corresponds to a thermodynamic profile.

At step 1506, in response to receiving the profile of the second substance (e.g., food, pharmaceutical, etc.); the system initiates a sequence of actions to characterize a process. Initially, at step 1508, the system extracts one or more parameters of the second substance from the received profile. These parameters, including thermodynamic properties (e.g., pre-freezing slopes y₁/x₁ post-freezing slopes y₃/x₃, solidification slopes y₂/x₂, etc.), previous process data (e.g., preferred set points, control variable settings, etc.), material composition (e.g., amount of first substance in the second substance), and physical characteristics provide tailored data for the curve generation. In some embodiments, the process corresponds to a lyophilization process.

Proceeding to step 1510, the system generates one or more curves for the process of the second substance based on various parameters. For example, the system may generate a cooling curve akin to those depicted in FIGS. 5B and 5C, utilizing factors such as cooling rates, the liquidus temperature (point 362B), solidus temperature (point 362C), and the expected quantity of the first substance (e.g., water, solvent, etc.) in the second substance (e.g., food, pharmaceutical, etc.). These parameters aid in determining the time required for the second substance (e.g., food, pharmaceutical, etc.) to attain specific states during the cooling process.

In some embodiments, the one or more curves correspond to any one of a temperature curve, a pressure curve, and a phase transition curve. For example, the system may generate other curves such as the transient pressure control curve 360-1 (transient pressure plot 210), the transient dynamic pump pressure control curve 370-1 (transient pressure plot 210), transient temperature control curve 360-2 (transient temperature plot 220), dynamic temperature control curve 370-2 (transient temperature plot 220), the environmental control curve 360 (phase plot 230), and dynamic environmental control curve 370 (phase plot 230).

Typically, the one or more parameters of the second substance (e.g., food, pharmaceutical, etc.) includes a liquidus temperature (point 362B) and a solidus temperature (point 362C). For example, as illustrated in FIG. 5B-5C, the system incorporates two distinct temperatures instead of a single melting point. The liquidus temperature (point 362B) denotes the temperature at which the system is entirely liquid, while the solidus temperature (point 362C) denotes the temperature at which the system is completely solid. The region between these points represents phase equilibrium where both liquid and solid phases coexist. In some embodiments, at least a portion of the one or more curves includes a cooling curve with a liquidus temperature and a solidus temperature.

At step 1512 the system displays, via the display generation component, the one or more curves for the process including one or more series of indicators, each indicator representing a point on the one or more curves. For example, as depicted in the phase plot 230 of FIG. 3D-3G, the generated environmental control curve 360 includes a dynamic pressure set point 360A, a phase curve equilibrium set point 360B, an initial pressure set point 360C, an equilibrium pressure set point 360D, a final temperature set point 360E, and a final pressure set point 360F.

Similar indicators are displayed for the cooling curves depicted in FIGS. 5C and 5B, transient pressure control curve 360-1 (transient pressure plot 210), the transient dynamic pump pressure control curve 370-1 (transient pressure plot 210), transient temperature control curve 360-2 (transient temperature plot 220), dynamic temperature control curve 370-2 (transient temperature plot 220), and dynamic environmental control curve 370 (phase plot 230).

In some embodiments, the one or more series of indicators displayed on the display generation component include visual cues representing different stages or properties of the process. For example, during a (lyophilization) process, the system might utilize colored regions on a graph to denote distinct process phases such as freezing, primary drying, and secondary drying. Alternatively, colored markers or different symbols could highlight specific events or milestones within the process, such as the initiation of a new phase or the attainment of set point temperatures or pressures. These visual cues provide intuitive insights into the progression and status of the process at a glance.

During the process the system estimates a quantity of mass of a first substance (e.g., water, solvent, etc.) within the second substance (e.g., food, pharmaceutical, etc.). For example, the system estimates the mass of the first substance (e.g., water, solvent, etc.) separated from the second substance (e.g., food, pharmaceutical, etc.), displaying a corresponding mass indicator on the dashboard 260 (e.g., shown as 0.00 kg in FIG. 5A-5C). Additionally, the transient mass plot 270 depicted in FIGS. 6A-6R visually represents the sublimation mass rate distribution and the cumulative mass distribution throughout the freeze-drying (e.g., lyophilization) process. Moreover, the estimate parameter 330B, visible on the graphical user interface of FIG. 5C and FIG. 5A-5C, offers feedback regarding the ongoing mass estimate (e.g., 3.58 kg) throughout the process.

In some embodiments, the one or more parameters of the second substance (e.g., food, pharmaceutical, etc.) includes a set of pre-freezing slopes (e.g., slope y₁/x₁ of FIGS. 5B and 5C). Each of the pre-freezing slopes (e.g., slope y₁/x₁ of FIGS. 5B and 5C) is associated with a quantity of mass of a first substance (e.g., water, solvent, etc.) within the second substance (e.g., food, pharmaceutical, etc.). During the process, the system calculates a pre-freezing slope (e.g., slope y₁/x₁ of FIGS. 5B and 5C) of the process and interpolates the quantity of mass of the first substance (e.g., water, solvent, etc.) from the pre-freezing slope (e.g., slope y₁/x₁ of FIGS. 5B and 5C) of the process and the set of pre-freezing slopes (e.g., slope y₁/x₁ of FIGS. 5B and 5C).

In some embodiments, the one or more parameters of the second substance (e.g., food, pharmaceutical, etc.) includes a set of post-freezing slopes (e.g., slope y₃/x₃ of FIGS. 5B and 5C). Each of the post-freezing slopes (e.g., slope y₃/x₃ of FIGS. 5B and 5C) is associated with a quantity of mass of a first substance (e.g., water, solvent, etc.) within the second substance (e.g., food, pharmaceutical, etc.). During the process, the system calculates a post-freezing slope (e.g., slope y₃/x₃ of FIGS. 5B and 5C) of the process and interpolates the quantity of mass of the first substance (e.g., water, solvent, etc.) from the post-freezing slope (e.g., slope y₃/x₃ of FIGS. 5B and 5C) of the process and the set of post-freezing slopes (e.g., slope y₃/x₃ of FIGS. 5B and 5C).

In some embodiments, the one or more parameters of the second substance (e.g., food, pharmaceutical, etc.) includes a set of solidification slopes (e.g., slope y₂/x₂ of FIGS. 5B and 5C). Each of the solidification slopes (e.g., slope y₂/x₂ of FIGS. 5B and 5C) is associated with a quantity of mass of a first substance (e.g., water, solvent, etc.) within the second substance (e.g., food, pharmaceutical, etc.). During the process, the system calculates a solidification slope (e.g., slope y₂/x₂ of FIGS. 5B and 5C) of the process and interpolates the quantity of mass of the first substance (e.g., water, solvent, etc.) from the solidification slope (e.g., slope y₂/x₂ of FIGS. 5B and 5C) of the process and the set of solidification slopes (e.g., slope y₂/x₂ of FIGS. 5B and 5C).

In some embodiments, the one or more parameters of the second substance (e.g., food, pharmaceutical, etc.) includes an equation correlating a quantity of mass of a first substance (e.g., water, solvent, etc.) within the second substance to a pre-freezing slope (e.g., slope y₁/x₁ of FIGS. 5B and 5C) of the second substance (e.g., food, pharmaceutical, etc.). During the process, the system calculates the pre-freezing slope (e.g., slope y₁/x₁ of FIGS. 5B and 5C) and estimates the quantity of the mass of the first substance (e.g., water, solvent, etc.) using the equation and the pre-freezing slope (e.g., slope y₁/x₁ of FIGS. 5B and 5C).

In some embodiments, the one or more parameters of the second substance (e.g., food, pharmaceutical, etc.) includes an equation correlating a quantity of mass of a first substance (e.g., water, solvent, etc.) within the second substance to a post-freezing slope (e.g., slope y₃/x₃ of FIGS. 5B and 5C) of the second substance (e.g., food, pharmaceutical, etc.). During the process, the system calculates the post-freezing slope (e.g., slope y₃/x₃ of FIGS. 5B and 5C) and estimates the quantity of the mass of the first substance (e.g., water, solvent, etc.) using the equation and the post-freezing slope (e.g., slope y₃/x₃ of FIGS. 5B and 5C).

In some embodiments, the one or more parameters of the second substance (e.g., food, pharmaceutical, etc.) includes an equation correlating a quantity of mass of a first substance (e.g., water, solvent, etc.) within the second substance (e.g., food, pharmaceutical, etc.) to a solidification slope (e.g., slope y₂/x₂ of FIGS. 5B and 5C) of the second substance (e.g., food, pharmaceutical, etc.). During the process, the system calculates the solidification slope (e.g., slope y₂/x₂ of FIGS. 5B and 5C) and estimates the quantity of the mass of the first substance (e.g., water, solvent, etc.) using the equation and the solidification slope (e.g., slope y₂/x₂ of FIGS. 5B and 5C).

Typically, the one or more parameters of the second substance (e.g., food, pharmaceutical, etc.) includes one or more thermal parameters. For instance, thermal parameters may include conductivity, specific heat capacity, and latent heat of fusion, and others such as thermal diffusivity, thermal expansion coefficient, and thermal conductivity.

In some embodiments, the one or more parameters of the second substance (e.g., food, pharmaceutical, etc.), such as the liquidus temperature (point 362B) and solidus temperature (point 362C), are integral components. As the process unfolds, the system continuously monitors the real-time temperature. Upon detecting that the real-time temperature surpasses the liquidus temperature (point 362B), the system marks the start time. Similarly, if the real-time temperature exceeds the solidus temperature (point 362C), the system records the end time. Subsequently, the system calculates the elapsed time between the start and end points to estimate the quantity of mass of a first substance (e.g., water, solvent, etc.) present within the second substance (e.g., food, pharmaceutical, etc.).

The system often refines one or more process event estimates utilizing the estimated quantity of mass of the first substance (e.g., water, solvent, etc.) present within the second substance (e.g., food, pharmaceutical, etc.). Following this refinement, the system proceeds to update the display via the display generation component. This update reflects the adjustments made to the one or more curves for the process, aligning them with the refined process event estimates and including the one or more series of indicators.

The system displays, via the display generation component, a first mass indicator corresponding to the estimated quantity of mass of the first substance. For example, the system displays the estimated quantity of mass of the first substance through a first mass indicator on the dashboard 260 (e.g., 0.00 kg in FIG. 5A-5C), along with the transient mass plot 270 in FIGS. 6A-6R illustrating cumulative mass distribution during (lyophilization). Additionally, the estimate parameter 330B on the graphical user interface of FIG. 5C and FIG. 5A-5C provides ongoing feedback on the mass estimate (e.g., 3.58 kg) throughout the process.

Preferably, the system includes a mass monitoring component. For example, in some embodiments, the mass monitoring component corresponds to any one of a thermodynamic model (e.g., heat transfer for sublimation), one or more scales (e.g., the shelf scale 524A, the enclosure scale 524B, the trap scale 524C, as depicted in FIGS. 10A-10C), and an image-capturing system (e.g., near-infrared spectroscopy (NIR)).

During the process, the system determines, via the mass monitoring component, an amount of the first substance (e.g., water, solvent, etc.) remaining in the second substance (e.g., food, pharmaceutical, etc.) and displays, via the display generation component, a second mass indicator corresponding to the estimated quantity of mass of the first substance (e.g., water, solvent, etc.) remaining in the second substance (e.g., food, pharmaceutical, etc.).

In some embodiments, the system optimizes a thermodynamic model using the one or more parameters and derives one or more predictive results from the thermodynamic model. For example, during a (lyophilization) process, the system might iteratively adjust parameters such as the cooling rate, heat transfer coefficients, and the like based on real-time data feedback and historical process performance. In some embodiments, at least one parameter of the one or more parameters of the second substance (e.g., food, pharmaceutical, etc.) is iteratively refined over multiple (lyophilization) processes.

Through machine learning algorithms or artificial intelligence techniques, the system continuously refines the thermodynamic model to better simulate and predict the behavior of the substance during the process. This iterative optimization process enhances the accuracy of predictive results derived from the thermodynamic model, allowing for more precise control and optimization of the (lyophilization) process. In some embodiments, the system refines the one or more parameters of the second substance (e.g., food, pharmaceutical, etc.) to optimize any one of processing time duration, reduced energy consumption, and elevated product quality.

In some embodiments, the one or more parameters includes one or both of a pressure set point and a temperature set point, each optimized for at least one of elevated product quality, reduced energy consumption, and processing time duration. Throughout the process, when optimized product quality is desired, adjustments are made to one or both of the pressure set point and the temperature set point, aligning them with optimized values conducive to enhanced product quality. Likewise, when reduced energy consumption is desired, adjustments are made to one or both of the pressure set point and the temperature set point, aligning them with optimized values conducive to reduced energy consumption. Alternatively, when reduced processing time is desired, adjustments are made to one or both of the pressure set point and the temperature set point, aligning them with optimized values conducive to processing time duration. Additionally, the timing (e.g., triggering times) of various process events may also be adjusted accordingly.

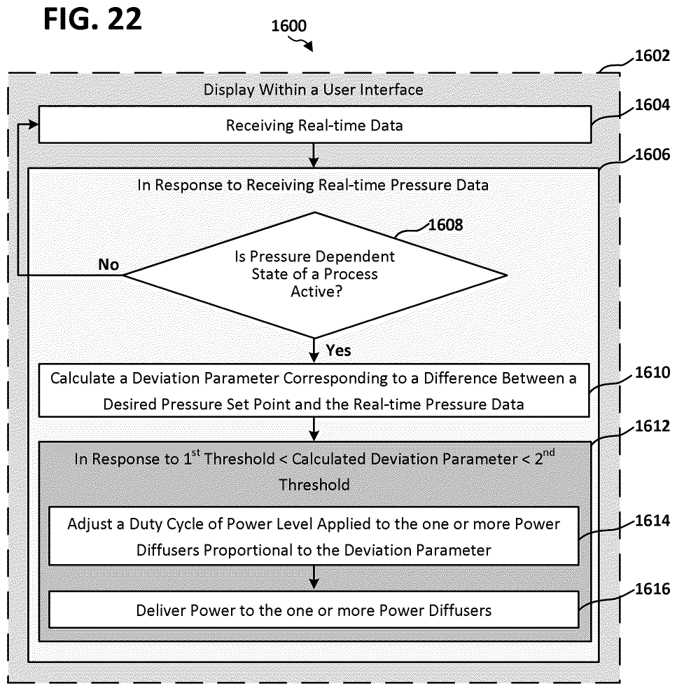

FIG. 22 illustrates a flow diagram outlining a method 1600 for adjusting the power level applied to the power diffusers proportionally to a deviation parameter within specified thresholds. The system interfaces with a power generator operatively coupled to one or more power diffusers and optionally with a display generation component to initiate the (lyophilization) process, presenting the outcomes within a distinct graphical user interface 1602. In some embodiments, the graphical user interface 1602 operates independently of the underlying operating system, providing the capability to halt or restart the interface without affecting core operating system functionality.

At step 1604, the system continuously receives real-time data from one or more sensors including real-time pressure data, such as a pressure sensor 450, and/or real-time temperature data, ensuring a constant flow of updated information. This ongoing refresh process maintains the timeliness of the data, with the time interval for data acquisition being predefined, for example, as 1 second, 5 seconds, 15 seconds, or any other suitable duration.

At step 1606, upon receiving the real-time pressure data, the system initiates a sequence of actions to adjust power levels, via the power generator, based on a calculated deviation parameter. In some embodiments, when the system is further in communication with a display generation component, it displays, via the display generation component, the calculated deviation parameter. For example, as depicted in FIGS. 2A-12D, the PWM is displayed in the dashboard 260.

Starting with step 1608, the system assesses if a pressure-dependent state of a process is currently active. For example, in FIG. 4A-4E, the pressure-dependent state of the (lyophilization) process depicted in the transient pressure plot 210 is active starting from the vacuum pump activation set point 360A1 until the transient final temperature set point 360E1 or the dynamic transient final temperature set point 370B1.

In general, the pressure-dependent state is adjusted either by throttling the vacuum pump or by leveraging the pressure and temperature relationship of the first substance (e.g., water, solvent, etc.). When leveraging the pressure-temperature relationship, the system applies power to one or more power diffusers to adjust the temperature of the second substance (e.g., food, pharmaceutical, etc.) to reach a specific pressure set point, guided by the deviation parameter, which indicates the current error between the pressure set point and the real-time pressure. While in a pressure-dependent state and in response to receiving the real-time pressure data at step 1610, the system calculates a deviation parameter based on the difference between the desired pressure set point and the real-time pressure data. In some embodiments, the deviation parameter is derived from a PID that sums the error for the proportional coefficient (P) 320A, integral coefficient (I) 320B, and derivative coefficient (D) 320C. In some embodiments, the deviation parameter is calculated using a proportional-integral-derivative (PID) control algorithm.

In leveraging the pressure and temperature relationship of the pressure dependent process, the power generator and the power diffusers, which control the rate of energy delivery to the second substance (e.g., food, pharmaceutical, etc.), are equipped with a range setting from −1 to 99, where −1 represents disabled power generator and 99 signifies maximum power generated by the power generator. For simplicity, the deviation parameter aligns with this range so that any calculated value of the deviation parameter below “−1” is set, the deviation parameter to “−1”, and any calculated value of the deviation parameter above “99” is set to “99”. It should be appreciated that the range setting input of the power generator can be any range, for example a range from 0-100, 10-99, 500-1000, etc. are all equally valid.

If the calculated deviation parameter exceeds the second threshold (e.g., PWM 99), indicating a significant positive deviation from the desired pressure set point (e.g., corresponding to too little pressure), the system promptly adjusts the power delivered, via the power generator, to the one or more power diffusers to the maximum power level of “99” to rapidly regulate the pressure. That is, the maximum power corresponds to full power delivered to the one or more power diffusers.

Conversely, if the deviation parameter does not exceed the first threshold (e.g., PWM −1), indicating a significant negative deviation from the desired pressure set point (e.g., corresponding to too much pressure), the system adjusts the power level, via the power generator, applied to the power diffusers to a minimum (e.g., setting the power level to 0). In some embodiments, the minimum power level corresponds to no power delivered to the one or more power diffusers. In some embodiments, when the deviation parameter does not exceed the first threshold the system disables the power from the power generator by setting it to “−1”, allowing the pressure to stabilize naturally without any energy input.

If the deviation parameter falls between the first and second threshold values, as outlined in step 1612, the system proportionally adjusts the power level applied to the power diffusers via the power generator, as outlined at step 1614, ranging from −1 to 99, to achieve a balanced and controlled response to pressure fluctuations.

The system also assesses if a temperature-dependent state of a process is currently active. For example, in FIG. 4A-4E, the temperature-dependent state of the (lyophilization) process depicted in the transient temperature plot 220 is active from transient final temperature set point 360E2 until the final temperature set point 360F2.

In general, the temperature-dependent state is adjusted by applying power, via the power generator, to one or more power diffusers to adjust the temperature of the second substance (e.g., food, pharmaceutical, etc.). While in a temperature-dependent state and in response to receiving the real-time temperature data, the system calculates the deviation parameter based on the difference between a desired temperature set point and the real-time temperature data.

If the calculated deviation parameter exceeds the fourth threshold, indicating a significant positive deviation from the desired pressure set point (e.g., corresponding to too little temperature), the system promptly adjusts the power, via the power generator, delivered to the one or more power diffusers to the maximum power level of 99 to rapidly regulate the temperature. That is, the maximum power level of 99 corresponds to full power delivered to the one or more power diffusers.

Conversely, if the deviation parameter does not exceed the third threshold, indicating a significant negative deviation from the desired pressure set point (e.g., corresponding to too much temperature), the system adjusts the power level, via the power generator, applied to the power diffusers to a minimum (e.g., setting the output to 0). In some embodiments, the minimum power level corresponds to no power delivered to the one or more power diffusers. In some embodiments, when the deviation parameter does not exceed the third threshold the system disables the power from the power generator by setting it to −1, allowing the temperature to stabilize naturally without any energy input.

If the deviation parameter falls between the third and fourth threshold values, the system proportionally adjusts the power level applied to the power diffusers via the power generator, ranging from −1 to 99, to achieve a balanced and controlled response to temperature fluctuations.

In step 1616, the system delivers the adjusted power level from the power generator to the designated power diffusers, ensuring each type of diffuser receives the appropriate energy for its specific function.

The power diffusers include various devices delivering specific forms of energy suitable for diverse processes. These include electrical heating elements, which generate heat through electrical resistance, commonly used for providing thermal energy. Radiation emitters emit radiant energy, such as heat or light, like those used in infrared lamps for warming materials. Infrared emitters specifically emit infrared radiation, which can directly apply heat to surfaces or substances. Ultra-violet emitters produce ultraviolet radiation, which can be utilized for various applications involving molecular activity. Microwave emitters generate microwave radiation, suitable for inducing molecular movement in materials. Plasma emitters provide plasma energy, capable of high-energy interactions with substances. Laser emitters produce highly focused and coherent beams of light, suitable for precision heating. Induction heating elements generate heat through electromagnetic induction, enabling controlled and localized heating.

The power generator encompasses a range of components and configurations tailored for precise control and modulation of electrical power. These components include an amplitude modulator, frequency modulator, phase modulator, voltage regulator, power amplifier, waveform generator, signal generator, pulse width modulator (PWM), and current limiter, each offering unique capabilities in adjusting power characteristics.

In some embodiments, the power generator includes an input that is electrically isolated with the output. For example, the power generator implements a bidirectional thyristor with a gate terminal and two main terminals, coupled with an optoisolator featuring input and output terminals. In this configuration, the output terminal of the optoisolator is linked to the gate terminal of the bidirectional thyristor, while a controller, such as a triac or an insulated gate bipolar transistor (IGBT), interfaces with the input terminal of the optoisolator. The controller is specifically designed to generate a variable control signal, enabling precise adjustment of the triggering angle of the bidirectional thyristor for optimal power modulation.

It should be appreciated that the power generator incorporates a versatile array of components and functionalities aimed at precise control and modulation of electrical power. These may include, but are not limited to, an amplitude modulator, frequency modulator, phase modulator, voltage regulator, power amplifier, waveform generator, signal generator, pulse width modulator (PWM), and current limiter. Each of these components contributes to the ability of the system to manipulate power characteristics, enabling tailored adjustments to suit specific operations. Furthermore, the controller is compatible with components such as a Triac or an Insulated Gate Bipolar Transistor (IGBT), enhancing the capability of the system for refined control and modulation.

In some embodiments, the power generator includes a bidirectional thyristor with a gate terminal and two main terminals, an optoisolator having an input terminal and an output terminal, wherein the output terminal of the optoisolator is connected to the gate terminal of the bidirectional thyristor, a controller connected to the input terminal of the optoisolator, wherein the controller is configured to generate a variable control signal to adjust a triggering angle of the bidirectional thyristor. In some embodiments, the controller corresponds to a Triac or an Insulated Gate Bipolar Transistor (IGBT).

The power generator is often configured to generate a modulated waveform and to adjust the power level of the power generator corresponds to adjusting a duty cycle of the modulated waveform. For example, in FIGS. 6B-6G, adjustments to the pulse width modulation (PWM) are depicted, ranging from 61 to 59, to fine-tune the power levels delivered to the power diffuser. FIGS. 7C and 7D depict the distinct modulated waveforms corresponding to PWM values of 62 and 59, respectively, highlighting the differences in duty cycle. These adjustments aim to maintain the desired pressure set point when deviations occur.

In some embodiments, the power generator generates a modulated sinusoidal waveform and the power level is adjusted by modifying the duty cycle of the modulated sinusoidal waveform. For example, in the waveform plot 410 of FIGS. 7C-7E, a PWM-modulated sinusoidal waveform is depicted, where the output voltage curve 414 is modulated with duty cycle values of 62, 59, and 25, respectively, representing different power levels. In some embodiments, the power generator that generates the modulated sinusoidal waveform corresponds to an AC or DC powered dimmer circuit.

Alternatively, the power generator can vary the amplitude of the waveform to adjust the power level. For example, in some embodiments, the power generator generates a sinusoidal waveform and adjusts the power level by modifying the amplitude of the sinusoidal waveform. The resulting waveforms manifest as sinusoids with varied voltage maximums (412B) and voltage minimums (412D).

In some embodiments, when the system is further in communication with a display generation component, it displays, via the display generation component, a waveform representing the power level applied to the one or more power diffusers. For example, as depicted in FIGS. 7A-7E, the waveform plot 410 displays the output voltage curve 414 corresponding to the power level output from the power generator that is delivered to the one or more power diffusers.

In some embodiments, the power generator generates DC power. Adjusting the power level of the power generator entails modifying the voltage or current output of the DC power. For example, if the power generator is delivering DC power to one or more power diffusers (e.g., one or more heating elements 514A-514E), adjusting the power level involves increasing or decreasing the voltage supplied to the one or more power diffusers (e.g., one or more heating elements 514A-514E).

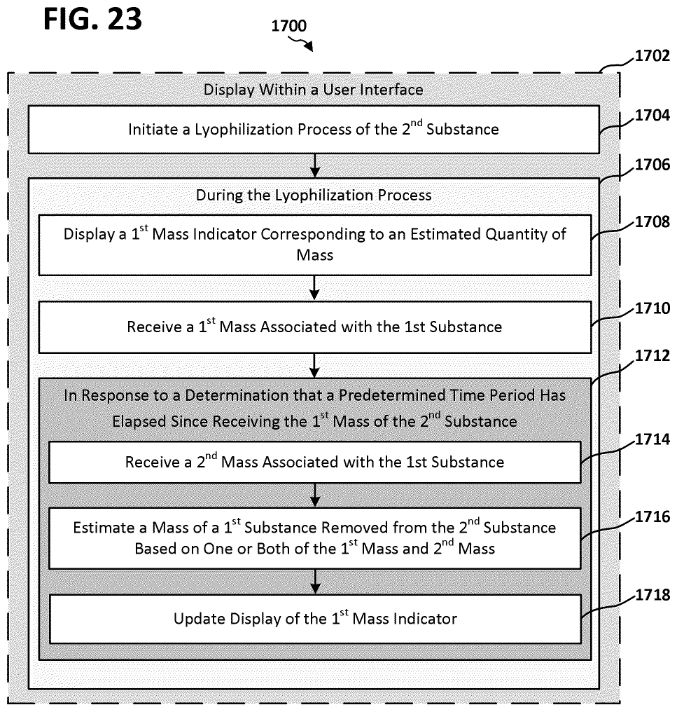

FIG. 23 illustrates a flow diagram outlining a method 1700 for displaying an estimate of a quantity of mass of the first substance (e.g., water, solvent, etc.) removed from the second substance (e.g., food, pharmaceutical, etc.) during a lyophilization process. The system interfaces with a display generation component and a mass monitoring component during the (lyophilization) process, presenting the outcomes within a distinct graphical user interface 1702. In some embodiments, the graphical user interface 1702 operates independently of the underlying operating system, providing the capability to halt or restart the interface without affecting core operating system functionality.

The system often includes a vacuum chamber such as the insulated shelf enclosure 511 depicted in FIGS. 8A-8E and 10A-11L. In some embodiments, the system includes a vacuum chamber where the mass monitoring component is enclosed within the vacuum chamber such as the shelf scale 524A enclosed with the insulated shelf enclosure 511 as depicted in FIGS. 10A-10C. In some embodiments, the system includes a vacuum chamber where the mass monitoring component is outside the vacuum chamber such as the enclosure scale 524B outside the insulated shelf enclosure 511 as depicted in FIGS. 10A-10D.

The mass monitoring component may take various forms. For example, in some embodiments, as illustrated in FIGS. 10A-10C, the monitoring component corresponds to one or more scales, such as the shelf scale (524A), the enclosure scale (524B), and the trap scale (524C) depicted in FIGS. 10A-10D. Each scale serves a specific purpose within the lyophilization system. The shelf scale (524A) measures the mass of the second substance (e.g., food, pharmaceutical, etc.) placed on the shelves (512) within the vacuum chamber (e.g., insulated shelf enclosure 511), providing the combined mass of the second substance (e.g., food, pharmaceutical, etc.) and the shelves (512). The enclosure scale (524B) monitors the mass of the entire vacuum chamber (e.g., insulated shelf enclosure 511) and its contents, which is particularly useful for detecting the accumulation of the first substance (e.g., water, solvent, etc.) when it condenses on the cold trap 520. The trap scale (524C) measures the mass of the independent cold trap 520, which accumulates the condensed first substance (e.g., water, solvent, etc.) sublimated from the second substance (e.g., food, pharmaceutical, etc.) during the lyophilization process.

In some embodiments, the mass monitoring component corresponds to an image-capturing system similar to the system and image depicted in FIGS. 9A-9F. This system utilizes imaging technology to assess the mass of the substances involved in the lyophilization process by either analyzing the images with respect to visual markers or analyzing specific spectral signatures.

The system analyzes the images for visual markers within the vacuum chamber (e.g., insulated shelf enclosure 511) akin to measurement indicators on a measuring cup. As the first substance (e.g., water, solvent, etc.) condenses on either an integrated cold trap (e.g., on the side walls of the insulated shelf enclosure 511) or an external cold trap 520 and its growth can be visually tracked relative to these markers. By analyzing the position of the condensate growth with respect to the markers, the system directly correlates this position to the quantity of mass accumulated. In some embodiments, the mass monitoring component implements an image-capturing system that captures images with respect to visual markers as this technique provides a straightforward and intuitive means of mass measurement, analogous to reading the volume marked on a measuring cup.

LIDAR technology offers precise measurement of the growth of the first substance (e.g., water, solvent, etc.) condensed on either an integrated cold trap (e.g., on the side walls of the insulated shelf enclosure 511) or an external cold trap 520. In some embodiments, the mass monitoring component implements a LIDAR system, which utilizes laser light pulses to measure distances with high accuracy. This allows the system to track the growth of condensate on the surfaces within the vacuum chamber (e.g., insulated shelf enclosure 511) or with the cold trap 520. By analyzing the reflected laser pulses, the LIDAR system provides real-time data on mass accumulation, enabling effective monitoring and control of the lyophilization process.

The system analyzes the images for specific spectral signatures, such as near-infrared spectroscopy (NIR) which involves analyzing the interaction between near-infrared light and the molecules within the substances being monitored. Each molecule absorbs and reflects light at unique wavelengths, creating distinct spectral patterns. By capturing images and analyzing these spectral signatures, the NIR system can accurately identify and quantify the substances present and distinguish the first substance from the second substance. In some embodiments, the mass monitoring component implements near-infrared spectroscopy (NIR), which offers a non-contact and highly sensitive method for mass measurement, leveraging the unique optical properties of the substances involved.

In some embodiments, the mass monitoring component is represented by a thermodynamic model. This model intricately balances the energy input and output of the system (e.g., enclosure model 510), taking into account factors such as thermal energy and losses to assess mass changes over time. Fundamentally, the thermodynamic model attributes the excess energy input to the latent heat of sublimation required to transform the first substance (e.g., water, solvent, etc.) from a solid to a gas, ensuring an energy balance. Consequently, the mass sublimated is directly proportional to the energy input to the power diffusers (e.g., electrical heating elements). Leveraging this thermodynamic model enables precise real-time monitoring and control of the lyophilization process. Through integration of parameters from FIGS. 8A-8E, the model effectively optimizes energy usage, ensuring efficient achievement of desired outcomes in the lyophilization process.

In some embodiments, the system incorporates a cold trap (520) that is independent of (e.g., decoupled from) the mass of the second substance (e.g., food, pharmaceutical, etc.) present on the shelves (512), as illustrated in FIGS. 8E and 10A-10B. Additionally, in some embodiments, the system includes a cold trap (520) separate from both the mass of the second substance (e.g., food, pharmaceutical, etc.) and the mass monitoring component, featuring a trap scale (524C) operatively connected to the cold trap (520), as shown in FIGS. 10A-10C.

At step 1704, the system initiates a lyophilization process of a second substance (e.g., food, pharmaceutical, etc.) by adjusting pressure and/or temperature at the surface of the second substance (e.g., food, pharmaceutical, etc.) to promote sublimation equilibrium of a first substance (e.g., water, solvent, etc.) contained within.

At step 1706, during the lyophilization process, the system provides real-time data including mass data associated with a first substance (e.g., water, solvent, etc.). Initially, at step 1708, the system displays, via the display generation component, a first mass indicator corresponding to an estimated quantity of mass of the first substance (e.g., water, solvent, etc.) removed from the second substance (e.g., food, pharmaceutical, etc.) over the lyophilization process.

At step 1710, the system receives a first mass associated with the first substance. Upon the lapse of a predetermined time period since receiving the first mass at step 1710, the system initiates a sequence of actions for estimating and displaying the mass estimate. This involves receiving, at step 1712, via the mass monitoring component, a first mass associated with the first substance (e.g., water, solvent, etc.). Then, at step 1714, the system receives, via the mass monitoring component, a second mass associated with the first substance (e.g., water, solvent, etc.). The difference between these two measurements corresponds to the mass of the first substance (e.g., water, solvent, etc.). The system then, at step 1716, estimates a quantity of mass of the first substance (e.g., water, solvent, etc.) removed from the second substance (e.g., food, pharmaceutical, etc.) based on one or both of the first mass and the second mass.

For systems featuring a vacuum chamber (e.g., insulated shelf enclosure 511) enclosing the second substance (e.g., food, pharmaceutical, etc.) and the shelf scale 524A, receiving the first mass and second mass each corresponds to the system measuring the mass, via the shelf scale 524A, of the second substance (e.g., food, pharmaceutical, etc.) and shelf 512. Consequently, the estimation of the mass of the first substance (e.g., water, solvent, etc.) is directly derived from the difference between the initial and subsequent mass measurements.

For systems incorporating a vacuum setup (e.g., insulated shelf enclosure 511) enclosing the second substance (e.g., food, pharmaceutical, etc.), along with an independent cold trap 520 configured to collect the first substance (e.g., water, solvent, etc.) during the lyophilization process, in addition to one or more scales such as the enclosure scale 524B, receiving the first mass and second mass each corresponds to the system measuring the mass, via the enclosure scale 524B, of the vacuum chamber (e.g., insulated shelf enclosure 511) including the second substance (e.g., food, pharmaceutical, etc.). Consequently, the estimation of the mass of the first substance (e.g., water, solvent, etc.) is directly derived from the difference between the initial and subsequent mass measurements.

For systems including an independent cold trap 520 that is decoupled from the mass of the second substance (e.g., food, pharmaceutical, etc.) and configured to accumulate the first substance (e.g., water, solvent, etc.) during lyophilization process, receiving the first mass and second mass each corresponds to the system measuring, via the trap scale 524C, the mass of the cold trap 520 including the accumulation of the first substance (e.g., water, solvent, etc.). Consequently, the estimation of the mass of the first substance (e.g., water, solvent, etc.) is directly derived from the difference between the initial and subsequent mass measurements.

For systems with a near-infrared spectroscopy (NIR) system, receiving the first and second mass associated with the first substance includes a sequence of steps. First, the system receives spectral data from the second substance (e.g., food, pharmaceutical, etc.) and analyzes the spectral data to identify characteristic absorption bands corresponding to the first substance (e.g., water, solvent, etc.) within the second substance (e.g., food, pharmaceutical, etc.). The system then quantifies a concentration of the first substance (e.g., water, solvent, etc.) based on intensity of the characteristic absorption bands. Finally, the system estimates the quantity of mass of the first substance (e.g., water, solvent, etc.) based on the concentration of the first substance (e.g., water, solvent, etc.).

For an image-capturing system receiving the first and second mass associated with the first substance (e.g., water, solvent, etc.) includes a sequence of steps. First, the system captures one or more images of the first substance (e.g., water, solvent, etc.) with respect to at least one volumetric marker. Then the system calculates a volume of the first substance (e.g., water, solvent, etc.) from the one or more captured images of the first substance (e.g., water, solvent, etc.) with respect to the at least one volumetric marker. Finally, the system estimates the quantity of mass of the first substance (e.g., water, solvent, etc.) based on a density conversion.

For an image-capturing system implementing LIDAR, receiving the first and second mass associated with the first substance includes a sequence of steps. First the system builds a point cloud representing a formation of the first substance (e.g., water, solvent, etc.). Then the system calculates a volume of at least a portion of the first substance (e.g., water, solvent, etc.) from the point cloud. Finally, the system estimates the quantity of mass of the first substance (e.g., water, solvent, etc.) based on a density of the first substance (e.g., water, solvent, etc.).

For systems implementing a thermodynamic model, receiving the first and second mass associated with the first substance, the system receives an amount of power delivered to the second substance (e.g., food, pharmaceutical, etc.) and the system estimates the quantity of mass of the first substance based on the thermodynamic model and the amount of power delivered to the second substance (e.g., food, pharmaceutical, etc.).

In some embodiments, the predetermined time period is determined based on a predetermined rate of sublimation of the first substance (e.g., water, solvent, etc.) within the second substance (e.g., food, pharmaceutical, etc.). For example, if the sublimation rate is estimated to be 0.5 grams per minute, the system may set the predetermined time period to trigger mass measurements every 10 minutes, allowing for the accumulation of approximately 5 grams of sublimated substance during the lyophilization process.

In some embodiments, during the lyophilization process, the system adjusts one or more lyophilization process parameters based on the estimated quantity of mass of the first substance (e.g., water, solvent, etc.) removed from the second substance (e.g., food, pharmaceutical, etc.). For example, during the lyophilization process, if the mass monitoring component indicates that more water is being removed than expected, the system might decrease the temperature slightly to slow down the sublimation process, ensuring that the product remains within the desired specifications.

At step 1718, the system updates the display via the display generation component, reflecting changes in the first mass indicator. For example, the dashboard 260 in FIGS. 2A-12D features a mass indicator representing the real-time mass estimate (e.g., H2O). In some embodiments, the mass indicator takes the form of a gauge, such as the real-time transient mass data 272A depicted in the transient mass plot 270 of FIGS. 6A-6R. Alternatively, in some embodiments, the indicator includes historical mass data, such as the transient sublimation mass rate data 274 and the transient mass data 272 of the transient mass plot 270.

In some embodiments, the system displays, via the display generation component, a second mass indicator corresponding to the estimated quantity of mass of the first substance removed from the second substance over the predetermined time period. For example, the second mass indicator may be represented by the increment of time depicted in the transient sublimation mass rate data 274 or the transient mass data 272 of the transient mass plot 270 of FIGS. 6A-6R. In some embodiments, the second mass indicator is displayed in a real-time prompt, such as output in terminal 250.

The system displays, via the display generation component, a progress indicator of the lyophilization process. For example, the progress indicator may represent a timer as depicted in dashboard 260 that either counts down (indicating when the lyophilization process terminates) or counting up (indicating the duration of the lyophilization process). For example, the progress indicator may represent the percentage of mass removed, as demonstrated by the real-time transient mass data 272A illustrated in the transient mass plot 270 of FIGS. 6A-6R.

During the lyophilization process, the system displays, via the display generation component, one or more indicators representing the real-time mass of the first substance (e.g., water, solvent, etc.) removed from the second substance (e.g., food, pharmaceutical, etc.). For example, the transient mass data 272 of the transient mass plot 270 of FIGS. 6A-6R displays cumulative increments of real-time mass of the first substance (e.g., water, solvent, etc.) removed from the second substance (e.g., food, pharmaceutical, etc.) over time.

In some embodiments, the system receives an estimate of the initial mass of the first substance (e.g., water, solvent, etc.) within the second substance (e.g., food, pharmaceutical, etc.). For example, the system could receive an estimate of the initial mass of first substance (e.g., water, solvent, etc.) within the second substance (e.g., food, pharmaceutical, etc.) by first calibrating the system with a known amount of the same second substance (e.g., food, pharmaceutical, etc.) before lyophilization. By measuring the mass of this known sample and its water content using standard laboratory techniques, the system can establish a correlation between the mass of the second substance (e.g., food, pharmaceutical, etc.) and the mass of first substance (e.g., water, solvent, etc.) it contains. This correlation factor can then be used to estimate the initial mass of first substance (e.g., water, solvent, etc.) within any subsequent batches of the same food product during the lyophilization process.

In some embodiments, the system calculates an estimate of the initial mass of the first substance (e.g., water, solvent, etc.) within the second substance (e.g., food, pharmaceutical, etc.). For example, the system can estimate the mass of the first substance (e.g., water, solvent, etc.) by fitting a linear regression to the liquid phase cooling curve 364A, a linear regression to the liquid-solid transition phase cooling curve 364B, and a linear regression to the solid phase cooling curve 364C, as depicted in FIGS. 5B and 5C.

In some embodiments, the system displays, via the display generation component, one or more indicators representing a real-time mass ratio of the first substance (e.g., water, solvent, etc.) removed from the second substance (e.g., food, pharmaceutical, etc.) relative to the estimated initial mass of the first substance (e.g., water, solvent, etc.). For example, the real-time mass ratio may represent the percentage of mass removed, as demonstrated by the real-time transient mass data 272A illustrated in the transient mass plot 270 of FIGS. 6A-6R.

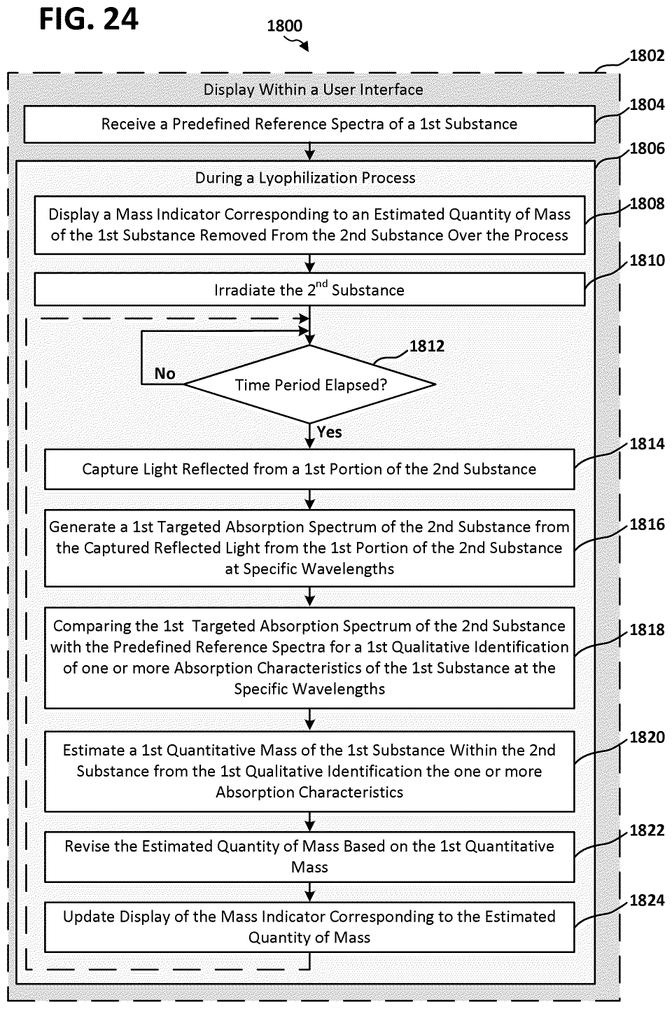

FIG. 24 illustrates a flow diagram outlining a method 1800 for comparing reflected light with a reference spectra to estimate and display an estimate of a quantity of mass of first substance (e.g., water, solvent, etc.) removed from the second substance (e.g., food, pharmaceutical, etc.) during a lyophilization process. The system interfaces with a display generation component, one or more image-capturing components, and one or more light generation components during the (lyophilization) process, presenting the outcomes within a distinct graphical user interface 1802. In some embodiments, the graphical user interface 1802 operates independently of the underlying operating system, providing the capability to halt or restart the interface without affecting core operating system functionality.

At step 1804, the system receives a predefined reference spectra of a first substance (e.g., water, solvent, etc.), which represents the unique pattern of wavelengths of light absorbed or emitted by the substance. In general, the spectra are graphical representations of these patterns, showing how the first substance (e.g., water, solvent, etc.) interacts with light across different wavelengths. For example, these predefined reference spectra could be sourced from a comprehensive database containing known spectral signatures, ensuring accurate identification and analysis.

At step 1806, during the lyophilization process, the system initiates a series of actions to update the display of the mass indicator. Initially, at step 1808, the system displays, via the display generation component, the mass indicator, reflecting the estimated mass of the first substance (e.g., water, solvent, etc.) removed from the second substance (e.g., food, pharmaceutical, etc.) throughout the process. For example, in the dashboard 260 shown in FIGS. 2A-12D, a mass indicator provides a real-time estimate (e.g., H2O) of the mass of the first substance. This mass indicator often manifests as a gauge, such as the real-time transient mass data 272A portrayed in the transient mass plot 270 of FIGS. 6A-6R, offering a visual representation of the lyophilization progress.

Proceeding further, at step 1810, the system irradiates the second substance (e.g., food, pharmaceutical, etc.) with light emitted from various light generation components, which may include LEDs (Light Emitting Diodes), lasers, or other sources. This irradiation ensures uniform and adequate illumination for spectroscopic analysis, where the interaction between light and the molecules of the substance provides valuable information for characterizing its composition. In some embodiments, the light generation component emits light within the spectral range of 700 nm to 2500 nm. In some embodiments, the light generation component comprises a near-infrared light emitter.

In some embodiments, the system implements a calibration process to adjust light intensity measurements, compensating for any discrepancies in sensor sensitivity. During calibration, the system compares the actual output of the light generation components with the measured intensity values received by the sensors. By analyzing this comparison, the system determines the correction factors needed to normalize the sensor readings, ensuring accurate and consistent measurements across different operating conditions.

During the lyophilization process, at step 1812, the system monitors the passage of time to determine if a predetermined time period has elapsed. For example, this interval might be set to refresh periodically after a predetermined duration, such as every second, five seconds, or fifteen seconds. This recurring time period allows the system to update and synchronize its processes efficiently, ensuring timely and accurate monitoring throughout the lyophilization cycle. Consequently, the system may loop from step 1824 back to step 1812 to continually reassess the elapsed time.

If the predetermined time period has elapsed, as in step 1814, the system proceeds to capture light reflected from a specified region of the second substance (e.g., food, pharmaceutical, etc.) using one or more image-capturing components. These components may include a variety of sensors such as CCD (Charge-Coupled Device) sensors, CMOS (Complementary Metal-Oxide-Semiconductor) sensors, PMTs (Photomultiplier Tubes), or cameras. In practice, the system ensures that any filters blocking the desired sensor range (e.g., infrared light, ultraviolet light, etc.) are removed from these sensors, as many are typically optimized for visible light to enhance color accuracy. Additionally, the system may utilize sensors and/or filters specifically designed to capture light from the near-infrared spectrum, ensuring compatibility with spectroscopic analysis methods. This capability allows for precise and versatile imaging under various conditions, enhancing the ability of the system to monitor the lyophilization process effectively.

After capturing the reflected light, the system then, at step 1816, generates a first targeted absorption spectrum of the second substance (e.g., food, pharmaceutical, etc.) from the captured reflected light from the first portion of the second substance (e.g., food, pharmaceutical, etc.) at specific wavelengths.

The system generates a targeted absorption spectrum by analyzing the captured light data to identify absorption peaks associated with the first substance (e.g., water, solvent, etc.). These peaks represent the wavelengths at which the substance absorbs light most strongly, allowing for qualitative and quantitative assessments of its presence and concentration within the sample. For example, if the first substance is water, the targeted absorption spectrum would show peaks at wavelengths where water molecules absorb light most effectively, typically in the near-infrared range.

At step 1818, the system compares the first targeted absorption spectrum of the second substance (e.g., food, pharmaceutical, etc.) with predefined reference spectra to qualitatively identify one or more absorption characteristics of the first substance (e.g., water, solvent, etc.) at specific wavelengths. This comparison enables the system to discern the presence and concentration of the target substance by analyzing its unique absorption patterns against established reference data, thereby enhancing the precision of the lyophilization process monitoring.

At step 1820, the system estimates the quantitative mass of the first substance (e.g., water, solvent, etc.) within the second substance (e.g., food, pharmaceutical, etc.) based on the qualitative identification of one or more absorption characteristics. In some embodiments, this estimation relies on a calibration curve, establishing a correlation between absorption characteristics and known mass concentrations of the first substance (e.g., water, solvent, etc.).

Additionally, the system may utilize calibration data of the first substance (e.g., water, solvent, etc.) to establish a relationship between the targeted absorption spectrum of the second substance (e.g., food, pharmaceutical, etc.) and known mass concentrations. This process enables the system to estimate the quantitative mass by leveraging machine learning algorithms or artificial intelligence models trained on datasets of known substance compositions and corresponding absorption spectra. These algorithms classify absorption spectrum patterns and identify the first substance (e.g., water, solvent, etc.), allowing for precise estimation of mass by correlating spectral features with substance mass.

In practice, the system incorporates a predefined mass threshold corresponding to a specific mass target or a percentage (e.g., 99%) of mass of the first substance (e.g., water, solvent, etc.) removed from the second substance (e.g., food, pharmaceutical, etc.), such as the real-time transient mass data 272A depicted in the transient mass plot 270 of FIGS. 6A-6R. If the estimated quantity of mass exceeds the predefined mass threshold, the system takes specific actions.

If the estimated quantity of mass exceeds the predefined threshold, the system changes the state of the lyophilization process. For example, if the estimated quantity of mass exceeds the predefined threshold the system transitions from an isobaric state (corresponding to a primary stage) to an isothermal state (corresponding to an annealing stage), as indicated by set point 360E in FIGS. 3D-3G.

If the estimated quantity of mass exceeds the predefined threshold, the system terminates the lyophilization process. This termination occurs when the mass threshold exceeds the final pressure set point 360F depicted in FIGS. 3D-3G. Specifically, it triggers when the estimated mass exceeds 99.9% of the mass of the first substance (e.g., water, solvent, etc.) removed from the second substance (e.g., food, pharmaceutical, etc.), marking the conclusion of the process.

In some embodiments, the system incorporates one or more power diffusers. If the estimated quantity of mass exceeds the predefined threshold, the system discontinues power delivery to these diffusers. For example, when the estimated mass exceeds 99.9% of the mass of the first substance (e.g., water, solvent, etc.) removed from the second substance (e.g., food, pharmaceutical, etc.), which triggers deactivation of the one or more power diffusers, possibly terminating the process altogether. Conversely, in some embodiments, if the estimated quantity of mass exceeds the predefined threshold, the system enables power delivery to these diffusers.

In some embodiments, the system incorporates a vacuum pump. If the estimated mass surpasses the predefined threshold, the system deactivates the vacuum pump. For example, the system triggers deactivation of the vacuum pump when the estimated mass exceeds 99.9% of the mass of the first substance (e.g., water, solvent, etc.) removed from the second substance (e.g., food, pharmaceutical, etc.), possibly concurrent with terminating the process altogether. Conversely, in some embodiments, if the estimated quantity of mass exceeds the predefined threshold, the system activates the vacuum pump.

In some embodiments, the system is in communication with a pressure sensor. If the estimated mass surpasses the predefined threshold, the system disables the pressure sensor and updates the display, via the display generation component, of the pressure indicator to reflect a disabled sensor. For example, the system triggers deactivation of the pressure sensor when the estimated mass exceeds 99.9% of the mass of the first substance (e.g., water, solvent, etc.) removed from the second substance (e.g., food, pharmaceutical, etc.), possibly concurrent with terminating the process altogether. Subsequently, the system updates the display, via the display generation component, of the pressure indicator to reflect a disabled sensor. Conversely, in some embodiments, if the estimated quantity of mass exceeds the predefined threshold, the system enables the pressure sensor and updates the display, via the display generation component, of the pressure indicator to reflect an enabled sensor (e.g., with a measurement reading).

If the estimated mass surpasses the predefined threshold, in some embodiments, the system ceases to monitor one or more parameters of the lyophilization process. For example, the system ceases to monitor one or more parameters of the lyophilization process when the estimated mass exceeds 99.9% of the mass of the first substance (e.g., water, solvent, etc.) removed from the second substance (e.g., food, pharmaceutical, etc.), possibly concurrent with terminating the process altogether. Conversely, in some embodiments, if the estimated quantity of mass exceeds the predefined threshold, the system starts to monitor one or more parameters of the lyophilization process.

In some embodiments, the system is in communication with one or more remote devices. If the estimated mass exceeds the predefined threshold, the system sends a notification to the one or more remote devices indicating that the estimated quantity of mass exceeds the predefined threshold. For example, the system sends a notification to the one or more remote devices indicating that the estimated mass has exceeded 99.9%. In some embodiments, if the estimated mass exceeds the predefined threshold, the system further ly triggers a termination process condition that terminates the process altogether.

Following the estimation of the quantitative mass estimate, the system revises the estimated quantity of mass at step 1822, and then proceeds to update the displayed mass indicator via the display generation component at step 1824.

In some embodiments, the system also presents a visual depiction of the second substance (e.g., food, pharmaceutical, etc.) via the display generation component. Additionally, the system may highlight one or more indicators on this representation, focusing on mass concentrations of the first substance (e.g., water, solvent, etc.), providing a clearer insight into the distribution of substances within the mixture.

In some implementations, the system visually represents the second substance (e.g., food, pharmaceutical, etc.) using the display generation component. For example, as depicted in FIGS. 9A-9F, the system might display a detailed image (e.g., the first image 610B, second image 612B, third image 614B, fourth image 616B, and fifth image 618B) of the second substance (e.g., food, pharmaceutical, etc.) being lyophilized. Moreover, the system might enhance this visual representation by overlaying indicators that highlight areas with higher mass concentrations of the first substance (e.g., water, solvent, etc.) (not depicted). This approach offers a more detailed understanding of how the substances are distributed within the mixture, aiding in monitoring and analysis.

During the lyophilization process and after a predetermined time period, the system captures, via the one or more image-capturing components, light reflected from a second portion of the second substance (e.g., food, pharmaceutical, etc.). The system generates a second targeted absorption spectrum of the second substance (e.g., food, pharmaceutical, etc.) from the captured reflected light from the second portion of the second substance (e.g., food, pharmaceutical, etc.) at specific wavelengths. The system compares the second targeted absorption spectrum of the second substance (e.g., food, pharmaceutical, etc.) with the predefined reference spectra for a second qualitative identification of one or more absorption characteristics of the first substance (e.g., water, solvent, etc.) at the specific wavelengths. The system estimates a second quantitative mass of the first substance (e.g., water, solvent, etc.) within the second substance (e.g., food, pharmaceutical, etc.) from the second qualitative identification of one or more absorption characteristics. The system revises the estimated quantity of mass based on the second quantitative mass.

During the lyophilization process, in some embodiments, the system employs the image-capturing components to capture light reflected from different parts of the second substance (e.g., food, pharmaceutical, etc.). Subsequently, the system utilizes this captured light to generate a second targeted absorption spectrum, focusing on specific wavelengths relevant to the analysis. By comparing this spectrum with predefined reference spectra, the system identifies additional absorption characteristics of the first substance (e.g., water, solvent, etc.). Based on these findings, the system estimates a refined mass of the first substance within the second substance and updates its previous estimations accordingly.

In some embodiments, the first portion of the second substance (e.g., food, pharmaceutical, etc.) is distinct from the second portion of the second substance (e.g., food, pharmaceutical, etc.). For example, in a lyophilization process, the second substance (e.g., food, pharmaceutical, etc.) may be arranged on different trays, each representing a distinct portion of the second substance (e.g., food, pharmaceutical, etc.). The first portion may refer to the second substance (e.g., food, pharmaceutical, etc.) on a first tray, while the second portion may refer to the second substance (e.g., food, pharmaceutical, etc.) on a second tray. It should be appreciated that the portion can be extended to multiple more trays (e.g., beyond two distinct trays).

In some embodiments, the first portion of the second substance (e.g., food, pharmaceutical, etc.) overlaps the second portion of the second substance (e.g., food, pharmaceutical, etc.). If the first portion overlaps the second portion, the system adjusts the first portion of the second substance (e.g., food, pharmaceutical, etc.) and the second portion of the second substance (e.g., food, pharmaceutical, etc.) into distinct non-overlapping portions.

In some embodiments, the first portion of the second substance (e.g., food, pharmaceutical, etc.) overlaps the second portion of the second substance (e.g., food, pharmaceutical, etc.). If the first portion overlaps the second portion, the system adjusts the first portion of the second substance (e.g., food, pharmaceutical, etc.) and the second portion of the second substance (e.g., food, pharmaceutical, etc.) into distinct non-overlapping portions. For example, in a lyophilization process, the image-capturing components may cover a single tray, capturing images of overlapping areas of the second substance (e.g., food, pharmaceutical, etc.). The first adjusted portion refers to the substance on one side of the tray, while the second adjusted portion pertains to the substance on the opposite side. This adjustment ensures that overlapping regions are unified into non-overlapping portions, preventing double-counting of mass in these areas. It should be appreciated that this technique can be extended to multiple overlapping areas across trays or within the same tray, enhancing the accuracy of mass measurements.

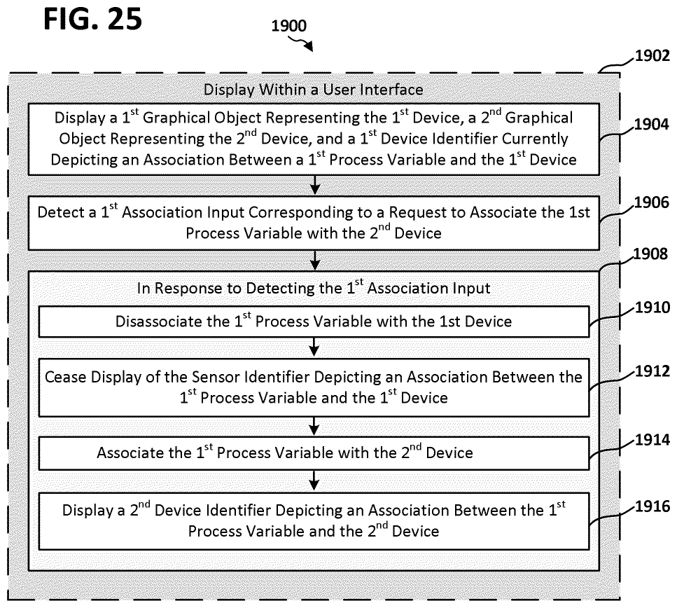

FIG. 25 illustrates a flow diagram outlining a method 1900 for dynamically assigning process variables between different devices represented graphically, allowing for flexible management and control of device associations within a system. The system interfaces with a display generation component, a first device, and a second device distinct from the first device, presenting the outcomes within a distinct graphical user interface 1902. In some embodiments, the graphical user interface 1902 operates independently of the underlying operating system, providing the capability to halt or restart the interface without affecting core operating system functionality.

Dynamically assigning process variables between different devices can be generalized for control circuits such as the relay map 640 shown in FIG. 11A or sensor circuits such as the sensors/calibration map 650 shown in FIG. 11A.

Dynamically assigning process variables between different devices applies broadly, spanning both control circuits, as depicted in the relay map 640 of FIG. 11A, and sensor circuits, exemplified by the sensors/calibration map 650 also depicted in the same FIG. 11A.

At step 1904, the system displays, via the display generation component, a first graphical object representing the first device, a second graphical object representing the second device, and a first device identifier currently depicting an association between a first process variable and the first device. In control circuits, the default relay map 640 of FIG. 11A depicts relay1 640A linked to the condenser process variable labeled “Condenser,” relay2 640B linked to a vacuum pump process variable labeled “Vacuum,” and so forth for relay3 640C to relay8 640H, each associated with specific process variables denoted accordingly.

For control circuits the first device corresponds to a first control circuit and the second device corresponds to a second control circuit different from the first control circuit. These control circuits can take various forms, including relay circuits, transistors, integrated circuits (ICs), microcontrollers, programmable logic controllers (PLCs), thyristors, triacs, and the like.

The first process variable for control circuits is responsible for activating or deactivating physical components. These components include, but are not limited to, a condenser for temperature regulation, a vacuum pump for pressure management, a heating element (heater) for temperature control, actuators for mechanical adjustments, motors for driving mechanical parts, switches for electrical control, or valves for regulating fluid flow.

In sensor circuits, the default sensors/calibration map 650 of FIG. 11A, depicts the primary pressure sensor labeled “P-primary” 650A linked to a vacuum tube thermocouple process variable labeled “DV-4,” the secondary pressure sensor labeled “P-Sensor2” (650B), linked to a no-connect process variable labeled “NC”. This mapping extends to the primary sensor “T-Primary” (650C) and the fifth temperature sensor “T-sensor5” 650G, each with its designated process variable.

In further embodiments of the sensors/calibration map 650 depicted across FIGS. 11A-11L, mass sensors are represented by additional mapping entries labeled MSensor1 (650H) and MSensor2 (6501). These entries enable the mapping of firmware or software variables to physical mass measurement devices such as the shelf scale 524A and trap scale 524C. This mapping extends to the chamber scale 524B. The ability to associate these mass sensors with internal process variables facilitates accurate real-time tracking of sublimation progress, cumulative mass loss, or system loading, which may be utilized for advanced diagnostics, batch analysis, or energy efficiency assessments.

For sensor circuits, the first device corresponds to a first sensor circuit and the second device corresponds to a second sensor circuit different from the first sensor circuit. The distinction in sensor circuits provides for independent data processing from each sensor, which minimizes interference. It also facilitates targeted troubleshooting and maintenance, as issues with one sensor circuit are less likely to affect others. Additionally, it provides flexibility in system design.

These sensor circuits can take various forms, including pressure sensors, temperature sensors, mass sensors, etc. Pressure sensors include vacuum tube thermocouples (e.g., 531, DV-4, DV-6), capacitance manometers, and similar devices, for precise vacuum level measurements within the freeze-dryer 110. Temperature sensors incorporate thermistors, thermocouples, RTDs (Resistance Temperature Detectors), infrared sensors, and similar variants, providing accurate temperature readings for process control and monitoring. Mass sensors (524A-524C), like strain gauges, piezoelectric gauges, and load cells, are for assessing the change in mass of the product.

The first process variable for sensor circuits encompasses a wide range of monitoring capabilities, including but not limited to measuring pressure, temperature, radiation (such as light, X-rays, and nuclear particles), motion, humidity, pH level, sound intensity, vibration, electrical current, voltage, concentration (including gas concentration and salinity), fluid flow rate, and mechanical strain.

At step 1906, the system detects a first association input corresponding to a request to associate the first process variable with the second device. For example, selecting the “Condenser” function from the relay map interface, as depicted by the contact 290AG in FIG. 11B and by maintaining contact with the touch-sensitive surface and shifting the selection of “Condenser” to overlap with the fourth spare function labeled “Spare4”, corresponding to relay8 640H in FIG. 11C, the system detects the request to reassign the “Condenser” function from relay1 640A to relay8 640H.

Similarly, upon selecting the “NC” (no connect) from the “TSensor2” temperature sensor category of the sensors/calibration map 650, the interface displays a list of options, including identifiers like “NC” (no connect), 531, DV-4, and DV6 for P-Sensor2, as depicted in FIG. 11D. The system recognizes a request to reassign the “TSensor2” from “NC” (no connect) to a “Thermistor” when a contact 290AK on “Thermistor” from the list of options is provided.

At step 1908, in response to detecting the first association input, the system initiates a series of actions. The system first disassociates the first process variable with the first device as outlined in 1910. This sequence of actions is triggered upon releasing contact 290AH, as depicted in FIG. 11C. Similarly, the sequence of actions is triggered upon releasing contact 290AK on “Thermistor” from the list of options.

At step 1912, the system ceases to display, via the display generation component, the first device identifier depicting an association between the first process variable and the first device. Following this, at step 1914, the system associates the first process variable with the second device. Subsequently, at step 1916, the system displays, via the display generation component, a second device identifier depicting an association between the first process variable and the second device. For example, the system severs the association between “Condenser” and relay1 640A, successfully reassigning the “Condenser” function to relay8 640H, while the fourth spare relay function is remapped to relay1 640A, as illustrated in FIG. 11D. Similarly, the system severs the link between “TSensor2” and “NC” (no-connect), then remaps “TSensor2” to “thermistor,” as shown in FIG. 11G.

The system detects a second association input corresponding to a request to associate a calibration file with the second device. Upon detecting this input, the system establishes a connection between the calibration file and the second device. This calibration file contains specific calibration data tailored to the characteristics of the second device, ensuring accurate and reliable performance. Within the Sensors/Calibration 650 interface, each sensor is accompanied by a calibration file input. This calibration process helps to correct any inaccuracies or deviations in sensor readings.

In some embodiments, the system is in communication with a third device distinct from the first device and the second device. The system displays, via the display generation component, a third graphical object representing the third device, and a third device identifier currently depicting a disassociation between any devices. The system detects a third association input corresponding to a request to associate a second process variable with the third device. In response to detecting the second association input, the system ceases to display, via the display generation component, the third device identifier depicting a disassociation between any devices. The system associates the second process variable with the third device. The system displays, via the display generation component, the third device identifier depicting an association between the second process variable and the third device. For example, relay4 640D can be remapped from “Spare0” to “Vacuum” similar to how, relay8 640H was remapped from “Spare4” to “Condenser,” as shown in FIGS. 11B-11C. Likewise, “TSensor3” 650D can be remapped from “NC” (no-connect) to “K-type” similar to how “TSensor2” was remapped from “NC” (no-connect) to “thermistor,” as shown in FIGS. 11D-11G.

For control circuits the third device corresponds to a third control circuit different from the first control circuit and the second control circuit. Like the first and second control circuits, the third control circuit can take various forms, including relay circuits, transistors, integrated circuits (ICs), microcontrollers, programmable logic controllers (PLCs), thyristors, triacs, and the like.

The second process variable for control circuits is responsible for activating or deactivating physical components. These components include, but are not limited to, a condenser for temperature regulation, a vacuum pump for pressure management, a heating element (heater) for temperature control, actuators for mechanical adjustments, motors for driving mechanical parts, switches for electrical control, or valves for regulating fluid flow.

For sensor circuits, the third device corresponds to a third sensor circuit different from the first sensor circuit and second sensor circuit. Like the first and second circuits, the third sensor circuit can take various forms, including a pressure sensor, a temperature sensor, a mass sensor, etc. Pressure sensors include vacuum tube thermocouples (e.g., 531, DV-4, DV-6), capacitance manometers, and similar devices, for precise vacuum level measurements within the freeze-dryer 110. Temperature sensors incorporate thermistors, thermocouples, RTDs (Resistance Temperature Detectors), infrared sensors, and similar variants, providing accurate temperature readings for process control and monitoring. Mass sensors (524A-524C), like strain gauges, piezoelectric gauges, and load cells, are for assessing the change in mass of the product.

The system detects a fourth association input corresponding to a request to associate a calibration file with the third device. Upon detecting this input, the system establishes a connection between the calibration file and the third device. This calibration file contains specific calibration data tailored to the characteristics of the third device, ensuring accurate and reliable performance. Within the Sensors/Calibration 650 interface, each sensor is accompanied by a calibration file input. This calibration process helps to correct any inaccuracies or deviations in sensor readings.

In some embodiments, the second process variable corresponds to controlling a different operational aspect of the system than the first process variable. For example, relay3 640C in FIGS. 11A-11L, controls the activation of the heating element “Heater” to adjust the temperature, while relay2 640B, manages the activation of the vacuum pump “Vacuum” to regulate the pressure levels during the lyophilization process.

In some embodiments, the second process variable corresponds to monitoring a different parameter than the first process variable. For example, relay3 640C in FIGS. 11A-11L, controls the activation of the heating element “Heater” to adjust the temperature, while relay2 640B, manages the activation of the vacuum pump “Vacuum” to regulate the pressure levels during the lyophilization process.

In some embodiments, the second process variable corresponds to monitoring a different parameter than the first process variable. For example, referring to FIGS. 11A-11C, “P-primary” 650A monitors the pressure, while “T-Primary.” monitors the temperature.

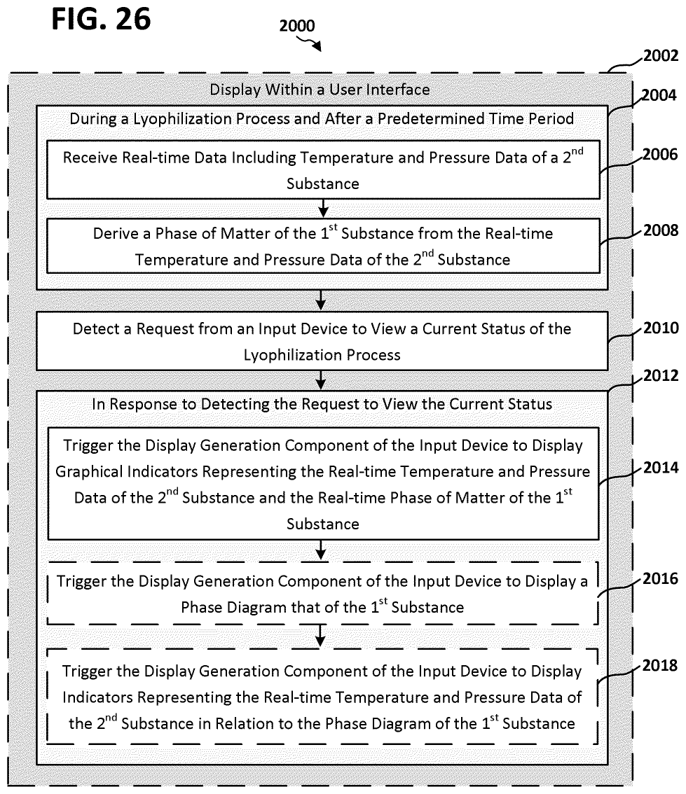

FIG. 26 illustrates a flow diagram outlining a method 2000 for remotely displaying real-time temperature, pressure, and equilibrium phase of matter data of the first substance within a second substance upon a current process status request. The system communicates with at least one input device equipped with a display generation component, presenting the outcomes within a distinct graphical user interface 2002 of a lyophilization process involving a first substance within a second substance. In some embodiments, the graphical user interface 2002 operates independently of the underlying operating system, providing the capability to halt or restart the interface without affecting core operating system functionality.

At step 2004, during the lyophilization process and after a predetermined time period, the system receives real-time data, at step 2006, including real-time temperature and pressure data of the second substance (e.g., food, pharmaceutical, etc.) and derives, at step 2008, an equilibrium phase of matter of the first substance (e.g., water, solvent, etc.) from the real-time temperature and pressure data of the second substance (e.g., food, pharmaceutical, etc.).

At step 2010, the system detects a request from the at least one input device to view a current status of the lyophilization process. In some embodiments, the input device is remote from the lyophilization process, enabling remote monitoring of the process status. This input device includes a display generation component and can be a smartphone 692, tablet, computer 720, or any other networked device equipped with the necessary interface to communicate with the lyophilization system. For example, such a device could access the graphical user interface of the lyophilization process, providing real-time updates on temperature, pressure, and equilibrium phase of matter data, and allowing for adjustments or halting of the process remotely.

In response, at step 2012, the system triggers the display generation component of the at least one input device to display graphical indicators representing the real-time temperature and pressure data of the second substance (e.g., food, pharmaceutical, etc.), and the real-time equilibrium phase of matter of the first substance (e.g., water, solvent, etc.). This functionality provides remote monitoring of parameters of the lyophilization process and provides an intuitive interface for viewing this data on mobile devices, such as smartphones 692 (with a display generation component) or computers 720 (with a display generation component). For example, leveraging features like the remote access configuration 670 with preview 690, individuals can easily visualize the status of the system directly from their smartphone 692 (with a display generation component) or computer 720 (with a display generation component), enabling quick decision-making and control adjustments from anywhere.

Upon detecting an adjustment input from the at least one input device, the system takes action to modify one or more parameters of the lyophilization process. In some embodiments, this adjustment involves disabling one or more devices integral to the lyophilization process, such as the heating elements 514A-514F, the vacuum pump, shelf enclosure compressor 513A, cold trap compressor 513B, etc. By disabling these devices, the system ensures they are placed in a safe state, effectively suspending the lyophilization process to prevent potential harm to both the system and the substances being processed. For example, if an abnormal condition is detected or intervention is required, the system may automatically disable the heating elements 514A-514F and the vacuum pump to halt the lyophilization process until the issue is resolved or further action is taken. Additionally, in some embodiments, adjusting one or more parameters of the lyophilization process involves suspending the entire process altogether, providing a failsafe mechanism to prevent any further progression until adjustments or interventions are made. In some embodiments, if an abnormal condition is detected or intervention is required, the system automatically sends a notification to manually disable the heating elements 514A-514F and the vacuum pump to halt the lyophilization process.

Upon detecting that a milestone of the lyophilization process has been achieved, the system, triggers the display generation component of the at least one input device to display a notification that the specific milestone has been achieved. For example, once the second substance the (e.g., food, pharmaceutical, etc.) has been sufficiently frozen to a point where the mass of the first substance (e.g., water, solvent, etc.) can be estimated (e.g., a location after solidus point 362C and before the vacuum pump activation set point 360A2 on FIGS. 5B and 5C).

When the system detects the attainment of a milestone in the lyophilization process, it triggers the display generation component of the at least one input device to present a notification signaling the achievement of that specific milestone. For example, upon reaching a stage, such as adequately freezing the second substance (e.g., food, pharmaceutical, etc.) to a point where the mass of the first substance (e.g., water, solvent, etc.) can be estimated, the system triggers a notification on a smartphone 692 (with a display generation component) or computer 720 (with a display generation component). This notification provides timely updates on the progress of the lyophilization process.

Upon detecting that one or more parameters of the lyophilization process have been exceeded, the system triggers the display generation component of the at least one input device to display a notification that one or more parameters of the lyophilization process have been exceeded. For example, if the system unexpectedly surpasses maximum or predetermined threshold boundaries for temperature and pressure, a notification is promptly displayed. This ensures that prompt actions are taken, such as adjusting settings or halting the process, to mitigate potential issues and maintain process integrity.

One approach to derive the equilibrium phase of matter of the first substance (e.g., water, solvent, etc.) is by employing the Clausius-Clapeyron relation. This involves analyzing the real-time temperature and pressure data of the second substance collected during the lyophilization process. The Clausius-Clapeyron relation describes the relationship between temperature, pressure, and phase transitions but does not directly output the equilibrium phase of matter. Instead, the Clausius-Clapeyron relation provides key insights like the phase line, which is used to identify specific phase transitions such as freezing, melting, or sublimation. In some embodiments, the Clausius-Clapeyron relation is implemented within a pressure range of 1 μTorr to 1000 Torr. In some embodiments, the Clausius-Clapeyron relation is implemented within a pressure range not exceeding 250 Torr.

In some embodiments, the equilibrium phase of matter of the first substance (e.g., water, solvent, etc.) corresponds to a phase transition of matter. For example, an input device like a smartphone 692 (with a display generation component) or computer 720 (with a display generation component) may offer a preview 690 featuring a dashboard 260 with a matter state indicator reflecting phase transitions, as depicted in FIGS. 12A-12D. This dashboard 260 could show indicators such as “SUBLIME” or “SUBLIMATING” to indicate sublimation, or “FREEZING” to signify the first substance undergoing freezing, as showcased in FIGS. 12A-12D.

Upon detecting the request to view the current status of the lyophilization process, the system triggers the display generation component of the at least one input device to display a phase diagram that illustrates the equilibrium conditions of temperature and pressure corresponding to distinct phases of matter of the first substance (e.g., water, solvent, etc.), as depicted at step 2016. One or more indicators representing the real-time temperature data of the second substance and the real-time pressure data of the second substance are also displayed overlaid onto the phase diagram of the first substance (e.g., water, solvent, etc.), as depicted at step 2018. For example, an input device like a smartphone 692 (with a display generation component) or computer 720 (with a display generation component) provides a preview 690 featuring historical and real-time temperature and pressure of the second substance (e.g., food, pharmaceutical, etc.) on a phase diagram, as illustrated in FIGS. 12A, 12B, and 12D.

In some embodiments, the real-time data includes a real-time environmental control variable setting. Subsequent to receiving the real-time environmental control variable setting, the system triggers the display generation component of the at least one input device to persistently display the real-time environmental control variable setting. For example, this setting, which corresponds to the duty cycle (e.g., PWM) (representing the amount of pulse width modulation applied to the power diffusers, such as electrical heating elements 514A-514E), remains displayed in the dashboard 260 of an input device like a smartphone 692 (with a display generation component) or computer 720 (with a display generation component), as depicted in FIGS. 12A-12D.

In some embodiments, the real-time data includes a real-time set point of an environmental control variable. Subsequent to receiving the real-time set point, the system triggers the display generation component of the at least one input device to persistently display the real-time set point of the environmental control variable. For example, this set point, established during setup to define a target for a pressure measurement or a temperature of the second substance (e.g., food or pharmaceuticals), remains displayed, within the dashboard 260 of the input device like a smartphone 692 (with a display generation component) or computer 720 (with a display generation component), as depicted in FIGS. 12A-12D.

In some embodiments, the real-time data includes the real-time second temperature data of the second substance (e.g., food, pharmaceutical, etc.) or a third substance (e.g., food, pharmaceutical, etc.) different from the first and second substances. Subsequent to receiving the real-time second temperature data, the system triggers the display generation component of the at least one input device to persistently display the real-time second temperature measurement. For example, this second real-time temperature, corresponding to the cold trap temperature (e.g., Trap), remains displayed, within the dashboard 260 of the input device like a smartphone 692 (with a display generation component) or computer 720 (with a display generation component), as depicted in FIGS. 12A-12D.

In some embodiments, the real-time data includes the real-time mass estimate corresponding to an amount of the first substance removed from the second substance. Subsequent to receiving the real-time mass estimate, the system triggers the display generation component of the at least one input device to persistently display the real-time mass estimate. For example, this real-time mass estimate, corresponding to the amount of the first substance (e.g., water, solvent, etc.) remaining in the second substance (e.g., food, pharmaceutical, etc.), remains displayed, within the dashboard 260 of the input device like a smartphone 692 (with a display generation component) or computer 720 (with a display generation component), as depicted in FIGS. 12A-12D.

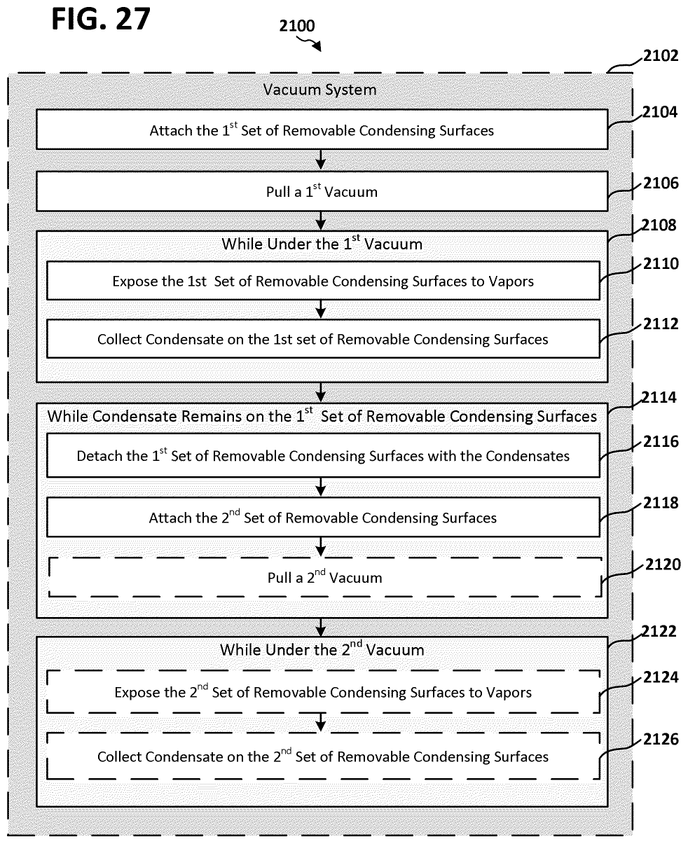

FIG. 27 illustrates a flow diagram outlining a method 2100 for replacing a first set of condensing surfaces 526B of a cold trap 520 containing condensate (e.g., second substance) with a second set of condensing surfaces 526B and before condensate (e.g., second substance) has been removed from the first set of condensing surfaces 526B initiating a vacuum process using the second set of condensing surfaces 526B. The cold trap 520, integrated into a vacuum system 2102, features interchangeable sets of condensing surfaces 526B designed to collect and condense vapors, often used to safeguard sensitive equipment such as vacuum pumps. The ability to replace these surfaces minimizes process downtime, ensuring efficiency even when the original surfaces become saturated and less effective.

Before commencing the vacuum process, step 2104 involves attaching the initial set of removable condensing surfaces 526B to the cold trap 520, facilitated by a quick-release mechanism. The quick-release mechanism for the condensing surfaces 526B of the cold trap 520 takes on various types designed for efficient and effortless removal. In some embodiments, the latch mechanisms include spring-loaded pins for quick engagement and disengagement, magnetic couplings for easy detachment via magnetic force, slide-and-lock mechanisms for smooth sliding action, and twist-and-lock mechanisms utilizing threaded connections or bayonet mounts for rapid installation and removal.

Initiating the process involves pulling a first vacuum at step 2106. While under the first vacuum as at step 2108, the first set of one or more removable condensing surfaces 526B is exposed to vapors at step 2110, leading to the collection of condensate (e.g., second substance) on these surfaces at step 2112. However, once the cold trap 520 fills to a point where it is no longer effective, the process is typically suspended for particulate removal. This often results in pressurization of the cold trap 520.

At this stage, while condensate (e.g., second substance) still remains on the first set of one or more removable condensing surfaces 526B at step 2114, the surfaces along with the condensate (e.g., second substance) are detached from the cold trap 520 at step 2116. Subsequently, the second set of one or more removable condensing surfaces 526B is attached to the cold trap 520 at step 2118. Notably, the process is resumed by pulling a second vacuum, as at step 2120, while condensate (e.g., second substance) remains on the first set of one or more removable condensing surfaces 526B.

While under the second vacuum as at step 2122, the second set of one or more removable condensing surfaces 526B is exposed to vapors at step 2124, leading to the collection of condensate (e.g., second substance) on these surfaces at step 2126. In some embodiments, the cold trap 520 is equipped with a condenser thermally coupled to the first or second set of one or more removable condensing surfaces 526B. When collecting condensate (e.g., second substance) the condenser cools the first or second set of one or more removable condensing surfaces 526B.

In some embodiments, the first or second set of one or more removable condensing surfaces 526B form a conduit with one or more turns. This conduit disrupts the flow of the condensates (e.g., second substance) across the first or second set of one or more removable condensing surfaces 526B within the cold trap 520, thereby facilitating condensate (e.g., second substance) collection.

Often it is desirable that one or more inner surfaces of the cold trap 520 are non-condensate forming. In some embodiments, the cold trap 520 is further equipped with a non-condensate forming mechanism operatively coupled to one or more inner surfaces of the cold trap 520. This means that while under the first or second vacuum this non-condensate forming mechanism prevents condensate (e.g., second substance) from forming on the one or more inner surfaces of the cold trap 520. In some embodiments, the non-condensate forming mechanism corresponds to one or more heating elements.

In some embodiments, the cold trap 520 may be additionally equipped with a mechanism designed to prevent condensate (e.g., second substance) formation on these surfaces. This mechanism ensures that, while under either the first or second vacuum, condensate (e.g., second substance) does not accumulate on the inner surfaces of the cold trap 520. For example, in some embodiments, this non-condensate forming mechanism may consist of one or more heating elements, which actively maintain the inner surfaces above the condensation threshold. One approach is to implement radiant heat sources, such as infrared lamps or radiant panels, to warm the surfaces and prevent condensation. Another approach is to utilize ultraviolet (UV) light, which reduces the likelihood of condensation.

In some embodiments, the non-condensate forming mechanism corresponds to a surface texture that discourages condensation. Examples of such surface textures include micro-grooved surfaces featuring tiny grooves or channels that disrupt the formation of water droplets, hydrophobic coatings made of materials such as Teflon or silicone to create water-repellent surfaces, and roughened surfaces with irregular patterns to minimize the contact area with condensate (e.g., second substance). In some embodiments, the non-condensate forming mechanism corresponds to nanostructured surfaces engineered at the nanoscale level and super-hydrophobic surfaces with high contact angles can effectively repel condensation. In some embodiments, the non-condensate forming mechanism corresponds to patterned surfaces to manipulate the movement of water droplets. In some embodiments, the non-condensate forming mechanism corresponds to patterned, self-cleaning surfaces coated with materials like titanium dioxide nanoparticles.

The cold trap 520 is typically equipped with one or more temperature sensors in communication with a vacuum system. These temperature sensors are thermally coupled to either the first or second set of one or more removable condensing surfaces 526B. During operation under the first and/or second vacuum conditions, the temperature sensors actively detect the real-time temperature of the condensates (e.g., second substance). Upon detection, this real-time temperature data is reported to the vacuum system, ensuring optimal performance of the cold trap 520 apparatus.

The cold trap 520 typically is equipped with one or more mass sensors integrated with the vacuum system. These mass sensors are thermally coupled to either the first or second set of one or more removable condensing surfaces 526B. While operating under either the first or second vacuum condition, the mass sensors continuously detect the real-time mass of the condensates (e.g., second substance). Upon detection, the system promptly reports the real-time mass data to the vacuum system for further analysis and control.

In some embodiments, at least one of the mass sensors is a scale, providing precise measurements of condensate (e.g., second substance) mass. Alternatively, in some embodiments, at least one mass sensor corresponds to a LIDAR system. While operating under either the first and/or second vacuum conditions, the LIDAR system captures measurements, constructs a point cloud from the acquired LIDAR data representing the spatial arrangement of the condensate (e.g., second substance). Subsequently, it computes the volume of at least a portion of the condensate (e.g., second substance) from the point cloud and estimates the mass quantity based on the condensate (e.g., second substance) density.

In some embodiments, at least one mass sensor is configured as an image-capturing system. Operating under the first and/or second vacuum conditions, this system captures images of the condensate (e.g., second substance) in relation to a designated volumetric marker. Utilizing these images, it calculates the condensate (e.g., second substance) volume with reference to the volumetric marker and estimates the mass based on density conversion.

In some embodiments, at least one mass sensor takes the form of a near-infrared spectroscopy (NIR) system. While under the first and/or second vacuum conditions, the NIR system receives spectral data from the condensate (e.g., second substance) and conducts analysis to identify characteristic absorption bands specific to the condensate (e.g., second substance). It then quantifies the condensate (e.g., second substance) concentration based on the intensity of these absorption bands and estimates the mass of the condensate (e.g., second substance) based on the concentration of the condensate (e.g., second substance).

Frequently, the cold trap 520 is equipped with a gauge display that interfaces with the vacuum system. While operating under either the first or second vacuum condition, the gauge display visually presents the quantity of mass or volume of the condensate (e.g., second substance) detected by the one or more mass sensors. That is, as the condensate (e.g., second substance) accumulates within the trap 520, the gauge display provides real-time visualization of the quantity of mass or volume of the condensate (e.g., second substance) detected by the mass sensors. This enables monitoring the status of the capacity of the cold trap 520 without interrupting the ongoing processes, ensuring timely intervention.

In some embodiments, the cold trap 520 is linked to a monitoring system that issues notifications when the quantity of mass or volume of the condensate (e.g., second substance), as detected by the one or more mass sensors, surpasses a predetermined threshold. These notifications may include alerts or messages delivered in real-time. For example, when the quantity of mass or volume of the condensate (e.g., second substance) detected by the mass sensors exceeds a predetermined threshold, such as indicating a full or nearly full state, the monitoring system triggers an automated notification. This notification could be sent via email, text, etc., alerting actions to be taken, such as initiating the condensate removal process or scheduling maintenance.

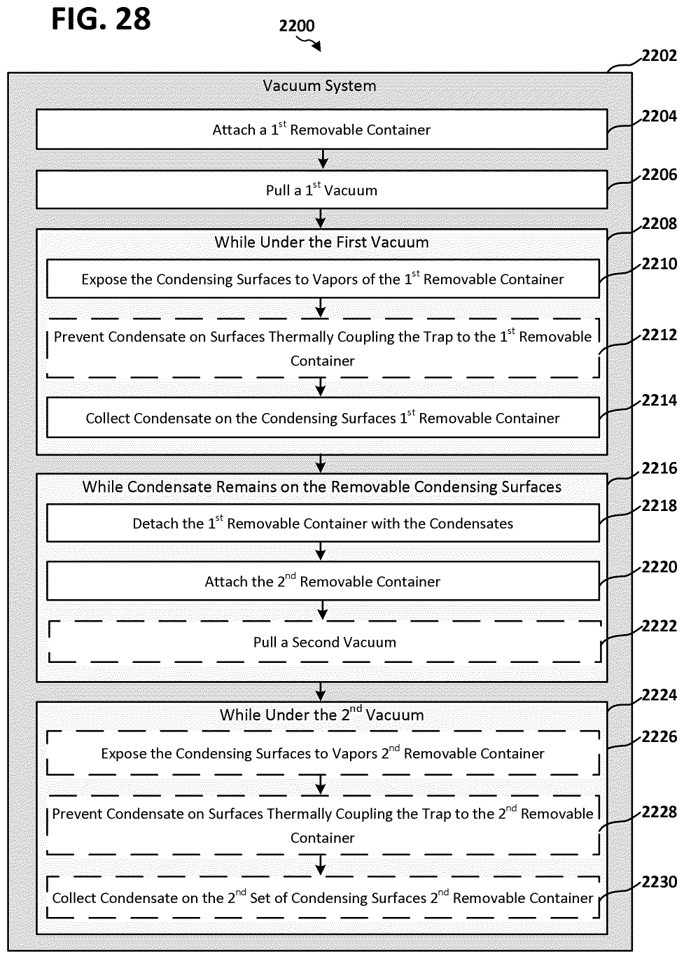

FIG. 28 illustrates a flow diagram outlining a method 2200 for replacing a first container of a cold trap 520 containing condensate (e.g., second substance) with a second container and before condensate (e.g., second substance) has been removed from the first container, initiates a vacuum process using the second container. The vacuum system 2202, features interchangeable containers (e.g., cold trap 520) with one or more condensing surfaces designed to collect and condense vapors. Both the first removable container and the second removable container include a latching mechanism.

Before commencing the vacuum process, step 2204 involves attaching the initial container to the cold trap 520, facilitated by a quick-release mechanism. The quick-release mechanism for the container of the cold trap 520 takes on various types designed for efficient and effortless removal. In some embodiments, the latching mechanism for the interchangeable containers of the cold trap may include various designs to ensure secure attachment. For example, simple snap on clips could be employed, offering case of use and reliable sealing between the container and the cold trap. Alternatively, a twist-lock mechanism may be utilized, providing a tight seal while allowing for straightforward removal and replacement of the container. Magnetic latches could also be incorporated, facilitating convenient attachment and detachment of the container while maintaining a strong connection. Additionally, embodiments may feature spring-loaded latch mechanisms or bayonet-style latch systems, offering robust and stable attachment of the container to the cold trap.

To initiate the process, a first vacuum is pulled at step 2206. While under the first vacuum at step 2208, the condensing surfaces 526B of the first removable container are exposed to vapors at step 2210, resulting in the collection of condensate (e.g., second substance) on these surfaces at step 2214. In some embodiments, the cold trap 520 is equipped with a non-condensate forming mechanism operatively coupled to the first or second removable container. This mechanism prevents condensate from forming on surfaces that thermally couple the cold trap 520 to the first or second removable container while under vacuum, as at step 2212. For example, in some embodiments, this non-condensate forming mechanism includes one or more heating elements, which are activated to remove condensation in order to detach the removable container from the cold trap 520. When the removable container is attached and in operation, these heating elements are deactivated and condensation can occur. These non-condensate forming mechanisms may consist of radiant heat sources, such as infrared lamps or radiant panels, or heating pads placed across the surfaces to provide uniform heating and inhibit condensation. Alternatively, another approach is to utilize ultraviolet (UV) light as the non-condensate forming mechanism, which can inhibit condensation. UV light can be applied during or after the condensation process, effectively complementing the cooling mechanism.

In some embodiments, the non-condensate forming mechanism corresponds to surface textures that discourage condensation. Examples of such textures include micro grooved surfaces with tiny grooves or channels that disrupt water droplet formation, hydrophobic coatings made of materials like Teflon or silicone to create water-repellent surfaces, and roughened surfaces with irregular patterns to minimize contact area with condensate. In some embodiments, the non-condensate forming mechanism corresponds to nanostructured surfaces that are super hydrophobic surfaces with high contact angles repel condensation. In some embodiments, the non-condensate forming mechanism corresponds to patterned surfaces to manipulate the movement of water droplets. In some embodiments, the non-condensate forming mechanism corresponds to patterned self-cleaning surfaces coated with materials like titanium dioxide nanoparticles.

When the condensing surfaces 526B of the first removable container in the cold trap 520 reach a point where they are no longer effective due to particulate buildup, the process is typically paused to remove the particulate, and the cold trap 520 is pressurized. While condensate (e.g., second substance) remains on the condensing surfaces 526B of the first removable container at step 2216, the condensate-containing first removable container with the condensate (e.g., second substance) is detached from the cold trap 520 at step 2218, and the second removable container is then attached to the cold trap 520 at step 2220. The process is then resumed by pulling a second vacuum, as at step 2222, while condensate (e.g., second substance) remains on the first set of one or more removable condensing surfaces 526B.

While under the second vacuum at step 2224, the condensing surfaces 526B of the second removable container are exposed to vapors at step 2226, resulting in the accumulation of condensate (e.g., second substance) on these surfaces at step 2228. Typically, these condensing surfaces 526B are cooled using a heat exchanger, such as a condenser. In certain embodiments, the cold trap 520 is furnished with a condenser that is thermally coupled to the condensing surfaces 526B. Additionally, in some configurations, a non-condensate forming mechanism is employed to prevent condensation on surfaces that thermally couple the cold trap 520 to the first or second removable container while under the second vacuum, as illustrated at step 2230.

In some embodiments, the condensing surfaces 526B form a conduit with one or more turns. This conduit disrupts the flow of condensates (e.g., second substance) across the condensing surfaces 526B within the cold trap 520, thereby facilitating the collection of condensate (e.g., second substance).

The cold trap 520 typically features one or more temperature sensors, thermally coupled to the one or more removable condensing surfaces 526B and in communication with a vacuum system. During operation under the first and/or second vacuum conditions, these sensors actively detect the real-time temperature of the condensates (e.g., second substance). Subsequently, the real-time temperature data is reported to the vacuum system for monitoring and control, ensuring optimal performance of the cold trap 520 apparatus.

The cold trap 520 is typically equipped with one or more mass sensors integrated into the vacuum system, with thermal connections to the one or more condensing surfaces 526B. Operating under either the first or second vacuum condition, these sensors continually monitor the real-time mass of the condensates (e.g., second substance). Subsequently, the system promptly relays the real-time mass data to the vacuum system for further analysis and control.

In some embodiments, one of the mass sensors functions as a scale, offering precise measurements of condensate (e.g., second substance) mass. Alternatively, in other embodiments, a mass sensor corresponds to a LIDAR system. Operating under either the first or second vacuum conditions, the LIDAR system captures measurements and constructs a point cloud from the acquired LIDAR data, representing the spatial arrangement of the condensate (e.g., second substance). It subsequently calculates the volume of at least a portion of the condensate (e.g., second substance) from the point cloud and estimates the mass quantity based on the condensate (e.g., second substance) density.

In some embodiments, one mass sensor is configured as an image-capturing system. Under the first and/or second vacuum conditions, this system captures images of the condensate (e.g., second substance) relative to a designated volumetric marker. Using these images, it computes the condensate (e.g., second substance) volume with respect to the volumetric marker and estimates the mass based on density conversion.

In some embodiments, one mass sensor is a near-infrared spectroscopy (NIR) system. Under the first and/or second vacuum conditions, this system collects spectral data from the condensate (e.g., second substance) and analyzes it to identify characteristic absorption bands unique to the condensate (e.g., second substance). Subsequently, it quantifies the concentration of the condensate (e.g., second substance) based on the intensity of these absorption bands and estimates the condensate (e.g., second substance) quantity accordingly.

The cold trap 520 is equipped with a gauge display that interfaces with the vacuum system. While under either the first or second vacuum condition, this display visually presents the detected quantity of mass or volume of the condensate (e.g., second substance) as it accumulates within the trap 520, thereby facilitating monitoring of the mass capacity status of the cold trap 520 in real-time without disrupting ongoing processes, facilitating timely intervention.

In some embodiments, the cold trap 520 is integrated with a monitoring system that sends notifications to remote devices when the detected quantity of mass or volume of the condensate (e.g., second substance) exceeds a predetermined threshold, as indicated by the mass sensors. These real-time alerts are triggered when the condensate reaches a predetermined threshold, such as full or nearly full state. For example, upon surpassing the predetermined threshold, such as when maintenance is required or the cold trap 520 approaches its capacity limit, the monitoring system automatically generates notifications. These alerts, conveyed via email, text, or similar means, prompt actions, such as initiating the condensate removal process or scheduling maintenance activities.

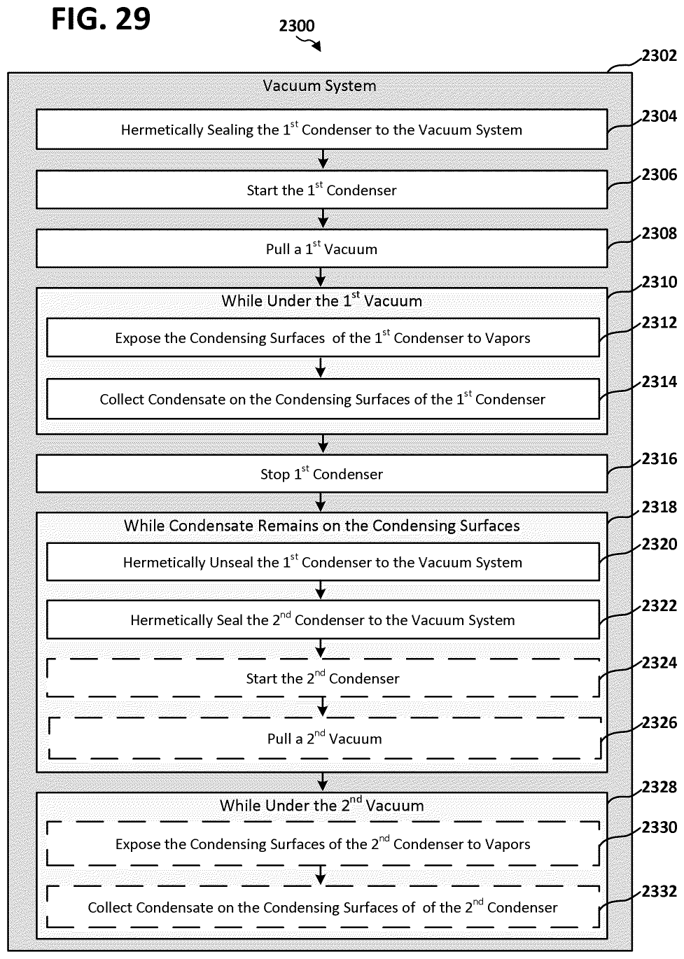

FIG. 29 illustrates a flow diagram outlining a method 2300 for running the first condenser to collect condensate (e.g., second substance) while under vacuum, then switching to the second condenser once the first condenser reaches condensate capacity, before condensate (e.g., second substance) has been removed from the first condenser. The first or second condenser, each with one or more condensing surfaces 526B operatively coupled to the vacuum system 2302.

Before initiating the vacuum process, the first condenser is hermetically sealed to the vacuum system, as at step 2304, a process facilitated by a quick-release mechanism. This mechanism, integrated into the vacuum system, offers a versatile range of options to streamline the attachment and removal of condensers within the vacuum system. Among these mechanisms are bayonet-style connectors, characterized by a locking mechanism reminiscent of bayonet mounts. These connectors consist of two parts, one featuring pins and the other with corresponding slots. Aligning and twisting these parts securely locks them in place, with a simple twist facilitating rapid detachment. Additionally, cam-lock connectors are employed, where turning a handle or lever tightens the connection, and releasing the handle disengages the cam for quick separation. Push-to-connect fittings feature a release collar that, when pushed, inserts a component, locking the connection upon release. Magnetic quick-release connectors utilize magnets to hold components together, securing the connection with magnetic force and enabling easy detachment by pulling the components apart. Lastly, snap-fit connectors incorporate interlocking tabs or protrusions that snap into place upon pressing together, with releasing tabs allowing for quick separation.

At step 2306, the first condenser is started to cool the one or more condensing surfaces 526B, which can be initiated manually by selecting the condenser checkbox 420A as depicted in FIGS. 7A-7E, or initiated automatically when the process starts. Initiating the process involves pulling a first vacuum at step 2308, and while under the first vacuum as at step 2310, the one or more condensing surfaces 526B of the first condenser are exposed to vapors at step 2312, leading to the collection of condensate (e.g., second substance) on these surfaces at step 2314. Once the vacuum system reaches its condensate mass capacity, the process is typically suspended for particulate removal, which usually results in the pressurization of the vacuum system.

At step 2316, the first condenser is stopped, and the vacuum system is pressurized. While condensate (e.g., second substance) still remains on the one or more condensing surfaces 526B at step 2318, the first condenser is hermetically unsealed from the vacuum system, as at step 2320. Subsequently, the second condenser is hermetically sealed to the vacuum system at step 2322, and the second condenser is started at step 2324 to cool the one or more condensing surfaces 526B of the second condenser. Importantly, the process resumes by pulling a second vacuum at step 2326, even if condensate (e.g., second substance) remains on the one or more condensing surfaces 526B of the first condenser.

While under the second vacuum, as at step 2328, the one or more condensing surfaces 526B of the second condenser are exposed to vapors at step 2330, resulting in the collection of condensate (e.g., second substance) on these surfaces at step 2332. The one or more condensing surfaces 526B can be planar or non-planar. In some embodiments, the one or more condensing surfaces 526B form a conduit with one or more turns. This conduit disrupts the flow of the condensates (e.g., second substance) across the one or more condensing surfaces 526B within the first or second condenser, thereby facilitating condensate (e.g., second substance) collection.

In some embodiments, the vacuum system is equipped with a non-condensate forming mechanism operatively coupled to one or more inner surfaces of the vacuum system. While under either the first or second vacuum, this mechanism prevents condensate (e.g., second substance) formation to accumulate on one or more inner surfaces of the vacuum system. In some embodiments, this non-condensate forming mechanism corresponds to one or more heating elements, which actively maintain the one or more inner surfaces above the condensation threshold. For example, one approach is to implement radiant heat sources, such as infrared lamps or radiant panels, or heating pads placed across the surfaces to provide uniform heating and inhibit condensation. An alternate approach is to utilize ultraviolet (UV) light, which reduces the likelihood of condensation.

In some embodiments, the non-condensate forming mechanism corresponds to a surface texture that discourages condensation. Examples of such surface textures include micro grooved surfaces featuring tiny grooves or channels that disrupt the formation of water droplets, hydrophobic coatings made of materials such as Teflon or silicone to create water-repellent surfaces, and roughened surfaces with irregular patterns to minimize the contact area with condensate (e.g., second substance). In some embodiments, the non-condensate forming mechanism corresponds to nanostructured surfaces that are super hydrophobic with high contact angles to repel condensation. In some embodiments, the non-condensate forming mechanism corresponds to patterned surfaces that manipulate the movement of particulate droplets away from one or more inner surfaces. In some embodiments, the non-condensate forming mechanism corresponds to self-cleaning patterned surfaces coated with materials like titanium dioxide nanoparticles.

The vacuum system is equipped with one or more temperature sensors in communication with a vacuum system. These temperature sensors are thermally coupled to the one or more condensing surfaces 526B. During operation under the first and/or second vacuum conditions, the temperature sensors actively detect the real-time temperature of the condensates (e.g., second substance). Upon detection, this real-time temperature data is reported to the vacuum system.

The vacuum system also is equipped with one or more mass sensors integrated with the vacuum system. These mass sensors are operatively coupled to the one or more removable condensing surfaces 526B. While operating under either the first or second vacuum condition, the mass sensors continuously detect the real-time mass of the condensates (e.g., second substance). Upon mass detection, the system reports the real-time mass data to the vacuum system.

In some embodiments, at least one of the mass sensors is a scale, providing precise measurements of condensate (e.g., second substance) mass. Alternatively, in some embodiments, at least one mass sensor corresponds to a LIDAR system. While operating under either the first and/or second vacuum conditions, the LIDAR system captures measurements, constructs a point cloud from the acquired LIDAR data, representing the spatial arrangement of the condensate (e.g., second substance). Subsequently, the LIDAR system computes the volume of at least a portion of the condensate (e.g., second substance) from the point cloud and estimates the mass quantity based on the condensate (e.g., second substance) density.

In some embodiments, at least one mass sensor is configured as an image-capturing system. Operating under the first and/or second vacuum conditions, this system captures images of the condensate (e.g., second substance) in relation to a designated volumetric marker. Utilizing these images, it calculates the condensate (e.g., second substance) volume with reference to the volumetric marker and estimates the mass based on density conversion.

In some embodiments, at least one mass sensor takes the form of a near-infrared spectroscopy (NIR) system. While under the first and/or second vacuum conditions, the NIR system receives spectral data from the condensate (e.g., second substance) and conducts analysis to identify characteristic absorption bands specific to the condensate (e.g., second substance). The NIR system then quantifies the condensate (e.g., second substance) concentration based on the intensity of these absorption bands and derives an estimate of the condensate (e.g., second substance) mass based on the concentration of the condensate (e.g., second substance).

The vacuum system is equipped with a gauge display that interfaces with the vacuum system. While operating under either the first or second vacuum condition, the gauge display visually presents the quantity of mass or volume of the condensate (e.g., second substance) detected by the one or more mass sensors. Notably, as the condensate (e.g., second substance) accumulates within the vacuum system, the gauge display provides real-time visualization of the quantity of mass or volume of the condensate (e.g., second substance) detected by the mass sensors. This enables status monitoring of the vacuum system capacity without interrupting the ongoing processes, while ensuring timely intervention.

In some embodiments, the vacuum system is operatively coupled to a monitoring system that issues notifications when the quantity of mass or volume of the condensate (e.g., second substance), as detected by the one or more mass sensors, surpasses a predetermined threshold. These notifications include alerts or messages delivered in real-time. For example, when the quantity of mass or volume of the condensate (e.g., second substance) detected by the mass sensors exceeds a predetermined threshold, such as indicating a full or nearly full state, the monitoring system triggers an automated notification. This notification could be sent via email, text, etc., prompting actions, such as initiating the condensate removal process or scheduling maintenance.

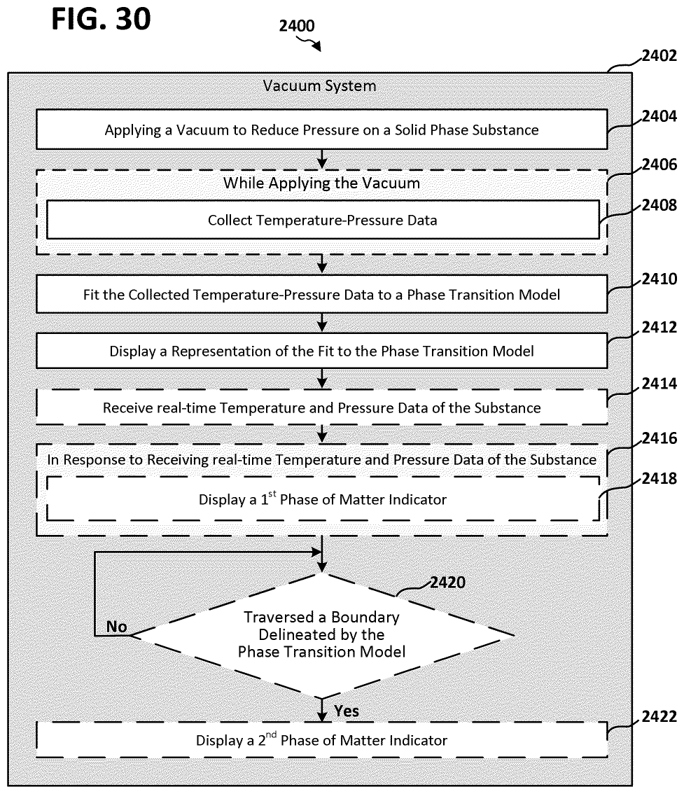

FIG. 30 illustrates a flow diagram outlining a method 2400 for determining a phase transition curve of a substance (e.g., food, pharmaceutical, etc.) and displaying a representation that delineates distinct phases of matter of the substance at equilibrium conditions. The vacuum system 2402 interfaces with a smartphone 692 (with a display generation component) or computer 720 (with a display generation component).

In step 2404, a vacuum is applied to a substance, such as food or pharmaceuticals, to reduce the pressure and create conditions conducive to phase transitions, particularly sublimation, that may not be achievable at standard atmospheric pressure. For example, if vacuum is applied to frozen food at 0° C., the temperature remains relatively constant until it reaches the transition phase line (e.g., sublimation phase line), where the temperature and pressure are in phase equilibrium, as depicted in the environmental control curve 360 of FIG. 3F down to the phase curve equilibrium set point 360B. Along the transition phase line (e.g., between the phase curve equilibrium set point 360B and the initial pressure set point 360C), the water in the food exists as both a solid and a gas. As the vacuum continues to be applied, the pressure is further reduced, causing the water in the frozen food to remain in phase equilibrium and follow the transition phase line. At these points, the temperature begins to change in relation to the pressure, illustrating the dynamic equilibrium conditions necessary for accurately determining the phase transition curve.

While applying the vacuum in step 2406, the system continues to step 2408, which collects temperature-pressure data corresponding to the equilibrium pressure-temperature (P-T) relationship. Collecting the temperature-pressure data is particularly important because it follows the transition phase line (e.g., sublimation phase line), providing empirical data that may differ from the theoretical transition phase line, as depicted between the sublimation fit line 236B and the sublimation line (ice-to-water vapor line) 234A in FIGS. 6A-6R. The difference between the empirical data and the theoretical transition phase line is due to the presence of impurities, such as food particles in water. These impurities can affect the phase transition behavior, causing deviations from idealized models. The precise temperature-pressure data collected accounts for these real-world variations, ensuring a more accurate representation of the phase transitions of the substance. This empirical data is crucial for refining the phase transition model, as it captures the true equilibrium conditions of the substance under specific experimental conditions, ultimately leading to more reliable and applicable phase diagrams for practical use.

In step 2410, the collected temperature-pressure data is fitted to a phase transition model. This step involves using the empirical data obtained in step 2408 to calibrate and refine the theoretical model that describes the phase transitions of the substance. The fitting process ensures that the model accurately represents the equilibrium conditions of temperature and pressure, accounting for any deviations caused by impurities or other real-world factors. Various statistical and computational techniques, such as linear or nonlinear regression analysis, may be employed to minimize the residuals between the observed data and the model predictions. This fitting process creates a robust and reliable phase transition model that can predict the behavior of the substance under different conditions.

In some embodiments, the equilibrium phase transition model is based on the Clausius-Clapeyron relation. According to the Clausius-Clapeyron relation, the natural logarithm of the pressure is proportional to the reciprocal of the temperature (in Kelvin) at equilibrium. This fundamental thermodynamic principle describes how phase transitions, such as along a transition phase line (e.g., sublimation phase line) occurs under varying conditions of temperature and pressure. Specifically, the relationship implies that as temperature increases, the pressure at which equilibrium between phases occurs also increases, and vice versa. This understanding assists in accurately modeling and predicting phase transitions in substances like food or pharmaceuticals, where maintaining precise control over temperature and pressure conditions is essential for optimizing processes and ensuring product quality and stability.

In some embodiments, the phase transition model incorporates adjustments to accommodate impurities present in the substance. For instance, in freeze-drying pharmaceuticals, residual solutes or excipients can significantly influence the phase transition behavior of water. These impurities alter freezing and drying dynamics, causing deviations from ideal phase transition curves. To address this, the phase transition model integrates corrections that account for the presence and impact of impurities. Refining model parameters using empirical data that considers impurity effects enhances the ability of the model to predict phase transitions accurately during freeze-drying. This approach ensures the phase transition model accurately represents real-world scenarios, enabling precise control over freeze-drying processes to maintain pharmaceutical product efficacy and stability.

In some embodiments, fitting the temperature-pressure data to the phase transition model involves minimizing residuals between the temperature-pressure data and the model predictions using linear or nonlinear regression analysis. For example, the Clausius-Clapeyron relation provides a framework where the logarithm of pressure varies linearly with the reciprocal of temperature at equilibrium. This fitting process ensures that the model parameters accurately capture the empirical data points, refining the ability of the model to predict phase transitions under varying temperature and pressure conditions. Such an approach adheres to fundamental thermodynamic principles and enhances the reliability of the model in describing complex phase behaviors, such as sublimation or condensation, observed in substances like water or pharmaceuticals.

In some embodiments, fitting the temperature-pressure data to the phase transition model involves employing Bayesian inference techniques to estimate parameters while considering uncertainties in the data. For example, Bayesian methods integrate prior knowledge or assumptions about the phase transition process with observed temperature-pressure data to iteratively update and refine model parameters. This approach provides a probabilistic framework that systematically addresses uncertainties in both the model predictions and the data itself, enhancing the ability of the model to accurately capture the complex interactions and variability observed in phase transitions. Applications of Bayesian inference in modeling phase behaviors, such as sublimation or crystallization in substances like water or pharmaceuticals, demonstrate its effectiveness in improving the reliability and predictive power of the phase transition model.

In some embodiments, fitting the temperature-pressure data to the phase transition model involves incorporating temperature-dependent or pressure-dependent coefficients to accommodate non-ideal behaviors exhibited by the substance. For example, when modeling the phase transition of substances like water, the model adjusts coefficients based on temperature and pressure variations. These adjustments account for deviations from ideal behavior observed in real-world conditions, such as departures from the ideal gas law or unconventional phase transitions. This adaptive modeling approach enhances the ability of the model to accurately predict complex phase behaviors, ensuring its reliability in practical applications across industries like food processing and pharmaceutical manufacturing.

In some embodiments, fitting the temperature-pressure data to the phase transition model involves iterative adjustments of model parameters based on observed temperature-pressure data to enhance the accuracy of the fit. For example, when investigating the sublimation process of a pharmaceutical substance, initial model parameters are established using theoretical insights or previous experimental findings. Throughout the iterative process, these parameters are systematically refined to better align with the empirical temperature-pressure data obtained from experiments. This iterative refinement includes comparing model predictions against observed data points, identifying discrepancies, and updating parameters accordingly to minimize discrepancies. This continuous improvement process enables the model to predict phase transitions more accurately under various conditions, enhancing its utility in applications such as optimizing manufacturing processes and advancing research.

In some embodiments, fitting the temperature-pressure data to the phase transition model involves incorporating phase equilibrium data obtained from literature or databases to refine model parameters. For instance, in optimizing freeze-drying processes for pharmaceutical formulations, researchers leverage phase equilibrium data from literature or databases. This data provides insights into temperature and pressure conditions that influence phase transitions in similar substances or formulations. Integrating this empirical knowledge into the phase transition model allows researchers to refine parameters effectively, improving predictions and control over phase transitions during freeze-drying. This method ensures the model accurately mirrors real-world phase behaviors, thereby enhancing its utility in optimizing freeze-drying protocols and ensuring the quality and stability of pharmaceutical products.

In some embodiments, fitting the temperature-pressure data to the phase transition model involves employing computational simulations like molecular dynamics or Monte Carlo methods to validate model predictions. For example, in freeze-drying processes for pharmaceuticals, molecular dynamics simulations can simulate the movement of water molecules within frozen formulations under varying temperature and pressure conditions. These simulations generate data that closely emulate experimental settings, enabling researchers to validate the accuracy of their phase transition models. Comparing computational simulation outcomes with empirical temperature-pressure data helps confirm the capability of the model to predict phase transitions during freeze-drying accurately. This method not only validates the theoretical underpinnings of the model but also enhances its utility in optimizing freeze-drying protocols and ensuring the stability and efficacy of pharmaceutical products.

In some embodiments, the system 2403 stores one or more parameters alongside the collected temperature-pressure data and stores the fit to the phase transition model in a database, which includes recording essential variables and characteristics. For example, in a pharmaceutical freeze-drying application, parameters such as initial substance composition, freeze-drying chamber temperature profiles, pressure levels during the process, and specific impurity concentrations are stored. These parameters provide a comprehensive record of the experimental conditions and model outputs, facilitating future analysis, comparison with theoretical predictions, and optimization of freeze-drying protocols. Maintaining a detailed database of such parameters supports process reproducibility, helps refine phase transition models, and ensures consistent product quality across manufacturing batches. This systematic approach assists in continuous improvement efforts in pharmaceutical formulation and process development.

Pressure gauges often have limited accuracy within specific pressure ranges. Consequently, the accuracy of the model can be improved by excluding certain data points. In some embodiments, when fitting the collected temperature-pressure data, data points above the triple point pressure of the substance are excluded. For example, in the case of water, this exclusion applies to temperature-pressure data points above the triple point pressure of water. Additionally, in some embodiments, data points above 2000 mTorr are excluded from the fitted temperature-pressure data. These exclusions ensure that the phase transition model accurately reflects the behavior of the substance under conditions where pressure measurement accuracy is reliable, enhancing the precision and applicability of the model in practical settings.

In step 2412, the method involves displaying a representation of the fit to the phase transition model. For example, as depicted in FIG. 6A, the sublimation fit line 236B is displayed to visually depict the equilibrium conditions of temperature and pressure corresponding to distinct phases of matter of the substance. In some embodiments, this representation takes the form of a phase diagram or graphical plot, where the fitted model is overlaid with the collected empirical data points. This visual representation provides a clear and intuitive depiction of how the substance behaves under different temperature and pressure conditions, highlighting phase boundaries and transitions. It serves as a valuable tool for researchers, engineers, and operators in understanding the phase behavior of the substance and optimizing process parameters. Additionally, the display may include interactive features, allowing real-time adjustments and simulations to explore various scenarios and conditions. This facilitates informed decision-making and enhances the efficiency and reliability of processes involving phase transitions, such as in material science, pharmaceuticals, and food technology.

It should be appreciated that the display generation component is configured to generate a graphical user interface (GUI) designed for real-time interaction and adjustment of pressure or temperature parameters, specifically tailored for freeze-drying processes. This GUI allows operators to monitor and dynamically control the freeze-drying conditions as they unfold. In a pharmaceutical production environment, for example, the GUI provides a visual representation of real-time temperature and pressure data within the freeze-drying chamber. Operators can utilize this interface to make immediate adjustments to parameters such as vacuum levels and shelf temperatures, enabling precise control over the drying kinetics and facilitating the achievement of desired product characteristics. This capability enhances overall process efficiency and ensures consistent product quality without disruption to the ongoing process.

In some embodiments, the system 2402 displays, via the display generation component, a phase diagram (phase plot 230) that illustrates the equilibrium conditions of temperature and pressure corresponding to distinct phases of matter of the substance (e.g., food, pharmaceuticals, etc.). In some instances, the phase diagram corresponds to the substance (e.g., food, pharmaceuticals, etc.). In some instances, the phase diagram corresponds to a solvent (e.g., water) of the substance (e.g., food, pharmaceuticals, etc.). In some instances, the phase diagram includes both one or more transition phase lines of the substance (e.g., food, pharmaceuticals, etc.) and one or more transition phase lines of a solvent (e.g., water) of the substance (e.g., food, pharmaceuticals, etc.) as depicted in FIGS. 6A-6R.

In some embodiments, the system 2402 receives real-time temperature and pressure data of the substance, as depicted at step 2414. Real-time data acquisition provides immediate status of current experimental conditions, ensuring precision and reliability in data collection. In certain embodiments, such as when the vacuum follows the transition curve, the real-time temperature and pressure data is integrated into the phase transition model.

In some embodiments, in response to receiving real-time temperature and pressure data of the substance at step 2416, the system 2402 displays a first phase of matter indicator. For example, if the real-time temperature and pressure correspond to a solid substance, such as frozen food, the system displays an indicator reading “solid” on the dashboard 260. This visual cue provides immediate feedback regarding the current phase state of the substance, derived directly from its real-time temperature and pressure data. It eliminates any ambiguity by clearly indicating how the substance aligns with its equilibrium phase of matter on the phase diagram. This feature enhances understanding and facilitates accurate monitoring of phase transitions in substances like food or pharmaceuticals, ensuring precise control and optimization of processes.

In some embodiments, beginning with step 2420, the system 2402 assesses whether the real-time temperature data and pressure data of the substance have crossed a boundary, such as the transition curve depicted between the real-time temperature-pressure data 236A in FIGS. 6A and 6B, delineated by the fit to the phase transition model (e.g., sublimation fit line 236B). Upon determining that the real-time temperature and pressure data of the substance have crossed the sublimation fit line 236B, the system 2402 stops displaying the first phase of matter indicator (e.g., “solid”) at step 2422 via the display generation component. Instead, it displays a second matter indicator corresponding to the second phase of matter (e.g., “sublime”) of the substance. This dynamic display adjustment provides real-time feedback on the phase transition of the substance, ensuring accurate representation and control in applications such as food processing or pharmaceutical manufacturing.

It is further contemplated that when real-time temperature-pressure data approaches pre-defined phase transition points, the system 2402 issues an alerts or displays a notification on the display generation component. For instance, during the lyophilization process, if the temperature and pressure in the chamber approach the “liquid” phase transition threshold, the system 2402 detects this condition and initiates alerts or notifications. These alerts indicate potential changes in process parameters or the need for intervention to maintain optimal operating conditions. This proactive notification system enhances process monitoring and control, ensuring that the freeze-drying process maintains the desired conditions for preserving product quality and consistency.

Likewise, as the system 2402 detects that real-time temperature-pressure data approaches predefined phase transition points, it triggers alerts or notifications to one or more remote devices. For example, in a lyophilization process, if the temperature and pressure within the chamber approach a “liquid” phase transition threshold, the system identifies the condition and generates alerts or notifications sent to designated remote devices, such as smartphones 692, tablets, or computers 720 (with a display generation component). These alerts inform remote operators or supervisors about the evolving conditions of the process, enabling timely action or adjustment as necessary to maintain optimal operational parameters. This remote notification capability enhances operational oversight and ensures that freeze-drying processes are closely monitored and managed from any location, thereby supporting consistent product quality and process efficiency.

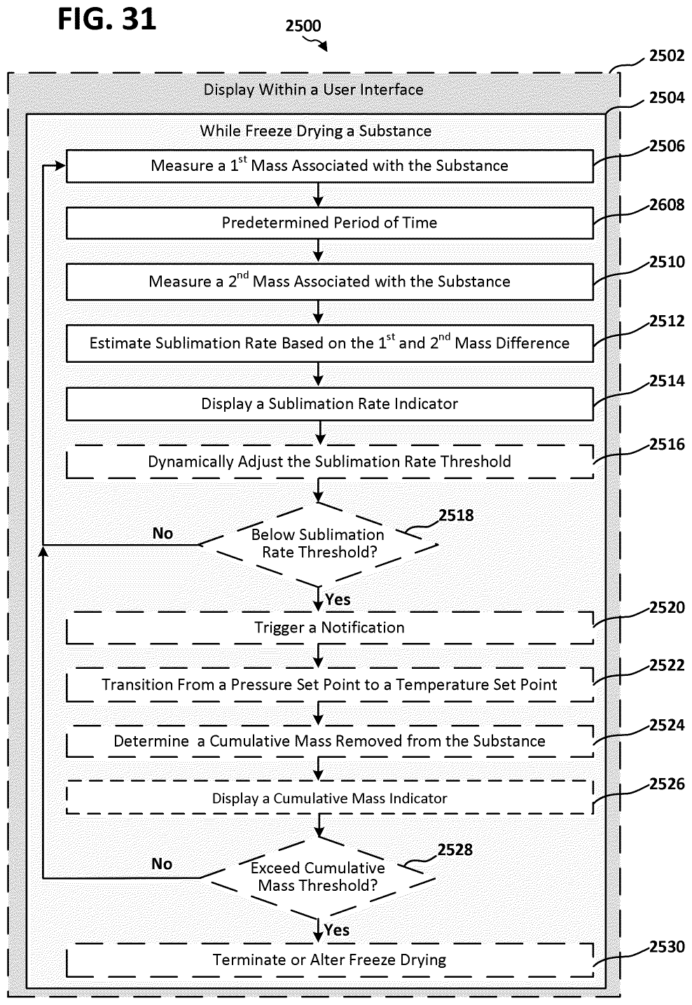

FIG. 31 illustrates a flow diagram outlining method 2500 for monitoring sublimation dynamics and controlling a freeze-drying (e.g., lyophilization) process based on measured mass loss over time. The method may be implemented by a system comprising a processor in communication with to a display device (e.g., touchscreen, monitor, mobile device), one or more mass sensors (e.g., load cells), and thermal and pressure control subsystems within a freeze-dryer. The processor is further processor in communication with one or more energy emitters, such as resistive heaters or infrared sources, configured to deliver thermal energy to a substance undergoing freeze-drying. The method enables real-time estimation of sublimation rate and facilitates responsive control based on observed drying behavior.

At step 2502, the system displays process information related to sublimation rate within a user interface. In various implementations, the interface may be rendered on a local touchscreen panel, a graphical workstation display, or a remote device such as a tablet or smartphone in communication with the freeze-dryer. In some embodiments, the sublimation rate is presented as a numerical value, visual indicator, trend plot, or progress bar representing the instantaneous or smoothed rate of mass loss. For example, a graphical display may include a transient mass plot 270 with a sublimation rate trace 274, where the y-axis (left-hand scale) displays sublimation rate in grams per minute ranging from approximately −0.10 to 7.00, as depicted in FIGS. 6A-6R. In this example, the visualization allows an operator to quickly assess the current drying phase (e.g., identifying a stable primary drying plateau or observing the tailing-off behavior characteristic of secondary drying).

At step 2504, method 2500 is executed while a substance is undergoing freeze-drying within a vacuum chamber, such as an insulated shelf enclosure 511 or other environment configured to enable sublimation under reduced pressure and controlled temperature. The chamber typically maintains sub-atmospheric pressure while applying energy to a substance in a controlled manner to drive the phase transition of a solvent (e.g., ice) directly into vapor.

At step 2506, the system measures a first mass associated with the substance using one or more mass sensors, such as load cells positioned beneath a shelf or tray (e.g., shelves 512). This initial mass measurement provides a baseline for estimating sublimation dynamics over time and may correspond to the frozen state prior to significant water loss. In some embodiments, the mass sensor corresponds to one or more load cells disposed beneath a shelf or tray within a vacuum chamber (e.g., insulated shelf enclosure 511), such as shelf scale 524A, enclosure scale 524B, or trap scale 524C, as depicted in FIGS. 10A-10C. In other embodiments, the mass sensor includes non-contact measurement technologies capable of estimating mass loss or product state, such as near-infrared (NIR) imaging, optical imaging with visual markers (e.g., glacier-like sublimation front tracking), structured light scanning, or other imaging modalities that detect changes in volume, reflectivity, opacity, or surface features correlated with mass change. In yet another embodiment, a 3D depth camera or stereo imaging system is used to track product shrinkage or surface evolution as a proxy for sublimation.

In various embodiments, the mass sensor includes a device or system configured to determine or estimate the mass of the product being freeze-dried, either directly or indirectly. Direct mass measurement can be achieved using load cells, strain gauges, torque sensors, or piezoelectric force sensors mounted beneath trays, chambers, or structural supports. Indirect mass measurement techniques can include visual or infrared imaging systems that track changes in product volume, height, or surface features, such as a visible sublimation front or “glacier”: near-infrared (NIR) spectroscopy to assess water content; structured light scanning or depth cameras for 3D surface mapping; or photogrammetry. In some embodiments, the system employs temperature sensors in conjunction with known thermal properties to estimate sublimation dynamics. Sensors located in the vacuum line or cold trap such as residual gas analyzers, mass spectrometers, humidity sensors, or flow meters may also be used to infer mass loss based on vapor characteristics. In other embodiments, sensor fusion techniques or machine learning models trained on historical drying profiles may estimate product mass based on a combination of parameters, including temperature, pressure, and heater power. Accordingly, any sensor or system capable of generating data representative of mass change or sublimation rate may be considered a “mass sensor.” Drying profiles, including sublimation rate thresholds and cumulative mass loss targets, can be customized for specific substances or product types, enabling adaptive control recipes that account for material-specific characteristics.

After a predetermined time interval (step 2508), which may be fixed or dynamically determined based on the rate of sublimation change, transitions between drying stages, or sensor confidence levels, the system measures a second mass (or image-derived proxy) of the substance at step 2510. At step 2512, the system estimates a sublimation rate based on the difference between the first and second mass measurements (or their proxies) and the time elapsed between their respective timestamps. In some embodiments, system clocks are synchronized to ensure accurate time intervals, allowing precise calculation of sublimation rate over the measurement window.

At step 2514, the user interface displays the estimated sublimation rate, providing real-time feedback on the drying process. For instance, in some embodiments, the sublimation rate is plotted at time zero on the transient mass plot 270 shown in FIGS. 6A-6R. In other embodiments, the real-time sublimation rate is displayed within the dashboard interface 260, as depicted in FIGS. 2A-12D.

At step 2516, the system dynamically adjusts or applies a sublimation rate threshold (e.g., a target value below which further actions can be triggered). This threshold can be predefined by a user-selected drying recipe, derived from historical process data, or determined in real time based on trends in process variables. In various embodiments, the sublimation rate threshold corresponds to a transition point marking the end of a primary drying stage, the onset of secondary drying, or the final completion of the drying process for the substance.

At optional decision step 2518, the system determines whether the sublimation rate has dropped below the sublimation rate threshold. If the sublimation rate has not dropped below the sublimation rate threshold (i.e., “No” at step 2518), control returns to decision step 2506 to continue monitoring mass loss and recalculating sublimation rates at subsequent intervals.

In response to the sublimation rate falling below the threshold (i.e., “Yes” at step 2518), the system proceeds to step 2520, where a notification is triggered, such as a visual or audible alert, or a message to an external device (e.g., mobile phone, computer). In some embodiments, this notification signals transition between drying phases such as beginning of primary dry (point 274A), secondary dry (point 274B), and final dry indicated at (point 274C). In some embodiments, this notification signals to take action such as a user-defined end of final dry corresponding to a near zero sublimation rate threshold (e.g., 0.001) at point 274D.

In some embodiments, in response to the estimated sublimation rate falling below a predetermined sublimation rate threshold (i.e., “Yes” at step 2518), the system proceeds to optional step 2530 to adjust (e.g., terminate or modify) the freeze-drying process. For example, if the threshold corresponds to the end of primary drying for a pharmaceutical product, the system can deactivate heating elements, initiate venting, or switch to an inert gas backfill. In other scenarios, such as with fruit or protein-based products, the system can enter a low-energy standby mode to reduce power consumption while preserving product integrity.

In some embodiments, the system considers both sublimation rate and product temperature to determine drying completion. If the estimated sublimation rate falls below a predetermined threshold and the product temperature exceeds a defined temperature threshold, indicating the end of active water loss, the system proceeds to step 2530 to conclude or transition the drying process. For instance, in freeze-drying of dairy formulations, exceeding 77° F. at low sublimation rate may indicate entry into a completion stage, prompting termination or transition to storage conditions.

In other embodiments, to reduce false positives caused by transient fluctuations, the system requires the sublimation rate to remain below the threshold for a configurable duration (e.g., 10-30 minutes) before proceeding to step 2530. This temporal filter helps ensure stability before terminating or modifying the process. For example, in secondary drying of biologics, a consistent low sublimation rate sustained for 20 minutes may trigger the system to conclude the drying cycle.

In some embodiments, when the sublimation rate drops below the threshold, the system transitions from a pressure-based control mode to a temperature-based control mode, as illustrated at step 2522. This can correspond to a shift from isobaric operation at set point 360C to isothermal control at set point 360E, as depicted in FIG. 3G. Such a transition may mark the end of secondary drying and the beginning of final drying. For instance, in lyophilization of vaccine components, this mode switch allows fine-tuned control over residual moisture removal by maintaining a target shelf temperature (e.g., 14° F.) rather than controlling based on pressure.

In some embodiments, instead of using absolute sublimation rate, the system monitors the time-derivative of the estimated sublimation rate. If the rate of change (i.e., slope) of the sublimation rate falls below a predefined derivative threshold for a specified period, indicating process stabilization, the system proceeds to step 2530. For example, during drying of fruit purées, a near-zero derivative over 15 minutes may suggest completion of the drying plateau, prompting automatic process transition or termination.

In parallel or as a subsequent step, at step 2524, the system determines a cumulative mass removed from the substance. This cumulative mass can be estimated via time-integration of the estimated sublimation rate, energy-based calculations leveraging heat of sublimation, or successive summation of measured mass changes over time. As depicted at step 2526, the system can display a cumulative mass indicator on the user interface, reflecting the total mass removed (e.g., of water or solvent) via sublimation. This cumulative mass indicator can assist in real-time monitoring of drying progress and provide actionable insight into material dehydration.

In some embodiments, the cumulative mass indicator corresponds to a real-time value (e.g., labeled “H2O”) shown in dashboard 260 in FIGS. 2A-12D, or the transient mass data 272A or 272 in the transient mass plot 270 of FIGS. 6A-6R. In some embodiments, the system overlays process conditions (e.g., chamber pressure, shelf temperature) alongside the cumulative mass plot to aid in interpreting drying kinetics. The system can highlight material-specific target thresholds such as when 97-99% of initial moisture has been removed for pharmaceuticals or when 10-12% residual moisture remains for cannabis to signal process endpoints, optimize product stability, and comply with quality standards. The system can also infer initial moisture content using one or more of: thermodynamic modeling, near-infrared (NIR) or other spectral analysis, or historical data linked to the type of substance being dried.

In some embodiments, the thermodynamic model estimates initial sublimatable mass by analyzing freezing plateaus (latent heat release), determining specific heat capacities based on temperature ramp slopes, or calculating energy input from measured power consumption of the refrigeration system. This modeling supports accurate endpoint estimation without relying solely on empirical recipes.

At decision step 2528, the system evaluates whether the cumulative mass removed exceeds a predefined threshold. This threshold may correspond to a user-defined endpoint, a percentage of estimated initial water or solvent content, or a target residual moisture level known to preserve product integrity. If the threshold is not met (i.e., “No” at step 2528), control loops back to step 2506 to continue drying and measurement. If the cumulative mass removed exceeds the threshold (i.e., “Yes” at step 2528), the system proceeds to step 2530 to terminate or alter the freeze-drying process. Alterations may include transitioning into a final drying stage, modifying chamber pressure or shelf temperature to shift the substance (or sublimatable constituent) across a phase boundary (e.g., vapor to solid), initiating a nitrogen backfill, or powering down energy emitters. In some embodiments, the system may also detect an inflection point in the cumulative mass loss curve to automatically transition between primary and secondary drying stages or extrapolate the mass loss trend to predict and adjust for future under-drying conditions.

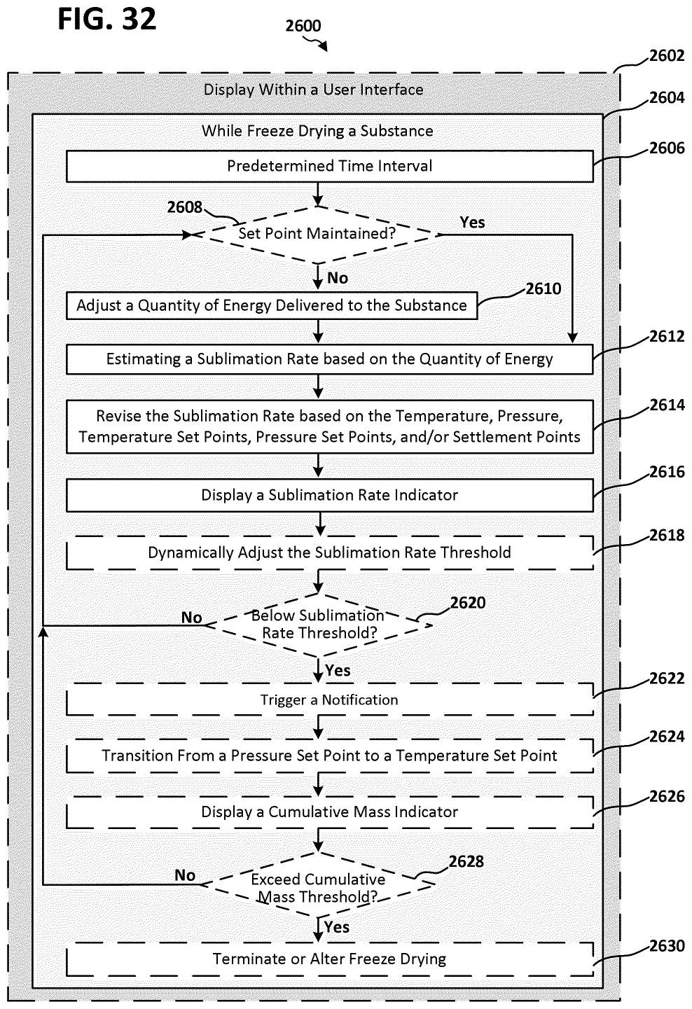

FIG. 32 illustrates a flow diagram outlining method 2600 for monitoring and controlling a freeze-drying (e.g., lyophilization) process. The method can be implemented by a system that includes a processor in communication with a display device, such as a local or remote monitor, touchscreen, or mobile device, and temperature and pressure control subsystems within a freeze-dryer apparatus. The processor is also operatively connected to one or more energy emitters (e.g., heating elements, infrared sources) configured to supply energy to a substance undergoing freeze-drying.

At step 2602, the system displays process information within a user interface. In some embodiments, this user interface is presented on a touchscreen or graphical display connected to the system. In some embodiments, this interface is presented on a remote device with a graphical display such as a mobile device, smartphone, tablet, or computer in communication with the system. The display can include visual indicators of temperature, pressure, sublimation rate, cumulative mass removed, or other relevant process parameters. As shown at step 2604, the method 2600 is performed while freeze-drying a substance within a vacuum chamber (e.g., insulated shelf enclosure 511) or similar environment configured to support sublimation under reduced pressure and controlled temperature conditions.

At step 2606, the system operates over predetermined time intervals to periodically assess system conditions and control parameters. The time intervals can be user-configurable, such as 15 seconds, 30 seconds, 1 minute, 5 minutes, or other suitable durations. In some embodiments, a default time interval is provided (e.g., 1 minute). It should be appreciated that while the system may not perform assessments at precisely uniform intervals due to interleaved measurements or control actions, it records accurate timing data (e.g., timestamps) to ensure each operation is properly time-aligned and tracked.

At decision step 2608, the system determines whether the temperature and/or pressure set points are being maintained within predefined set point tolerances. These set points can correspond to predefined target values that optimize sublimation and drying efficiency. For example, a pressure set point (e.g., SP 310A in FIGS. 6A-6R) can correspond to the target vacuum pressure during the primary and secondary drying stages. Similarly, a final temperature set point (e.g., T_{f} 310C in FIGS. 6A-6R) can correspond to final drying temperature used to remove residual bound moisture.

If the set points are not maintained (i.e., “No” at step 2608) the method proceeds to step 2610, where the system adjusts the quantity of energy delivered to the substance over the predetermined time interval. For example, if the pressure set point (SP 310A) increases during the primary drying stage, the system's PID controller adjusts the energy delivered to the energy emitters. The adjustment can include modulating power output from one or more energy emitters based on real-time sensor feedback. In some embodiments, adjusting the energy delivered to the substance corresponds to adjusting PWM setting (e.g., between 0-99 or 0-255) to increase or decrease the duty cycle of AC power delivered to one or more heating elements 514A-514F that delivers energy to the substance (see FIGS. 7A-7F). In some embodiments, the PWM setting adjusts the duty cycle of DC or irradiation power (e.g., IR heater, UV diode, microwave, x-ray) delivered to the substance. In some embodiments, adjusting the quantity of energy delivered includes applying a pulsed or duty-cycled power to the energy emitters. In some instances, the energy from the pulsed or duty-cycled power to the energy emitters maintains stable sublimation rate, stable pressure, or stable temperature conditions.

If the set points are maintained (i.e., “Yes” at step 2608), the method proceeds to step 2612, where the system estimates a sublimation rate based at least in part on the quantity of energy delivered during the time interval (e.g., default 1 minute). This estimation can involve applying thermodynamic principles, including latent heat of sublimation, to determine the rate at which material is removed from the substance.

As shown at optional step 2614, the estimated sublimation rate (e.g., real-time or time zero of the transient sublimation mass rate data 274 of FIGS. 6A-6R) is revised using additional process data. This includes temperature measurements, pressure measurements, temperature and pressure set points, and one or more estimated onset sublimation points (e.g., conditions empirically determined to represent process stability or material transition). In some embodiments, the estimated onset sublimation point of point 274A corresponds to the equilibrium (non-ringing) stability point for the sublimation rate of the primary dry and is an indicator of the beginning of primary dry. In some instances, the estimated onset sublimation point of point 274A is filtered, time averaged, interpolated, or extrapolated, as these points may not correspond to a precise point on the sublimation mass rate data 274. In some instances, the estimated onset sublimation point of point 360D1 corresponds to the pressure of the equilibrium (non-ringing) stability point for the sublimation rate of the primary dry. In some instances, the estimated onset sublimation point of point 360D2 corresponds to the temperature of the equilibrium (non-ringing) stability point for the sublimation rate of the primary dry.

In some embodiments, estimating the sublimation rate includes adjusting the sublimation rate based on one or more of: a real-time temperature of the substance, a real-time environmental pressure proximate to the substance, a temperature set point, a pressure set point, or a known or estimated onset temperature for sublimation of the sublimatable constituent. In some embodiments, estimating the sublimation rate includes applying a calibration factor derived from prior system behavior, power calibration curves, or temperature sensor drift. In further embodiments, estimating the sublimation rate or a corresponding cumulative mass includes applying a machine learning model trained on historical drying profile. The model may utilize input features such as time-series power consumption, temperature gradients, and chamber pressure, and may output a predicted sublimation rate or a predicted endpoint time.

At step 2616, the system displays a sublimation rate indicator within the user interface. The indicator can be a graphical representation. (real-time) numeric value, or trend visualization of the estimated or revised sublimation rate as determined in prior steps (2612, 2614). In some embodiments, the sublimation rate indicator is graphical or numerical, and can be color-coded to indicate whether the rate falls within an optimal range. In some embodiments, the sublimation rate indicator corresponds to a numerical value, progress bar, graph, or visual cue representing the current estimated sublimation rate of the substance or constituent of the substance undergoing freeze-drying. For example, transient mass plot 270 displays transient sublimation mass rate data 274 as the sublimation rate indicator in grams per minute with the scale displayed on the right having a range from −0.10 to 7.00. In some embodiments, the sublimation rate indicator corresponds to a real-time estimated sublimation rate displayed in the dashboard 260.

In certain embodiments, the sublimation rate indicator includes contextual information, such as whether the current rate is within an acceptable operational window or is approaching a threshold indicative of process transition. For instance, in pharmaceutical applications where preserving the biological structure of proteins is important the interface visually signals when the sublimation rate falls below a level typically associated with primary drying completion. In botanical drying contexts, such as cannabis processing, the sublimation rate indicator is tuned to reflect the slower terminal phase of drying aimed at terpene preservation, thereby assisting the operator in managing the transition to post-drying steps.

As shown at optional step 2618, the system dynamically adjusts a sublimation rate threshold. In some embodiments, this threshold is modified in response to a user-defined drying recipe, prior batch data, or real-time process measurements. For example, if the system identifies similarities between the current freeze-drying process and a previously archived process, the system adapts the sublimation rate threshold accordingly. This capability is particularly useful when the sublimation rate has deviated from the expected freeze-drying path such as deviation between set points 360D and 360F in FIGS. 3D-3G. In general, the sublimation rate threshold serves as a benchmark to determine whether the drying process is progressing within expected or optimal parameters. The sublimation rate threshold may be informed by batch-specific data, historical system performance, or adaptive algorithms. In some embodiments, the sublimation rate threshold is dynamically adjusted based on one or more of: a user-defined dryness percentage, an estimated cumulative mass loss, or a humidity value derived from dew point analysis at the vacuum exhaust. For example, manually setting the dryness percentage to 99.9% sets a sublimation threshold rate of 0.001 grams per minute. In another example, the system may estimate cumulative mass loss to be 4.5 kilograms out of an initial 5.0 kilograms of sublimatable content, corresponding to 90% completion, and use this estimate to lower the sublimation rate threshold to signal a transition into the final drying stage. In yet another example, dew point analysis at the vacuum exhaust may indicate a dew point temperature of approximately 120° F., corresponding to a vapor pressure of about 500 mTorr, depending on the specific volatile profile of the substance. This vapor pressure is converted to an absolute humidity value using a known correlation between dew point and partial pressure of water vapor. In response to detecting that the absolute humidity at the vacuum exhaust has fallen below a threshold level—for instance, 10 parts per million (ppm) sustained over a 10-minute window—the system may decrease the sublimation rate threshold accordingly. This adjustment enables the system to recognize the transition into the final drying phase, where moisture levels are critically low and sublimation slows dramatically.

In some embodiments, the sublimation rate threshold corresponds to an endpoint of a primary drying stage, secondary drying stage, or final drying stage. For example, in a pharmaceutical freeze-drying cycle, the system may identify the end of primary drying when the sublimation rate falls below 0.1 grams per minute, indicating that most unbound water has been removed. In some embodiments, the cumulative mass threshold corresponds to a percentage of an estimated initial mass of sublimatable material contained within the substance. For instance, if the initial sublimatable mass is estimated to be 5 grams and the cumulative mass loss reaches 4.5 grams, the system may infer that 90% of water has been removed and transition to the next stage. In some embodiments, estimating the initial mass of sublimatable material is based on one or more of: a thermodynamic model, spectral analysis including near-infrared (NIR) imaging or a known, measured, or tabulated moisture ratio of the substance. For example, a thermodynamic model may estimate the initial sublimatable mass by calculating energy absorbed during a freezing plateau and comparing it with the latent heat of fusion and sublimation. Spectral techniques, such as NIR imaging, can infer moisture content by detecting characteristic absorption peaks of water. Alternatively, a known or tabulated moisture ratio can be used, such as in the case of cannabis flower, which typically contains about 80% moisture by weight, allowing historical values to inform drying thresholds in batch-specific recipes.

In some embodiments, the thermodynamic model further includes modeling thermal transitions based on one or more of: identifying latent heat release during a freezing plateau using temperature-time data, calculating sensible heat capacity from the slopes of temperature curves before and after the freezing phase, and estimating energy input to the freezing process from refrigeration system power consumption. For example, during initial freezing, the system may detect a temperature plateau around 32° F., lasting for 25 minutes while power consumption remains high, allowing it to calculate the energy associated with the phase change and estimate the amount of water frozen. In certain implementations, the initial water content of the substance is estimated by calculating the total energy delivered to the substance and applying a thermodynamic phase change model. This can involve identifying a freezing plateau and using the latent heat of fusion (e.g., ˜334 J/g for water) to estimate the original water mass (e.g., if 3,340 joules are consumed during the plateau, the system estimates 10 grams of water were present initially).

In some embodiments, the system further executes a staged drying protocol that incorporates one or more plateaus (e.g., primary drying plateau, ramp schedule) in chamber temperature or pressure. These plateaus are typically designed to stabilize molecular structure or prevent collapse of the porous matrix. For example, in drying a protein-based pharmaceutical formulation, the chamber pressure may be held constant at 100 mTorr for 30 minutes to allow sublimation to stabilize before entering secondary drying. In another example, during botanical freeze-drying, the system may hold the chamber temperature at 14° F. for an extended period to prevent excessive shrinkage of terpene-rich plant material, preserving texture and aroma.

It should be appreciated that other transition set points are conceived such as for delicate substances intermediate plateaus of constant pressure during the secondary dry stage can be applied to reduce the loss of volatile components. In food the volatile components include aromatic compounds (e.g., essential oils, esters, terpenes) and flavor compounds (aldehydes, alcohols), whereas in pharmaceuticals/biologics, preserving volatile components includes buffers, excipients, or active compounds that are heat- or vacuum-sensitive and organic solvents or stabilizers critical to shelf life or reconstitution. In general, the loss of volatiles equate to a loss of product quality, efficacy, or identity.

In some embodiments, the system reduces a vacuum pump duty cycle or increasing chamber pressure as the estimated sublimation rate falls below a transition threshold to preserve volatile components during secondary drying. In some embodiments, preserving volatile components includes maintaining the chamber pressure above a vapor pressure threshold associated with a known volatile compound of the substance.

At optional decision step 2620, the system determines whether the sublimation rate has dropped below the sublimation rate threshold. If the sublimation rate has not dropped below the sublimation rate threshold (i.e., “No” at step 2620), control returns to decision step 2608 for continued monitoring and adjustment. For example, if the sublimation rate remains at 0.5 grams per minute while the threshold is set at 0.2 grams per minute, the system continues active drying, updating parameters as needed.

In some embodiments, if the sublimation rate has dropped below the sublimation rate threshold (i.e., “Yes” at step 2620), the method proceeds to optional step 2622, where a completion notification is triggered. This notification can include a visual indicator on a user interface, an audible alert, or an automated message sent to a remote monitoring device, such as a smartphone or control console. For instance, the system may display a message such as “Primary Drying Complete” when the sublimation rate drops below 0.1 grams per minute, based on predefined thresholds for a pharmaceutical lyophilization process.

In some embodiments, in response to the estimated sublimation rate falling below a predetermined sublimation rate threshold (i.e., “Yes” at step 2620), the system proceeds to optional step 2630 to terminate or alter freeze-drying of the substance. For example, in a botanical drying process, the system may automatically reduce chamber vacuum pressure and initiate a completion stage once the sublimation rate falls below a set point, such as 0.05 grams per minute, signaling the end of the active sublimation phase. Alternatively, the system may switch to an energy-saving mode or begin a nitrogen backfill procedure to protect the dried material from oxidation.

In some embodiments, in response to both the estimated sublimation rate falling below a predetermined sublimation rate threshold (i.e., “Yes” at step 2620) and a temperature of the substance exceeding a temperature threshold, the system proceeds to step 2630, terminating or altering freeze-drying of the substance. For example, in a protein-based pharmaceutical formulation, when the sublimation rate drops below 0.05 grams per minute and the product temperature exceeds −4° C., the system may automatically end primary drying to prevent denaturation or collapse.

In some embodiments, in response to the estimated sublimation rate falling below a predetermined sublimation rate threshold (i.e., “Yes” at step 2620) for a configurable time period, the system proceeds to step 2630, terminating or altering freeze-drying of the substance. For instance, if the sublimation rate remains below 0.03 grams per minute for more than 15 minutes, the system concludes that the drying process has plateaued and subsequently triggers a completion stage.

In some embodiments, in response to the sublimation rate dropping below the sublimation rate threshold (i.e., “Yes” at step 2620), the system transitions from operating under a pressure set point to a temperature set point as shown at step 2624. This may correspond to change from the isobaric set point 360C to the isothermal set point 360E at point 360E depicted in FIG. 3G. In some embodiments, this transition corresponds to a stage change in the freeze-drying process (e.g., from secondary drying to final drying). For instance, the system may hold chamber pressure constant during primary drying, but once the sublimation rate drops below 0.04 grams per minute, the system switches to final drying where the control switches from constant pressure to constant shelf temperature.

In some embodiments, in response to a time-derivative of the estimated sublimation rate falling below a derivative threshold (i.e., “Yes” at step 2620) for a predefined duration, the system proceeds to step 2630, terminating or altering the freeze-drying of the substance. For example, if the rate of change of the sublimation rate (i.e., its slope) remains below 0.001 grams/min² for 10 minutes, indicating a near-flat sublimation profile, the system may conclude that active sublimation has ceased and automatically advance to the next drying stage or stop the process.

Rather than using the sublimation rate of the first substance (e.g., water, solvent, etc.) the system can use the cumulative mass of the first substance (e.g., water, solvent, etc.). In some embodiments, the system estimates a cumulative mass removed from the first substance based on the energy delivered and heat of sublimation, or on time-integration of the estimated sublimation rate. At step 2626, the system optionally displays a cumulative mass indicator. This indicator reflects the total mass of water or solvent removed from the substance over time. This may be calculated using the integral of the sublimation rate over time or other energy-based estimations. In some embodiments, the cumulative mass indicator corresponds to the real-time transient mass data 272A or 272 of the transient mass plot 270 depicted in FIGS. 6A-6R. It should be appreciated that the slope of the cumulative mass curve corresponds to the derivative of the cumulative mass curve, which is equivalent to the sublimation rate.

In some embodiments, the cumulative mass indicator is presented in conjunction with process parameters, such as chamber pressure and shelf temperature, allowing operators to correlate mass loss with drying conditions. For pharmaceutical products, the indicator may include overlays or annotations denoting target thresholds for residual moisture content (e.g., visual cues when 97-99% of initial water content has been removed). In the cannabis industry, the cumulative mass indicator may similarly denote the threshold associated with a moisture content of 10-12%, aligning with product quality and safety standards. The inclusion of such thresholds allows for informed decision-making in real time, and may trigger visual or audible alerts when the drying process nears or exceeds the desired endpoint.

In some embodiments, the system displays, via the display, one or more cumulative mass indicators of one or both of: a real-time numeric value representing the estimated cumulative mass removed from the substance (e.g., labeled “H2O” shown in dashboard 260 in FIGS. 2A-12D) and a visualization of the cumulative mass removed (e.g., transient sublimation mass rate data 274) from the substance over time. In some embodiments, the system displays, via the display, a progress indicator showing cumulative mass removed compared to a preloaded drying recipe target. In some embodiments, the system displays, via the display, a rate-of-change indicator derived from the estimated sublimation rate over time, the rate-of-change indicator including a trend line, a slope indicator, or a rate-of-change curve. In some embodiments, the system detects an inflection point in the cumulative mass loss curve, and in response, transitions from a primary drying stage to a secondary drying stage. In some embodiments, the system predicts a drying endpoint based on extrapolation of the cumulative mass loss trajectory, and adjusts a drying recipe or user interface accordingly. In some embodiments, the system predicts a future under-drying condition based on a mass loss trajectory, and in response, adjusts a temperature set point or a pressure set point to maintain sublimation, temperature, or pressure. In some embodiments, the system displays, via the display, a cumulative mass indicator corresponding to the estimated cumulative mass removed from the substance.

At decision step 2628, the system determines whether a cumulative mass threshold has been exceeded. This threshold may correspond to a user-defined endpoint or a condition indicative of near-complete drying. In some embodiments, the cumulative mass threshold represents a target mass loss associated with a predetermined level of residual moisture in the dried substance. For example, in pharmaceutical freeze-drying applications, the endpoint may correspond to a residual moisture content of approximately 1-3%, as is typical for antibiotics, monoclonal antibodies, and vaccines. Exceeding this threshold may risk denaturation or crystallization, compromising the therapeutic efficacy of the product. In such contexts, the cumulative mass threshold is selected to preserve biological stability and ensure batch-to-batch consistency. Similarly, in botanical drying applications such as cannabis, the cumulative mass threshold may reflect an optimal moisture range (e.g., 10-12%) required to preserve flavor and aromatic compounds while minimizing the risk of microbial contamination. Exceeding the target loss may result in excessive dryness, degrading product quality, while under-drying may leave the product susceptible to mold growth. In monitoring cumulative mass loss and comparing it to the threshold, the system enables real-time control of drying progress with precision tailored to the material-specific requirements.

If the threshold is not exceeded (i.e., “No” at step 2628), control returns to step 2608. If the cumulative mass threshold is exceeded (i.e., “Yes” at step 2628), the system proceeds to step 2630, where it either terminates or alters the freeze-drying process. In some embodiments, altering the freeze-drying process includes entering a final drying stage, reducing chamber pressure, or initiating a cool-down sequence.

In some embodiments, terminating or altering freeze-drying of the substance comprises modifying a pressure or temperature setting to either: shift the substance (or sublimatable constituent) from a vapor phase to a solid phase by crossing a phase boundary, or adjust sublimation kinetics within the vapor phase region. In some embodiments, terminating or altering the freeze-drying of the substance comprises initiating a completion stage or powering down the one or more energy emitters.

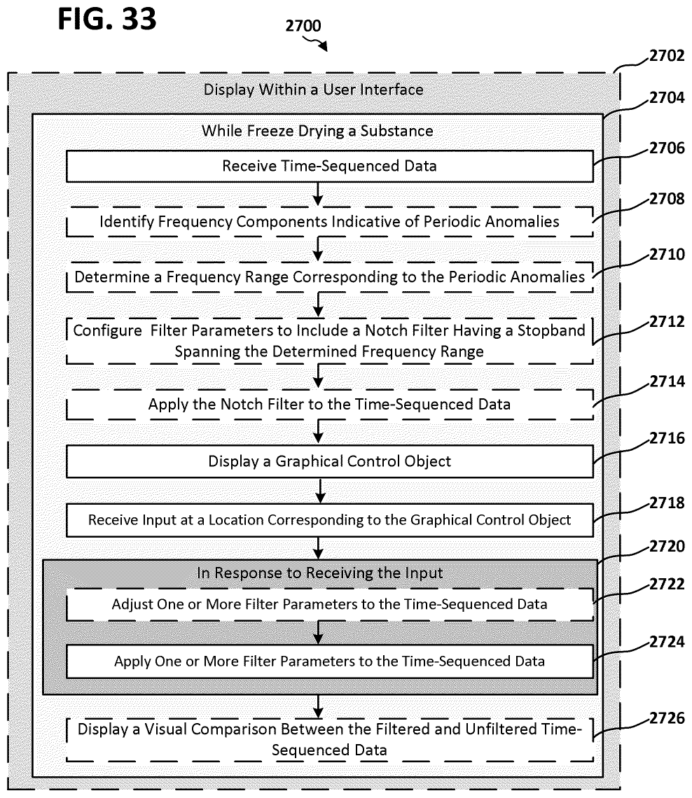

FIG. 33 illustrates a flow diagram of a method 2700 for adjusting sensor data during a freeze-drying process using configurable filtering techniques. The method involves identifying and suppressing periodic anomalies in time-sequenced data (such as temperature or power measurements), thereby enhancing the signal quality of the sensor data. This enables more accurate monitoring and visualization of freeze-drying conditions through a user interface. The method can be implemented by a system that includes a processor in communication with a display device (e.g., a local or remote monitor, touchscreen, or mobile device), as well as with temperature and pressure control subsystems of a freeze-dryer apparatus. The processor is also operatively connected to one or more sensors and energy emitters (e.g., heating elements or infrared sources) that interact with the substance being freeze dried.

At step 2702, the system displays process information within a user interface. In some embodiments, the user interface is presented on a touchscreen or graphical display connected to the system. In other embodiments, the interface is presented on a remote device such as a mobile device, smartphone, tablet, or computer. The display may include visual indicators such as temperature, pressure, sublimation rate, cumulative mass removed, signal quality, or other relevant process parameters. As shown at step 2704, the method 2700 is performed while freeze-drying a substance within a vacuum chamber (e.g., insulated shelf enclosure 511) or similar environment configured to support sublimation under reduced pressure and controlled temperature conditions.

At step 2706, the system receives time-sequenced data during the freeze-drying process. The data may include temperature measurements from thermocouples, thermistors, RTDs, or infrared sensors positioned at various locations within the chamber; pressure readings from vacuum tube thermocouples (e.g., 531, DV-4, DV-6, etc.) and Pirani sensors; and power or energy usage data from energy metering modules (e.g., PZEM004, etc.). In some embodiments, the received data is sampled at regular intervals and stored as a time-series dataset. It should be appreciated that the time-sequenced data is indicative of the condition of the substance during freeze-drying and can be analyzed in real time or post-processed.

At step 2708, the system analyzes the time-sequenced data to identify one or more frequency components that may correspond to periodic anomalies. Such anomalies may result from mechanical oscillations, electrical interference, or control-related cycling behaviors. In some embodiments, the periodic anomalies correspond to thermal interference induced by cyclical activation of a heating element proximate to a temperature sensor. These periodic patterns can mask the true thermal behavior of the substance. Spectral analysis, such as a Fast Fourier Transform (FFT), may be performed to identify dominant frequency components that are characteristic of these anomalies.

At step 2710, the system determines a frequency range that corresponds to the identified anomalies. This range may include a central (dominant) frequency and a surrounding bandwidth. The frequency range can be identified automatically or configured manually via a user interface. In some embodiments, the system centers the notch filter stopband (e.g., ±0.1 Hz) on a single dominant frequency (e.g., 0.33 Hz corresponding to a 3-second cycle) observed in the FFT output. In some embodiments, the system selects a range automatically based on spectral density thresholds, peak prominence (e.g., identifying sharp spectral peaks), or historical knowledge of system-specific interference patterns. In some embodiments, the frequency range can be manually entered through an interactive graphical interface.

At step 2712, the system configures one or more filter parameters to attenuate the identified frequency range. In some embodiments, the parameters define a digital notch filter. The filter may be implemented using Infinite Impulse Response (IIR) or Finite Impulse Response (FIR) structures. The system may allow for selection among various filter types, such as notch, Butterworth, Chebyshev, exponential smoothing, or moving average filters. Filter parameters can include gain, cutoff frequency, bandwidth, smoothing factor, time constant, Q-factor, filter order, and the like. In some embodiments, filter parameters are configurable and are stored in memory.

At step 2714, the system applies the filter to the time-sequenced data. This may occur in real time as new data is acquired, or in batch mode when processing historical data. The filter attenuates or removes unwanted frequency components while preserving meaningful thermal trends. The filtered data enables more accurate control behavior and improves signal quality for downstream analysis and visualization.

At step 2716, the system displays a graphical control object within the user interface. The control object may be rendered on a touchscreen and may take the form of a slider, dial, toggle switch, drop-down menu, or other interactive element. The graphical control object can adjust one or more filter parameters. In some embodiments, the graphical control object is part of a sensor-specific filter configuration interface, such as those shown in FIG. 7H (e.g., filter controls 480A-480I). Each filter configuration interface may correspond to a specific sensor such as a pressure sensor, temperature sensor, or mass sensor and enables real-time adjustment of filter settings through graphical components like sliders and checkboxes. For example, the slider may simultaneously enable the filter if advanced beyond a threshold and then adjust its center frequency or width beyond the threshold. In some embodiments, different preconfigured modes are selectable (e.g., high suppression, auto-detect, minimal filtering). In some embodiments, a second graphical control object is used to access additional filter controls.

At step 2718, the system receives input at a location corresponding to a graphical control object. In some embodiments, a first graphical control object is displayed for basic filter engagement and adjustment. For example, the first control object may be a slider or dial that simultaneously enables the filter and adjusts a primary filter parameter, such as the center frequency or suppression strength of a notch filter. In certain embodiments, the graphical control object is rendered within the filtering interface depicted in FIG. 7H and may be mapped to a particular sensor, such as the T-Primary sensor (filter 480C) or the primary pressure sensor (filter 480A). This layout enables independent configuration of filter parameters for multiple sensors concurrently within the same interface view.

In some embodiments, a second graphical control object is also displayed within the user interface and is associated with advanced filter parameter adjustment. The system may detect a long-press input at a location corresponding to this second graphical control object. In response to the long-press input, the system may display one or more filter parameter controls, such as a numerical input box, a frequency range selector, or toggles to enable or disable specific filter types. These filter parameter controls may correspond to the advanced configuration panel available in the filtering view of FIG. 7H, where each sensor filter supports customizable attributes such as filter type (e.g., Butterworth, FIR, Chebyshev), filter order, or window size. These parameters can be accessed by long-pressing a sensor's corresponding interface element (e.g., 480A-480I), which causes the control region to dynamically expand. The system may then receive input selecting or modifying the one or more filter parameters via these controls.

At step 2718, the system receives input at a location corresponding to the graphical control object. In some embodiments, the graphical control object corresponds to a slider or dial to adjust the primary filter parameter, such as the notch center frequency. In some embodiments, a long-press input at a control object may trigger additional parameter controls to appear. The filter parameter controls may include numerical input boxes, frequency range selectors, or toggles for enabling or disabling different filter types. These controls may be part of the extended parameter region associated with the filter interfaces depicted in FIG. 7H. In some embodiments, the second graphical control object activates a modal or collapsible section of the sensor's filter panel, enabling selection from a predefined list of filter types (e.g., Butterworth, Moving Average, Kalman) and manual adjustment of numeric values such as gain or cutoff frequency.

At step 2720, in response to the received input, the system optionally adjusts one or more filter parameters as at step 2722 and applies the one or more filter parameters to the time-sequenced data, either in real time or retrospectively as at step 2724. For instance, in some embodiments, the one or more filter parameters include gain, frequency range, or filter type that may be updated in memory. This allows for refinement of the filtered signal and tuning of the noise suppression process.

At step 2726, the system displays a visual comparison between the filtered and unfiltered time-sequenced data. This may be rendered using overlaid line graphs, split-screen views, or a toggle switch to alternate between representations. In some embodiments, signal quality metrics or FFT overlays may be presented. These visualizations enable quick evaluation of the effectiveness of filtering, ensure preservation of meaningful data trends, and better understand the influence of filtering on sublimation rate estimation.

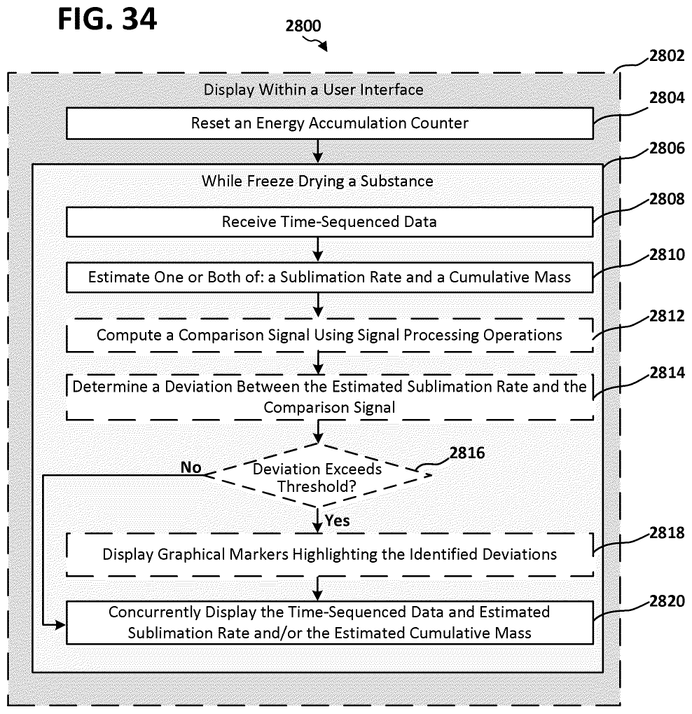

FIG. 34 illustrates a flow diagram of a method 2800 for displaying estimated sublimation behavior, such as sublimation rate and cumulative mass loss, concurrently with time-sequenced process data (e.g., energy, power, voltage, current, etc.) while freeze-drying. The method facilitates visual correlation between sublimation-related trends and the underlying process behavior. The method may be implemented by a system including a processor in communication with one or more sensors and a display device (e.g., touchscreen, monitor, or mobile device), and is operable during an active freeze-drying cycle. The sensors may include temperature sensors, pressure sensors, and mass sensors, among others. The processor may also access power monitoring components (e.g., PZEM004 modules) for energy tracking.

At step 2802, the system displays process information within a user interface. In some embodiments, this includes a parameter view section such as that shown in FIG. 7G (e.g., section 468), where the user may enable or disable the display of electrical parameters through a set of checkboxes 468A-468F. These controls allow dynamic selection of views including energy (460), power (462), current (464), and voltage (466), providing a customizable dashboard to monitor freeze-drying operations in real time.

At step 2804, the system resets an energy accumulation counter. In some embodiments, an energy counter reset button 472, as shown in FIG. 7G, is used to reset the cumulative energy view 460 to zero. This enables batch-specific energy tracking and aligns the energy counter with the start of a freeze-drying run.

At step 2806, the system begins monitoring while freeze-drying a substance comprising a sublimatable constituent. During the process, the system receives time-sequenced data from the plurality of sensors (step 2808). The data may include time, energy, power, current, voltage, temperature, pressure, and mass readings, each sampled at regular intervals and stored as a time-series dataset.

At step 2810, the system estimates one or both of a sublimation rate of the sublimatable constituent and a cumulative extracted mass. In some embodiments, enabling the “SubRate” checkbox 470A or “CumMass” checkbox 470B in the overlay controls section 470 (FIG. 7G) causes the system to plot a time-based sublimation rate or cumulative mass overlay onto the electrical parameter graphs (e.g., overlaid on energy view 460 or current view 464). This facilitates visual analysis of the estimated sublimation behavior in the context of system energy use and thermal performance.

At step 2812, the system computes a comparison signal from the time-sequenced data using one or more signal processing operations. These operations may include derivatives, moving averages, smoothing functions, Fourier transforms, or machine learning-based predictions. The purpose of this signal is to represent an expected or idealized behavior of sublimation or mass loss.

At step 2814, the system determines a deviation between the estimated sublimation rate or cumulative extracted mass and the computed comparison signal. If this deviation exceeds a defined threshold (step 2816), the system proceeds to step 2818; otherwise, it continues to step 2820. In some embodiments, the deviation is calculated using statistical operations or residual analysis between plotted overlays (e.g., SubRate or CumMass) and smoothed or model-derived signals.

At step 2818, the system displays one or more graphical markers highlighting the identified deviations. These markers may appear as shaded bands, flags, annotations, or colored trace overlays along the same time axis as the electrical and process plots. For example, a deviation marker may appear on the same graph as the SubRate overlay atop energy view 460, revealing anomalies where sublimation behavior diverges from expected energy usage.

At step 2820, the system concurrently displays one or more graphical representations of the time-sequenced data and one or both of the estimated sublimation rate and cumulative extracted mass. These views may be presented as multi-axis graphs, overlaid plots, or dynamically generated parameter views as described in FIG. 7G. Each data stream using checkboxes (e.g., 468A-468F and 470A-470D) can be enabled or disabled, allowing efficient allocation of display space and tailored visibility of relevant data.

In addition to providing real-time visibility into process behavior, the concurrent display of estimated sublimation data with time-sequenced electrical parameters serves an important diagnostic function. Because sublimation behavior is thermodynamically linked to system inputs (e.g., energy applied by heaters, the correlation between these data streams) can reveal hardware or process faults. For example, if the system estimates a nonzero sublimation rate despite no measurable increase in energy usage, this may indicate a failed relay, disconnected heater, or calibration error. Similarly, a drop in sublimation rate concurrent with a steady power draw may suggest sensor drift, mechanical obstruction, or loss of chamber vacuum.

In embodiments where graphical overlays (e.g., SubRate and CumMass overlays from section 470) are enabled alongside energy, voltage, or pressure traces, it is easier to identify deviations from expected thermodynamic behavior. This visual correlation enables intuitive root-cause analysis during troubleshooting. For instance, a delayed onset of sublimation relative to heater activation could reveal poor thermal coupling or misplacement of temperature sensors. By supporting these comparisons within a unified time axis, the system offers a streamlined approach for evaluating operational integrity and optimizing freeze-drying efficiency.

In some embodiments, the system calculates a real-time or projected cost of freeze-drying the substance. This may be based on cumulative energy data from energy view 460 and matched to one or more energy rate tiers, such as those defined by a utility provider's time-of-use (TOU) schedule.

At step 2824, the estimated cost may be displayed in a dedicated panel or annotated alongside the energy view 460. In some configurations, the system generates cost plots overlaid with power consumption and sublimation trends to contextualize cost efficiency.

In some embodiments, the system also estimates a total duration of the freeze-drying process based on ongoing sublimation rates and batch progress trends. This estimate may be used to project remaining runtime and evaluate throughput planning.

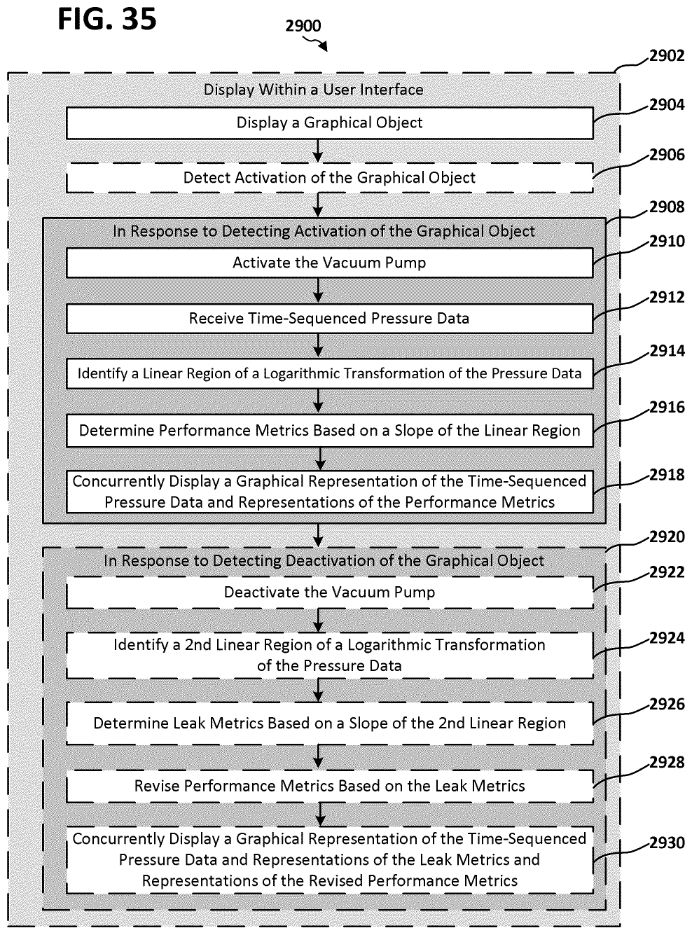

FIG. 35 illustrates a flow diagram of a method 2900 for evaluating vacuum system performance and vacuum chamber integrity in a freeze-drying apparatus. The method enables dynamic, sensor-driven performance evaluation of a vacuum pump and leak diagnostics, based on analysis of time-sequenced pressure data. In some embodiments, method 2900 is initiated through interaction with a graphical control object presented within a display interface and proceeds through automated test stages before presenting derived performance and leak metrics. As shown in FIG. 7J, this interface may include options for selecting between Pull Down 493A and Hold 493B tests (see contact 290T7), each representing a distinct phase of vacuum performance characterization.

At step 2902, the system displays process information and test initiation controls within a user interface. In some embodiments, this includes rendering a dedicated performance test view containing one or more selectable graphical control objects (e.g., buttons, toggles, sliders, or test preset selectors) to configure and initiate the pump evaluation sequence. These graphical objects may be configurable with test parameters such as vacuum chamber volume, test duration, and threshold pressures used in metric calculations. A configuration panel may include numeric input fields, sliders, and dropdown menus to facilitate rapid adjustment of test parameters based on vessel size or desired diagnostic resolution. As illustrated in FIGS. 7J and 7K, test parameters and results are managed through parameter settings section 496 and test results section 498.

At step 2904, a graphical object for initiating the vacuum test is displayed. At step 2906, the system detects activation of the graphical object, such as a button press or touchscreen selection, triggering the vacuum pump test sequence.

In response to detecting activation (step 2908), the system proceeds to step 2910 and activates the vacuum pump. At this point, the system begins acquiring pressure readings from a pressure sensor within the vacuum chamber. At step 2912, these pressure readings are collected as time-sequenced data and stored to memory. Sampling may occur at sub-second intervals to ensure sufficient granularity for identifying pump behavior transitions. The pressure data is continuously plotted on a time axis, providing real-time visibility into pressure evolution during evacuation.

At step 2914, the system identifies a linear region of a logarithmic transformation of the pressure data. In many vacuum systems, plotting pressure vs. time on a logarithmic scale reveals a linear decay phase during which the vacuum pump is operating efficiently. This region is isolated using thresholds, slope detection, or regression fitting. For example, as shown in FIG. 7J, curves 490A and 490B represent historical and recent tests, respectively, with linear extrapolations 490C and 490D extended toward the 10² mTorr region. Time constant marker 492B indicates the extrapolated time to reach a reference pressure, enabling visual comparison of performance degradation.

At step 2916, the system determines one or more performance metrics of the vacuum pump based on the slope of the linear region. These metrics may include: Pump time constant, defined as the time required to reduce pressure by a fixed ratio, often visualized by extending a linear slope to intersect a threshold pressure; Evacuation velocity, representing the effective rate of pressure reduction, expressed in units of pressure per unit time; and Initial pull-down efficiency, indicating how rapidly the pump achieves a partial vacuum. These metrics are displayed in the test results section 498, with toggles (e.g., 498A) to switch between values such as “CFM”.

At step 2918, the system concurrently displays a graphical representation of the time-sequenced pressure data and the derived performance metrics. In some embodiments, the display includes: A pressure vs. time curve plotted in log-scale; An overlaid regression line representing the linear decay region; Textual annotations indicating slope, time constant, or evacuation velocity; and Visual markers showing the intersection of extrapolated slope with a threshold pressure. For instance, the time constant marker 492B in FIG. 7J is 7 minutes and the time constant marker 492C is 7.5 minutes.

The graphical display may also allow toggling between current and historical tests. In some embodiments, previously stored test data (pressure curves and performance metrics) are retrieved and plotted alongside the current test. This side-by-side or overlaid comparison helps identify performance degradation over time (e.g., a lengthened time constant or reduced evacuation velocity). Color-coded traces or labels visually distinguish current vs. historical data. A degradation indicator may be displayed based on the delta between current and stored metrics, providing intuitive feedback on equipment aging or emerging failures. In FIG. 7J, test1 494A and test2 494B curves exemplify such historical comparisons.

In some embodiments, the system automatically deactivates the vacuum pump either upon detecting completion of the linear evacuation phase or after a fixed time period.

Upon deactivation of the vacuum pump, the system initiates a leak test. At step 2922, with the pump off, the system monitors pressure rebound behavior by continuing to collect time-sequenced pressure data. At step 2924, a second linear region of a logarithmic transformation of the pressure data is identified. This typically corresponds to a slow, upward slope in pressure resulting from leaks into the chamber or outgassing from internal surfaces. In FIG. 7K, this behavior is recorded during the Hold test 493B, which begins once a threshold pressure (e.g., 600 mTorr) is reached and the pump is disabled.

At step 2926, the system determines one or more leak metrics of the vacuum chamber based on the slope of this second linear region and the known volume of the vacuum chamber. In some embodiments, the leak metric is expressed in units of volume per unit time (e.g., CFM). This metric may be derived using ideal gas laws and assumptions about uniform leak distribution or based on empirical correlations for the chamber geometry. In FIG. 7K, test1 curve 490E shows a leak rate of −0.31 CFM (acceptable), while test2 curve 490F reveals a higher leak rate of −2.1 CFM, indicating degraded chamber sealing.

At step 2928, the system optionally revises previously calculated performance metrics in light of the leak behavior. For example, an evacuation velocity may be adjusted downward to account for backflow losses due to leakage. This results in more accurate pump diagnostics under real-world conditions.

At step 2930, the system concurrently displays the updated pressure curve, leak metrics, and revised performance metrics. The second linear region is often overlaid as a second colored line on the existing pressure plot, and textual annotations show leak rate. This dual-phase visualization (evacuation followed by rebound) provides a comprehensive overview of system vacuum integrity and pump health. Test results such as those in the pump metrics section 497 (e.g., total runtime 497B) allow lifetime performance tracking for each pump.

For instance, if the measured leak rate exceeds a defined tolerance, the system may highlight the result with a red marker and generate a diagnostic alert. This enables proactive maintenance or sealing inspections. Similarly, a deviation between the current and prior test slope may suggest progressive seal degradation or pump wear. These comparisons can be used to generate maintenance recommendations or flag abnormal operating conditions. A new test entry can be added using control 494C and navigate results through the test list 494 for comprehensive trend evaluation.

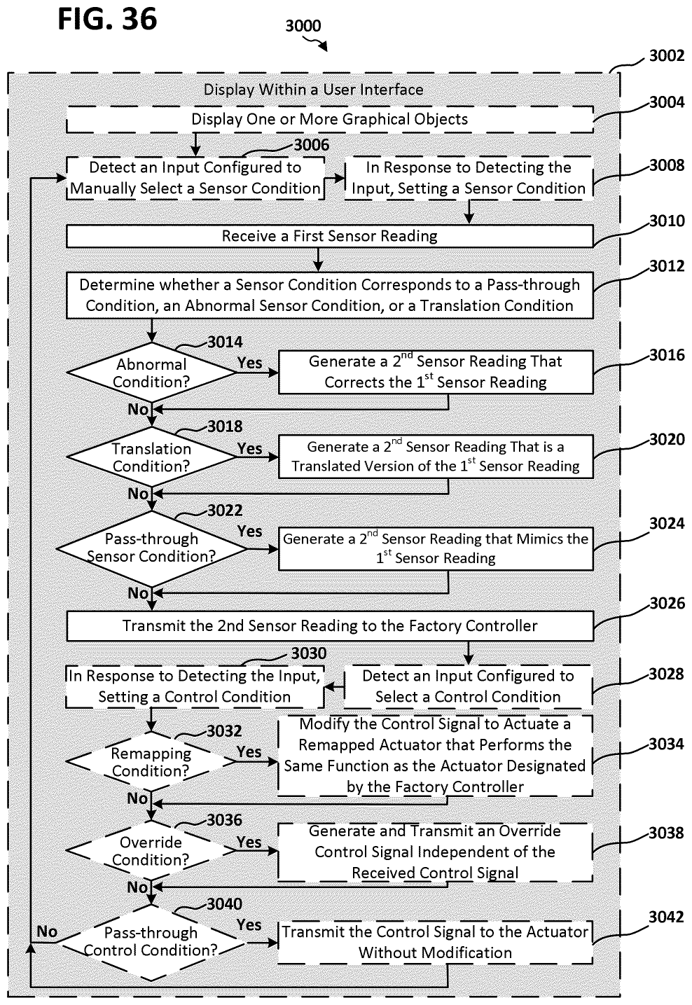

FIG. 36 illustrates a flow diagram of a method 3000 for signal routing and override control in a man-in-the-middle configuration within a freeze-drying system. The method enables dynamic signal evaluation, selective relay manipulation, and user-defined control logic in response to real-time sensor data and operator inputs. The system includes a man-in-the-middle controller 702B, one or more sensors, a primary controller 702A, one or more actuators (e.g., relays 640A-640H), a display generation component (e.g., touchscreen, monitor, mobile device), and an input interface (e.g., touchscreen, touch-sensitive surface, etc.).

At step 3002, the system displays process information and control settings within a user interface. In some embodiments, this includes a dashboard 260 interface showing current sensor values (e.g., temperature, pressure), actuator (e.g., relays 640A-640H) states, and selectable routing conditions. The display generation component may render an indicator of a sensor condition, such as a visual tag showing whether a sensor reading is currently being passed through, corrected, or translated.

At step 3004, one or more graphical control objects are displayed within the user interface. These enable manual selection of how a sensor's data is handled. For example, the graphical objects may include toggles, buttons, or dropdown menus labeled “pass-through,” “override,” or “remap,” to configure how sensor data is handled.

At step 3006, the system detects an input configured to select a sensor condition. This input may be received via the input interface, such as a touchscreen, touch-sensitive surface, keyboard, or remote software connection. The input may specify a selected condition such as an abnormal condition, pass-through, or translation behavior.

At step 3008, in response to detecting the input, the system sets the sensor condition in accordance with the selected input. In some embodiments, this involves modifying an internal routing table or logic rule to activate signal correction or simulation behavior. This condition determines how incoming sensor data is handled before it is forwarded to the primary controller 702A.

At step 3010, the system receives a first sensor reading from one or more sensors. This reading may represent a physical parameter such as pressure (e.g., vacuum gauge thermocouple), temperature (e.g., thermocouple, thermistor, etc.), mass (e.g., balance), or other values relevant to the freeze-drying process.

At step 3012, the system determines whether the sensor condition corresponds to a pass-through condition, an abnormal sensor condition, or a translation condition. If the system determines the sensor condition corresponds to an abnormal condition (decision step 3014, “yes”), it proceeds to step 3016, where the system generates a second sensor reading that corrects the first reading. Abnormal condition may include situations when the sensor reading exceeds a threshold range, exhibits a stuck value, or displays a rate of change outside of expected bounds.

In some embodiments, correction involves filtering, clamping, or substituting known-good values or backup sensor readings. For example, the correction can apply a correction factor, substituting a previously known good value, or replacing the first sensor reading with a backup sensor value received from another sensor. In some embodiments, the system applies this correction automatically upon detection of a stuck reading or physical inconsistency.

For example, during primary drying, the thermistor detects a −90° F. after consistently reading around 10° F. As such, the man-in-the-middle controller 702B detects that the reading is faulty as the change in temperature exceeds a change threshold, triggering detection of an abnormal sensor condition. A second thermistor, used as a backup sensor, detects 10.3° F. The controller replaces the faulty value (e.g., −90° F.) with the backup sensor's reading (e.g., 10.3° F.), and transmits this as the second sensor reading to the primary controller 702A, allowing continued operation without interruption.

If the system determines the sensor condition corresponds to a translation condition (step 3018, “yes”), it proceeds to step 3020, where it generates a second sensor reading that is a translated version of the first. Generally, incoming readings (e.g., sensor signal) require transformation into a different scale, format, or value space expected by the primary controller 702A. In some embodiments, this involves recalibrating values from one sensor type to match the expected range (e.g., sensor signal profile) of another. In some embodiments, this involves applying a polynomial conversion, scaling factor, or calibration mapping to transform the first sensor reading into a format compatible with the primary controller 702A.

If neither abnormal nor translation conditions are present, the system treats the reading as a pass-through condition and generates a second sensor reading that mimics the first sensor reading, transmitting it unmodified to the primary controller 702A as indicated at step 3024. In some embodiments, this includes relaying the raw sensor value when no noise, error, or discontinuity is detected.

At step 3026, the second sensor reading, whether corrected, translated, or mimicked, is transmitted to the primary controller 702A. This primary controller 702A continues to operate as if it were receiving the original sensor data, even though it may be filtered, relayed, transformed, simulated, or substituted.

At step 3028, the system detects an input configured to manually select a control condition. This input may originate from a graphical control interface, command-line instruction, or remote update. For example, manually selecting an override mode from a touchscreen panel can directly actuate a relay.

At step 3030, in response to detecting the input, the system sets the control condition in accordance with the selected configuration. The control condition may define how subsequent control signals from the primary controller 702A are handled by the man-in-the-middle controller 702B. In some embodiments, available control conditions include: remapping, in which the control signal is redirected to a different actuator that performs the same function as the originally designated actuator; an override, in which the man-in-the-middle controller 702B generates its own control signal, independent of the control signal received from the primary controller 702A; and pass-through control condition, in which control signals are relayed unaltered.

At step 3032, the system determines whether the control condition corresponds to a remapping condition. If so step (3032, “yes”), at step 3034, the system modifies the control signal to actuate a remapped actuator. In some embodiments, the remapped actuator is selected from a lookup table or preconfigured mapping that associates a failed or overridden actuator with a substitute actuator capable of performing the same function. For example, heater relay (connected to GPIO 18) fails to actuate the heaters. The system is configured with a remapping table that links heater relay logic to GPIO 23. When the remapping condition is manually selected through the UI, the man-in-the-middle controller 702B modifies the heater relay (connected to GPIO 18) to the spare relay (connected at GPIO 23). The heaters operate normally and the primary controller 702A continues as if the heater relay is implemented and in fact continues to signal for the heater relay to trip.

If the control condition corresponds to an override condition (determined at step 3036, “yes”), the system proceeds to step 3038 and generates and transmits an override control signal that is independent of the received control signal from the primary controller. In some embodiments, override logic may be triggered by safety interlocks, process alarms, or diagnostic conditions. For example: a safety interlock may trigger deactivation of the heaters regardless of the primary controller's 702A command to run them. A manual override may trigger actuation of a vacuum pump to speed up the process;

If no remapping or override condition is detected, the system defaults to a pass-through control condition (step 3040, “yes”), and at step 3042, it transmits the control signal to the actuator without modification. This allows normal operation of the actuator under the direct command of the primary controller 702A, as long as no override or remapping behavior is selected or detected.

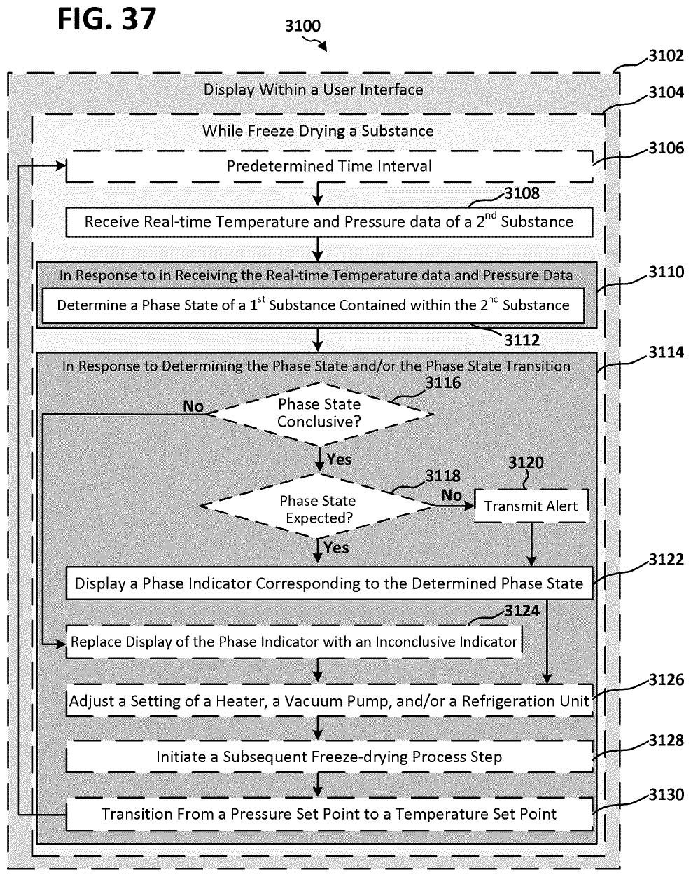

FIG. 37 illustrates a flow diagram of a method 3100 for determining and displaying a phase state or phase transition state of a first substance during a freeze-drying process. The method supports dynamic visualization, uncertainty handling, and process control based on real-time temperature and pressure data. In various implementations, the method is performed by a system that includes a display generation component (e.g., a touchscreen interface, monitor, or mobile device), a processor, and one or more sensors configured to collect environmental measurements from a freeze-drying apparatus, such as from a drying chamber or cold trap.

At step 3102, the system displays a user interface configured to visually represent conditions within the freeze-drying environment. For example, the interface may include at least a portion of a phase diagram that shows equilibrium conditions of temperature and pressure for a first substance (e.g., water), such as boundaries between solid, liquid, and vapor states, or regions of phase transitions like sublimation or condensation.

At step 3104, the system operates during a freeze-drying process in which a second substance (e.g., a food sample, pharmaceutical compound, or biological material) contains or is associated with the first substance (e.g., water or another volatile solvent). At a predetermined time interval (step 3106), the system collects sensor readings including real-time temperature and pressure data of the second substance (step 3108). These measurements may be taken at various locations within the freeze-drying system, such as within a sample vial, condenser, or cold trap.

At step 3110, in response to receiving the real-time data, the system determines a phase state of the first substance contained within the second substance (step 3112). The phase state may correspond to a discrete equilibrium phase, such as solid, liquid, or vapor, or to a transition phase (e.g., sublimation, deposition, melting, boiling, evaporation, freezing, or condensation). In some embodiments, the system evaluates the location of the real-time temperature and pressure values relative to a boundary on a phase diagram associated with the first substance. Alternatively or additionally, the phase state may be determined using a mathematical relation (e.g., a Clausius-Clapeyron equation) or by referencing a predefined lookup table that maps temperature-pressure pairs to corresponding phase states.

At step 3114, in response to determining the phase state and/or detecting a transition between phase states, the system evaluates whether the determination is conclusive (step 3116). For example, in cases where a sensor is not reading either a temperature or pressure, or a sensor readings fall within overlapping or undefined regions of a phase diagram, or where noise exceeds a threshold, the determination may be considered inconclusive. If the result is inconclusive, the system replaces any active phase indicator with an alternative display (step 3124) to convey uncertainty, such as by showing a placeholder symbol, a color-coded warning, or a textual message (e.g., “uncertain”, “sensor error”, “N/A”, “-”).

If the system determines the phase state conclusively, it evaluates whether the determined phase state is expected at step 3118. For instance, based on prior state history, programmed freeze-drying steps (FIGS. 3A-3G or 4A-4G), or a predicted trajectory of temperature and pressure values, the system may detect a deviation from the anticipated phase path. If the detected phase state is unexpected, the system may transmit an alert to an operator as indicated at step 3120 (e.g., display a warning, send a test message/email), log the event, or initiate corrective action.

When the phase state is both conclusive and expected, the system displays a phase indicator corresponding to the current phase state of the first substance, as depicted at step 3122. The phase state indicator may take several forms: a marker overlaid on the displayed phase diagram (e.g., a dot at the coordinate of current temperature of pressure), a color-coded graphical region (e.g., blue for ice, green for vapor, red for liquid), a moving symbol that reflects transitions across phase boundaries, or a textual label indicating the detected state (e.g., “SUBLIMATING” or “SUBLIME”, “LIQUID”, “SOLID”, “FREEZING”, “MELTING”). In some embodiments, the phase state indicator is persistently displayed as in dashboard 260. In some embodiments, the phase state indicator is not persistently displayed such as a tooltip, hover text, info bubble, or popup label. The phase state indicator may be updated in real-time as temperature and pressure data change (step 3122 continued).

In some embodiments, the system may also display a time-history or trajectory of the phase indicator (e.g., showing the path across a phase diagram over the last five minutes) to provide additional context to operators. This can assist in verifying that the process is proceeding as expected and reveal trends in real-time drying behavior.

At step 3126, based on the determined phase state, the system may further perform control operations. For instance, in response to detecting ongoing sublimation, the system may maintain or lower the chamber pressure via a vacuum pump or modulate a heating element to continue energy input. Alternatively, if the system detects completion of a transition (e.g., endpoint of primary drying), it may initiate a subsequent freeze-drying step, as indicated at step 3128, such as secondary drying. In some implementations, the transition between process stages may involve shifting from a pressure-controlled phase to a temperature-controlled phase (step 3130), depending on the target residual moisture or process objectives.

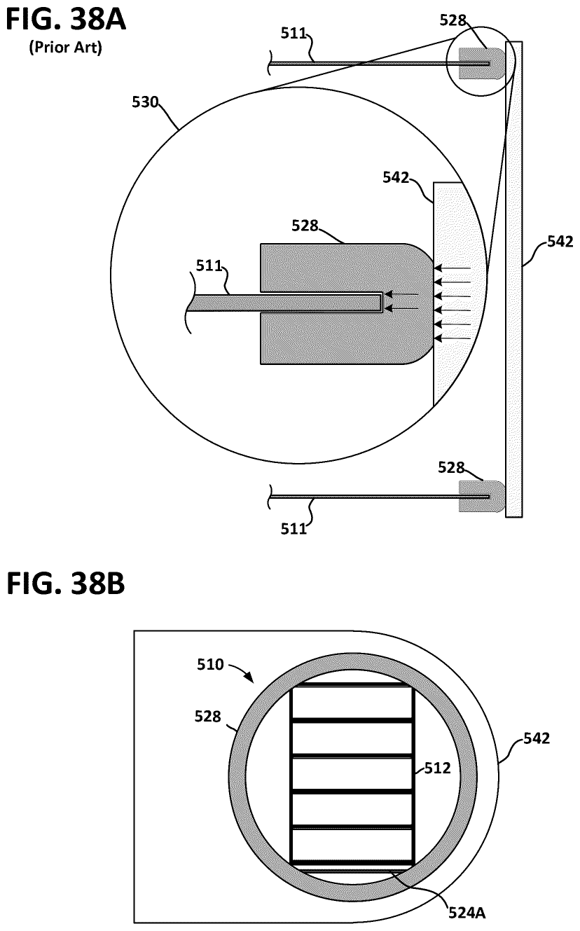

Referring to FIGS. 38A and 38B, a conventional door seal configuration for freeze-dryers is illustrated. In this design, a flexible plastic or rubber gasket 528 is placed over the interior lip of the shelf enclosure 511 opening. As shown in FIG. 38A, the gasket 528 extends inward into the drying chamber (e.g., shelf enclosure 511) and partially obstructs the usable space surrounding the shelves 512. This inward-facing geometry requires removal and reseating of the gasket 528 whenever the shelves 512 are adjusted or removed, introducing frequent physical interaction that accelerates material fatigue and increases the likelihood of vacuum leaks over time.

As depicted in the zoomed cross-sectional view 530 of FIG. 38A, the gasket 528 is compressed between the edge of the shelf enclosure 511 and the door 542 under vacuum. However, the sealing force applied by the door 542 is concentrated along a narrow edge of the shelf enclosure 511. This results in localized stress on the gasket material which, over time, acts like a dull blade gradually slicing into the gasket 528. While the gasket may initially hold vacuum, repeated removal and reinstallation introduce small tears, warping, and compression set, each of which incrementally degrades sealing performance.

Additionally, the design shown in FIGS. 38A and 38B limits usability. Because the gasket 528 projects into the chamber and partially occludes the shelf opening, the shelves 512 cannot be removed from the shelf enclosure 511 without first removing the gasket. This restriction does not apply to individual load trays, which may still pass through the opening. However, when the shelf has to be removed for cleaning, maintenance, or reconfiguration, the gasket has to be removed and reinstalled, making routine tasks unnecessarily tedious and increasing the risk of damaging the gasket 528 with each cycle.

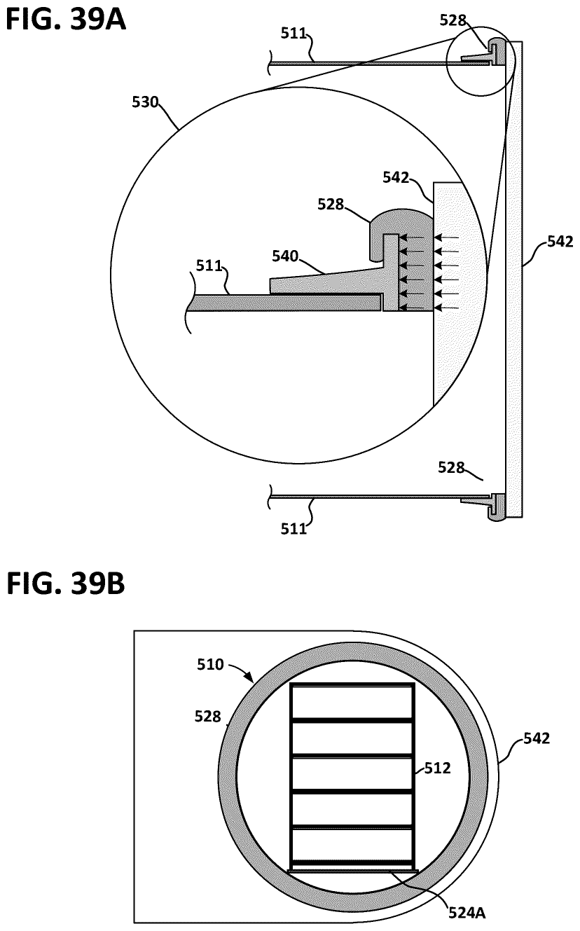

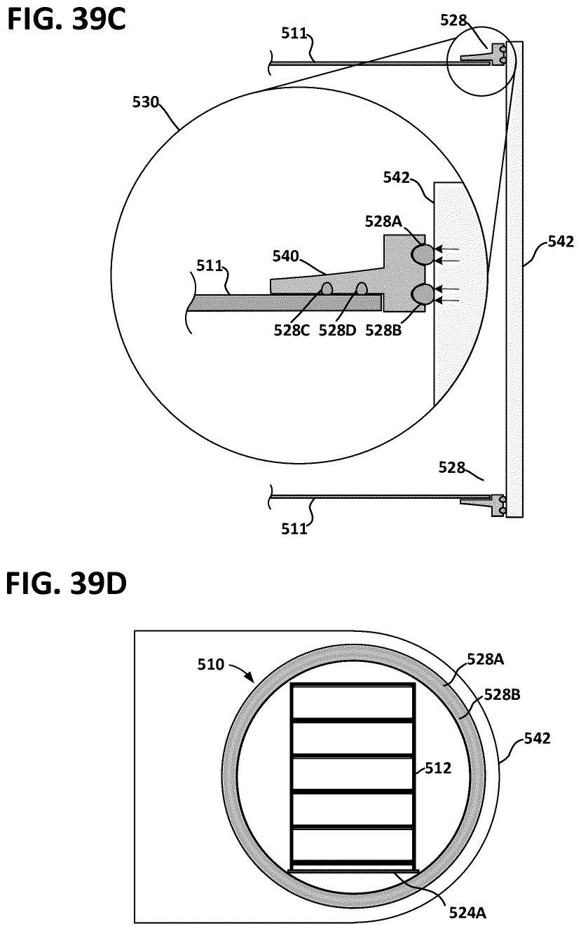

Referring now to FIGS. 39A and 39B, an improved door seal configuration is depicted, incorporating a removable pressed coupling flange 540. As shown in FIG. 39A, the coupling flange 540 is pressed against the outer annular surface of the shelf enclosure 511, with a portion of the flange extending laterally along the external wall of the enclosure and terminating at the front lip or edge of the opening. This engagement provides mechanical stability and enables the coupling flange 540 to form a continuous, air-tight surface without welding or adhesives.

Referring now to FIGS. 39A and 39B, an improved door seal configuration is depicted, incorporating a removable pressed coupling flange 540. As shown in FIG. 39A, the coupling flange 540 is pressed against the outer annular surface of the shelf enclosure 511, with a portion of the flange extending laterally along the external wall of the enclosure and terminating at or near the front lip or edge of the opening. This engagement provides mechanical stability and enables the coupling flange 540 to form a continuous, air-tight sealing surface without the need for welding or adhesives.

As shown in the front view of FIG. 39B, the improved flange geometry preserves the full internal width of the shelf enclosure 511. Unlike the conventional gasket shown in FIG. 38B, which projects inward and obstructs shelf removal, the coupling flange 540 reorients the gasket 528 outward, allowing the shelves 512 to be inserted and removed freely without disturbing the gasket 528, thereby greatly simplifying routine maintenance, cleaning, and reconfiguration.

Referring now to FIGS. 39C and 39D, an alternative embodiment of the improved flange design is shown, incorporating a multi-gasket sealing arrangement. Rather than a single broad gasket 528, this configuration employs a pair of concentric O-ring gaskets (e.g., an inner O-ring 528B and an outer O-ring 528A) situated within grooves on the sealing face of the coupling flange 540. As shown in FIG. 39C, these O-rings are positioned between the coupling flange 540 and the door 542 and are compressed upon closure, creating a redundant vacuum seal across two radial bands. This dual-seal configuration enhances reliability by providing a secondary sealing path in the event of partial failure or wear in one of the O-rings.

A detailed cross-sectional view 530 of FIG. 39C further depicts an additional pair of O-ring gaskets 528C and 528D embedded within grooves on the lateral extension of the coupling flange 540, which interfaces with the outer annular surface of the shelf enclosure 511. These O-rings are compressed between the coupling flange 540 and the shelf enclosure 511 upon installation, serving two functions: improving the vacuum integrity between the flange and the enclosure body and enhancing the mechanical grip of the flange, allowing it to remain securely in place while still permitting removability for maintenance or reconfiguration. In some embodiments, these O-rings assist in vibration damping or tolerance compensation during repeated use.

The front view of FIG. 39D illustrates the positioning of the coupling flange 540, which is visible unlike the prior configurations of FIGS. 38A-38B and 39A-39B where it was obscured by the gasket 528. The concentric O-ring gaskets 528A and 528B are shown nested against the acrylic door 542, forming distinct sealing bands that span the visible circular face of the coupling flange 540.

In some embodiments, the coupler 540 is annular in shape and dimensioned to surround the outer rim of the shelf enclosure 511 with an interference or press-fit. The annular geometry promotes uniform distribution of mechanical force and consistent sealing performance upon installation. In other embodiments, the coupler 540 can be non-annular in shape such as polygonal, square, rectangular, or other geometries configured to match the profile of the shelf enclosure.

To further enhance the vacuum integrity between the coupler and the shelf enclosure 511, the inner diameter of the coupler 540 can include one or more grooves configured to receive O-ring gaskets. These O-rings, such as 528C and 528D (see FIG. 39C), are compressed during installation to form an air-tight seal between the flange assembly and the enclosure body. This not only reduces the need for extremely tight mechanical tolerances but also facilitates removal and reinstallation of the assembly with minimal degradation to sealing performance.

In other embodiments, the planar sealing surface of the coupling flange 540 may include one or more concentric grooves configured to receive circular gaskets such as O-rings (e.g., 528A and 528B), which can provide either a single- or dual-seal configuration depending on the desired vacuum reliability and load profile. The grooves serve both to locate the gaskets precisely and to retain them when the door 542 is open.

The flange may include retaining ridges or molded detents configured to prevent displacement of the gasket during non-compressed states (e.g., when the door is open). These features help maintain the gasket in its intended position and alignment.

The gasket material used in conjunction with the coupling flange 540 can be selected from compressible, chemically and thermally resistant elastomers. Suitable materials include, but are not limited to, silicone rubber, Viton (fluorocarbon rubber), and nitrile rubber (Buna-N), depending on the process conditions and cleaning agents used.

In some designs, the coupling flange 540 extends circumferentially around the full perimeter of the shelf enclosure 511 rim, forming a continuous planar sealing surface. This geometry distributes sealing pressure more evenly and eliminates points of localized stress that might otherwise degrade the gasket.

To facilitate assembly, the coupler 540 can include a tapered or chamfered inner edge to guide installation over the shelf enclosure rim. Alternatively, the coupler may incorporate set screws, alignment pins, or quick-release fasteners to secure it in place with repeatable precision. In yet another embodiment, the flange and coupler can be integrally formed as a single molded or machined part to simplify fabrication and improve structural integrity.

The flange geometry can be tailored to distribute sealing pressure across a surface area greater than, equal to, or smaller than that of the original enclosure rim. For instance, configurations with wide flat gaskets may improve durability by distributing load over a broader contact surface, while grooves for O-rings may concentrate force into defined sealing paths with a smaller footprint.

The previous description is provided to enable any person skilled in the art to practice the various examples described herein. Various modifications to these examples will be readily apparent to those skilled in the art, and the generic principles defined herein may be applied to other examples. Thus, the claims are not intended to be limited to the examples shown herein, but are to be accorded the full scope consistent with the language claims, wherein reference to an element in the singular is not intended to mean “one and only one” unless specifically so stated, but rather “one or more”. The word “exemplary” is used herein to mean “serving as an example, instance, or illustration”. Any aspect described herein as “exemplary” is not necessarily to be construed as preferred or advantageous over other examples. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various examples described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means”. As such, no claim element is to be construed under 35 U.S.C § 112(f) unless the element is expressly recited using the phrase “means for”.

1. A system configured to communicate with a display generation component and a mass sensor, comprising:
one or more processors; and
memory storing one or more programs configured to be executed by the one or more processors, the one or more programs including instructions for:
while freeze-drying a substance having a sublimatable constituent:
displaying, via the display generation component, one or both of:
a real-time sublimation rate indicator representing a real-time sublimation rate of the sublimatable constituent removed from the substance, and
a real-time cumulative mass indicator representing a real-time cumulative mass of the sublimatable constituent removed from the substance;
measuring, via the mass sensor, a first mass associated with the substance;
tracking elapsed time since measuring the first mass; and
in response to determining that the elapsed time meets or exceeds one or more predetermined time intervals:
measuring a second mass associated with the substance;
calculating one or both of:
the real-time sublimation rate of the sublimatable constituent based on a difference between the first mass and second mass and the one or more predetermined time intervals, and
the real-time cumulative mass of the sublimatable constituent removed from the substance based on time-integration of the real-time sublimation rate of the sublimatable constituent or based on cumulative summation of mass differences measured over time; and
updating display, via the display generation component, of one or both of the real-time sublimation rate indicator and the real-time cumulative mass indicator.

2. The system of claim 1, wherein:
displaying the real-time sublimation rate indicator includes at least one of:
a numeric value representing the real-time sublimation rate of the sublimatable constituent;
a time-based visualization of the real-time sublimation rate of the sublimatable constituent; and
concurrently displaying historical sublimation rate data distinguishable from the real-time sublimation rate.

3. The system of claim 1, the one or more programs further including instructions for:
displaying, via the display generation component, a rate-of-change indicator derived from the real-time sublimation rate, the rate-of-change indicator including one or more of:
a trend line, a slope indicator, or a rate-of-change curve.

4. The system of claim 1, wherein the mass sensor comprises one or more load cells, strain gauges, torque sensors, piezoelectric force sensors, optical moisture sensors, and acoustic sensors, operatively coupled to a shelf enclosure, and configured to measure, directly or indirectly, mass of the substance.

5. The system of claim 1, wherein the mass sensor comprises one or more load cells, strain gauges, torque sensors, piezoelectric force sensors, optical moisture sensors, and acoustic sensors, operatively coupled to a cold trap, and configured to measure, directly or indirectly, mass of the sublimatable constituent accumulated in the cold trap.

6. The system of claim 1, the one or more programs further including instructions for:
detecting user input to initiate freeze-drying of the substance; and
in response to detecting the user input:
initiating freeze-drying of the substance, and
enabling monitoring of one or both of the real-time sublimation rate of the sublimatable constituent and the real-time cumulative mass of the sublimatable constituent removed from the substance.

7. The system of claim 1, the one or more programs further including instructions for:
terminating or altering freeze-drying of the substance in response to at least one of:
the real-time sublimation rate or a time-derivative of the real-time sublimation rate falling below a sublimation rate threshold for a predefined time duration, and
the real-time cumulative mass meeting or exceeding a cumulative mass threshold for a predefined time duration.

8. The system of claim 7, wherein terminating or altering freeze-drying of the substance comprises modifying at least one of a temperature and a pressure setting to:
shift the sublimatable constituent from a vapor phase of matter to a solid or liquid equilibrium phase of matter by crossing a phase boundary, or
adjust sublimation kinetics within the vapor phase of matter region.

9. The system of claim 7, wherein terminating or altering the freeze-drying of the substance comprises initiating a completion stage or powering down one or more energy emitters.

10. The system of claim 1, the one or more programs further including instructions for:
triggering a completion notification in response to at least one of:
the real-time sublimation rate falling below a sublimation rate threshold for a predefined time duration; and
the cumulative mass meeting or exceeding a cumulative mass threshold for a predefined time duration.

11. The system of claim 10, the one or more programs further including instructions for:
dynamically adjusting at least one of the sublimation rate threshold and cumulative mass threshold based on one more of:
a user-defined drying recipe,
prior batch data,
real-time process measurements,
a user-defined dryness percentage,
the cumulative mass removed from the substance, and
a humidity value derived from dew point analysis at a vacuum exhaust.

12. The system of claim 10, wherein at least one of the sublimation rate threshold and the cumulative mass threshold correspond to a predetermined endpoint condition of a primary drying stage, secondary drying stage, or final drying stage.

13. (canceled)

14. (canceled)

15. The system of claim 1, wherein displaying the real-time cumulative mass indicator includes at least one of:
displaying a numeric value representing a total amount of the sublimatable constituent removed from the substance;
displaying a time-based visualization of the real-time cumulative mass of the sublimatable constituent removed from the substance; and
concurrently displaying historical cumulative mass data distinguishable from the real-time cumulative mass of the sublimatable constituent removed from the substance.

16. (canceled)

17. (canceled)

18. The system of claim 10, wherein the cumulative mass threshold corresponds to a predetermined residual moisture level of the substance, the residual moisture level based on at least one of:
a percentage of an initial mass of the sublimatable constituent within the substance; and
a data-driven value correlated with target product characteristics including sensory quality and microbial stability.

19. The system of claim 18, wherein the initial mass of the sublimatable constituent within the substance is calculated based on one or more of:
a thermodynamic model,
spectral analysis including near-infrared (NIR) imaging, and
a moisture ratio of the substance.

20. The system of claim 19, wherein the thermodynamic model comprises one or more of:
calculating a quantity of energy or power input over the one or more predetermined time intervals from known power and duty cycle;
inferring phase of matter transitions based on observed plateaus in temperature; and
cross-referencing energy consumption to modeled latent heat profiles of the substance or the sublimatable constituent.

21. The system of claim 19, wherein the thermodynamic model comprises modeling thermal transitions based on one or more of:
identifying latent heat of the substance or the sublimatable constituent released during a freezing plateau from temperature-time data;
calculating sensible heat capacity of the substance or the sublimatable constituent based on pre- and post-freezing slopes of temperature curves; and
calculating energy or power input to freeze the substance or the sublimatable constituent from refrigeration system power consumption data.

22. A non-transitory computer-readable storage medium storing one or more programs configured to be executed by one or more processors of a system, wherein the system is in communication with a display generation component and a mass sensor, the one or more programs including instructions for:
while freeze-drying a substance having a sublimatable constituent:
displaying, via the display generation component, one or both of:
a real-time sublimation rate indicator representing a real-time sublimation rate of the sublimatable constituent removed from the substance, and
a real-time cumulative mass indicator representing a real-time cumulative mass of the sublimatable constituent removed from the substance;
measuring, via the mass sensor, a first mass associated with the substance;
tracking elapsed time since measuring the first mass; and
in response to determining that the elapsed time meets or exceeds one or more predetermined time intervals:
measuring a second mass associated with the substance;
calculating one or both of:
the real-time sublimation rate of the sublimatable constituent based on a difference between the first mass and second mass and the one or more predetermined time intervals, and
the real-time cumulative mass of the sublimatable constituent removed from the substance based on time-integration of the real-time sublimation rate of the sublimatable constituent or based on cumulative summation of mass differences measured over time; and
updating display, via the display generation component, of one or both of the real-time sublimation rate indicator and the real-time cumulative mass indicator.

23. A method, comprising:
at a system that is in communication with a display generation component and a mass sensor;
while freeze-drying a substance having a sublimatable constituent:
displaying, via the display generation component, one or both of:
a real-time sublimation rate indicator representing a real-time sublimation rate of the sublimatable constituent removed from the substance, and
a real-time cumulative mass indicator representing a real-time cumulative mass of the sublimatable constituent removed from the substance;
measuring, via the mass sensor, a first mass associated with the substance at a first time;
tracking elapsed time since measuring the first mass; and
in response to determining that the elapsed time meets or exceeds one or more predetermined time intervals:
measuring a second mass associated with the substance;
calculating one or both of:
the real-time sublimation rate of the sublimatable constituent based on a difference between the first mass and second mass and the one or more predetermined time intervals, and
the real-time cumulative mass of the sublimatable constituent removed from the substance based on time-integration of the real-time sublimation rate of the sublimatable constituent or based on cumulative summation of mass differences measured over time; and
updating display, via the display generation component, of one or both of the real-time sublimation rate indicator and the real-time cumulative mass indicator.

24. A system configured to communicate with a display generation component and one or more energy emitters, comprising:
one or more processors; and
memory storing one or more programs configured to be executed by the one or more processors, the one or more programs including instructions for:
while freeze-drying a substance having a sublimatable constituent:
displaying, via the display generation component, one or both of:
a real-time sublimation rate indicator representing a real-time sublimation rate of the sublimatable constituent removed from the substance, and
a real-time cumulative mass indicator representing a real-time cumulative mass of the sublimatable constituent removed from the substance;
adjusting a quantity of energy or power, via the one or more energy emitters, delivered to the substance over one or more predetermined time intervals;
tracking elapsed time since adjusting the quantity of energy or power delivered to the substance; and
in response to determining that the elapsed time meets or exceeds the one or more predetermined time intervals:
calculating one or both of:
the real-time sublimation rate of the sublimatable constituent based on the quantity of energy or power delivered to the substance over the one or more predetermined time intervals and a heat of sublimation of the sublimatable constituent, and
the real-time cumulative mass of the sublimatable constituent removed from the substance based on the quantity of energy or power delivered to the substance over the one or more predetermined time intervals and the heat of sublimation of the sublimatable constituent, or based on time-integration of the real-time sublimation rate; and
updating display, via the display generation component, of one or both of the real-time sublimation rate indicator and the real-time cumulative mass indicator.

25. The system of claim 24, wherein displaying the real-time sublimation rate indicator includes at least one of:
displaying a numeric value representing the real-time sublimation rate of the sublimatable constituent;
displaying a time-based visualization of the real-time sublimation rate of the sublimatable constituent; and
concurrently displaying historical sublimation rate data distinguishable from the real-time sublimation rate.

26. The system of claim 24, the one or more programs further including instructions for:
displaying, via the display generation component, a rate-of-change indicator derived from the real-time sublimation rate, the rate-of-change indicator including one or more of:
a trend line, a slope indicator, or a rate-of-change curve.

27. The system of claim 24, wherein calculating the sublimation rate comprises applying a model or algorithm based on one or more of:
a real-time temperature of the substance,
a real-time environmental pressure proximate to the substance,
a temperature set point,
a pressure set point,
a known or calculated onset temperature for sublimation of the sublimatable constituent,
a calibration factor derived from prior system behavior,
machine learning or artificial intelligence techniques trained on historical drying data, and
iteratively adjusting one or more model parameters.

28. The system of claim 24, the one or more programs further including instructions for:
detecting a user input to initiate freeze-drying of the substance; and
in response to detecting the user input:
initiating freeze-drying of the substance, and
enabling monitoring of one or both of the real-time sublimation rate of the sublimatable constituent and the real-time cumulative mass of the sublimatable constituent removed from the substance.

29. The system of claim 24, the one or more programs further including instructions for:
terminating or altering freeze-drying of the substance in response to one or both of:
the real-time sublimation rate or a time-derivative of the real-time sublimation rate falling below a threshold for a predefined time duration; and
the real-time cumulative mass meeting or exceeding a cumulative mass threshold for a predefined time duration.

30. The system of claim 29, wherein terminating or altering freeze-drying of the substance comprises modifying at least one of a temperature and a pressure setting to:
shift the sublimatable constituent from a vapor phase of matter to a solid or liquid equilibrium phase of matter by crossing a phase boundary, or
adjust sublimation kinetics within the vapor phase of matter region.

31. The system of claim 29, wherein terminating or altering the freeze-drying of the substance comprises initiating a completion stage or powering down the one or more energy emitters.

32. (canceled)

33. The system of claim 24, the one or more programs further including instructions for:
triggering a completion notification in response to at least one of:
the real-time sublimation rate falling below a sublimation rate threshold for a predefined time duration; and
the cumulative mass meeting or exceeding a cumulative mass threshold for a predefined time duration.

34. The system of claim 33, the one or more programs further including instructions for:
dynamically adjusting at least one of the sublimation rate threshold and the cumulative mass threshold based on one or more of:
a user-defined drying recipe,
prior batch data,
real-time process measurements,
a user-defined dryness percentage,
a cumulative mass removed from the substance, and
a humidity value derived from dew point analysis at a vacuum exhaust.

35. The system of claim 33,
wherein at least one of the sublimation rate threshold and the cumulative mass threshold correspond to a predetermined endpoint condition of a primary drying stage, secondary drying stage, or final drying stage.

36. (canceled)

37. The system of claim 24, wherein displaying the real-time cumulative mass indicator includes at least one of:
displaying a numeric value representing a total amount of the sublimatable constituent removed from the substance;
displaying a time-based visualization of the real-time cumulative mass of the sublimatable constituent removed from the substance; and
concurrently displaying historical cumulative mass data distinguishable from the real-time cumulative mass of the sublimatable constituent removed from the substance.

38. (canceled)

39. (canceled)

40. The system of claim 33, wherein the cumulative mass threshold corresponds to a predetermined residual moisture level of the substance, the residual moisture level based on at least one of:
a percentage of an initial mass of the sublimatable constituent within the substance; and
a data-driven value correlated with target product characteristics including sensory quality and microbial stability.

41. The system of claim 40, wherein the initial mass of sublimatable constituent within the substance is calculated based on one or more of:
a thermodynamic model,
spectral analysis including near-infrared (NIR) imaging, and
a moisture ratio of the substance.

42. The system of claim 41, wherein the thermodynamic model comprises one or more of:
calculating the quantity of energy or power over the one or more predetermined time intervals from known power and duty cycle;
inferring phase of matter transitions based on observed plateaus in temperature; and
cross-referencing energy consumption to modeled latent heat profiles of the substance or the sublimatable constituent.

43. The system of claim 41, wherein the thermodynamic model comprises modeling thermal transitions based on one or more of:
identifying latent heat of the substance or the sublimatable constituent released during a freezing plateau from temperature-time data;
calculating sensible heat capacity of the substance based on pre- and post-freezing slopes of temperature curves; and
calculating energy or power input to freeze the substance or the sublimatable constituent from refrigeration system power consumption data.

44. A non-transitory computer-readable storage medium storing one or more programs configured to be executed by one or more processors of a system, wherein the system is in communication with a display generation component and one or more energy emitters, the one or more programs including instructions for:
while freeze-drying a substance having a sublimatable constituent:
displaying, via the display generation component, one or both of:
a real-time sublimation rate indicator representing a real-time sublimation rate of the sublimatable constituent removed from the substance, and
a real-time cumulative mass indicator representing a real-time cumulative mass of the sublimatable constituent removed from the substance;
adjusting a quantity of energy or power, via the one or more energy emitters, delivered to the substance one or more predetermined time intervals;
tracking elapsed time since adjusting the quantity of energy or power delivered to the substance; and
in response to determining that the elapsed time meets or exceeds the one or more predetermined time intervals:
calculating one or both of:
the real-time sublimation rate of the sublimatable constituent based on the quantity of energy or power delivered to the substance over the one or more predetermined time intervals and a heat of sublimation of the sublimatable constituent, and
the real-time cumulative mass of the sublimatable constituent removed from the substance based on the quantity of energy or power delivered to the substance over the one or more predetermined time intervals and heat of sublimation of the sublimatable constituent, or based on time-integration of the real-time estimated sublimation rate; and
updating display, via the display generation component, of one or both of the real-time sublimation rate indicator and the real-time cumulative mass indicator.

45. A method, comprising:
at a system that is in communication with a display generation component and one or more energy emitters:
while freeze-drying a substance having a sublimatable constituent:
displaying, via the display generation component, one or both of:
a real-time sublimation rate indicator representing a real-time sublimation rate of the sublimatable constituent removed from the substance, and
a real-time cumulative mass indicator representing a real-time cumulative mass of the sublimatable constituent removed from the substance;
adjusting a quantity of energy or power, via the one or more energy emitters, delivered to the substance one or more predetermined time intervals;
tracking elapsed time since adjusting the quantity of energy or power delivered to the substance; and
in response to determining that the elapsed time meets or exceeds one or more predetermined time intervals:
calculating one or both of:
the real-time sublimation rate of the sublimatable constituent based on the quantity of energy or power delivered to the substance over the one or more predetermined time intervals and a heat of sublimation of the sublimatable constituent, and
the real-time cumulative mass of the sublimatable constituent removed from the substance based on the quantity of energy or power delivered to the substance over the one or more predetermined time intervals and heat of sublimation of the sublimatable constituent, or based on time-integration of the real-time sublimation rate; and
updating display, via the display generation component, of one or both of the real-time sublimation rate indicator and the real-time cumulative mass indicator.

46. The system of claim 1, the one or more programs further including instructions for:
extrapolating, based on an initial mass of sublimatable constituent within the substance and the real-time sublimation rate or the cumulative mass removed from the substance, a time remaining until completion of freeze-drying the substance; and
displaying, via the display generation component, a completion-time indicator representative of the extrapolated time remaining until completion of freeze-drying.

47. The system of claim 24, the one or more programs further including instructions for:
extrapolating, based on an initial mass of sublimatable constituent within the substance and the real-time sublimation rate or the cumulative mass removed from the substance, a time remaining until completion of freeze-drying the substance; and
displaying, via the display generation component, a completion-time indicator representative of the extrapolated time remaining until completion of freeze-drying.

48. The system of claim 24, wherein calculating the real-time sublimation rate or the real-time cumulative mass includes applying an efficiency factor representing transfer efficiency of energy or power between the one or more energy emitters and the substance.

49. The non-transitory computer-readable storage medium of claim 22, wherein displaying the real-time sublimation rate indicator includes at least one of:
displaying a numeric value representing the real-time sublimation rate of the sublimatable constituent;
displaying a time-based visualization of the real-time sublimation rate of the sublimatable constituent; and
concurrently displaying historical sublimation rate data distinguishable from the real-time sublimation rate.

50. The non-transitory computer-readable storage medium of claim 22, the one or more programs further including instructions for:
displaying, via the display generation component, a rate-of-change indicator derived from the real-time sublimation rate, the rate-of-change indicator including one or more of:
a trend line, a slope indicator, or a rate-of-change curve.

51. The non-transitory computer-readable storage medium of claim 22, wherein the mass sensor comprises one or more load cells, strain gauges, torque sensors, piezoelectric force sensors, optical moisture sensors, and acoustic sensors, operatively coupled to a shelf enclosure, and configured to measure, directly or indirectly, mass of the substance.

52. The non-transitory computer-readable storage medium of claim 22, wherein the mass sensor comprises one or more load cells, strain gauges, torque sensors, piezoelectric force sensors, optical moisture sensors, and acoustic sensors, operatively coupled to a cold trap, and configured to measure, directly or indirectly, mass of the sublimatable constituent accumulated in the cold trap.

53. The non-transitory computer-readable storage medium of claim 22, the one or more programs further including instructions for:
detecting a user input to initiate freeze-drying of the substance; and
in response to detecting the user input:
initiating freeze-drying of the substance, and
enabling monitoring of one or both of the real-time sublimation rate of the sublimatable constituent and the real-time cumulative mass of the sublimatable constituent removed from the substance.

54. The non-transitory computer-readable storage medium of claim 22, the one or more programs further including instructions for:
terminating or altering freeze-drying of the substance, in response to at least one of:
the real-time sublimation rate or a time-derivative of the real-time sublimation rate falling below a sublimation rate threshold for a predefined time duration; and
the real-time cumulative mass meeting or exceeding a cumulative mass threshold for a predefined time duration.

55. The non-transitory computer-readable storage medium of claim 54, wherein terminating or altering freeze-drying of the substance comprises modifying at least one of a temperature and a pressure setting to:
shift the sublimatable constituent from a vapor phase of matter to a solid or liquid equilibrium phase of matter by crossing a phase boundary, or
adjust sublimation kinetics within the vapor phase of matter region.

56. The non-transitory computer-readable storage medium of claim 54, wherein terminating or altering the freeze-drying of the substance comprises initiating a completion stage or powering down one or more energy emitters.

57. The non-transitory computer-readable storage medium of claim 22, the one or more programs further including instructions for:
triggering a completion notification in response to at least one of:
the real-time sublimation rate falling below a sublimation rate threshold for a predefined time duration; and
the cumulative mass meeting or exceeding a cumulative mass threshold for a predefined time duration.

58. The non-transitory computer-readable storage medium of claim 57, the one or more programs further including instructions for:
dynamically adjusting at least one of the sublimation rate threshold and cumulative mass threshold based on one or more of:
a user-defined drying recipe,
prior batch data,
real-time process measurements,
a user-defined dryness percentage,
the cumulative mass removed from the substance, and
a humidity value derived from dew point analysis at a vacuum exhaust.

59. The non-transitory computer-readable storage medium of claim 57, wherein at least one of the sublimation rate threshold and the cumulative mass threshold correspond to a predetermined endpoint condition of a primary drying stage, secondary drying stage, or final drying stage.

60. The non-transitory computer-readable storage medium of claim 22, wherein displaying the real-time cumulative mass indicator includes at least one of:
displaying a numeric value representing a total amount of the sublimatable constituent removed from the substance;
displaying a time-based visualization of the real-time cumulative mass of the sublimatable constituent removed from the substance; and
concurrently displaying historical cumulative mass data distinguishable from the real-time cumulative mass of the sublimatable constituent removed from the substance.

61. The non-transitory computer-readable storage medium of claim 57, wherein the cumulative mass threshold corresponds to a predetermined residual moisture level of the substance, the residual moisture level based on at least one of:
a percentage of an initial mass of the sublimatable constituent within the substance; and
a data-driven value correlated with target product characteristics including sensory quality and microbial stability.

62. The non-transitory computer-readable storage medium of claim 61, wherein the initial mass of the sublimatable constituent within the substance is calculated based on one or more of:
a thermodynamic model,
spectral analysis including near-infrared (NIR) imaging, and
a moisture ratio of the substance.

63. The non-transitory computer-readable storage medium of claim 62, wherein the thermodynamic model comprises one or more of:
calculating a quantity of energy or power input over the one or more predetermined time intervals from known power and duty cycle;
inferring phase of matter transitions based on observed plateaus in temperature; and
cross-referencing energy consumption to modeled latent heat profiles of the substance or the sublimatable constituent.

64. The non-transitory computer-readable storage medium of claim 62, wherein the thermodynamic model comprises modeling thermal transitions based on one or more of:
identifying latent heat of the substance or the sublimatable constituent released during a freezing plateau from temperature-time data;
calculating sensible heat capacity of the substance or the sublimatable constituent based on pre- and post-freezing slopes of temperature curves; and
calculating energy or power input to freeze the substance or the sublimatable constituent from refrigeration system power consumption data.

65. The non-transitory computer-readable storage medium of claim 22, the one or more programs further including instructions for:
extrapolating, based on an initial mass of sublimatable constituent within the substance and the real-time sublimation rate or the cumulative mass removed from the substance, a time remaining until completion of freeze-drying the substance; and
displaying, via the display generation component, a completion-time indicator representative of the extrapolated time remaining until completion of freeze-drying.

66. The method of claim 23, wherein displaying the real-time sublimation rate indicator includes at least one of:
displaying a numeric value representing the real-time sublimation rate of the sublimatable constituent;
displaying a time-based visualization of the real-time sublimation rate of the sublimatable constituent; and
concurrently displaying historical sublimation rate data distinguishable from the real-time sublimation rate.

67. The method of claim 23, further comprising:
displaying, via the display generation component, a rate-of-change indicator derived from the real-time sublimation rate, the rate-of-change indicator including one or more of:
a trend line, a slope indicator, or a rate-of-change curve.

68. The method of claim 23, wherein the mass sensor comprises one or more load cells, strain gauges, torque sensors, piezoelectric force sensors, optical moisture sensors, and acoustic sensors, operatively coupled to a shelf enclosure, and configured to measure, directly or indirectly, mass of the substance.

69. The method of claim 23, wherein the mass sensor comprises one or more load cells, strain gauges, torque sensors, piezoelectric force sensors, optical moisture sensors, and acoustic sensors, operatively coupled to a cold trap, and configured to measure, directly or indirectly, mass of the sublimatable constituent accumulated in the cold trap.

70. The method of claim 23, further comprising:
detecting a user input to initiate freeze-drying of the substance; and
in response to detecting the user input:
initiating freeze-drying the substance, and
enabling monitoring of one of the real-time sublimation rate of the sublimatable constituent and the real-time cumulative mass of the sublimatable constituent removed from the substance.

71. The method of claim 23, further comprising:
terminating or altering freeze-drying of the substance in response to at least one of:
the real-time sublimation rate or a time-derivative of the real-time sublimation rate falling below a sublimation rate threshold for a predefined time duration; and
the real-time cumulative mass meeting or exceeding a cumulative mass threshold for a predefined time duration.

72. The method of claim 71, wherein terminating or altering freeze-drying of the substance comprises modifying at least one of a temperature and a pressure setting to:
shift the sublimatable constituent from a vapor phase of matter to a solid or liquid equilibrium phase of matter by crossing a phase boundary, or
adjust sublimation kinetics within the vapor phase of matter region.

73. The method of claim 71, wherein terminating or altering the freeze-drying of the substance comprises initiating a completion stage or powering down one or more energy emitters.

74. The method of claim 23, further comprising:
triggering a completion notification in response to at least one of:
the real-time sublimation rate falling below a sublimation rate threshold for a predefined time duration; and
the cumulative mass meeting or exceeding a cumulative mass threshold for a predefined time duration.

75. The method of claim 74, further comprising:
dynamically adjusting at least one of the sublimation rate threshold and cumulative mass threshold based on one or more of:
a user-defined drying recipe,
prior batch data,
real-time process measurements,
a user-defined dryness percentage,
the cumulative mass removed from the substance, and
a humidity value derived from dew point analysis at a vacuum exhaust.

76. The method of claim 74, wherein at least one of the sublimation rate threshold and the cumulative mass threshold correspond to a predetermined endpoint condition of a primary drying stage, secondary drying stage, or final drying stage.

77. The method of claim 23, wherein displaying the real-time cumulative mass indicator includes displaying at least one of:
displaying a numeric value representing a total amount of the sublimatable constituent removed from the substance;
displaying a time-based visualization of the real-time cumulative mass of the sublimatable constituent removed from the substance over time; and
concurrently displaying historical cumulative mass data distinguishable from the real-time cumulative mass of the sublimatable constituent removed from the substance.

78. The method of claim 74, wherein the cumulative mass threshold corresponds to a predetermined residual moisture level of the substance, the residual moisture level based on at least one of:
a percentage of an initial mass of the sublimatable constituent within the substance; and
a data-driven value correlated with target product characteristics including sensory quality and microbial stability.

79. The method of claim 78, wherein the initial mass of the sublimatable constituent within the substance is calculated based on one or more of:
a thermodynamic model,
spectral analysis including near-infrared (NIR) imaging, and
a moisture ratio of the substance.

80. The method of claim 79, wherein the thermodynamic model comprises one or more of:
calculating a quantity of energy or power over the one or more predetermined time intervals from known power and duty cycle;
inferring phase of matter transitions based on observed plateaus in temperature; and
cross-referencing energy consumption to modeled latent heat profiles of the substance or the sublimatable constituent.

81. The method of claim 79, wherein the thermodynamic model comprises modeling thermal transitions based on one or more of:
identifying latent heat of the substance or the sublimatable constituent released during a freezing plateau from temperature-time data;
calculating sensible heat capacity of the substance or the sublimatable constituent based on pre- and post-freezing slopes of temperature curves; and
calculating energy or power input to freeze the substance or the sublimatable constituent from refrigeration system power consumption data.

82. The method of claim 23, further comprising:
extrapolating, based on an initial mass of sublimatable constituent within the substance and the real-time sublimation rate or the cumulative mass removed from the substance, a time remaining until completion of freeze-drying the substance; and
displaying, via the display generation component, a completion-time indicator representative of the extrapolated time remaining until completion of freeze-drying.

83. The non-transitory computer-readable storage medium of claim 44, wherein displaying the real-time sublimation rate indicator includes at least one of:
displaying a numeric value representing the real-time sublimation rate of the sublimatable constituent;
displaying a time-based visualization of the real-time sublimation rate of the sublimatable constituent; and
concurrently displaying historical sublimation rate data distinguishable from the real-time sublimation rate.

84. The non-transitory computer-readable storage medium of claim 44, the one or more programs further including instructions for:
displaying, via the display generation component, a rate-of-change indicator derived from the real-time sublimation rate, the rate-of-change indicator including one or more of:
a trend line, a slope indicator, or a rate-of-change curve.

85. The non-transitory computer-readable storage medium of claim 44, wherein calculating the sublimation rate comprises applying a model or algorithm based on one or more of:
a real-time temperature of the substance,
a real-time environmental pressure proximate to the substance,
a temperature set point,
a pressure set point,
a known or calculated onset temperature for sublimation of the sublimatable constituent,
a calibration factor derived from prior system behavior,
machine learning or artificial intelligence techniques trained on historical drying data, and
iteratively adjusting one or more model parameters.

86. The non-transitory computer-readable storage medium of claim 44, the one or more programs further including instructions for:
detecting a user input to initiate freeze-drying of the substance; and
in response to detecting the user input:
initiating freeze-drying the substance, and
enabling monitoring of one or both of the real-time sublimation rate of the sublimatable constituent and the real-time cumulative mass of the sublimatable constituent removed from the substance.

87. The non-transitory computer-readable storage medium of claim 44, the one or more programs further including instructions for:
terminating or altering freeze-drying of the substance in response to at least one of:
the real-time sublimation rate or a time-derivative of the real-time sublimation rate falling below a threshold for a predefined time duration; and
the real-time cumulative mass meeting or exceeding a cumulative mass threshold for a predefined time duration.

88. The non-transitory computer-readable storage medium of claim 87, wherein terminating or altering freeze-drying of the substance comprises modifying at least one of a temperature and a pressure setting to:
shift the sublimatable constituent from a vapor phase of matter to a solid or liquid equilibrium phase of matter by crossing a phase boundary, or
adjust sublimation kinetics within the vapor phase of matter region.

89. The non-transitory computer-readable storage medium of claim 87, wherein terminating or altering the freeze-drying of the substance comprises initiating a completion stage or powering down the one or more energy emitters.

90. The non-transitory computer-readable storage medium of claim 44, the one or more programs further including instructions for:
triggering a completion notification in response to at least one of:
the real-time sublimation rate falling below a sublimation rate threshold for a predefined time duration; and
the cumulative mass meeting or exceeding a cumulative mass threshold for a predefined time duration.

91. The non-transitory computer-readable storage medium of claim 90, the one or more programs further including instructions for:
dynamically adjusting at least one of the sublimation rate threshold and the cumulative mass threshold based on one more of:
a user-defined drying recipe,
prior batch data,
real-time process measurements,
a user-defined dryness percentage,
the cumulative mass removed from the substance, and
a humidity value derived from dew point analysis at a vacuum exhaust.

92. The non-transitory computer-readable storage medium of claim 90, wherein at least one of the sublimation rate threshold and the cumulative mass threshold correspond to a predetermined endpoint condition of a primary drying stage, secondary drying stage, or final drying stage.

93. The non-transitory computer-readable storage medium of claim 44, wherein displaying the real-time cumulative mass indicator includes at least one of:
displaying a numeric value representing a total amount of the sublimatable constituent removed from the substance;
displaying a time-based visualization of the real-time cumulative mass of the sublimatable constituent removed from the substance over time; and
concurrently displaying historical cumulative mass data distinguishable from the real-time cumulative mass of the sublimatable constituent removed from the substance.

94. The non-transitory computer-readable storage medium of claim 90, wherein the cumulative mass threshold corresponds to a predetermined residual moisture level of the substance, the residual moisture level based on at least one of:
a percentage of an initial mass of the sublimatable constituent within the substance; and
a data-driven value correlated with target product characteristics including sensory quality and microbial stability.

95. The non-transitory computer-readable storage medium of claim 94, wherein the initial mass of sublimatable constituent within the substance is calculated based on one or more of:
a thermodynamic model,
spectral analysis including near-infrared (NIR) imaging, and
a moisture ratio of the substance.

96. The non-transitory computer-readable storage medium of claim 95, wherein the thermodynamic model comprises one or more of:
calculating the quantity of energy or power over the one or more predetermined time intervals from known power and duty cycle;
inferring phase of matter transitions based on observed plateaus in temperature; and
cross-referencing energy consumption to modeled latent heat profiles of the substance or the sublimatable constituent.

97. The non-transitory computer-readable storage medium of claim 95, wherein the thermodynamic model comprises modeling thermal transitions based on one or more of:
identifying latent heat of the substance or the sublimatable constituent released during a freezing plateau from temperature-time data;
calculating sensible heat capacity of the substance based on pre- and post-freezing slopes of temperature curves; and
calculating energy or power input to freeze the substance or the sublimatable constituent from refrigeration system power consumption data.

98. The non-transitory computer-readable storage medium of claim 44, the one or more programs further including instructions for:
extrapolating, based on an initial mass of sublimatable constituent within the substance and the real-time sublimation rate or the cumulative mass removed from the substance, a time remaining until completion of freeze-drying the substance; and
displaying, via the display generation component, a completion-time indicator representative of the extrapolated time remaining until completion of freeze-drying.

99. The non-transitory computer-readable storage medium of claim 44, wherein calculating the real-time sublimation rate or the real-time cumulative mass includes applying an efficiency factor representing transfer efficiency of energy or power between the one or more energy emitters and the substance.

100. The method of claim 45, wherein displaying the real-time sublimation rate indicator includes at least one of:
displaying a numeric value representing the real-time sublimation rate of the sublimatable constituent;
displaying a time-based visualization of the real-time sublimation rate of the sublimatable constituent; and
concurrently displaying historical sublimation rate data distinguishable from the real-time sublimation rate.

101. The method of claim 45, further comprising:
displaying, via the display generation component, a rate-of-change indicator derived from the real-time sublimation rate, the rate-of-change indicator including one or more of:
a trend line, a slope indicator, or a rate-of-change curve.

102. The method of claim 45, wherein calculating the sublimation rate comprises applying a model or algorithm based on one or more of:
a real-time temperature of the substance,
a real-time environmental pressure proximate to the substance,
a temperature set point,
a pressure set point,
a known or calculated onset temperature for sublimation of the sublimatable constituent,
a calibration factor derived from prior system behavior,
machine learning or artificial intelligence techniques trained on historical drying data, and
iteratively adjusting one or more model parameters.

103. The method of claim 45, further comprising:
detecting a user input to initiate freeze-drying of the substance; and
in response to detecting the user input:
initiating freeze-drying the substance, and
enabling monitoring of one or both of the real-time sublimation rate of the sublimatable constituent and the real-time cumulative mass of the sublimatable constituent removed from the substance.

104. The method of claim 45, further comprising:
terminating or altering freeze-drying of the substance in response to at least one of:
the real-time sublimation rate or a time-derivative of the real-time sublimation rate falling below a threshold for a predefined time duration; and
the real-time cumulative mass meeting or exceeding a cumulative mass threshold for a predefined time duration.

105. The method of claim 104, wherein terminating or altering freeze-drying of the substance comprises modifying at least one of a temperature and a pressure setting to:
shift the sublimatable constituent from a vapor phase of matter to a solid or liquid equilibrium phase of matter by crossing a phase boundary, or
adjust sublimation kinetics within the vapor phase of matter region.

106. The method of claim 104, wherein terminating or altering the freeze-drying of the substance comprises initiating a completion stage or powering down the one or more energy emitters.

107. The method of claim 45, further comprising:
triggering a completion notification in response to at least one of:
the real-time sublimation rate falling below a sublimation rate threshold for a predefined time duration; and
the cumulative mass meeting or exceeding a cumulative mass threshold for a predefined time duration.

108. The method of claim 107, further comprising:
dynamically adjusting at least one of the sublimation rate threshold and the cumulative mass threshold based on one more of:
a user-defined drying recipe,
prior batch data,
real-time process measurements,
a user-defined dryness percentage,
the cumulative mass removed from the substance, and
a humidity value derived from dew point analysis at a vacuum exhaust.

109. The method of claim 107, wherein at least one of the sublimation rate threshold and the cumulative mass threshold correspond to a predetermined endpoint condition of a primary drying stage, secondary drying stage, or final drying stage.

110. The method of claim 45, wherein displaying the real-time cumulative mass indicator includes displaying at least one of:
displaying a numeric value representing a total amount of the sublimatable constituent removed from the substance;
displaying a time-based visualization of the real-time cumulative mass of the sublimatable constituent removed from the substance; and
concurrently displaying historical cumulative mass data distinguishable from the real-time cumulative mass of the sublimatable constituent removed from the substance.

111. The method of claim 107, wherein the cumulative mass threshold corresponds to a predetermined residual moisture level of the substance, the residual moisture level based on at least one of:
a percentage of an initial mass of the sublimatable constituent within the substance; and
a data-driven value correlated with target product characteristics including sensory quality and microbial stability.

112. The method of claim 111, wherein the initial mass of sublimatable constituent within the substance is calculated based on one or more of:
a thermodynamic model,
spectral analysis including near-infrared (NIR) imaging, and
a moisture ratio of the substance.

113. The method of claim 112, wherein the thermodynamic model comprises one or more of:
calculating the quantity of energy or power over the one or more predetermined time intervals from known power and duty cycle;
inferring phase of matter transitions based on observed plateaus in temperature; and
cross-referencing energy consumption to modeled latent heat profiles of the substance or the sublimatable constituent.

114. The method of claim 112, wherein the thermodynamic model comprises modeling thermal transitions based on one or more of:
identifying latent heat of the substance or the sublimatable constituent released during a freezing plateau from temperature-time data;
calculating sensible heat capacity of the substance or the sublimatable constituent based on pre- and post-freezing slopes of temperature curves; and
calculating energy or power input to freeze the substance or the sublimatable constituent from refrigeration system power consumption data.

115. The method of claim 45, further comprising:
extrapolating, based on an initial mass of sublimatable constituent within the substance and the real-time sublimation rate or the cumulative mass removed from the substance, a time remaining until completion of freeze-drying the substance; and
displaying, via the display generation component, a completion-time indicator representative of the extrapolated time remaining until completion of freeze-drying.

116. The method of claim 45, wherein calculating the real-time sublimation rate or the real-time cumulative mass includes applying an efficiency factor representing transfer efficiency of energy or power between the one or more energy emitters and the substance.
